(19) United States
(12) Patent Application Publication
(10) Pub. No.: US 2012/0214679 A1
(43) Pub. Date: Aug. 23, 2012

(54) METHODS AND SYSTEMS FOR EVALUATING THE SENSITIVITY OR RESISTANCE OF TUMOR SPECIMENS TO CHEMOTHERAPEUTIC AGENTS

(75) Inventors: Michael GABRIN, Pittsburgh, PA (US); Kui Shen, Pittsburgh, PA (US); Nan Song, Pittsburgh, PA (US); Zhenyu Ding, Pittsburgh, PA (US); David Gingrich, Pittsburgh, PA (US)

(73) Assignee: Precision Therapeutics, Inc., Pittsburgh, PA (US)

(21) Appl. No.: 13/304,990

(22) Filed: Nov. 28, 2011

Related U.S. Application Data
(60) Provisional application No. 61/417,678, filed on Nov. 29, 2010.
(60) Provisional application No. 61/469,364, filed on Mar. 30, 2011.

(51) Int. Cl. C40B 30/04; C40B 40/06

(52) U.S. Cl. 506/9; 506/16

(57) ABSTRACT

The present invention provides methods, systems, and kits for evaluating the sensitivity and/or resistance of tumor specimens to one or a combination of chemotherapeutic agents. Particularly, the invention provides malignant cell gene signatures that are predictive of a tumor's response to candidate chemotherapeutic regimens.

### PRIORITY

This application claims the benefit of U.S. Provisional Application No. 61/417,678, filed Nov. 29, 2010, and U.S. Provisional Application No. 61/469,364, filed Mar. 30, 2011.

### FIELD OF THE INVENTION

The present invention relates to the field of molecular diagnostics, and particularly to gene expression signatures that are indicative of a tumor's sensitivity and/or resistance to chemotherapeutic agents or combinations of agents, including chemotherapeutic agents, small molecule agents, biologics, and targeted therapies. The subject matter of this application is related to PCT/US2010/036854, filed Jun. 1, 2010, which are hereby incorporated by reference in their entireties.

### BACKGROUND

Traditionally, treatments for cancer patients are selected based on agents and regimens identified to be most effective in large randomized clinical trials. However, since such therapy is not individualized, this approach often results in the administration of sub-optimal chemotherapy. The administration of sub-optimal or ineffective chemotherapy to a particular patient can lead to unsuccessful treatment, including death, disease progression, unnecessary toxicity, and higher health care costs.

In an attempt to individualize cancer treatment, in vitro drug-response assay systems (chemoresponse assays) and gene expression signatures have been developed to guide patient treatment decisions. However, the use of these systems are not sufficiently widespread due, in-part, to difficulties in interpreting the data in a clinically meaningful way, as may be required in many instances to drive administration of an individualized treatment regimen. For example, while in vitro systems are recognized as predicting generally inactive and/or generally active agents, and/or for predicting short-term responses, such systems are not generally recognized as providing accurate estimations of patient survival with particular treatment regimens (Fruehauf et al., Endocrine-Related Cancer 9:171-182 (2002). Further, gene expression signatures sufficient to guide patient treatment are difficult to validate, generally taking many years to identify and validate in independent patient populations. For example, identifying and validating gene expression signatures in independent patient populations generally requires access to large numbers of patient samples as well as corresponding clinical data, including the chosen course of treatment and treatment outcome.

A system that provides convenient, cost-effective and accurate results with regard to a tumor's sensitivity or resistance to candidate treatments would encourage more individualized treatment plans. Such methods could present a clear advantage of an individualized treatment regimen, as compared to a non-individualized selection of agents based on large randomized trials.

### SUMMARY OF THE INVENTION

The present invention provides methods, systems, and kits for preparing gene expression profiles that are indicative of a tumor's sensitivity and/or resistance to chemotherapeutic agents or combinations. Thus, the invention further provides methods systems, and kits for evaluating the sensitivity and/or resistance of tumor specimens to one or a combination of therapeutic agents. Particularly, the invention provides malignant cell, gene expression signatures that are indicative of a tumor's sensitivity and/or resistance to candidate therapeutic regimens.

In one aspect, the invention provides methods for preparing gene expression profiles for tumor specimens and cultured cells, as well as methods for predicting a tumor's sensitivity or resistance to therapeutic agents or combinations by evaluating tumor gene expression profiles for the presence of indicative gene expression signatures. The method comprises preparing a gene expression profile for a patient tumor specimen, and evaluating the gene expression profile for the presence of one or more gene expression signatures, each gene expression signature being indicative of sensitivity or resistance to a therapeutic agent or combination of agents. By predicting the tumor's sensitivity or resistance to candidate chemotherapeutic agents, the invention thereby provides information to guide individualized cancer treatment.

The gene expression profile may be prepared directly from patient specimens, e.g., by a process comprising RNA extraction or isolation directly from tumor specimens, or alternatively, and particularly where specimens are amenable to culture, malignant cells may be enriched (e.g., expanded) in culture for gene expression analysis. For example, malignant cells may be enriched in culture by disaggregating or mincing the tumor specimen to prepare tumor tissue explants, and allowing one or more tumor tissue explants to form a cell culture monolayer. RNA is then extracted from the cultured cells for gene expression analysis. The resulting gene expression profile, whether prepared directly from patient tumor tissue or prepared from cultured cells, contains gene transcript levels (or “expression levels”) for genes that are representative of the cells sensitivity or resistance to chemotherapeutic agents and/or combinations of agents.

The gene expression profile may be evaluated for the presence of one or more indicative gene expression signatures. For example, the profiles are compared to one or more gene expression signatures that are each indicative of sensitivity or resistance to a candidate agent or combination of agents, to thereby score or classify the patient's specimen as sensitive or resistant to such agents or combinations. The gene expression signatures in some embodiments include those generally applicable to a variety of cancer types and/or therapeutic agent(s). Alternatively, or in addition, the gene expression signatures are predictive for a particular type of cancer, such as breast cancer, and/or for a particular course of treatment. The gene expression signature may be predictive of survival or duration of survival, a pathological complete response (pCR) to treatment, or other measure of patient outcome, such as progression free interval or tumor size, among others.

For example, the gene expression signature may be indicative of sensitivity or resistance to one or more of paclitaxel, fluorouracil, doxorubicin, and cyclophosphamide, or the combination (e.g., “TFAC”), and exemplary gene expression signatures according to this embodiment are disclosed in Table 1. In another embodiment, the gene expression signature is indicative of sensitivity and/or resistance to treatment with one or more of epirubicin and/or cyclophosphamide (e.g., “EC” combination), and such exemplary gene expression signatures are disclosed in Table 2. In another embodiment, the gene expression signature may be indicative of sensitivity or resistance to one or more of fluorouracil, epirubicin and cyclophosphamide, (e.g., “FEC” combination), and exemplary gene expression signatures according to this embodiment are disclosed in Table 3. Still further, the gene expression signature may be indicative of sensitivity or resistance to one or more of doxorubicin and cyclophosphamide (e.g., “AC” combination), and exemplary gene expression signatures according to this embodiment are disclosed in Table 4 and Table 9. In another embodiment, the gene signature is indicative of sensitivity or resistance to one or more of doxorubicin, cyclophosphamide and docetaxel (e.g., “ACT” combination), and exemplary gene expression signatures in accordance with this embodiment are disclosed in Table 5 and Table 10. In another embodiment, the gene expression signature is indicative of sensitivity or resistance to one or more of Cyclophosphamide, Epirubicin, Fluorouracil, and Paclitaxel (e.g., “TFEC” combination), and exemplary gene expression signatures in accordance with this embodiment are disclosed in Table 6 and Table 8. In another embodiment, the gene expression signature is indicative of sensitivity or resistance to one or more of Docetaxel and Fluorouracil (e.g., “DX” combination), and exemplary gene expression signatures in accordance with this embodiment are disclosed in Table 7. Such gene expression signatures were identified in cancer cell lines by correlating the level of in vitro chemosensitivity with levels of gene expression. Resulting gene expression signatures were independently validated in patient test populations as described in detail herein.

In some embodiments, the results of gene expression analysis are combined with results from in vitro chemosensitivity testing, to provide a more complete and/or accurate prognostic and/or predictive tool for guiding patient therapy.

In a related aspect, the invention provides methods for determining gene expression signatures that are indicative of a tumor or cancer cell's sensitivity to a chemotherapeutic agent or combination. Such gene expression signatures are first identified in cancer cells by correlating the level of in vitro chemosensitivity with gene expression levels. The cultured cells may be immortalized cell lines, or may be derived directly from patient tumor specimens, for example, by enriching or expanding malignant epithelial cells from the tumor specimen in monolayer culture, and suspending the cultured cells for testing and/or RNA isolation. The resulting gene expression signatures are then independently validated in patient test populations having available gene expression data and corresponding clinical data, including information regarding the treatment regimen and outcome of treatment. This aspect of the invention reduces the length of time and quantity of patient samples needed for identifying and validating such gene expression signatures.

In other aspects, the invention provides computer systems and kits (e.g., arrays, bead sets, and probe sets) for generating gene expression profiles that are useful for predicting a patient's response to a chemotherapeutic agent or combination, for example, in connection with the methods of the invention.

### DESCRIPTION OF THE FIGURES

FIG. 1 illustrates a method for identifying and validating gene expression signatures. Cancer cell lines are used for determining gene expression levels, as well as levels of in vitro sensitivity/resistance to therapeutics agents or combinations of agents (e.g., using CHEMOFX). Gene expression signatures indicative of resistance and/or sensitivity to these agents or combinations in vitro are identified by correlating in vitro responses with gene expression levels. The resulting gene expression signature(s) are validated in a patient population by evaluating patient tumor gene expression data for the presence of the gene expression signatures. Patient samples are scored and/or classified as resistant and/or sensitive to chemotherapeutic agents on the basis of the gene signatures, thereby obtaining an outcome prediction. The accuracy of the classification or prediction is tested by comparing the prediction with the actual outcome of treatment.

FIG. 2 illustrates the accuracy of a 350-gene signature from Table 1 for predicting pCR in an independent patient population (133 neoadjuvant breast cancer patients treated with TFAC). Outcome is pathological complete response (pCR). The results are shown as a receiver operator curve (ROC). When using one third of the prediction scores as cutoff, the accuracy is 0.73, sensitivity is 0.62 and specificity is 0.78. The right panel shows that the gene expression signature of Table 1 is stable over a large range of increasing gene number, from less than about 10 to over 1000 genes (Table 1 lists the top 350 genes/probes).

FIG. 3 illustrates the accuracy of a 350-gene signature from Table 2 for predicting pCR in an independent patient population (37 neoadjuvant breast cancer patients treated with EC). Outcome is pathological complete response (pCR). The results are shown as a receiver operator curve (ROC). When using one third of the prediction scores as cutoff, the accuracy is 0.71, sensitivity is 0.56 and specificity is 0.77. The right panel shows that the gene expression signature of Table 2 is stable over a large range of increasing gene number, from less than about 10 to over 1000 genes (Table 2 lists the top 350 genes/probes).

FIG. 4 illustrates the accuracy of a 350-gene signature from Table 3 for predicting pCR in an independent patient population (87 neoadjuvant breast cancer patients treated with FAC). Outcome is pathological complete response (pCR). The results are shown as a receiver operator curve (ROC). When using one third of the prediction scores as cutoff, the accuracy is 0.69, sensitivity is 0.57 and specificity is 0.70. The right panel shows that the gene expression signature of Table 3 is stable over a large range of increasing gene number, from less than about 10 to over 1000 genes (Table 3 lists the top 350 genes/probes).

FIG. 5 shows prediction results for patients receiving FEC/TX with and without H treatment. A: ROC curve for TFEC MGP for all patients who did not receive H treatment. B: ROC for TFEC MGP for all patients who received H treatment. C: ROC curve for TFEC MGP for ER− patients who did not receive H treatment. D: ROC curve for TFEC MGP for ER+ patients who did not receive H treatment.

FIG. 6 shows the accuracy of a 417-gene signature from Table 9 for predicting pCR in an independent patient population (220 patients who received pre-operative AC). Outcome is pathological complete response (pCR). The results are shown as a receiver operator curve (ROC) for: all patients, ER− patients, and ER+ patients.

FIG. 7 shows the accuracy of a 438-gene signature from Table 10 for predicting pCR in an independent population (102 patients who received pre-operative AC+T). Outcome is pathological complete response (pCR). The results are shown as a receiver operator curve (ROC) for: all patients, ER− patients, and ER+ patients.

### DETAILED DESCRIPTION OF THE INVENTION

The present invention provides methods, systems, and kits for preparing gene expression profiles that are indicative of a tumor's sensitivity and/or resistance to chemotherapeutic agents or combinations. Thus, the invention further provides methods systems, and kits for evaluating the sensitivity and/or resistance of tumor specimens to one or a combination of chemotherapeutic agents. The invention provides malignant cell gene expression signatures that are indicative of a tumor's sensitivity and/or resistance to candidate chemotherapeutic regimens.

### Methods for Gene Expression Profiling and Predicting Response to Treatment

The invention provides methods for preparing gene expression profiles for tumor specimens, as well as methods for evaluating a tumor's sensitivity and/or resistance to one or more chemotherapeutic agents or combinations of agents. For example, the gene expression profile generated for a tumor specimen, or cultured cells derived therefrom, is evaluated for the presence of one or more indicative gene expression signatures. The gene expression signatures are indicative of a response to a treatment regimen. In this aspect, the invention provides information to guide a physician in designing/administering an individualized chemotherapeutic regimen for a cancer patient.

The patient generally is one with a cancer or neoplastic condition, such as one that is treated with the therapeutic agents described herein. The patient may suffer from cancer of essentially any tissue or organ, including breast, ovaries, lung, colon, skin, prostate, kidney, endometrium, nasopharynx, pancreas, head and neck, kidney, and brain, among others. The patient may be inflicted with a carcinoma or sarcoma. The patient may have a solid tumor of epithelial origin. The tumor specimen may be obtained from the patient by surgery, or may be obtained by biopsy, such as a fine needle biopsy or other procedure prior to the selection/initiation of therapy. In certain embodiments, the cancer is breast cancer, including preoperative or post-operative breast cancer. In certain embodiments, the patient has not undergone treatment to remove the breast tumor, and therefore is a candidate for neoadjuvant therapy.

The cancer may be primary or recurrent, and may be of any type (as described above), stage (e.g., Stage I, II, III, or IV or an equivalent of other staging system), and/or histology (e.g., serous adenocarcinoma, endometroid adenocarcinoma, mucinous adenocarcinoma, undifferentiated adenocarcinoma, transitional cell adenocarcinoma, or adenocarcinoma, etc.). The patient may be of any age, sex, performance status, and/or extent and duration of remission.

In certain embodiments, the patient is a candidate for treatment with the combination of cyclophosphamide, doxorubicin, fluorouracil, and paclitaxel (“TFAC”). In other embodiments, the patient is a candidate for treatment with the combination of doxorubicin, fluorouracil, and cyclophosphamide (“FAC”). In other embodiments, the patient is a candidate for treatment with the combination of cyclophosphamide and epirubicin (“EC”). Still further, the patient may be a candidate for treatment with the combination of cyclophosphamide and doxorubicin (“AC”). In other embodiments, the patient is a candidate for treatment with the combination of cyclophosphamide, docetaxel, and doxorubicin (“ACT”). In other embodiments, the patient is a candidate for treatment with the combination with cyclophosphamide, epirubicin, fluorouracil, and docetaxel (“TFEC”). In other embodiments, the patient is a candidate for treatment with a combination of docetaxel and fluorouracil (“DX”). As used herein in the context of patient treatment, the term “combination” includes any treatment regimen with the particular set of agents. For example, the combination TFEC includes treatment with cycles of FEC followed by cycles of T.

The gene expression profile is determined for a tumor tissue or cell sample, such as a tumor sample removed from the patient by surgery or biopsy. The tumor sample may be “fresh,” in that it was removed from the patent within about five days of processing, and remains suitable or amenable to culture. In some embodiments, the tumor sample is not “fresh,” in that the sample is not suitable or amenable to culture. Tumor samples are generally not fresh after from 3 to 7 days (e.g., about five days) of removal from the patient. The sample may be frozen after removal from the patient, and preserved for later RNA isolation. The sample for RNA isolation may be a formalin-fixed paraffin-embedded (FFPE) tissue.

In certain embodiments, the malignant cells are enriched or expanded in culture by forming a monolayer culture from tumor sample explants. For example, cohesive multicellular particulates (explants) are prepared from a patient's tissue sample (e.g., a biopsy sample or surgical specimen) using mechanical fragmentation. This mechanical fragmentation of the explant may take place in a medium substantially free of enzymes that are capable of digesting the explant. Some enzymatic digestion may take place in certain embodiments, such as for ovarian or colorectal tumors.

For example, where it is desirable to expand and/or enrich malignant cells in culture relative to non-malignant cells that reside in the tumor, the tissue sample is systematically minced using two sterile scalpels in a scissor-like motion, or mechanically equivalent manual or automated opposing incisor blades. This cross-cutting motion creates smooth cut edges on the resulting tissue multicellular particulates. The tumor particulates each measure from about 0.25 to about 1.5 mm³, for example, about 1 mm³. After the tissue sample has been minced, the particles are plated in culture flasks. The number of explants plated per flask may vary, for example, between 1 and 25, such as from 5 to 20 explants per flask. For example, about 9 explants may be plated per T-25 flask, and 20 particulates may be plated per T-75 flask. For purposes of illustration, the explants may be evenly distributed across the bottom surface of the flask, followed by initial inversion for about 10-15 minutes. The flask may then be placed in a non-inverted position in a 37° C. CO₂ incubator for about 5-10 minutes. Flasks are checked regularly for growth and contamination. Over a period of days to a few weeks a cell monolayer will form.

Further, it is believed that tumor cells grow out from the multicellular explant prior to stromal cells. Thus, by initially maintaining the tissue cells within the explant and removing the explant at a predetermined time (e.g., at about 10 to about 50 percent confluency, or at about 15 to about 25 percent confluency), growth of the tumor cells (as opposed to stromal cells) into a monolayer is facilitated. In certain embodiments, the tumor explant may be agitated to substantially loosen or release tumor cells from the tumor explant, and the released cells cultured to produce a cell culture monolayer. The use of this procedure to form a cell culture monolayer helps maximize the growth of representative malignant cells from the tissue sample. Monolayer growth rate and/or cellular morphology (e.g., epithelial character) may be monitored using, for example, a phase-contrast inverted microscope. Generally, the cells of the monolayer should be actively growing at the time the cells are suspended for RNA extraction. IHC may be used to determine the epithelial character of the cultured cells.

The process for enriching or expanding malignant cells in culture is described in U.S. Pat. Nos. 5,728,541, 6,900,027, 6,887,680, 6,933,129, 6,416,967, 7,112,415, 7,314,731, and 7,501,260 (all of which are hereby incorporated by reference in their entireties). The process may further employ the variations described in US Published Patent Application Nos. 2007/0059821 and 2008/0085519, both of which are hereby incorporated by reference in their entireties.

In preparing the gene expression profile, RNA is extracted from the tumor tissue or cultured cells by any known method. For example, RNA may be purified from cells using a variety of standard procedures as described, for example, in RNA Methodologies, A laboratory guide for isolation and characterization, 2nd edition, 1998, Robert E. Farrell, Jr., Ed., Academic Press. In addition, there are various products commercially available for RNA isolation which may be used. Total RNA or polyA+ RNA may be used for preparing gene expression profiles in accordance with the invention.

The gene expression profile is then generated for the samples using any of various techniques known in the art, and described in detail elsewhere herein. Such methods generally include, without limitation, hybridization-based assays, such as microarray analysis and similar formats (e.g., Whole Genome DASL™ Assay, Illumina, Inc.), polymerase-based assays, such as RT-PCR (e.g., Taqman™), flap-endonuclease-based assays (e.g., Invader™), as well as direct mRNA capture with branched DNA (QuantiGene™) or Hybrid Capture™ (Digene).

The gene expression profile contains gene expression levels for a plurality of genes whose expression levels are predictive or indicative of the tumor's response to one or a combination of chemotherapeutic agents. Such genes are listed collectively in Tables 1-10. As used herein, the term “gene,” refers to a DNA sequence expressed in a sample as an RNA transcript, and may be a full-length gene (protein encoding or non-encoding) or an expressed portion thereof such as expressed sequence tag or “EST.” Thus, the genes listed in Tables 1-10 are each independently a full-length gene sequence, whose expression product is present in samples, or is a portion of an expressed sequence detectable in samples, such as an EST sequence. The probe and gene sequences listed in Tables 1-10 are publicly available, and such sequences are hereby incorporated by reference.

The genes listed in Tables 1-10 may be differentially expressed in drug-sensitive samples versus drug-resistant (e.g., non-responsive) samples as described below. As used herein, “differentially expressed” means that the level or abundance of an RNA transcript (or abundance of an RNA population sharing a common target (or probe-hybridizing) sequence, such as a group of splice variant RNAs) is significantly higher or lower in a drug-sensitive sample as compared to a reference level (e.g., a drug resistant or non-responsive sample). For example, the level of the RNA or RNA population may be higher or lower than a reference level. The reference level may be the level of the same RNA or RNA population in a control sample or control population (e.g., a Mean level for a drug-resistant or non-responsive sample), or may represent a cut-off or threshold level for a sensitive or resistant designation.

Gene expression profiles for the cell lines tested herein, determined with the hgu133a+2 microarray platform (Affymetrix), are publicly available (Hoeflich et al: In vivo Antitumor Activity of MEK and Phosphatidylinositol 3-Kinase Inhibitors in Basal-Like Breast Cancer Models. Clinical Cancer Research 2009, 15(14):4649-4664 (which is hereby incorporated by reference in its entirety). Also see the Gene Expression Omnibus database (e.g., Accession No. GSE12777).

Table 1 lists genes that are expressed at significantly different levels in TFAC-sensitive and TFAC-resistant cell lines. TFAC refers to the combination cyclophosphamide, doxorubicin, fluorouracil, and paclitaxel. Table 2 lists genes that are expressed at significantly different levels in EC-sensitive versus EC-resistant cell lines. EC refers to the combination cyclophosphamide and doxorubicin. Table 3 lists genes that are expressed at significantly different levels in FEC-sensitive versus FEC-resistant cell lines. FEC refers to the combination of cyclophosphamide, fluorouracil and epirubicin. Tables 4 and 9 list genes that are expressed at significantly different levels in AC-sensitive versus AC-resistant cell lines. AC refers to the combination of cyclophosphamide and doxorubicin. Tables 5 and 10 list genes that are expressed at significantly different levels in ACT-sensitive versus ACT-resistant cell lines. ACT refers to the combination cyclophosphamide, docetaxel, and doxorubicin. Table 6 and Table 8 each list genes that are expressed at significantly different levels in TFEC-sensitive versus TFEC-resistant cell lines. TFEC refers to the combination cyclophosphamide, fluorouracil, epirubicin, and paclitaxel. Table 7 lists genes that are expressed at significantly different levels in DX-sensitive versus DX-resistant cell lines. DX refers to the combination docetaxel and fluorouracil. Sequences that correspond to these genes are known, and the publicly available sequences are hereby incorporated by reference.

Tables 1-8 include the sensitive and resistant mean expression scores for each gene (or probe), and list the fold change from sensitive to resistant to TFAC, EC, FEC, AC, ACT, TFEC, and DX. For example, where x is the mean expression score for sensitive cell lines for a particular gene, and y is the mean expression score for resistant cell lines for that gene, fold change is represented by mean X/mean Y. Sensitivity and resistance to the indicated drug or combination were determined for each cell line in vitro as an AUC value essentially as described herein, and the top ⅓ values were designated as sensitive, and the bottom ⅓ values were designated as resistant.

Thus, in accordance with this aspect, the gene expression profile, which is generated from the tumor specimen or malignant cells cultured therefrom as described, may contain the levels of expression for at least about 3 genes listed in Table 1. In some embodiments, the patient's gene expression profile contains the levels of expression for at least about 5, 7, 10, 12, 15, 20, 25, 40, 50, 75, 100, or 200 genes listed in Table 1, such genes being differentially expressed in drug-sensitive tumor cells (e.g., TFAC-sensitive cells) versus drug resistant tumor cells, and which may be breast cancer cells. In some embodiments, the gene expression profile may contain the levels of expression for all or substantially all genes listed in Table 1 such as at least about 250, 300, or 350 genes. In some embodiments, the gene expression profile contains the expression levels of no more than 2000 genes, 1000 genes, or 500 genes so as to allow profiles to be prepared from custom detection assays (e.g., custom microarray), where the profile includes the genes from Table 1. The profile may be generated in some embodiments with the probes disclosed in Table 1.

Alternatively or in addition, the gene expression profile may contain the levels of expression for at least about 3 genes listed in Table 2. In some embodiments, the patient's gene expression profile contains the levels of expression for at least about 5, 7, 10, 12, 15, 20, 25, 40, 50, 75, 100, or 200 genes listed in Table 2, such genes being differentially expressed in drug-sensitive tumor cells (e.g., EC-sensitive cells) versus drug resistant tumor cells, and which may be breast cancer cells. In some embodiments, the gene expression profile may contain the levels of expression for all or substantially all genes listed in Table 2, such as at least about 250, 300 or 350 genes. In some embodiments, the gene expression profile contains the expression levels of no more than 2000 genes, 1000 genes, or 500 genes, including the genes from Table 2. The profile may be generated in some embodiments with the probes disclosed in Table 2.

Alternatively or in addition, the gene expression profile may contain the levels of expression for at least about 3 genes listed in Table 3. In some embodiments, the patient's gene expression profile contains the levels of expression for at least about 5, 7, 10, 12, 15, 20, 25, 40, 50, 75, 100, or 200 genes listed in Table 3, such genes being differentially expressed in drug-sensitive tumor cells (e.g., FEC-sensitive cells) versus drug resistant tumor cells, and which may be breast cancer cells. In some embodiments, the gene expression profile may contain the levels of expression for all or substantially all genes listed in Table 3, such as at least about 250, 300 or 350 genes. In some embodiments, the gene expression profile contains the expression levels of no more than 2000 genes, 1000 genes, or 500 genes, including the genes from Table 3. The profile may be generated in some embodiments with the probes disclosed in Table 3.

Alternatively or in addition, the gene expression profile may contain the levels of expression for at least about 3 genes listed in Table 4 or Table 9. In some embodiments, the patient's gene expression profile contains the levels of expression for at least about 5, 7, 10, 12, 15, 20, 25, 40, 50, 75, 100, or 200 genes listed in Table 4 or Table 9, such genes being differentially expressed in drug-sensitive tumor cells (e.g., AC-sensitive cells) versus drug resistant tumor cells, and which may be breast cancer cells. In some embodiments, the gene expression profile may contain the levels of expression for all or substantially all genes listed in Tables 4 and/or 9, such as at least about 250, 300, or 350 genes. In some embodiments, the gene expression profile contains the expression levels of no more than 2000 genes, 1000 genes, or 500 genes, including the genes from Table 4 or Table 9. The profile may be generated in some embodiments with the probes disclosed in Table 4 or Table 9.

Alternatively or in addition, the gene expression profile may contain the levels of expression for at least about 3 genes listed in Table 5 or Table 10. In some embodiments, the patient's gene expression profile contains the levels of expression for at least about 5, 7, 10, 12, 15, 20, 25, 40, 50, 75, 100, or 200 genes listed in Table 5 or Table 10, such genes being differentially expressed in drug-sensitive tumor cells (e.g., ACT-sensitive cells) versus drug resistant tumor cells, and which may be breast cancer cells. In some embodiments, the gene expression profile may contain the levels of expression for all or substantially all genes listed in Table 5 or Table 10, such as at least about 250, 300, or 350 genes. In some embodiments, the gene expression profile contains the expression levels of no more than 2000 genes, 1000 genes, or 500 genes, including the genes from Table 5 or Table 10. The profile may be generated in some embodiments with the probes disclosed in Table 5 or Table 10.

Alternatively or in addition, the gene expression profile may contain the levels of expression for at least about 3 genes listed in Table 6 or Table 8. In some embodiments, the patient's gene expression profile contains the levels of expression for at least about 5, 7, 10, 12, 15, 20, 25, 40, 50, 75, 100, or 200 genes listed in Table 6 or Table 8, such genes being differentially expressed in drug-sensitive tumor cells (e.g., TFEC-sensitive cells) versus drug resistant tumor cells, and which may be breast cancer cells. In some embodiments, the gene expression profile may contain the levels of expression for all or substantially all genes listed in Table 6 or Table 8, such as at least about 250, 300, or 350 genes. In some embodiments, the gene expression profile contains the expression levels of no more than 2000 genes, 1000 genes, or 500 genes, including the genes from Table 6 or Table 8. The profile may be generated in some embodiments with the probes disclosed in Table 6 or Table 8.

Alternatively or in addition, the gene expression profile may contain the levels of expression for at least about 3 genes listed in Table 7. In some embodiments, the patient's gene expression profile contains the levels of expression for at least about 5, 7, 10, 12, 15, 20, 25, 40, 50, 75, 100, or 200 genes listed in Table 7, such genes being differentially expressed in drug-sensitive tumor cells (e.g., DX-sensitive cells) versus drug resistant tumor cells, and which may be breast cancer cells. In some embodiments, the gene expression profile may contain the levels of expression for all or substantially all genes listed in Table 7, such as at least about 250, 300, or 350 genes. In some embodiments, the gene expression profile contains the expression levels of no more than 2000 genes, 1000 genes, or 500 genes, including the genes from Table 7. The profile may be generated in some embodiments with the probes disclosed in Table 7.

The gene expression profile prepared according to this aspect of the invention is evaluated for the presence of one or more drug-sensitive and/or drug-resistant signatures. The gene expression signature(s) comprise the gene expression levels indicative of a drug-sensitive and/or drug-resistant cell, so as to enable a classification of the tumor's profile as sensitive or resistant. Specifically, the gene expression signature comprises indicative gene expression levels for a plurality of genes listed in one or more of Tables 1-10, such as at least 5, 7, 10, 12, 15, 20, 25, 40, 50, 75, 100, 200, 250, 300, or 350 genes listed in one or more of Tables 1-10. The signature may comprise the Mean expression levels listed in Tables 1-10 or alternatively, may be prepared from other data sets or using other statistical criteria.

The gene expression signature(s) may be in a format consistent with any nucleic acid detection format, such as those described herein, and will generally be comparable to the format used for profiling patient samples. For example, the gene expression signature and patient profiles may both be prepared by nucleic acid hybridization method, and with the same hybridization platform and controls so as to facilitate comparisons. The gene expression signatures may further embody any number of statistical measures to distinguish drug-sensitive and/or drug-resistant levels, including Mean or Median expression levels and/or cut-off or threshold values. Such signatures may be prepared from the data sets disclosed herein or independent gene expression data sets.

Once the gene expression profile for patient samples are prepared, the profile is evaluated for the presence of one or more of the gene signatures, by scoring or classifying the patient profile against each gene signature.

Various classification schemes are known for classifying samples between two or more classes or groups, and these include, without limitation: Principal Components Analysis, Naïve Bayes, Support Vector Machines, Nearest Neighbors, Decision Trees, Logistic, Artificial Neural Networks, and Rule-based schemes. In addition, the predictions from multiple models can be combined to generate an overall prediction. For example, a “majority rules” prediction may be generated from the outputs of a Naïve Bayes model, a Support Vector Machine model, and a Nearest Neighbor model.

Thus, a classification algorithm or “class predictor” may be constructed to classify samples. The process for preparing a suitable class predictor is reviewed in R. Simon, Diagnostic and prognostic prediction using gene expression profiles in high-dimensional microarray data, British Journal of Cancer (2003) 89, 1599-1604, which review is hereby incorporated by reference in its entirety.

Generally, the gene expression profiles for patient specimens are scored or classified as drug-sensitive signatures or drug-resistant signatures, including with stratified or continuous intermediate classifications or scores reflective of drug sensitivity. As discussed, such signatures may be assembled from gene expression data disclosed herein (Tables 1-8), or prepared from independent data sets. The signatures may be stored in a database and correlated to patient tumor gene expression profiles in response to user inputs.

After comparing the patient's gene expression profile to the drug-sensitive and/or drug-resistant signature, the sample is classified as, or for example, given a probability of being, a drug-sensitive profile or a drug-resistant (e.g., non-responsive) profile. The classification may be determined computationally based upon known methods as described above. The result of the computation may be displayed on a computer screen or presented in a tangible form, for example, as a probability (e.g., from 0 to 100%) of the patient responding to a given treatment. The report will aid a physician in selecting a course of treatment for the cancer patient. For example, in certain embodiments of the invention, the patient's gene expression profile will be determined to be a drug-sensitive profile on the basis of a probability, and the patient will be subsequently treated with that drug or combination. In other embodiments, the patient's profile will be determined to be a drug-resistant profile, thereby allowing the physician to exclude that candidate treatment for the patient, thereby sparing the patient the unnecessary toxicity.

In various embodiments, the method according to this aspect of the invention distinguishes a drug-sensitive tumor from a drug-resistant tumor with at least about 60%, 75%, 80%, 85%, 90% or greater accuracy. In this respect, the method according to this aspect may lend additional or alternative predictive value over standard methods, such as for example, gene expression tests known in the art, or chemoresponse testing.

The methods of the invention aid the prediction of an outcome of treatment. That is, the gene expression signatures are each predictive of an outcome upon treatment with a candidate agent or combination. The outcome may be quantified in a number of ways. For example, the outcome may be an objective response, a clinical response, or a pathological response to a candidate treatment. The outcome may be determined based upon the techniques for evaluating response to treatment of solid tumors as described in Therasse et al., New Guidelines to Evaluate the Response to Treatment in Solid Tumors, J. of the National Cancer Institute 92(3):205-207 (2000), which is hereby incorporated by reference in its entirety. For example, the outcome may be survival (including overall survival or the duration of survival), progression-free interval, or survival after recurrence. The timing or duration of such events may be determined from about the time of diagnosis or from about the time treatment (e.g., chemotherapy) is initiated. Alternatively, the outcome may be based upon a reduction in tumor size, tumor volume, or tumor metabolism, or based upon overall tumor burden, or based upon levels of serum markers especially where elevated in the disease state (e.g., PSA). The outcome in some embodiments may be characterized as a complete response, a partial response, stable disease, and progressive disease, as these terms are understood in the art.

In certain embodiments, the gene signature is indicative of a pathological complete response upon treatment with a particular candidate agent or combination (as already described). A pathological complete response, e.g., as determined by a pathologist following examination of tissue (e.g., breast and/or nodes in the case of breast cancer) removed at the time of surgery, generally refers to an absence of histological evidence of invasive tumor cells in the surgical specimen.

### Chemoresponse Assay

The present invention may further comprise conducting chemoresponse testing with a panel of chemotherapeutic agents on cultured cells from a cancer patient, to thereby add additional predictive value. That is, the presence of one or more gene expression signatures in tumor cells, and the in vitro chemoresponse results for the tumor specimen, are used to predict an outcome of treatment (e.g., survival, pCR, etc.). For example, where the gene expression profile and chemoresponse test both indicate that a tumor is sensitive or resistant to a particular treatment, the predictive value of the method may be particularly high.

In other aspects of the invention, in vitro chemoresponse testing is used for identifying gene signatures in cultured malignant cells (e.g., immortalized cell lines or cultures derived directly from patient cells), as described elsewhere herein. For example, the identification of gene expression signatures within tumor gene expression profiles (the signatures being indicative of sensitivity and/or resistance to treatment regimens) may be supervised using results obtained from the in vitro chemoresponse test described herein.

Several in vitro chemoresponse systems are known and art, and some are reviewed in Fruehauf et al., In vitro assay-assisted treatment selection for women with breast or ovarian cancer, Endocrine-Related Cancer 9: 171-82 (2002). In certain embodiments, the chemoresponse assay is as described in U.S. Pat. Nos. 5,728,541, 6,900,027, 6,887,680, 6,933,129, 6,416,967, 7,112,415, 7,314,731, 7,501,260 (all of which are hereby incorporated by reference in their entireties). The chemoresponse method may further employ the variations described in US Published Patent Application Nos. 2007/0059821 and 2008/0085519, both of which are hereby incorporated by reference in their entireties.

Briefly, in certain embodiments, cohesive multicellular particulates (explants) are prepared from a patient's tissue sample (e.g., a biopsy sample or surgical specimen) using mechanical fragmentation. This mechanical fragmentation of the explant may take place in a medium substantially free of enzymes that are capable of digesting the explant. Some enzymatic digestion may take place in certain embodiments. Generally, the tissue sample is systematically minced using two sterile scalpels in a scissor-like motion, or mechanically equivalent manual or automated opposing incisor blades. This cross-cutting motion creates smooth cut edges on the resulting tissue multicellular particulates. The tumor particulates each measure from about 0.25 to about 1.5 mm³, for example, about 1 mm³.

After the tissue sample has been minced, the particles are plated in culture flasks. The number of explants plated per flask may vary, for example, between one and 25, such as from 5 to 20 explants per flask. For example, about 9 explants may be plated per T-25 flask, and 20 particulates may be plated per T-75 flask. For purposes of illustration, the explants may be evenly distributed across the bottom surface of the flask, followed by initial inversion for about 10-15 minutes. The flask may then be placed in a non-inverted position in a 37° C. CO₂ incubator for about 5-10 minutes. Flasks are checked regularly for growth and contamination. Over a period of days to a few weeks a cell monolayer will form. Further, it is believed (without any intention of being bound by the theory) that tumor cells grow out from the multicellular explant prior to stromal cells. Thus, by initially maintaining the tissue cells within the explant and removing the explant at a predetermined time (e.g., at about 10 to about 50 percent confluency, or at about 15 to about 25 percent confluency), growth of the tumor cells (as opposed to stromal cells) into a monolayer is facilitated. In certain embodiments, the tumor explant may be agitated to substantially release tumor cells from the tumor explant, and the released cells cultured to produce a cell culture monolayer. The use of this procedure to form a cell culture monolayer helps maximize the growth of representative tumor cells from the tissue sample.

Prior to the chemotherapy assay, the growth of the cells may be monitored, and data from periodic counting may be used to determine growth rates which may or may not be considered parallel to growth rates of the same cells in vivo in the patient. If growth rate cycles can be documented, for example, then dosing of certain active agents can be customized for the patient. Monolayer growth rate and/or cellular morphology may be monitored using, for example, a phase-contrast inverted microscope. Generally, the cells of the monolayer should be actively growing at the time the cells are suspended and plated for drug exposure. The epithelial character of the cells may be confirmed by any number of methods. Thus, the monolayers will generally be non-confluent monolayers at the time the cells are suspended for drug exposure.

A panel of active agents may then be screened using the cultured cells. Generally, the agents are tested against the cultured cells using plates such as microtiter plates. For the chemosensitivity assay, a reproducible number of cells is delivered to a plurality of wells on one or more plates, preferably with an even distribution of cells throughout the wells. For example, cell suspensions are generally formed from the monolayer cells before substantial phenotypic drift of the tumor cell population occurs. The cell suspensions may be, without limitation, about 4,000 to 12,000 cells/ml, or may be about 4,000 to 9,000 cells/ml, or about 7,000 to 9,000 cells/ml. The individual wells for chemoresponse testing are inoculated with the cell suspension, with each well or “segregated site” containing about 10² to 10⁴ cells. The cells are generally cultured in the segregated sites for about 4 to about 30 hours prior to contact with an agent.

Each test well is then contacted with at least one pharmaceutical agent, for example, an agent for which a gene expression signature is available. Such agents include the combination of cyclophosphamide, doxorubicin, fluorouracil, and paclitaxel (“TFAC”), the combination of cyclophosphamide, doxorubicin, fluorouracil (“FAC”), the combination of cyclophosphamide and epirubicin (“EC” combination), the combination of cyclophosphamide and doxorubicin (“AC” combination), the combination of cyclophosphamide, docetaxel, and doxorubicin (“ACT” combination), the combination of cyclophosphamide, epirubicin, fluorouracil, and paclitaxel (“TFEC”), and the combination of docetaxel and fluorouracil (DX).

Alternatively, suitable pharmaceutical agents for training gene signatures by in vitro chemoresponse include small molecule agents, biologics, and targeted therapies. Exemplary agents are listed in the following table.

| Drug Name | Alternative Nomenclature |
|---|---|
| Altretamine | Hexalen ®, hydroxymethylpentamethylmelamine |
| | (HMPMM) |
| Bleomycin | Blenoxane ® |
| Carboplatin | Paraplatin ® |
| Carmustine | BCNU, BiCNU ® |
| Cisplatin | Platinol ®, CDDP |
| Cyclophosphamide | Cytoxan ®, Neosar ®, |
| | 4-hydroperoxycyclophosphamide, 4-HC |
| Docetaxel | Taxotere ®, D-Tax |
| Doxorubicin | Adriamycin ®, Rubex ®, Doxil ®* |
| Epirubicin | Ellence ® |
| Erlotinib | Tarceva ®, OSI-774 |
| Etoposide | VePesid ®, Etopophos ®, VP-16 |
| Fluorouracil | Adrucil ®, 5-FU, Efudex ®, Fluoroplex ®, |
| | Capecitabine*, Xeloda ®* |
| Gemcitabine | Gemzar ® |
| Ifosfamide | Ifex ®, 4-hydroperoxyifosfamide, 4-HI |
| Irinotecan/SN-38 | Camptosar ®, CPT-11, SN-38 |
| Leucovorin | Wellcovorin ® |
| Lomustine | CCNU, CeeNU ® |
| Melphalan | Alkeran ®, L-PAM |
| Mitomycin | Mutamycin ®, Mitozytrex ®, Mitomycin-C |
| Oxaliplatin | Eloxatin ® |
| Paclitaxel | Taxol ®, Abraxane ®* |
| Procarbazine | Matulane ®, PCZ |
| Temozolomide | Temodar ® |
| Topotecan | Hycamtin ® |
| Vinblastine | Velban ®, Exal ®, Velbe ®, Velsar ®, VLB |
| Vincristine | Oncovin ®, Vincasar PFS ®, VCR |
| Vinorelbine | Navelbine ®, NVB |
| Pemetrexed | Alimta ® |
| Sunitinib | Sutent ® |

The efficacy of each agent in the panel is determined against the patient's cultured cells, by determining the viability of the cells (e.g., number of viable cells). For example, at predetermined intervals before, simultaneously with, or beginning immediately after, contact with each agent or combination, an automated cell imaging system may take images of the cells using one or more of visible light, UV light and fluorescent light. Alternatively, the cells may be imaged after about 25 to about 200 hours of contact with each treatment. The cells may be imaged once or multiple times, prior to or during contact with each treatment. Of course, any method for determining the viability of the cells may be used to assess the efficacy of each treatment in vitro.

In this manner the in vitro efficacy grade for each agent in the panel may be determined. While any grading system may be employed (including continuous or stratified), in certain embodiments the grading system is stratified, having from 2 or 3, to 10 response levels, e.g., about 3, 4, or 5 response levels. For example, when using three levels, the three grades may correspond to a responsive grade (e.g., sensitive), an intermediate responsive grade, and a non-responsive grade (e.g., resistant), as discussed more fully herein. In certain embodiments, the patient's cells show a heterogeneous response across the panel of agents, making the selection of an agent particularly crucial for the patient's treatment.

The output of the assay is a series of dose-response curves for tumor cell survivals under the pressure of a single or combination of drugs, with multiple dose settings each (e.g., ten dose settings). To better quantify the assay results, the invention employs in some embodiments a scoring algorithm accommodating a dose-response curve. Specifically, the chemoresponse data are applied to an algorithm to quantify the chemoresponse assay results by determining an area under curve (AUC).

However, since a dose-response curve only reflects the cell survival pattern in the presence of a certain tested drug, assays for different drugs and/or different cell types have their own specific cell survival pattern. Thus, dose response curves that share the same AUC value may represent different drug effects on cell survival. Additional information may therefore be incorporated into the scoring of the assay. In particular, a factor or variable for a particular drug or drug class (such as those drugs and drug classes described) and/or reference scores may be incorporated into the algorithm.

For example, in certain embodiments, the invention quantifies and/or compares the in vitro sensitivity/resistance of cells to drugs having varying mechanisms of action, and thus, in some cases, different dose-response curve shapes. In these embodiments, the invention compares the sensitivity of the patient's cultured cells to a plurality of agents that show some effect on the patient's cells in vitro (e.g., all score sensitive to some degree), so that the most effective agent may be selected for therapy. In such embodiments, an aAUC can be calculated to take into account the shape of a dose response curve for any particular drug or drug class. The aAUC takes into account changes in cytotoxicity between dose points along a dose-response curve, and assigns weights relative to the degree of changes in cytotoxicity between dose points. For example, changes in cytotoxicity between dose points along a dose-response curve may be quantified by a local slope, and the local slopes weighted along the dose-response curve to emphasize cytotoxicity.

For example, aAUC may be calculated as follows.

Step 1: Calculate Cytotoxity Index (CI) for each dose, where CI=Mean_{drug}/Mean_{control}.

Step 2: Calculate local slope (S_{d}) at each dose point, for example, as S_{d}=(CI_{d}−CI_{d-1})/Unit of Dose, or S_{d}=(CI_{d-1}−CI_{d})/Unit of Dose.

Step 3: Calculate a slope weight at each dose point, e.g., W_{d}=1−S_{d}.

Step 4: Compute aAUC, where aAUC=ΣW_{d} CI_{d}, and where, d=1, 2, . . . , 10; aAUC˜(0, 10); And at d=1, then CI_{d-1}=1. Equation 4 is the summary metric of a dose response curve and may used for subsequent regression over reference outcomes.

Usually, the dose-response curves vary dramatically around middle doses, not in lower or higher dose ranges. Thus, the algorithm in some embodiments need only determine the aAUC for a middle dose range, such as for example (where from 8 to 12 doses are experimentally determined, e.g., about 10 doses), the middle 4, 5, 6, or 8 doses are used to calculate aAUC. In this manner, a truncated dose-response curve might be more informative in outcome prediction by eliminating background noise.

The numerical aAUC value (e.g., test value) may then be evaluated for its effect on the patient's cells. For example, a plurality of drugs may be tested, and AUC determined as above for each, to determine whether the patient's cells have a sensitive response, intermediate response, or resistant response to each drug.

In some embodiments, each drug is designated as, for example, sensitive, or resistant, or intermediate, by comparing the aAUC test value to one or more cut-off values for the particular drug (e.g., representing sensitive, resistant, and/or intermediate aAUC scores for that drug). The cut-off values for any particular drug may be set or determined in a variety of ways, for example, by determining the distribution of a clinical outcome within a range of corresponding aAUC reference scores. That is, a number of patient tumor specimens are tested for chemosenstivity/resistance (as described herein) to a particular drug prior to treatment, and aAUC quantified for each specimen. Then after clinical treatment with that drug, aAUC values that correspond to a clinical response (e.g., sensitive) and the absence of significant clinical response (e.g., resistant) are determined. Cut-off values may alternatively be determined from population response rates. For example, where a patient population is known to have a response rate of 30% for the tested drug, the cut-off values may be determined by assigning the top 30% of aAUC scores for that drug as sensitive. Further still, cut-off values may be determined by statistical measures.

In other embodiments, the aAUC scores may be adjusted for drug or drug class. For example, aAUC values for dose response curves may be regressed over a reference scoring algorithm adjusted for test drugs. The reference scoring algorithm may provide a categorical outcome, for example, sensitive (s), intermediate sensitive (i) and resistant (r), as already described. Logistic regression may be used to incorporate the different information, i.e., three outcome categories, into the scoring algorithm. However, regression can be extended to other forms, such as linear or generalized linear regression, depending on reference outcomes. The regression model may be fitted as the following: Logit(Pref)=α+β(aAUC)+γ(drugs), where γ is a covariate vector and the vector can be extended to clinical and genomic features. The score may be calculated as Score=β(aAUC)+γ(drugs). Since the score is a continuous variable, results may be classified into clinically relevant categories, i.e., sensitive (S), intermediate sensitive (I), and resistant (R), based on the distribution of a reference scoring category or maximized sensitivity and specificity relative to the reference.

As stated, the chemoresponse score for cultures derived from patient specimens may provide additional predictive or prognostic value in connection with the gene expression profile analysis.

Alternatively, where applied to immortalized cell line collections or patient-derived cultures, the in vitro chemoresponse assay may be used to supervise or train gene expression signatures. Once gene expression signatures are identified in cultured cells, e.g., by correlating the level of in vitro chemosensitivity with gene expression levels, the resulting gene expression signatures may be independently validated in patient test populations having available gene expression data and corresponding clinical data, including information regarding the treatment regimen and outcome of treatment. This aspect of the invention reduces the length of time and quantity of patient samples needed for identifying and validating such gene expression signatures.

### Gene Expression Assay Formats

Gene expression profiles, including patient gene expression profiles and the drug-sensitive and drug-resistant signatures as described herein, may be prepared according to any suitable method for measuring gene expression. That is, the profiles may be prepared using any quantitative or semi-quantitative method for determining RNA transcript levels in samples. Such methods include polymerase-based assays, such as RT-PCR, Taqman™, hybridization-based assays, for example using DNA microarrays or other solid support (e.g., Whole Genome DASL™ Assay, Illumina, Inc.), nucleic acid sequence based amplification (NASBA), flap endonuclease-based assays, as well as direct mRNA capture with branched DNA (QuantiGene™) or Hybrid Capture™ (Digene). The assay format, in addition to determining the gene expression levels for a combination of genes listed in one or more of Tables 1-8, will also allow for the control of, inter alia, intrinsic signal intensity variation between tests. Such controls may include, for example, controls for background signal intensity and/or sample processing, and/or other desirable controls for gene expression quantification across samples. For example, expression levels between samples may be controlled by testing for the expression level of one or more genes that are not differentially expressed between drug-sensitive and drug-resistant cells, or which are generally expressed at similar levels across the population. Such genes may include constitutively expressed genes, many of which are known in the art. Exemplary assay formats for determining gene expression levels, and thus for preparing gene expression profiles and drug-sensitive and drug-resistant signatures are described in this section.

The nucleic acid sample is typically in the form of mRNA or reverse transcribed mRNA (cDNA) isolated from a tumor tissue sample or a derived cultured cell population. In some embodiments, the nucleic acids in the sample may be cloned or amplified, generally in a manner that does not bias the representation of the transcripts within a sample. In some embodiments, it may be preferable to use total RNA or polyA+ RNA as a source without cloning or amplification, to avoid additional processing steps.

As is apparent to one of skill in the art, nucleic acid samples used in the methods of the invention may be prepared by any available method or process. Methods of isolating total mRNA are well known to those of skill in the art. For example, methods of isolation and purification of nucleic acids are described in detail in Chapter 3 of Laboratory Techniques in Biochemistry and Molecular Biology, Vol. 24, Hybridization With Nucleic Acid Probes: Theory and Nucleic Acid Probes, P. Tijssen, Ed., Elsevier Press, New York, 1993. Such samples include RNA samples, but also include cDNA synthesized from a mRNA sample isolated from a cell or specimen of interest. Such samples also include DNA amplified from the cDNA, and RNA transcribed from the amplified DNA.

In determining a tumor's gene expression profile, or in determining a drug-sensitive or drug-resistant profile in accordance with the invention, a hybridization-based assay may be employed. Nucleic acid hybridization involves contacting a probe and a target sample under conditions where the probe and its complementary target sequence (if present) in the sample can form stable hybrid duplexes through complementary base pairing. The nucleic acids that do not form hybrid duplexes may be washed away leaving the hybridized nucleic acids to be detected, typically through detection of an attached detectable label. It is generally recognized that nucleic acids may be denatured by increasing the temperature or decreasing the salt concentration of the buffer containing the nucleic acids. Under low stringency conditions (e.g., low temperature and/or high salt) hybrid duplexes (e.g., DNA:DNA, RNA:RNA, or RNA:DNA) will form even where the annealed sequences are not perfectly complementary. Thus, specificity of hybridization is reduced at lower stringency. Conversely, at higher stringency (e.g., higher temperature or lower salt) successful hybridization tolerates fewer mismatches. One of skill in the art will appreciate that hybridization conditions may be selected to provide any degree of stringency.

In certain embodiments, hybridization is performed at low stringency, such as 6×SSPET at 37° C. (0.005% Triton X-100), to ensure hybridization, and then subsequent washes are performed at higher stringency (e.g., 1×SSPET at 37° C.) to eliminate mismatched hybrid duplexes. Successive washes may be performed at increasingly higher stringency (e.g., down to as low as 0.25×SSPET at 37° C. to 50° C.) until a desired level of hybridization specificity is obtained. Stringency can also be increased by addition of agents such as formamide. Hybridization specificity may be evaluated by comparison of hybridization to the test probes with hybridization to the various controls that may be present, as described below (e.g., expression level control, normalization control, mismatch controls, etc.).

In general, there is a tradeoff between hybridization specificity (stringency) and signal intensity. Thus, in a preferred embodiment, the wash is performed at the highest stringency that produces consistent results and that provides a signal intensity greater than approximately 10% of the background intensity. The hybridized array may be washed at successively higher stringency solutions and read between each wash. Analysis of the data sets thus produced will reveal a wash stringency above which the hybridization pattern is not appreciably altered and which provides adequate signal for the particular oligonucleotide probes of interest.

The hybridized nucleic acids are typically detected by detecting one or more labels attached to the sample nucleic acids. The labels may be incorporated by any of a number of means well known to those of skill in the art. See WO 99/32660.

Numerous hybridization assay formats are known, and which may be used in accordance with the invention. Such hybridization-based formats include solution-based and solid support-based assay formats. Solid supports containing oligonucleotide probes designed to detect differentially expressed genes (e.g., listed in Tables 1-8) can be filters, polyvinyl chloride dishes, particles, beads, microparticles or silicon or glass based chips, etc. Any solid surface to which oligonucleotides can be bound, either directly or indirectly, either covalently or non-covalently, may be used. Bead-based assays are described, for example, in U.S. Pat. Nos. 6,355,431, 6,396,995, and 6,429,027, which are hereby incorporated by reference. Other chip-based assays are described in U.S. Pat. Nos. 6,673,579, 6,733,977, and 6,576,424, which are hereby incorporated by reference.

An exemplary solid support is a high density array or DNA chip, which may contain a particular oligonucleotide probes at predetermined locations on the array. Each predetermined location may contain more than one molecule of the probe, but each molecule within the predetermined location has an identical probe sequence. Such predetermined locations are termed features. Probes corresponding to the genes of Tables 1-8 may be attached to single or multiple solid support structures, e.g., the probes may be attached to a single chip or to multiple chips to comprise a chip set. An exemplary chip format is hgu133a+2 (Affymetrix).

Oligonucleotide probe arrays for determining gene expression can be made and used according to any techniques known in the art (see for example, Lockhart et al (1996), Nat Biotechnol 14:1675-1680; McGall et al. (1996), Proc Nat Acad Sci USA 93:13555-13460). Such probe arrays may contain the oligonucleotide probes necessary for determining a tumor's gene expression profile, or for preparing drug-resistant and drug-sensitive signatures. Thus, such arrays may contain oligonucleotide designed to hybridize to at least 2, 3, 4, 5, 6, 7, 8, 9, 10, 20, 30, 50, 70, 100, 200, 300 or more of the genes described herein (e.g., as described in one of Tables 1-10, or as described in any of Tables 1-10). In some embodiments, the array contains probes designed to hybridize to all or nearly all of the genes listed in one or more of Tables 1-10. In still other embodiments, arrays are constructed that contain oligonucleotides designed to detect all or nearly all of the genes in Tables 1-10 on a single solid support substrate, such as a chip or a set of beads. The array, bead set, or probe set may contain, in some embodiments, no more than 3000 probes, no more than 2000 probes, no more than 1000 probes, or no more than 500 probes, so as to embody a custom probe set for determining gene expression signatures in accordance with the invention.

Probes based on the sequences of the genes described herein for preparing expression profiles may be prepared by any suitable method. Oligonucleotide probes, for hybridization-based assays, will be of sufficient length or composition (including nucleotide analogs) to specifically hybridize only to appropriate, complementary nucleic acids (e.g., exactly or substantially complementary RNA transcripts or cDNA). Typically the oligonucleotide probes will be at least about 10, 12, 14, 16, 18, 20 or 25 nucleotides in length. In some cases, longer probes of at least 30, 40, or 50 nucleotides may be desirable. In some embodiments, complementary hybridization between a probe nucleic acid and a target nucleic acid embraces minor mismatches (e.g., one, two, or three mismatches) that can be accommodated by reducing the stringency of the hybridization media to achieve the desired detection of the target polynucleotide sequence. Of course, the probes may be perfect matches with the intended target probe sequence, for example, the probes may each have a probe sequence that is perfectly complementary to a target sequence (e.g., a sequence of a gene listed in Tables 1-10).

A probe is a nucleic acid capable of binding to a target nucleic acid of complementary sequence through one or more types of chemical bonds, usually through complementary base pairing, usually through hydrogen bond formation. A probe may include natural (i.e., A, G, U, C, or T) or modified bases (7-deazaguanosine, inosine, etc.), or locked nucleic acid (LNA). In addition, the nucleotide bases in probes may be joined by a linkage other than a phosphodiester bond, so long as the bond does not interfere with hybridization. Thus, probes may be peptide nucleic acids in which the constituent bases are joined by peptide bonds rather than phosphodiester linkages.

When using hybridization-based assays, in may be necessary to control for background signals. The terms “background” or “background signal intensity” refer to hybridization signals resulting from non-specific binding, or other interactions, between the labeled target nucleic acids and components of the oligonucleotide array (e.g., the oligonucleotide probes, control probes, the array substrate, etc.). Background signals may also be produced by intrinsic fluorescence of the array components themselves. A single background signal can be calculated for the entire array, or a different background signal may be calculated for each location of the array. In an exemplary embodiment, background is calculated as the average hybridization signal intensity for the lowest 5% to 10% of the probes in the array. Alternatively, background may be calculated as the average hybridization signal intensity produced by hybridization to probes that are not complementary to any sequence found in the sample (e.g. probes directed to nucleic acids of the opposite sense or to genes not found in the sample such as bacterial genes where the sample is mammalian nucleic acids). Background can also be calculated as the average signal intensity produced by regions of the array that lack any probes at all. Of course, one of skill in the art will appreciate that hybridization signals may be controlled for background using one or a combination of known approached, including one or a combination of approaches described in this paragraph.

The hybridization-based assay will be generally conducted under conditions in which the probe(s) will hybridize to their intended target subsequence, but with only insubstantial hybridization to other sequences or to other sequences, such that the difference may be identified. Such conditions are sometimes called “stringent conditions.” Stringent conditions are sequence-dependent and can vary under different circumstances. For example, longer probe sequences generally hybridize to perfectly complementary sequences (over less than fully complementary sequences) at higher temperatures. Generally, stringent conditions may be selected to be about 5° C. lower than the thermal melting point (Tm) for the specific sequence at a defined ionic strength and pH. Exemplary stringent conditions may include those in which the salt concentration is at least about 0.01 to 1.0 M Na⁺ ion concentration (or other salts) at pH 7.0 to 8.3 and the temperature is at least about 30° C. for short probes (e.g., 10 to 50 nucleotides). Desired hybridization conditions may also be achieved with the addition of agents such as formamide or tetramethyl ammonium chloride (TMAC).

When using an array, one of skill in the art will appreciate that an enormous number of array designs are suitable for the practice of this invention. The array will typically include a number of test probes that specifically hybridize to the sequences of interest. That is, the array will include probes designed to hybridize to any region of the genes listed in Tables 1-8. In instances where the gene reference in the Tables is an EST, probes may be designed from that sequence or from other regions of the corresponding full-length transcript that may be available in any of the public sequence databases, such as those herein described. See WO 99/32660 for methods of producing probes for a given gene or genes. In addition, software is commercially available for designing specific probe sequences. Typically, the array will also include one or more control probes, such as probes specific for a constitutively expressed gene, thereby allowing data from different hybridizations to be normalized or controlled.

The hybridization-based assays may include, in addition to “test probes” (e.g., that bind the target sequences of interest, which are listed in Tables 1-10), the assay may also test for hybridization to one or a combination of control probes. Exemplary control probes include: normalization controls, expression level controls, and mismatch controls. For example, when determining the levels of gene expression in patient or control samples, the expression values may be normalized to control between samples. That is, the levels of gene expression in each sample may be normalized by determining the level of expression of at least one constitutively expressed gene in each sample. In accordance with the invention, the constitutively expressed gene is generally not differentially expressed in drug-sensitive versus drug-resistant samples.

Other useful controls are normalization controls, for example, using probes designed to be complementary to a labeled reference oligonucleotide added to the nucleic acid sample to be assayed. The signals obtained from the normalization controls after hybridization provide a control for variations in hybridization conditions, label intensity, “reading” efficiency and other factors that may cause the signal of a perfect hybridization to vary between arrays. In one embodiment, signals (e.g., fluorescence intensity) read from all other probes in the array are divided by the signal (e.g., fluorescence intensity) from the control probes thereby normalizing the measurements. Exemplary normalization probes are selected to reflect the average length of the other probes (e.g., test probes) present in the array, however, they may be selected to cover a range of lengths. The normalization control(s) may also be selected to reflect the (average) base composition of the other probes in the array. In some embodiments, the assay employs one or a few normalization probes, and they are selected such that they hybridize well (i.e., no secondary structure) and do not hybridize to any potential targets.

The hybridization-based assay may employ expression level controls, for example, probes that hybridize specifically with constitutively expressed genes in the biological sample. Virtually any constitutively expressed gene provides a suitable target for expression level controls. Typically expression level control probes have sequences complementary to subsequences of constitutively expressed “housekeeping genes” including, but not limited to the actin gene, the transferrin receptor gene, the GAPDH gene, and the like.

The hybridization-based assay may also employ mismatch controls for the target sequences, and/or for expression level controls or for normalization controls. Mismatch controls are probes designed to be identical to their corresponding test or control probes, except for the presence of one or more mismatched bases. A mismatched base is a base selected so that it is not complementary to the corresponding base in the target sequence to which the probe would otherwise specifically hybridize. One or more mismatches are selected such that under appropriate hybridization conditions (e.g., stringent conditions) the test or control probe would be expected to hybridize with its target sequence, but the mismatch probe would not hybridize (or would hybridize to a significantly lesser extent). Preferred mismatch probes contain a central mismatch. Thus, for example, where a probe is a 20-mer, a corresponding mismatch probe will have the identical sequence except for a single base mismatch (e.g., substituting a G, a C or a T for an A) at any of positions 6 through 14 (the central mismatch).

Mismatch probes thus provide a control for non-specific binding or cross hybridization to a nucleic acid in the sample other than the target to which the probe is directed. For example, if the target is present, the perfect match probes should provide a more intense signal than the mismatch probes. The difference in intensity between the perfect match and the mismatch probe helps to provide a good measure of the concentration of the hybridized material.

Alternatively, the invention may employ reverse transcription polymerase chain reaction (RT-PCR), which is a sensitive method for the detection of mRNA, including low abundant mRNAs present in clinical samples. The application of fluorescence techniques to RT-PCR combined with suitable instrumentation has led to quantitative RT-PCR methods that combine amplification, detection and quantification in a closed system. Two commonly used quantitative RT-PCR techniques are the Taqman RT-PCR assay (ABI, Foster City, USA) and the Lightcycler assay (Roche, USA).

Thus, in one embodiment of the present invention, the preparation of patient gene expression profiles or the preparation of drug-sensitive and drug-resistant profiles comprises conducting real-time quantitative PCR (TaqMan) with sample-derived RNA and control RNA. Holland, et al., PNAS 88:7276-7280 (1991) describe an assay known as a Taqman assay. The 5′ to 3′ exonuclease activity of Taq polymerase is employed in a polymerase chain reaction product detection system to generate a specific detectable signal concomitantly with amplification. An oligonucleotide probe, non-extendable at the 3′ end, labeled at the 5′ end, and designed to hybridize within the target sequence, is introduced into the polymerase chain reaction assay. Annealing of the probe to one of the polymerase chain reaction product strands during the course of amplification generates a substrate suitable for exonuclease activity. During amplification, the 5′ to 3′ exonuclease activity of Taq polymerase degrades the probe into smaller fragments that can be differentiated from undegraded probe. A version of this assay is also described in Gelfand et al., in U.S. Pat. No. 5,210,015, which is hereby incorporated by reference.

Further, U.S. Pat. No. 5,491,063 to Fisher, et al., which is hereby incorporated by reference, provides a Taqman-type assay. The method of Fisher et al. provides a reaction that results in the cleavage of single-stranded oligonucleotide probes labeled with a light-emitting label wherein the reaction is carried out in the presence of a DNA binding compound that interacts with the label to modify the light emission of the label. The method of Fisher uses the change in light emission of the labeled probe that results from degradation of the probe.

The TaqMan detection assays offer certain advantages. First, the methodology makes possible the handling of large numbers of samples efficiently and without cross-contamination and is therefore adaptable for robotic sampling. As a result, large numbers of test samples can be processed in a very short period of time using the TaqMan assay. Another advantage of the TaqMan system is the potential for multiplexing. Since different fluorescent reporter dyes can be used to construct probes, the expression of several different genes associated with drug sensitivity or resistance may be assayed in the same PCR reaction, thereby reducing the labor costs that would be incurred if each of the tests were performed individually. Thus, the TaqMan assay format is preferred where the patient's gene expression profile, and the corresponding drug-sensitive and drug-resistance profiles comprise the expression levels of about 20 of fewer, or about 10 or fewer, or about 7 of fewer, or about 5 genes (e.g., genes listed in one or more of Tables 1-10).

Alternatively, the assay format may employ the methodologies described in Direct Multiplexed Measurement of Gene Expression with Color-Coded Probe Pairs, Nature Biotechnology (Mar. 7, 2008), which describes the nCounter™ Analysis System (nanoString Technologies). This system captures and counts individual mRNA transcripts by a molecular bar-coding technology, and is commercialized by Nanostring.

In other embodiments, the invention employs detection and quantification of RNA levels in real-time using nucleic acid sequence based amplification (NASBA) combined with molecular beacon detection molecules. NASBA is described for example, in Compton J., Nucleic acid sequence-based amplification, Nature 1991; 350(6313):91-2. NASBA is a singe-step isothermal RNA-specific amplification method. Generally, the method involves the following steps: RNA template is provided to a reaction mixture, where the first primer attaches to its complementary site at the 3′ end of the template; reverse transcriptase synthesizes the opposite, complementary DNA strand; RNAse H destroys the RNA template (RNAse H only destroys RNA in RNA-DNA hybrids, but not single-stranded RNA); the second primer attaches to the 3′ end of the DNA strand, and reverse transcriptase synthesizes the second strand of DNA; and T7 RNA polymerase binds double-stranded DNA and produces a complementary RNA strand which can be used again in step 1, such that the reaction is cyclic.

In yet other embodiments, the assay format is a flap endonuclease-based format, such as the Invader™ assay (Third Wave Technologies). In the case of using the invader method, an invader probe containing a sequence specific to the region 3′ to a target site, and a primary probe containing a sequence specific to the region 5′ to the target site of a template and an unrelated flap sequence, are prepared. Cleavase is then allowed to act in the presence of these probes, the target molecule, as well as a FRET probe containing a sequence complementary to the flap sequence and an auto-complementary sequence that is labeled with both a fluorescent dye and a quencher. When the primary probe hybridizes with the template, the 3′ end of the invader probe penetrates the target site, and this structure is cleaved by the Cleavase resulting in dissociation of the flap. The flap binds to the FRET probe and the fluorescent dye portion is cleaved by the Cleavase resulting in emission of fluorescence.

In yet other embodiments, the assay format employs direct mRNA capture with branched DNA (QuantiGene™ Panomics) or Hybrid Capture™ (Digene).

The design of appropriate probes for hybridizing to a particular target nucleic acid, and as configured for any appropriate nucleic acid detection assay, is well known.

### Computer System

In another aspect, the invention is a computer system that contains a database, on a computer-readable medium, of gene expression values indicative of a tumor's drug-resistance and/or drug-sensitivity. These gene expression values are determined (as already described) in established cell lines, cell cultures established from patient samples, or directly from patient specimens, and for genes selected from one or more of Tables 1-7. The database may include, for each gene, sensitive and resistant gene expression levels, thresholds, or Mean values, as well as various statistical measures, including measures of value dispersion (e.g., Standard Variation), fold change (e.g., between sensitive and resistant samples), and statistical significance (statistical association with drug sensitivity or resistance). Generally, signatures may be assembled based upon parameters to be selected and input by a user, with these parameters including of cancer or tumor type, histology, and/or candidate chemotherapeutic agents or combinations.

In certain embodiments, the database contains mean or median gene expression values for at least about 5, 7, 10, 20, 40, 50, or 100 genes selected from any one, or a combination of, Tables 1-10. In some embodiments, the database may contain mean or median gene expression values for more than about 100 genes, or about 300 genes, or about 350 genes selected from Tables 1-10. In one embodiment, the database contains mean gene expression values for all or substantially all the genes listed in Tables 1-10.

The computer system of the invention may be programmed to compare, score, or classify (e.g., in response to user inputs) a gene expression profile against a drug-sensitive gene expression signature and/or a drug-resistant gene expression signature stored and/or generated from the database, to determine whether the gene expression profile is itself a drug sensitive or drug-resistant profile. For example, the computer system may be programmed to perform any of the known classification schemes for classifying gene expression profiles. Various classification schemes are known for classifying samples, and these include, without limitation: Principal Components Analysis, Naïve Bayes, Support Vector Machines, Nearest Neighbors, Decision Trees, Logistic, Artificial Neural Networks, and Rule-based schemes. The computer system may employ a classification algorithm or “class predictor” as described in R. Simon, Diagnostic and prognostic prediction using gene expression profiles in high-dimensional microarray data, British Journal of Cancer (2003) 89, 1599-1604, which is hereby incorporated by reference in its entirety.

The computer system of the invention may comprise a user interface, allowing a user to input gene expression values for comparison to a drug-sensitive and/or drug-resistant gene expression profile. The patient's gene expression values may be input from a location remote from the database.

The computer system may further comprise a display, for presenting and/or displaying a result, such as a signature assembled from the database, or the result of a comparison (or classification) between input gene expression values and a drug-sensitive and drug-resistant signatures. Such results may further be provided in any form (e.g., as a printable or printed report).

The computer system of the invention may further comprise relational databases containing sequence information, for instance, for the genes of Tables 1-10. For example, the database may contain information associated with a given gene, cell line, or patient sample used for preparing gene signatures, such as descriptive information about the gene associated with the sequence information, or descriptive information concerning the clinical status of the patient (e.g., treatment regimen and outcome). The database may be designed to include different parts, for instance a sequence database and a gene expression database. Methods for the configuration and construction of such databases and computer-readable media to which such databases are saved are widely available, for instance, see U.S. Pat. No. 5,953,727, which is hereby incorporated by reference in its entirety.

The databases of the invention may be linked to an outside or external database (e.g., on the world wide web) such as GenBank (ncbi.nlm.nih.gov/entrez.index.html); KEGG (genome.ad.jp/kegg); SPAD (grt.kuyshu-u.ac.jp/spad/index.html); HUGO (gene.ucl.ac.uk/hugo); Swiss-Prot (expasy.ch.sprot); Prosite (expasy.ch/tools/scnpsitl.html); OMIM (ncbi.nlm.nih.gov/omim); and GDB (gdb.org). In certain embodiments, the external database is GenBank and the associated databases maintained by the National Center for Biotechnology Information (NCBI) (ncbi.nlm.nih.gov).

Any appropriate computer platform, user interface, etc. may be used to perform the necessary comparisons between sequence information, gene expression information (e.g., gene expression profiles) and any other information in the database or information provided as an input. For example, a large number of computer workstations are available from a variety of manufacturers, such has those available from Silicon Graphics. Client/server environments, database servers and networks are also widely available and appropriate platforms for the databases described herein.

The databases of the invention may be used to produce, among other things, electronic Northerns that allow the user to determine the samples in which a given gene is expressed and to allow determination of the abundance or expression level of the given gene.

### Diagnostic Kits

The invention further provides a kit or probe array containing nucleic acid primers and/or probes for determining the level of expression in a patient tumor specimen or cell culture of a plurality of genes listed in Tables 1-10. The probe array may contain 3000 probes or less, 2000 probes or less, 1000 probes or less, 500 probes or less, so as to embody a custom set for preparing gene expression profiles described herein. In some embodiments, the kit may consist essentially of primers and/or probes related to evaluating drug-sensitivity/resistant in a sample, and primers and/or probes related to necessary or meaningful assay controls (such as expression level controls and normalization controls, as described herein under “Gene Expression Assay Formats”). The kit for evaluating drug-sensitivity/resistance may comprise nucleic acid probes and/or primers designed to detect the expression level of ten or more genes associated with drug sensitivity/resistance, such as the genes listed in Tables 1-10. The kit may include a set of probes and/or primers designed to detect or quantify the expression levels of at least 5, 7, 10, or 20 genes listed in one of Tables 1-10. The primers and/or probes may be designed to detect gene expression levels in accordance with any assay format, including those described herein under the heading “Assay Format.” Exemplary assay formats include polymerase-based assays, such as RT-PCR, Taqman™, hybridization-based assays, for example using DNA microarrays or other solid support, nucleic acid sequence based amplification (NASBA), flap endonuclease-based assays. The kit need not employ a DNA microarray or other high density detection format.

In accordance with this aspect, the probes and primers may comprise antisense nucleic acids or oligonucleotides that are wholly or partially complementary to the diagnostic targets described herein (e.g., Tables 1-10). The probes and primers will be designed to detect the particular diagnostic target via an available nucleic acid detection assay format, which are well known in the art. The kits of the invention may comprise probes and/or primers designed to detect the diagnostic targets via detection methods that include amplification, endonuclease cleavage, and hybridization.

### EXAMPLES

### Example 1

### Identifying and Validation Gene Expression Signatures

Cancer cell lines (breast cancer) from a Berkeley Labs collection (Hoeflich et al: In vivo Antitumor Activity of MEK and Phosphatidylinositol 3-Kinase Inhibitors in Basal-Like Breast Cancer Models. Clinical Cancer Research 2009, 15(14):4649-4664.) were tested for their sensitivity in vitro to the combinations TFAC, EC, FEC, AC, ACT, TFEC, and DX. TFAC is the combination of paclitaxel, fluorouracil, doxorubicin and cyclophosphamide. EC is the combination of epirubicin and cyclophosphamide. FEC is the combination of fluorouracil, epirubicin and cyclophosphamide. AC is the combination of doxorubicin and cyclophosphamide. ACT is the combination of doxorubicin, cyclophosphamide and docetaxel. TFEC is the combination of paclitaxel, fluorouracil, epirubicin and cyclophosphamide. DX is the combination of docetaxel and fluorouracil. In vitro chemosensitivity was determined using the ChemoFx™ assay (Precision Therapeutics, Inc., Pittsburgh, Pa.).

The AUC scores for all cell lines across the four drug combinations were as follows: smaller AUC corresponds to higher sensitivity to drug.

| | TFAC | EC | FEC | ACT | AC | TFEC | DX |
|---|---|---|---|---|---|---|---|
| AU565 | 4.39 | 4.27 | 3.97 | 4.77 | 4.71 | 3.63 | 4.9 |
| BT20 | 6.68 | 5.82 | 6.1 | 6 | 7.43 | 4.8 | 7.77 |
| BT474 | 6.56 | 7.1 | 6.76 | 7.55 | 7.25 | 6.73 | NA |
| BT483 | 9.09 | 8.12 | 7.75 | NA | 8.37 | NA | NA |
| BT549 | 4.75 | 3.88 | 3.95 | 4.75 | 4.68 | 4.15 | 6.34 |
| CAL120 | 4.4 | 3.39 | 4.01 | 4.47 | 4.14 | 3.66 | 6.8 |
| CAL51 | 4.1 | 3.81 | 4.25 | 4.85 | 4.88 | 2.8 | 7.37 |
| CAL851 | 5.14 | 4 | 4.29 | 5.05 | 4.62 | 4.28 | 6.13 |
| CAMA1 | 6.79 | 5.66 | 5.54 | 6.06 | NA | NA | 7.8 |
| EFM19 | 8.84 | 7.1 | 8 | 9.52 | 8.54 | 6.99 | 8.5 |
| EFM192A | 7.25 | 5.23 | 6.07 | 7.82 | 7.38 | 4.85 | 7.13 |
| EVSAT | 4.3 | 3.2 | 3.82 | 4.33 | 4.2 | 3.41 | 4.84 |
| HCC1143 | 5.41 | 4.95 | 5.08 | 5.69 | 5.6 | 5.07 | 6.94 |
| HCC1187 | 4.06 | 4.15 | 4.07 | NA | 4.33 | NA | NA |
| HCC1395 | 4.37 | 3.9 | 5.09 | NA | 4.85 | NA | 7.1 |
| HCC1419 | 8.94 | 7.11 | NA | 8.31 | 8.59 | 6.83 | NA |
| HCC1428 | 8.19 | 7.29 | 7.31 | 7.6 | 8.27 | 6.71 | 9.75 |
| HCC1500 | 7.52 | 7.42 | 7.3 | 8.4 | 8.73 | 7.27 | NA |
| HCC1569 | 5.68 | NA | NA | 5.76 | NA | 5.01 | NA |
| HCC1806 | 3.76 | 2.69 | NA | 3.85 | 3.75 | 2.73 | NA |
| HCC1937 | 5.74 | 5.04 | 5.03 | 6.21 | 5.83 | 4.49 | 7.46 |
| HCC1954 | 4.45 | 3.82 | 3.54 | 4.47 | 4.7 | 3.52 | NA |
| HCC202 | NA | NA | NA | 8.28 | NA | 6.81 | 8.87 |
| HCC38 | 3.73 | 3.51 | 3.59 | 4.07 | 4.46 | 3.82 | 5.58 |
| HDQP1 | 5.11 | 4.6 | 4.97 | 5.44 | 5.52 | 4.11 | 4.9 |
| HS578T | 3.37 | 3.33 | 2.81 | 3.59 | 3.47 | NA | 5.09 |
| JIMT1 | 4.45 | 4.2 | 4.59 | 4.91 | 5.04 | 4.11 | 4.66 |
| KPL1 | 4.02 | 3.75 | 4.39 | 4.98 | 5.04 | 2.83 | 4.05 |
| MCF10A | 4.55 | 4.18 | 4.38 | 4.67 | 4.84 | 4.07 | 5.93 |
| MCF7 | 5.81 | 5.36 | 5.19 | 5.72 | 6.31 | 4.76 | 7.23 |
| MDAMB134VI | 5.3 | 5.23 | 5.11 | 5.42 | 5.63 | 5.06 | 7.5 |
| MDAMB157 | NA | 3.57 | 4.36 | 4.39 | 5.15 | 3.91 | NA |
| MDAMB175VII | 7.91 | 7.09 | 7.8 | 8.14 | 9.33 | 7.94 | NA |
| MDAMB231 | 3.57 | 3.25 | 3.36 | 3.97 | 3.32 | 3.64 | 6.37 |
| MDAMB361 | 8.2 | 8.43 | 7.94 | 8.92 | 9.14 | 7.73 | NA |
| MDAMB415 | 7.2 | 7.33 | 7.15 | 4.83 | 8.67 | 4.45 | 6.72 |
| MDAMB436 | 5.32 | 4.9 | 4.95 | 5.05 | 5.31 | 4.68 | 7.12 |
| MDAM8453 | 6.64 | 6.77 | 6.7 | 7.63 | 8.24 | 6.27 | 9.94 |
| MDAMB468 | 3.58 | 3.08 | 3.08 | 3.37 | 3.52 | 3.18 | 5.78 |
| MFM223 | 4.66 | 4.2 | 4.63 | 5.11 | 5.18 | 3.11 | 5.5 |
| SKBR3 | 4.07 | 3.65 | 3.4 | NA | 4.31 | 2.43 | 6.12 |
| SW527 | NA | 2.92 | 4.18 | 3.73 | 4.42 | 3.01 | 6.94 |
| T47D | 3.86 | 3.73 | 3.53 | 4.6 | 4.11 | 3.79 | 8.07 |
| UACC812 | 3.89 | 3.05 | 2.97 | 3.68 | 3.93 | 2.71 | 6.68 |
| ZR751 | 6.64 | 6.1 | 5.64 | 7.63 | 7.12 | 6.97 | NA |
| ZR7530 | 6.4 | 5.49 | 5 | NA | 5.79 | 6.43 | 8 |

Sensitive and resistant cells were designated as follows:

| | Range of Sensitive cells | Range of Resistant cells |
|---|---|---|
| TFAC | 3.37-4.39 | 6.64-9.09 |
| EC | 2.69-3.81 | 5.66-8.43 |
| ACT | 3.37-4.77 | 6.06-9.52 |
| AC | 3.32-4.68 | 7.12-9.33 |
| FEC | 2.81-4.18 | 5.54-8.00 |
| TFEC | 2.43-3.66 | 5.06-7.94 |
| DX | 4.05-6.13 | 7.37-9.94 |

Tables 1-8 each provide the mean gene expression values for sensitive cell lines, and the mean gene expression values for resistant cell lines, for each combination of therapeutic agents. The Tables also provide the fold change from sensitive to resistant. For example, where x is the mean expression score for sensitive cell lines for a particular gene, and y is the mean expression score for resistant cell lines for that gene, fold change is represented by mean X/mean Y.

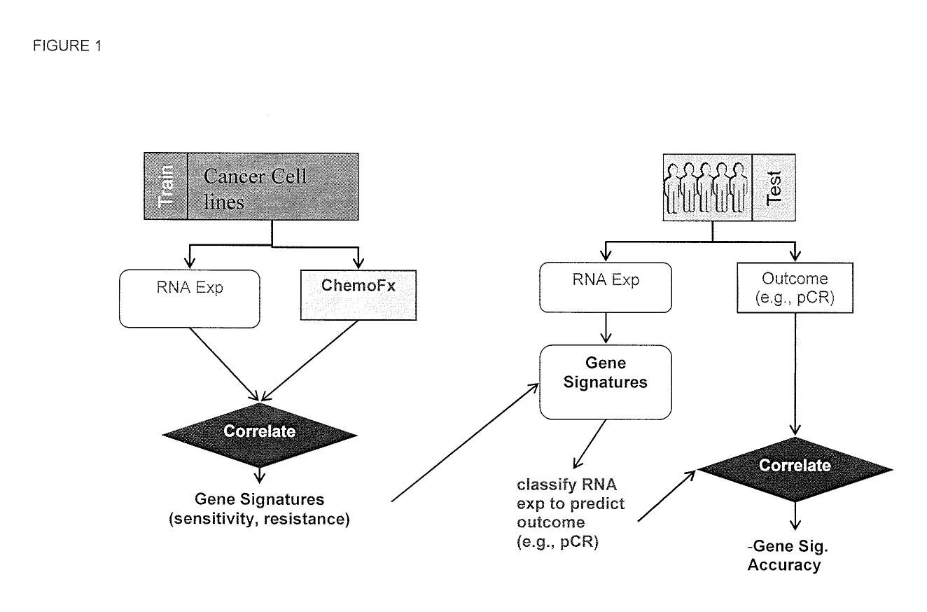

The procedure for identifying gene expression signatures is shown diagrammatically in FIG. 1.

The gene expression signatures resulting from the above analysis were validated in patient populations by comparing publicly available patient tumor gene expression data (based on hgu133a microarray platform) with the corresponding outcome of treatment with TFAC, EC and FAC. The validation sets were as follows.

133 neoadjuvant breast cancer patients, treated with TFAC, and outcomes evaluated for pCR (“Pusztai set”). Hess, K R, Anderson, K, Symmans, W F, Valero, V, Ibrahim, N, Mejia, J A, Booser, D, Theriault, R L, Buzdar, A U, Dempsey, P J, Rouzier, R, Sneige, N, Ross, J S, Vidaurre, T, Gómez, H L, Hortobagyi, G N, Pusztai, L (2006). Pharmacogenomic predictor of sensitivity to preoperative chemotherapy with paclitaxel and fluorouracil, doxorubicin, and cyclophosphamide in breast cancer. J. Clin. Oncol., 24, 26:4236-44.

37 neoadjuvant breast cancer patients, treated with EC, and outcomes evaluated for pCR (“Bertheau set”). Bertheau, P, Turpin, E, Rickman, D S, Espié, M, de Reyniés, A, Feugeas, J P, Plassa, L F, Soliman, H, Varna, M, de Roquancourt, A, Lehmann-Che, J, Beuzard, Y, Marty, M, Misset, J L, Janin, A, de Thé, H (2007). Exquisite sensitivity of TP53 mutant and basal breast cancers to a dose-dense epirubicin-cyclophosphamide regimen. PLoS Med., 4, 3:e90.

87 neoadjuvant breast cancer patients, treated with FAC, and outcomes evaluated for pCR (“Tabchy.FAC”). Tabchy, A, Valero, V, Vidaurre, T, Lluch, A, Gomez, H, Martin, M, Qi, Y, Barajas-Figueroa, L, Souchon, E, Coutant, C, Doimi, F, Ibrahim, N, Gong, Y, Hortobagyi, G, Hess, K, Symmans, W, Pusztai, L (2010). Evaluation of a 30-gene paclitaxel, fluorouracil, doxorubicin and cyclophosphamide chemotherapy response predictor in a multicenter randomized trial in breast cancer, Clinical Cancer Research, 16, 5351

The data sets for validation are summarized as follows:

| | | | | | no. |
|---|---|---|---|---|---|
| | | | | no. patients | patients |
| | Platform | Drug | Outcome | pCR | non-pCR |
| Pusztai | Hgu133a | TFAC | pCR | 34 (19%) | 98 |
| Bertheau | Hgu133a | EC | pCR | 9 (25.7%) | 26 |
| Tabchy.FAC | Hgu133a | FAC | pCR | 7 (8.0%) | 80 |

Patient samples were classified as resistant and/or sensitive to the chemotherapeutic agent combinations by scoring the publicly available gene expression data against the identified gene signatures, thereby obtaining an outcome prediction. Bair, E, Tibshirani, R (2004). Semi-supervised methods to predict patient survival from gene expression data. PLoS Biol., 2, 4:E108. Specifically, standard regression coefficients for each gene in the training set were calculated; genes were selected having a coefficient larger than the threshold, where the threshold is estimated by cross-validation in the training set; a reduced data matrix on these selected genes was formed; the first principal components based on the reduced data matrix was calculated; and the first principal component was used in a regression model to predict the patient's outcome. The accuracy of the classification or prediction was validated by comparing the prediction with the actual outcome of treatment.

The accuracy of the gene signatures were as follows.

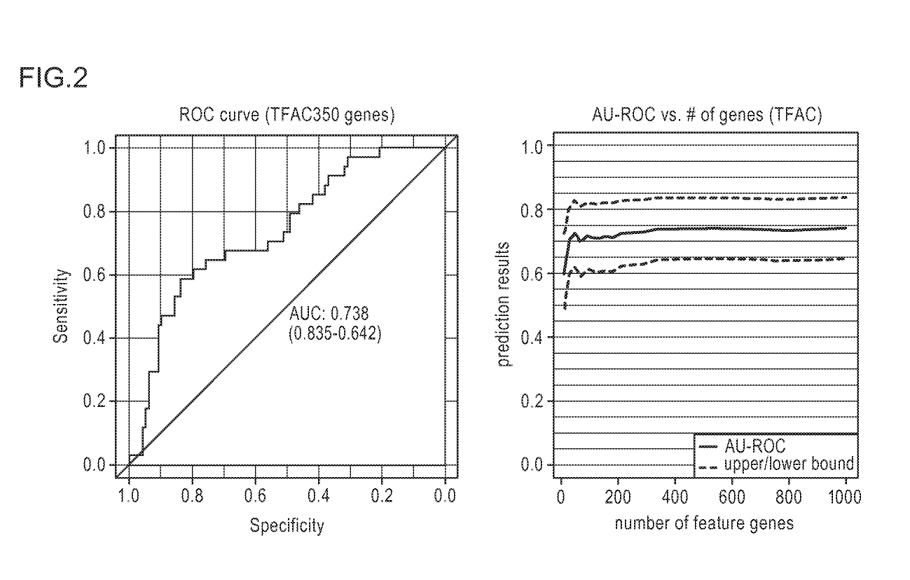

The accuracy of a 350-gene signature from Table 1 for predicting pCR in the Pusztai data set was determined, and is shown in FIG. 2. The results are shown as a receiver operator curve (ROC) as shown in the left panel. The right panel shows that the gene expression signature of Table 1 is stable over a large range of increasing gene number, from less than about 10 to over 1000 genes (the top 350 genes are listed in Table 1).

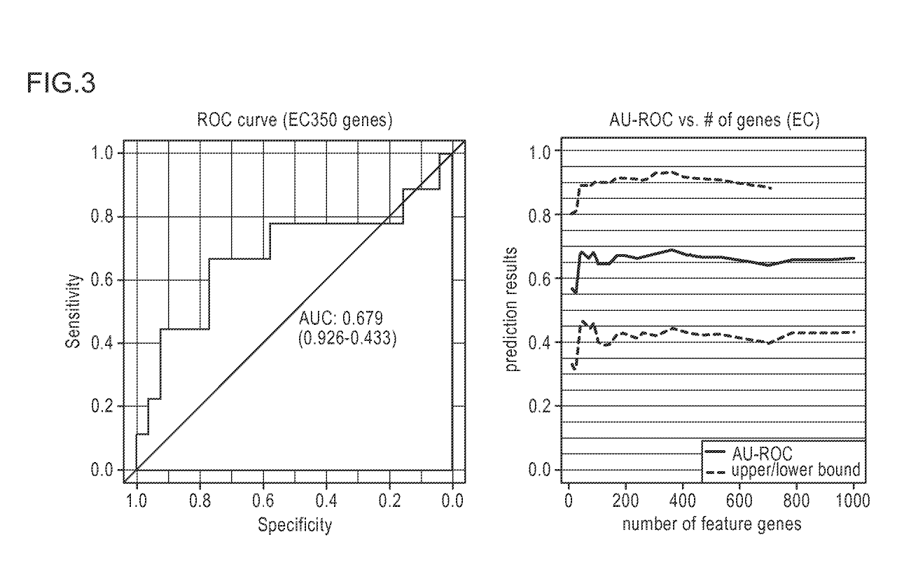

The accuracy of a 350-gene signature from Table 2 for predicting pCR in the Bertheau data set was determined, and is shown in FIG. 3. The results are shown as a receiver operator curve (ROC) as shown in the left panel. The right panel shows that the gene expression signature of Table 2 is stable over a large range of increasing gene number, from less than about 10 to over 1000 genes (the top 350 genes are listed in Table 2).

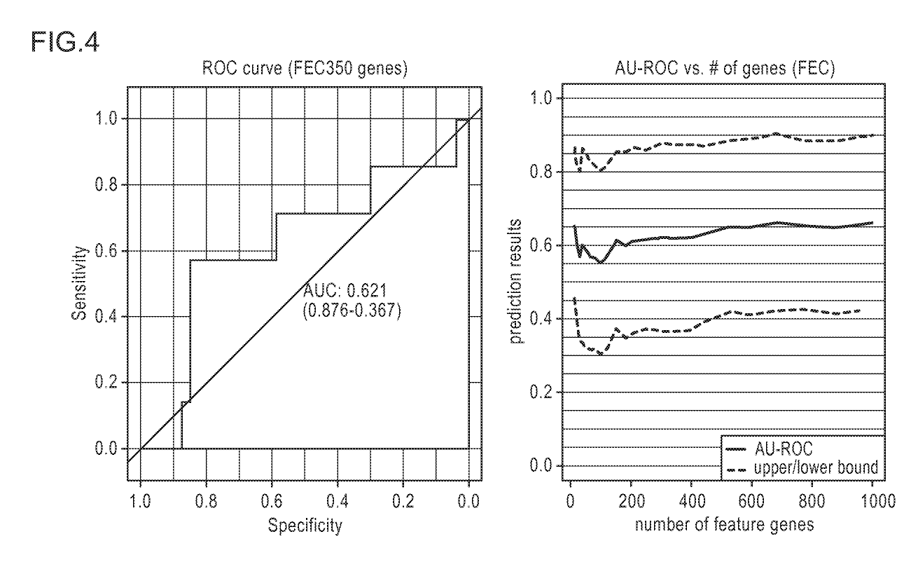

The accuracy of a 350-gene signature from Table 3 for predicting pCR in the Tabchy-FAC data set was determined, and is shown in FIG. 4. The results are shown as a receiver operator curve (ROC) as shown in the left panel. The right panel shows that the gene expression signature of Table 3 is stable over a large range of increasing gene number, from less than about 10 to over 1000 genes (the top 350 genes are listed in Table 3).

TABLE 1
TFAC

| probeID | Gene.Symbol | mean_sens | mean_resis | fold.change |
|---|---|---|---|---|
| 177_at | PLD1 | 187.67 | 94.93 | 1.98 |
| 200659_s_at | PHB | 1466.67 | 3425.67 | 0.43 |
| 200755_s_at | CALU | 3940.76 | 1745.37 | 2.26 |
| 200757_s_at | CALU | 6556.95 | 3294.48 | 1.99 |
| 200864_s_at | RAB11A | 2147.06 | 3276.50 | 0.66 |
| 200894_s_at | FKBP4 | 2455.50 | 5230.35 | 0.47 |
| 200895_s_at | FKBP4 | 5091.49 | 10247.97 | 0.50 |
| 200905_x_at | HLA-E | 3189.65 | 2029.02 | 1.57 |
| 200931_s_at | VCL | 6847.25 | 3793.12 | 1.81 |
| 201005_at | CD9 | 7842.90 | 15376.27 | 0.51 |
| 201329_s_at | ETS2 | 514.03 | 212.47 | 2.42 |
| 201440_at | DDX23 | 1622.15 | 2267.53 | 0.72 |
| 201467_s_at | NQO1 | 3804.59 | 8350.48 | 0.46 |
| 201468_s_at | NQO1 | 5458.85 | 13385.40 | 0.41 |
| 201484_at | SUPT4H1 | 1143.42 | 1794.74 | 0.64 |
| 201494_at | PRCP | 2638.73 | 1937.80 | 1.36 |
| 201552_at | LAMP1 | 6211.28 | 8692.23 | 0.71 |
| 201582_at | SEC23B | 773.20 | 1282.01 | 0.60 |
| 201631_s_at | IER3 | 11146.28 | 5666.34 | 1.97 |
| 201657_at | ARL1 | 1140.58 | 2073.82 | 0.55 |
| 201658_at | ARL1 | 1443.46 | 2940.08 | 0.49 |
| 201733_at | CLCN3 | 456.10 | 887.11 | 0.51 |
| 201734_at | CLCN3 | 1790.03 | 3037.18 | 0.59 |
| 201764_at | TMEM106C | 3642.59 | 5476.92 | 0.67 |
| 201834_at | PRKAB1 | 436.03 | 734.29 | 0.59 |
| 201886_at | DCAF11 | 1288.41 | 1699.15 | 0.76 |
| 201911_s_at | FARP1 | 922.21 | 1761.78 | 0.52 |
| 201968_s_at | PGM1 | 4901.51 | 1735.81 | 2.82 |
| 202076_at | BIRC2 | 4028.18 | 2176.31 | 1.85 |
| 202132_at | WWTR1 | 799.45 | 267.10 | 2.99 |
| 202133_at | WWTR1 | 3013.74 | 966.24 | 3.12 |
| 202134_s_at | WWTR1 | 1082.15 | 354.31 | 3.05 |
| 202187_s_at | PPP2R5A | 1461.19 | 2245.91 | 0.65 |
| 202204_s_at | AMFR | 701.23 | 1288.11 | 0.54 |
| 202321_at | GGPS1 | 568.06 | 894.13 | 0.64 |
| 202381_at | ADAM9 | 5335.71 | 3215.14 | 1.66 |
| 202449_s_at | RXRA | 2554.76 | 4531.69 | 0.56 |
| 202558_s_at | HSPA13 | 1846.76 | 902.91 | 2.05 |
| 202613_at | CTPS | 2578.65 | 1576.45 | 1.64 |
| 202623_at | EAPP | 1923.82 | 2618.60 | 0.73 |
| 202636_at | RNF103 | 2353.81 | 4327.87 | 0.54 |
| 202684_s_at | RNMT | 331.61 | 158.93 | 2.09 |
| 202704_at | TOB1 | 5485.49 | 11466.59 | 0.48 |
| 202708_s_at | HIST2H2BE | 731.53 | 2409.58 | 0.30 |
| 202727_s_at | IFNGR1 | 3118.80 | 1712.98 | 1.82 |
| 202731_at | PDCD4 | 1932.28 | 4638.61 | 0.42 |
| 202743_at | PIK3R3 | 2161.80 | 4537.22 | 0.48 |
| 202870_s_at | CDC20 | 5239.00 | 2706.58 | 1.94 |
| 202900_s_at | NUP88 | 2279.47 | 1394.15 | 1.64 |
| 202908_at | WFS1 | 1040.38 | 2069.40 | 0.50 |
| 202937_x_at | RRP7A | 1259.84 | 692.48 | 1.82 |
| 202955_s_at | ARFGEF1 | 983.01 | 1455.10 | 0.68 |
| 203009_at | BCAM | 160.64 | 302.50 | 0.53 |
| 203045_at | NINJ1 | 1384.50 | 2192.21 | 0.63 |
| 203123_s_at | SLC11A2 | 1171.75 | 1371.68 | 0.85 |
| 203212_s_at | MTMR2 | 567.81 | 342.61 | 1.66 |
| 203282_at | GBE1 | 3538.89 | 1289.35 | 2.74 |
| 203320_at | SH2B3 | 529.38 | 200.44 | 2.64 |
| 203350_at | AP1G1 | 1531.81 | 2493.49 | 0.61 |
| 203370_s_at | PDLIM7 | 793.88 | 374.92 | 2.12 |
| 203491_s_at | CEP57 | 707.95 | 484.60 | 1.46 |
| 203492_x_at | CEP57 | 1278.45 | 806.81 | 1.58 |
| 203712_at | KIAA0020 | 1873.69 | 1152.29 | 1.63 |
| 203754_s_at | BRF1 | 189.95 | 405.15 | 0.47 |
| 203764_at | DLGAP5 | 3193.93 | 1946.80 | 1.64 |
| 203796_s_at | BCL7A | 176.38 | 342.06 | 0.52 |
| 203825_at | BRD3 | 2296.66 | 4024.69 | 0.57 |
| 203831_at | R3HDM2 | 1132.41 | 1681.95 | 0.67 |
| 203870_at | USP46 | 633.03 | 1134.69 | 0.56 |
| 203968_s_at | CDC6 | 3602.75 | 1323.52 | 2.72 |
| 204088_at | P2RX4 | 692.84 | 1469.26 | 0.47 |
| 204162_at | NDC80 | 1890.01 | 1043.42 | 1.81 |
| 204182_s_at | ZBTB43 | 228.96 | 419.64 | 0.55 |
| 204194_at | BACH1 | 869.97 | 420.19 | 2.07 |
| 204287_at | SYNGR1 | 300.64 | 534.65 | 0.56 |
| 204365_s_at | REEP1 | 243.73 | 800.06 | 0.30 |
| 204485_s_at | TOM1L1 | 1726.56 | 3784.39 | 0.46 |
| 204613_at | PLCG2 | 318.58 | 178.98 | 1.78 |
| 204906_at | RPS6KA2 | 582.40 | 291.63 | 2.00 |
| 204934_s_at | HPN | 174.10 | 341.36 | 0.51 |
| 204958_at | PLK3 | 213.98 | 128.76 | 1.66 |
| 204975_at | EMP2 | 2974.31 | 5770.62 | 0.52 |
| 204977_at | DDX10 | 1850.57 | 984.79 | 1.88 |
| 205005_s_at | NMT2 | 721.99 | 287.62 | 2.51 |
| 205006_s_at | NMT2 | 423.46 | 164.50 | 2.57 |
| 205074_at | SLC22A5 | 1059.54 | 2090.21 | 0.51 |
| 205126_at | VRK2 | 1386.52 | 909.22 | 1.52 |
| 205173_x_at | CD58 | 2192.12 | 1216.21 | 1.80 |
| 205203_at | PLD1 | 314.70 | 164.62 | 1.91 |
| 205251_at | PER2 | 961.51 | 1448.10 | 0.66 |
| 205260_s_at | ACYP1 | 1281.13 | 650.92 | 1.97 |
| 205443_at | SNAPC1 | 1188.55 | 589.60 | 2.02 |
| 205574_x_at | BMP1 | 433.49 | 173.02 | 2.51 |
| 205594_at | ZNF652 | 1176.87 | 3392.50 | 0.35 |
| 205607_s_at | SCYL3 | 411.46 | 741.90 | 0.55 |
| 205796_at | TCP11L1 | 400.36 | 189.94 | 2.11 |
| 205996_s_at | AK2 | 1030.93 | 576.28 | 1.79 |
| 206076_at | LRRC23 | 128.78 | 282.87 | 0.46 |
| 206127_at | ELK3 | 147.42 | 79.04 | 1.87 |
| 206194_at | HOXC4 | 439.74 | 813.52 | 0.54 |
| 206272_at | RAB4A /// SPHAR | 638.38 | 1110.62 | 0.57 |
| 206275_s_at | MICAL2 | 201.78 | 93.28 | 2.16 |
| 206412_at | FER | 332.84 | 167.37 | 1.99 |
| 206491_s_at | NAPA | 2035.95 | 3615.41 | 0.56 |
| 206527_at | ABAT | 283.59 | 546.90 | 0.52 |
| 206653_at | POLR3G | 257.09 | 141.78 | 1.81 |
| 206745_at | HOXC11 | 509.13 | 1291.25 | 0.39 |
| 206752_s_at | DFFB | 211.37 | 139.74 | 1.51 |
| 206870_at | PPARA | 158.93 | 78.49 | 2.02 |
| 207081_s_at | PI4KA | 1275.20 | 1940.98 | 0.66 |
| 207181_s_at | CASP7 | 1016.47 | 1545.01 | 0.66 |
| 207300_s_at | F7 | 150.28 | 337.80 | 0.44 |
| 207809_s_at | ATP6AP1 | 7204.46 | 12230.18 | 0.59 |
| 207821_s_at | PTK2 | 2063.51 | 3190.04 | 0.65 |
| 208002_s_at | ACOT7 | 3520.85 | 2322.02 | 1.52 |
| 208033_s_at | ZFHX3 | 227.64 | 428.92 | 0.53 |
| 208180_s_at | HIST1H4H | 390.45 | 1369.19 | 0.29 |
| 208270_s_at | RNPEP | 4900.79 | 6517.90 | 0.75 |
| 208296_x_at | TNFAIP8 | 917.61 | 654.27 | 1.40 |
| 208309_s_at | MALT1 | 675.93 | 377.30 | 1.79 |
| 208490_x_at | HIST1H2BF | 1035.84 | 1611.08 | 0.64 |
| 208636_at | ACTN1 | 9503.45 | 5275.96 | 1.80 |
| 208637_x_at | ACTN1 | 5298.19 | 2307.53 | 2.30 |
| 208740_at | SAP18 | 953.58 | 1438.74 | 0.66 |
| 208741_at | SAP18 | 394.50 | 890.14 | 0.44 |
| 208774_at | CSNK1D | 2123.12 | 2805.89 | 0.76 |
| 208817_at | COMT | 3285.04 | 5606.72 | 0.59 |
| 208818_s_at | COMT | 7961.24 | 12486.53 | 0.64 |
| 208820_at | PTK2 | 3028.16 | 5085.74 | 0.60 |
| 208837_at | TMED3 | 3047.22 | 4431.02 | 0.69 |
| 208873_s_at | REEP5 | 3612.35 | 7045.58 | 0.51 |
| 208886_at | H1F0 | 4105.26 | 5542.52 | 0.74 |
| 208906_at | BSCL2 | 1264.64 | 2630.16 | 0.48 |
| 208921_s_at | SRI | 6405.51 | 2617.12 | 2.45 |
| 208927_at | SPOP | 1534.51 | 2859.46 | 0.54 |
| 208931_s_at | ILF3 | 2640.57 | 1177.85 | 2.24 |
| 208935_s_at | LGALS8 | 583.14 | 1456.29 | 0.40 |
| 208938_at | PRCC | 1537.19 | 2152.79 | 0.71 |
| 208944_at | TGFBR2 | 1184.42 | 244.14 | 4.85 |
| 208999_at | SEPT8 | 1844.99 | 2907.79 | 0.63 |
| 209050_s_at | RALGDS | 793.09 | 1245.47 | 0.64 |
| 209051_s_at | RALGDS | 481.01 | 683.99 | 0.70 |
| 209110_s_at | RGL2 | 2325.00 | 3387.55 | 0.69 |
| 209112_at | CDKN1B | 3097.17 | 5596.92 | 0.55 |
| 209163_at | CYB561 | 3283.34 | 5566.65 | 0.59 |
| 209164_s_at | CYB561 | 1872.96 | 3258.12 | 0.57 |
| 209222_s_at | OSBPL2 | 1287.25 | 2084.15 | 0.62 |
| 209262_s_at | NR2F6 | 2376.60 | 4020.34 | 0.59 |
| 209333_at | ULK1 | 404.79 | 743.23 | 0.54 |
| 209337_at | PSIP1 | 2162.53 | 1541.30 | 1.40 |
| 209339_at | SIAH2 | 1749.38 | 3882.41 | 0.45 |
| 209380_s_at | ABCC5 | 1654.06 | 2196.55 | 0.75 |
| 209431_s_at | PATZ1 | 579.17 | 1037.47 | 0.56 |
| 209494_s_at | PATZ1 | 839.60 | 2062.89 | 0.41 |
| 209572_s_at | EED | 2637.72 | 1867.30 | 1.41 |
| 209623_at | MCCC2 | 3564.77 | 5683.21 | 0.63 |
| 209624_s_at | MCCC2 | 1473.36 | 2534.41 | 0.58 |
| 209642_at | BUB1 | 1716.60 | 1208.45 | 1.42 |
| 209645_s_at | ALDH1B1 | 434.58 | 262.00 | 1.66 |
| 209667_at | CES2 | 939.95 | 1759.68 | 0.53 |
| 209681_at | SLC19A2 | 896.31 | 1717.23 | 0.52 |
| 209782_s_at | DBP | 449.32 | 793.12 | 0.57 |
| 209850_s_at | CDC42EP2 | 506.67 | 264.31 | 1.92 |
| 209862_s_at | CEP57 | 924.56 | 579.19 | 1.60 |
| 209865_at | SLC35A3 | 701.90 | 1319.52 | 0.53 |
| 209935_at | ATP2C1 | 655.83 | 331.96 | 1.98 |
| 210005_at | GART | 725.01 | 384.71 | 1.88 |
| 210010_s_at | SLC25A1 | 3472.64 | 4783.11 | 0.73 |
| 210018_x_at | MALT1 | 645.81 | 395.46 | 1.63 |
| 210075_at | 2-Mar | 428.48 | 620.19 | 0.69 |
| 210183_x_at | PNN | 10518.70 | 14923.43 | 0.70 |
| 210191_s_at | PHTF1 | 540.17 | 307.79 | 1.75 |
| 210260_s_at | TNFAIP8 | 784.12 | 497.47 | 1.58 |
| 210719_s_at | HMG20B | 2110.26 | 2799.30 | 0.75 |
| 210720_s_at | NECAB3 | 862.00 | 1203.80 | 0.72 |
| 210731_s_at | LGALS8 | 219.17 | 382.40 | 0.57 |
| 210740_s_at | ITPK1 | 2060.69 | 3123.27 | 0.66 |
| 210816_s_at | CYB561 | 605.72 | 1042.62 | 0.58 |
| 210817_s_at | CALCOCO2 | 2699.66 | 4436.21 | 0.61 |
| 210958_s_at | MAST4 | 188.77 | 451.26 | 0.42 |
| 211051_s_at | EXTL3 | 256.22 | 142.05 | 1.80 |
| 211084_x_at | PRKD3 | 752.79 | 299.57 | 2.51 |
| 211113_s_at | ABCG1 | 267.37 | 599.25 | 0.45 |
| 211160_x_at | ACTN1 | 4181.94 | 1487.78 | 2.81 |
| 211392_s_at | PATZ1 | 530.74 | 1093.53 | 0.49 |
| 211416_x_at | GGTLC1 | 355.29 | 614.72 | 0.58 |
| 211519_s_at | KIF2C | 1768.91 | 1070.79 | 1.65 |
| 211565_at | SH3GL3 | 94.02 | 171.03 | 0.55 |
| 211574_s_at | CD46 | 2171.48 | 3072.83 | 0.71 |
| 211744_s_at | CD58 | 1340.04 | 780.50 | 1.72 |
| 211919_s_at | CXCR4 | 302.64 | 1037.64 | 0.29 |
| 211967_at | TMEM123 | 7896.58 | 4481.38 | 1.76 |
| 212046_x_at | MAPK3 | 849.57 | 2275.92 | 0.37 |
| 212057_at | KIAA0182 | 3017.15 | 5148.94 | 0.59 |
| 212071_s_at | SPTBN1 | 6804.63 | 4133.43 | 1.65 |
| 212114_at | ATXN7L3B | 2602.35 | 3724.38 | 0.70 |
| 212155_at | RNF187 | 3638.43 | 5782.28 | 0.63 |
| 212174_at | AK2 | 1534.16 | 774.47 | 1.98 |
| 212202_s_at | TMEM87A | 1493.36 | 2362.58 | 0.63 |
| 212246_at | MCFD2 | 1709.28 | 763.15 | 2.24 |
| 212262_at | QKI | 1285.66 | 596.41 | 2.16 |
| 212263_at | QKI | 1539.68 | 832.60 | 1.85 |
| 212332_at | RBL2 | 379.13 | 1197.40 | 0.32 |
| 212367_at | FEM1B | 689.05 | 1313.19 | 0.52 |
| 212398_at | RDX | 2214.12 | 1215.57 | 1.82 |
| 212400_at | FAM102A | 1439.81 | 3594.33 | 0.40 |
| 212441_at | KIAA0232 | 1234.15 | 2661.03 | 0.46 |
| 212442_s_at | LASS6 | 2225.61 | 5189.17 | 0.43 |
| 212446_s_at | LASS6 | 1413.02 | 3320.84 | 0.43 |
| 212462_at | MYST4 | 1076.19 | 1960.29 | 0.55 |
| 212473_s_at | MICAL2 | 2516.31 | 639.26 | 3.94 |
| 212506_at | PICALM | 4275.46 | 2877.52 | 1.49 |
| 212508_at | MOAP1 | 1900.18 | 3073.83 | 0.62 |
| 212511_at | PICALM | 725.74 | 560.56 | 1.29 |
| 212568_s_at | DLAT | 3196.11 | 2006.91 | 1.59 |
| 212569_at | SMCHD1 | 834.31 | 511.97 | 1.63 |
| 212577_at | SMCHD1 | 1206.36 | 671.45 | 1.80 |
| 212593_s_at | PDCD4 | 3277.77 | 8409.78 | 0.39 |
| 212637_s_at | WWP1 | 1257.14 | 3174.36 | 0.40 |
| 212638_s_at | WWP1 | 3721.20 | 8307.39 | 0.45 |
| 212668_at | SMURF1 | 166.88 | 71.09 | 2.35 |
| 212672_at | ATM | 413.23 | 261.52 | 1.58 |
| 212680_x_at | PPP1R14B | 3950.78 | 2284.09 | 1.73 |
| 212692_s_at | LRBA | 1257.84 | 2672.15 | 0.47 |
| 212724_at | RND3 | 4737.53 | 1814.69 | 2.61 |
| 212728_at | DLG3 | 476.18 | 823.81 | 0.58 |
| 212729_at | DLG3 | 736.35 | 1213.18 | 0.61 |
| 212811_x_at | SLC1A4 | 1020.34 | 2190.88 | 0.47 |
| 212959_s_at | GNPTAB | 1247.03 | 1756.43 | 0.71 |
| 212960_at | TBC1D9 | 347.58 | 681.29 | 0.51 |
| 212961_x_at | CXorf40B | 2114.70 | 3440.69 | 0.61 |
| 213076_at | ITPKC | 453.21 | 670.74 | 0.68 |
| 213093_at | PRKCA | 1084.31 | 286.50 | 3.78 |
| 213120_at | UHRF1BP1L | 103.47 | 178.83 | 0.58 |
| 213143_at | C2orf72 | 191.08 | 520.95 | 0.37 |
| 213234_at | KIAA1467 | 546.76 | 1018.42 | 0.54 |
| 213302_at | PFAS | 930.42 | 390.07 | 2.39 |
| 213315_x_at | CXorf40A | 2236.26 | 3747.87 | 0.60 |
| 213342_at | YAP1 | 1634.95 | 890.10 | 1.84 |
| 213427_at | RPP40 | 2129.19 | 1097.49 | 1.94 |
| 213508_at | C14orf147 | 1262.08 | 2321.32 | 0.54 |
| 213587_s_at | ATP6V0E2 | 1920.32 | 4001.85 | 0.48 |
| 213633_at | SH3BP1 | 212.10 | 139.82 | 1.52 |
| 213724_s_at | PDK2 | 309.76 | 806.54 | 0.38 |
| 213737_x_at | LOC728498 | 544.22 | 455.54 | 1.19 |
| 214062_x_at | NFKBIB | 316.37 | 209.57 | 1.51 |
| 214109_at | LRBA | 1028.32 | 1823.42 | 0.56 |
| 214112_s_at | CXorf40A /// CXorf40B | 1617.17 | 2764.85 | 0.58 |
| 214169_at | — | 221.70 | 114.58 | 1.93 |
| 214440_at | NAT1 | 923.22 | 3415.33 | 0.27 |
| 214443_at | PVR | 499.25 | 222.30 | 2.25 |
| 214455_at | HIST1H2BC | 261.02 | 474.16 | 0.55 |
| 214543_x_at | QKI | 869.96 | 461.30 | 1.89 |
| 214616_at | HIST1H3E | 279.18 | 387.12 | 0.72 |
| 214754_at | TET3 | 288.65 | 428.85 | 0.67 |
| 214845_s_at | CALU | 3661.34 | 1507.09 | 2.43 |
| 215198_s_at | CALD1 | 176.28 | 78.43 | 2.25 |
| 215236_s_at | PICALM | 1795.15 | 1083.53 | 1.66 |
| 215285_s_at | PHTF1 | 413.17 | 207.95 | 1.99 |
| 215380_s_at | GGCT | 9827.73 | 11927.01 | 0.82 |
| 215464_s_at | TAX1BP3 | 2558.18 | 1318.92 | 1.94 |
| 215696_s_at | SEC16A | 3236.59 | 6301.92 | 0.51 |
| 215707_s_at | PRNP | 2456.45 | 446.67 | 5.50 |
| 215728_s_at | ACOT7 | 886.11 | 608.70 | 1.46 |
| 215743_at | NMT2 | 173.54 | 74.14 | 2.34 |
| 215942_s_at | GTSE1 | 924.67 | 632.17 | 1.46 |
| 217200_x_at | CYB561 | 2782.98 | 4485.27 | 0.62 |
| 217677_at | PLEKHA2 | 162.35 | 98.75 | 1.64 |
| 217795_s_at | TMEM43 | 2678.00 | 1510.50 | 1.77 |
| 217940_s_at | CARKD | 2244.89 | 3639.13 | 0.62 |
| 217993_s_at | MAT2B | 4930.96 | 3303.06 | 1.49 |
| 218065_s_at | TMEM9B | 2709.45 | 4004.59 | 0.68 |
| 218156_s_at | TSR1 | 2697.46 | 1657.61 | 1.63 |
| 218164_at | SPATA20 | 1435.79 | 2189.17 | 0.66 |
| 218170_at | ISOC1 | 3145.49 | 6112.08 | 0.51 |
| 218174_s_at | C10orf57 | 447.45 | 870.42 | 0.51 |
| 218194_at | REXO2 | 6889.09 | 4173.19 | 1.65 |
| 218195_at | C6orf211 | 3033.33 | 6012.88 | 0.50 |
| 218237_s_at | SLC38A1 | 4394.00 | 6831.29 | 0.64 |
| 218242_s_at | SUV420H1 | 1451.27 | 2545.51 | 0.57 |
| 218245_at | TSKU | 1315.84 | 3536.49 | 0.37 |
| 218288_s_at | CCDC90B | 2505.59 | 1533.44 | 1.63 |
| 218292_s_at | PRKAG2 | 591.92 | 351.34 | 1.68 |
| 218342_s_at | ERMP1 | 2093.03 | 4280.99 | 0.49 |
| 218373_at | AKTIP | 1631.47 | 3895.28 | 0.42 |
| 218379_at | RBM7 | 1979.96 | 1190.61 | 1.66 |
| 218394_at | ROGDI | 1004.99 | 1511.04 | 0.67 |
| 218471_s_at | BBS1 | 735.56 | 892.31 | 0.82 |
| 218500_at | C8orf55 | 1031.94 | 2452.44 | 0.42 |
| 218561_s_at | LYRM4 | 1941.79 | 976.00 | 1.99 |
| 218566_s_at | CHORDC1 | 4310.01 | 2500.98 | 1.72 |
| 218597_s_at | CISD1 | 3363.97 | 1999.33 | 1.68 |
| 218611_at | IER5 | 4535.31 | 1806.62 | 2.51 |
| 218640_s_at | PLEKHF2 | 2242.24 | 4358.84 | 0.51 |
| 218707_at | ZNF444 | 146.66 | 322.46 | 0.45 |
| 218770_s_at | TMEM39B | 666.30 | 278.70 | 2.39 |
| 218778_x_at | EPS8L1 | 291.57 | 433.78 | 0.67 |
| 218862_at | ASB13 | 867.69 | 1718.94 | 0.50 |
| 218886_at | PAK1IP1 | 1445.48 | 750.07 | 1.93 |
| 218890_x_at | MRPL35 | 1746.24 | 976.24 | 1.79 |
| 218978_s_at | SLC25A37 | 174.97 | 77.12 | 2.27 |
| 218985_at | SLC2A8 | 357.56 | 691.37 | 0.52 |
| 219017_at | ETNK1 | 961.91 | 1765.20 | 0.54 |
| 219100_at | OBFC1 | 602.85 | 1034.18 | 0.58 |
| 219164_s_at | ATG2B | 380.08 | 529.96 | 0.72 |
| 219189_at | FBXL6 | 587.02 | 928.42 | 0.63 |
| 219223_at | C9orf7 | 471.29 | 830.88 | 0.57 |
| 219234_x_at | SCRN3 | 175.71 | 291.23 | 0.60 |
| 219236_at | PAQR6 | 288.69 | 627.62 | 0.46 |
| 219252_s_at | GEMIN8 | 182.92 | 301.46 | 0.61 |
| 219306_at | KIF15 | 917.16 | 562.32 | 1.63 |
| 219311_at | CEP76 | 703.76 | 459.82 | 1.53 |
| 219374_s_at | ALG9 | 854.18 | 531.35 | 1.61 |
| 219401_at | XYLT2 | 293.91 | 504.06 | 0.58 |
| 219500_at | CLCF1 | 447.46 | 240.22 | 1.86 |
| 219626_at | MAP7D3 | 490.55 | 255.40 | 1.92 |
| 219687_at | HHAT | 153.60 | 273.85 | 0.56 |
| 219741_x_at | ZNF552 | 556.39 | 960.80 | 0.58 |
| 219760_at | LIN7B | 195.94 | 335.59 | 0.58 |
| 219913_s_at | CRNKL1 | 1025.36 | 1712.35 | 0.60 |
| 219928_s_at | CABYR | 450.47 | 286.17 | 1.57 |
| 220238_s_at | KLHL7 | 891.27 | 594.48 | 1.50 |
| 220239_at | KLHL7 | 1197.37 | 659.68 | 1.82 |
| 220295_x_at | DEPDC1 | 1467.24 | 712.94 | 2.06 |
| 220319_s_at | MYLIP | 804.18 | 1611.29 | 0.50 |
| 220486_x_at | TMEM164 | 1398.14 | 2925.84 | 0.48 |
| 220936_s_at | H2AFJ | 155.98 | 380.03 | 0.41 |
| 221222_s_at | C1orf56 | 474.70 | 856.85 | 0.55 |
| 221273_s_at | RNF208 | 269.54 | 625.31 | 0.43 |
| 221519_at | FBXW4 | 792.39 | 1076.31 | 0.74 |
| 221580_s_at | TAF1D | 3131.61 | 1626.18 | 1.93 |
| 221622_s_at | TMEM126B | 4045.33 | 3003.31 | 1.35 |
| 221656_s_at | ARHGEF10L | 336.60 | 462.49 | 0.73 |
| 221685_s_at | CCDC99 | 2794.58 | 1453.45 | 1.92 |
| 221802_s_at | KIAA1598 | 1452.85 | 2204.67 | 0.66 |
| 221856_s_at | FAM63A | 853.92 | 1361.36 | 0.63 |
| 221869_at | ZNF512B | 520.80 | 1137.87 | 0.46 |
| 221920_s_at | SLC25A37 | 551.12 | 236.01 | 2.34 |
| 222303_at | — | 183.74 | 61.36 | 2.99 |
| 32062_at | LRRC14 | 275.10 | 506.80 | 0.54 |
| 35147_at | MCF2L | 560.46 | 1078.57 | 0.52 |
| 38340_at | HIP1R /// LOC100294412 | 1711.29 | 2714.61 | 0.63 |
| 41329_at | SCYL3 | 447.03 | 917.83 | 0.49 |
| 45653_at | KCTD13 | 381.06 | 552.92 | 0.69 |
| 48106_at | SLC48A1 | 664.85 | 1296.47 | 0.51 |
| 55872_at | ZNF512B | 2049.11 | 3419.45 | 0.60 |
| 57516_at | ZNF764 | 254.44 | 451.08 | 0.56 |
| 61874_at | C9orf7 | 788.64 | 1409.92 | 0.56 |
| 62987_r_at | CACNG4 | 1375.17 | 2582.09 | 0.53 |
| 74694_s_at | RABEP2 | 752.65 | 1318.05 | 0.57 |

TABLE 2
EC

| probeID | Gene.Symbol | mean_sens | mean_resis | fold.change |
|---|---|---|---|---|
| 177_at | PLD1 | 169.91 | 95.45 | 1.78 |
| 200076_s_at | C19orf50 | 2036.80 | 1321.67 | 1.54 |
| 200670_at | XBP1 | 7838.42 | 16253.14 | 0.48 |
| 200864_s_at | RAB11A | 1974.56 | 3282.05 | 0.60 |
| 200894_s_at | FKBP4 | 2617.01 | 5234.00 | 0.50 |
| 200895_s_at | FKBP4 | 5325.43 | 10261.41 | 0.52 |
| 200904_at | HLA-E | 826.56 | 323.78 | 2.55 |
| 200905_x_at | HLA-E | 2984.25 | 1914.12 | 1.56 |
| 201003_x_at | RNPEP /// TMEM189 /// TMEM189- | 3869.73 | 5796.20 | 0.67 |
| | UBE2V1 /// UBE2V1 | | | |
| 201323_at | EBNA1BP2 | 3572.66 | 1433.13 | 2.49 |
| 201329_s_at | ETS2 | 567.18 | 213.19 | 2.66 |
| 201440_at | DDX23 | 1584.35 | 2173.32 | 0.73 |
| 201468_s_at | NQO1 | 4803.97 | 12113.92 | 0.40 |
| 201484_at | SUPT4H1 | 1240.48 | 1812.63 | 0.68 |
| 201533_at | CTNNB1 | 3874.15 | 2433.32 | 1.59 |
| 201582_at | SEC23B | 726.54 | 1317.11 | 0.55 |
| 201605_x_at | CNN2 | 2368.04 | 1369.21 | 1.73 |
| 201631_s_at | IER3 | 10520.90 | 5496.12 | 1.91 |
| 201734_at | CLCN3 | 1819.00 | 2949.48 | 0.62 |
| 201764_at | TMEM106C | 3499.52 | 5316.15 | 0.66 |
| 201976_s_at | MYO10 | 2730.90 | 1091.11 | 2.50 |
| 202076_at | BIRC2 | 4254.63 | 2254.80 | 1.89 |
| 202132_at | WWTR1 | 685.01 | 268.54 | 2.55 |
| 202133_at | WWTR1 | 2625.60 | 963.67 | 2.72 |
| 202134_s_at | WWTR1 | 952.77 | 365.30 | 2.61 |
| 202147_s_at | IFRD1 | 1759.62 | 1005.48 | 1.75 |
| 202187_s_at | PPP2R5A | 1298.81 | 2201.46 | 0.59 |
| 202204_s_at | AMFR | 682.95 | 1250.71 | 0.55 |
| 202321_at | GGPS1 | 553.49 | 937.51 | 0.59 |
| 202381_at | ADAM9 | 5866.12 | 3089.33 | 1.90 |
| 202431_s_at | MYC | 4982.95 | 1939.31 | 2.57 |
| 202449_s_at | RXRA | 2358.92 | 4474.92 | 0.53 |
| 202500_at | DNAJB2 | 686.75 | 937.82 | 0.73 |
| 202558_s_at | HSPA13 | 1723.47 | 892.08 | 1.93 |
| 202579_x_at | HMGN4 | 4248.67 | 2646.12 | 1.61 |
| 202590_s_at | PDK2 | 329.00 | 792.05 | 0.42 |
| 202613_at | CTPS | 2749.79 | 1546.23 | 1.78 |
| 202623_at | EAPP | 1934.94 | 2614.59 | 0.74 |
| 202636_at | RNF103 | 2133.44 | 4237.30 | 0.50 |
| 202684_s_at | RNMT | 340.60 | 167.71 | 2.03 |
| 202704_at | TOB1 | 5194.53 | 10543.09 | 0.49 |
| 202708_s_at | HIST2H2BE | 698.97 | 2339.56 | 0.30 |
| 202727_s_at | IFNGR1 | 2627.01 | 1616.03 | 1.63 |
| 202870_s_at | CDC20 | 5556.95 | 2968.47 | 1.87 |
| 202900_s_at | NUP88 | 2511.84 | 1390.64 | 1.81 |
| 202937_x_at | RRP7A | 1205.78 | 700.11 | 1.72 |
| 202955_s_at | ARFGEF1 | 932.09 | 1548.86 | 0.60 |
| 202982_s_at | ACOT1 /// ACOT2 | 1379.05 | 2236.08 | 0.62 |
| 203009_at | BCAM | 149.62 | 311.02 | 0.48 |
| 203023_at | NOP16 | 1992.20 | 1115.13 | 1.79 |
| 203045_at | NINJ1 | 1187.71 | 2067.73 | 0.57 |
| 203247_s_at | ZNF24 | 1113.83 | 2027.05 | 0.55 |
| 203282_at | GBE1 | 3219.53 | 1203.89 | 2.67 |
| 203350_at | AP1G1 | 1479.50 | 2550.85 | 0.58 |
| 203388_at | ARRB2 | 687.24 | 437.41 | 1.57 |
| 203411_s_at | LMNA | 7741.01 | 5540.32 | 1.40 |
| 203491_s_at | CEP57 | 809.46 | 495.44 | 1.63 |
| 203492_x_at | CEP57 | 1402.35 | 844.27 | 1.66 |
| 203712_at | KIAA0020 | 1834.70 | 1134.41 | 1.62 |
| 203754_s_at | BRF1 | 177.55 | 409.93 | 0.43 |
| 203764_at | DLGAP5 | 3310.45 | 1845.34 | 1.79 |
| 203778_at | MANBA | 485.40 | 801.85 | 0.61 |
| 203796_s_at | BCL7A | 193.43 | 389.93 | 0.50 |
| 203870_at | USP46 | 667.24 | 1061.61 | 0.63 |
| 203967_at | CDC6 | 2563.20 | 1151.80 | 2.23 |
| 203968_s_at | CDC6 | 2906.15 | 1239.65 | 2.34 |
| 204049_s_at | PHACTR2 | 1310.01 | 728.01 | 1.80 |
| 204088_at | P2RX4 | 651.16 | 1510.25 | 0.43 |
| 204162_at | NDC80 | 2411.14 | 1117.60 | 2.16 |
| 204194_at | BACH1 | 900.93 | 460.86 | 1.95 |
| 204199_at | RALGPS1 | 149.52 | 392.70 | 0.38 |
| 204287_at | SYNGR1 | 284.85 | 550.36 | 0.52 |
| 204365_s_at | REEP1 | 215.11 | 817.57 | 0.26 |
| 204372_s_at | KHSRP | 4183.88 | 2661.80 | 1.57 |
| 204395_s_at | GRK5 | 279.46 | 100.06 | 2.79 |
| 204485_s_at | TOM1L1 | 1768.65 | 4385.17 | 0.40 |
| 204966_at | BAI2 | 278.49 | 632.08 | 0.44 |
| 204969_s_at | RDX | 652.94 | 214.55 | 3.04 |
| 204975_at | EMP2 | 2431.84 | 5666.62 | 0.43 |
| 204977_at | DDX10 | 2083.42 | 989.58 | 2.11 |
| 205005_s_at | NMT2 | 730.69 | 303.91 | 2.40 |
| 205006_s_at | NMT2 | 445.72 | 175.63 | 2.54 |
| 205074_at | SLC22A5 | 956.58 | 1919.24 | 0.50 |
| 205126_at | VRK2 | 1392.65 | 913.24 | 1.52 |
| 205130_at | RAGE | 1286.85 | 276.80 | 4.65 |
| 205173_x_at | CD58 | 2343.05 | 1174.78 | 1.99 |
| 205176_s_at | ITGB3BP | 2160.18 | 1281.82 | 1.69 |
| 205193_at | MAFF | 473.58 | 295.07 | 1.60 |
| 205251_at | PER2 | 871.18 | 1436.65 | 0.61 |
| 205260_s_at | ACYP1 | 1323.32 | 610.87 | 2.17 |
| 205443_at | SNAPC1 | 1556.98 | 576.77 | 2.70 |
| 205486_at | TESK2 | 395.62 | 734.29 | 0.54 |
| 205527_s_at | GEMIN4 | 741.70 | 393.81 | 1.88 |
| 205594_at | ZNF652 | 1218.56 | 3520.48 | 0.35 |
| 205732_s_at | NCOA2 | 243.90 | 428.61 | 0.57 |
| 205796_at | TCP11L1 | 349.98 | 187.20 | 1.87 |
| 205961_s_at | PSIP1 | 1696.91 | 1098.37 | 1.54 |
| 205996_s_at | AK2 | 1001.72 | 576.53 | 1.74 |
| 206074_s_at | HMGA1 | 6888.09 | 3435.70 | 2.00 |
| 206076_at | LRRC23 | 144.41 | 291.64 | 0.50 |
| 206127_at | ELK3 | 154.31 | 82.24 | 1.88 |
| 206194_at | HOXC4 | 423.43 | 824.15 | 0.51 |
| 206275_s_at | MICAL2 | 204.67 | 104.58 | 1.96 |
| 206412_at | FER | 354.76 | 155.71 | 2.28 |
| 206491_s_at | NAPA | 2076.17 | 3379.57 | 0.61 |
| 206527_at | ABAT | 280.21 | 572.87 | 0.49 |
| 206653_at | POLR3G | 356.37 | 136.42 | 2.61 |
| 206752_s_at | DFFB | 247.24 | 140.82 | 1.76 |
| 207081_s_at | PI4KA | 1185.63 | 1964.34 | 0.60 |
| 207196_s_at | TNIP1 | 2162.21 | 1247.19 | 1.73 |
| 207809_s_at | ATP6AP1 | 6497.63 | 11558.89 | 0.56 |
| 207821_s_at | PTK2 | 1961.13 | 3216.42 | 0.61 |
| 207824_s_at | MAZ | 664.58 | 1247.09 | 0.53 |
| 208002_s_at | ACOT7 | 3662.99 | 2331.49 | 1.57 |
| 208033_s_at | ZFHX3 | 211.36 | 451.73 | 0.47 |
| 208078_s_at | SIK1 | 1026.65 | 572.03 | 1.79 |
| 208180_s_at | HIST1H4H | 354.02 | 1350.03 | 0.26 |
| 208270_s_at | RNPEP | 4258.64 | 6383.97 | 0.67 |
| 208384_s_at | MID2 | 546.86 | 759.84 | 0.72 |
| 208636_at | ACTN1 | 9775.62 | 5451.76 | 1.79 |
| 208637_x_at | ACTN1 | 5199.44 | 2367.45 | 2.20 |
| 208740_at | SAP18 | 942.27 | 1326.35 | 0.71 |
| 208741_at | SAP18 | 423.47 | 824.34 | 0.51 |
| 208751_at | NAPA | 1058.44 | 1740.25 | 0.61 |
| 208774_at | CSNK1D | 2061.66 | 2924.88 | 0.70 |
| 208817_at | COMT | 2945.19 | 5515.93 | 0.53 |
| 208818_s_at | COMT | 7111.89 | 12199.22 | 0.58 |
| 208836_at | ATP1B3 | 11598.05 | 7206.03 | 1.61 |
| 208873_s_at | REEP5 | 3746.96 | 6440.32 | 0.58 |
| 208886_at | H1F0 | 4224.77 | 5644.62 | 0.75 |
| 208910_s_at | C1QBP | 10282.75 | 6215.27 | 1.65 |
| 208912_s_at | CNP | 2120.29 | 1403.97 | 1.51 |
| 208921_s_at | SRI | 5733.58 | 2551.05 | 2.25 |
| 208927_at | SPOP | 1753.95 | 3097.44 | 0.57 |
| 208930_s_at | ILF3 | 1547.37 | 823.55 | 1.88 |
| 208931_s_at | ILF3 | 2810.73 | 1244.61 | 2.26 |
| 208933_s_at | LGALS8 | 1321.23 | 3326.27 | 0.40 |
| 208934_s_at | LGALS8 | 2095.06 | 3965.76 | 0.53 |
| 208935_s_at | LGALS8 | 587.17 | 1434.39 | 0.41 |
| 208936_x_at | LGALS8 | 1349.81 | 3125.76 | 0.43 |
| 209050_s_at | RALGDS | 785.66 | 1327.78 | 0.59 |
| 209051_s_at | RALGDS | 458.75 | 742.75 | 0.62 |
| 209087_x_at | MCAM | 803.67 | 154.98 | 5.19 |
| 209110_s_at | RGL2 | 2162.18 | 3418.40 | 0.63 |
| 209112_at | CDKN1B | 3207.05 | 5832.22 | 0.55 |
| 209163_at | CYB561 | 3072.40 | 5262.15 | 0.58 |
| 209164_s_at | CYB561 | 1757.99 | 3093.35 | 0.57 |
| 209222_s_at | OSBPL2 | 1280.42 | 2130.92 | 0.60 |
| 209333_at | ULK1 | 358.30 | 771.01 | 0.46 |
| 209337_at | PSIP1 | 2381.60 | 1490.50 | 1.60 |
| 209339_at | SIAH2 | 1776.11 | 4351.41 | 0.41 |
| 209431_s_at | PATZ1 | 533.57 | 1105.00 | 0.48 |
| 209494_s_at | PATZ1 | 803.86 | 2242.86 | 0.36 |
| 209530_at | CACNB3 | 447.87 | 1001.60 | 0.45 |
| 209572_s_at | EED | 2791.91 | 1780.09 | 1.57 |
| 209611_s_at | SLC1A4 | 370.80 | 708.88 | 0.52 |
| 209624_s_at | MCCC2 | 1458.15 | 2524.13 | 0.58 |
| 209645_s_at | ALDH1B1 | 449.14 | 247.13 | 1.82 |
| 209667_at | CES2 | 987.93 | 1796.32 | 0.55 |
| 209681_at | SLC19A2 | 859.43 | 1880.79 | 0.46 |
| 209693_at | ASTN2 | 211.53 | 401.86 | 0.53 |
| 209703_x_at | METTL7A | 485.86 | 1040.99 | 0.47 |
| 209818_s_at | HABP4 | 227.02 | 111.40 | 2.04 |
| 209862_s_at | CEP57 | 995.83 | 609.71 | 1.63 |
| 209883_at | GLT25D2 | 162.24 | 97.43 | 1.67 |
| 209935_at | ATP2C1 | 650.63 | 345.22 | 1.88 |
| 210005_at | GART | 742.94 | 383.18 | 1.94 |
| 210010_s_at | SLC25A1 | 3326.80 | 4616.32 | 0.72 |
| 210018_x_at | MALT1 | 715.66 | 415.64 | 1.72 |
| 210075_at | MARCH2 | 399.91 | 635.27 | 0.63 |
| 210183_x_at | PNN | 9407.58 | 14334.16 | 0.66 |
| 210191_s_at | PHTF1 | 550.19 | 294.11 | 1.87 |
| 210457_x_at | HMGA1 | 701.94 | 185.47 | 3.78 |
| 210463_x_at | TRMT1 | 778.54 | 395.95 | 1.97 |
| 210519_s_at | NQO1 | 10666.99 | 17779.20 | 0.60 |
| 210582_s_at | LIMK2 | 771.51 | 1545.72 | 0.50 |
| 210651_s_at | EPHB2 | 346.29 | 177.67 | 1.95 |
| 210719_s_at | HMG20B | 1923.81 | 2832.25 | 0.68 |
| 210740_s_at | ITPK1 | 1797.05 | 3296.35 | 0.55 |
| 210816_s_at | CYB561 | 573.54 | 983.28 | 0.58 |
| 210958_s_at | MAST4 | 187.88 | 448.20 | 0.42 |
| 211139_s_at | NAB1 | 753.64 | 350.75 | 2.15 |
| 211160_x_at | ACTN1 | 4255.13 | 1540.36 | 2.76 |
| 211233_x_at | ESR1 | 89.09 | 248.81 | 0.36 |
| 211256_x_at | BTN2A1 | 457.34 | 278.18 | 1.64 |
| 211392_s_at | PATZ1 | 510.21 | 1214.35 | 0.42 |
| 211416_x_at | GGTLC1 | 319.66 | 651.95 | 0.49 |
| 211519_s_at | KIF2C | 1801.53 | 1076.18 | 1.67 |
| 211559_s_at | CCNG2 | 755.48 | 1513.34 | 0.50 |
| 211565_at | SH3GL3 | 100.25 | 176.98 | 0.57 |
| 211686_s_at | MAK16 | 1600.99 | 926.72 | 1.73 |
| 211744_s_at | CD58 | 1430.37 | 738.56 | 1.94 |
| 211967_at | TMEM123 | 8083.51 | 4928.18 | 1.64 |
| 212046_x_at | MAPK3 | 808.06 | 2213.82 | 0.37 |
| 212057_at | KIAA0182 | 2677.45 | 5276.67 | 0.51 |
| 212090_at | GRINA | 2483.11 | 4552.62 | 0.55 |
| 212110_at | SLC39A14 | 2668.68 | 1176.95 | 2.27 |
| 212114_at | ATXN7L3B | 2691.55 | 3883.93 | 0.69 |
| 212155_at | RNF187 | 3427.23 | 5560.11 | 0.62 |
| 212174_at | AK2 | 1509.08 | 780.68 | 1.93 |
| 212202_s_at | TMEM87A | 1342.13 | 2329.64 | 0.58 |
| 212246_at | MCFD2 | 1751.43 | 755.18 | 2.32 |
| 212262_at | QKI | 1227.72 | 579.68 | 2.12 |
| 212263_at | QKI | 1544.22 | 779.34 | 1.98 |
| 212335_at | GNS | 3000.46 | 3785.92 | 0.79 |
| 212367_at | FEM1B | 671.62 | 1323.64 | 0.51 |
| 212398_at | RDX | 2312.71 | 1089.10 | 2.12 |
| 212400_at | FAM102A | 1363.12 | 3739.76 | 0.36 |
| 212441_at | KIAA0232 | 1226.52 | 2630.88 | 0.47 |
| 212442_s_at | LASS6 | 2219.13 | 4931.94 | 0.45 |
| 212446_s_at | LASS6 | 1407.02 | 3153.66 | 0.45 |
| 212462_at | MYST4 | 997.05 | 1937.00 | 0.51 |
| 212506_at | PICALM | 4519.67 | 2855.16 | 1.58 |
| 212508_at | MOAP1 | 1942.91 | 2963.48 | 0.66 |
| 212534_at | ZNF24 | 1294.97 | 1871.97 | 0.69 |
| 212568_s_at | DLAT | 3275.35 | 1888.67 | 1.73 |
| 212569_at | SMCHD1 | 985.38 | 572.45 | 1.72 |
| 212577_at | SMCHD1 | 1408.23 | 760.03 | 1.85 |
| 212637_s_at | WWP1 | 1199.68 | 3048.85 | 0.39 |
| 212638_s_at | WWP1 | 3358.63 | 8050.37 | 0.42 |
| 212662_at | PVR | 710.25 | 361.55 | 1.96 |
| 212668_at | SMURF1 | 143.96 | 69.54 | 2.07 |
| 212672_at | ATM | 478.62 | 275.29 | 1.74 |
| 212692_s_at | LRBA | 1227.92 | 2681.49 | 0.46 |
| 212728_at | DLG3 | 443.77 | 809.82 | 0.55 |
| 212729_at | DLG3 | 653.90 | 1230.92 | 0.53 |
| 212811_x_at | SLC1A4 | 1081.59 | 2336.89 | 0.46 |
| 212830_at | MEGF9 | 900.25 | 3127.18 | 0.29 |
| 212831_at | MEGF9 | 147.86 | 555.58 | 0.27 |
| 212867_at | — | 1237.78 | 2084.76 | 0.59 |
| 212870_at | SOS2 | 1192.43 | 1652.88 | 0.72 |
| 212891_s_at | GADD45GIP1 | 1233.86 | 798.90 | 1.54 |
| 212956_at | TBC1D9 | 1850.54 | 4755.03 | 0.39 |
| 212960_at | TBC1D9 | 326.51 | 704.24 | 0.46 |
| 212961_x_at | CXorf40B | 2177.38 | 3358.72 | 0.65 |
| 213005_s_at | KANK1 | 1333.83 | 484.14 | 2.76 |
| 213035_at | ANKRD28 | 863.65 | 433.64 | 1.99 |
| 213055_at | CD47 | 224.32 | 380.40 | 0.59 |
| 213067_at | MYH10 | 503.20 | 146.13 | 3.44 |
| 213136_at | PTPN2 | 1878.35 | 1011.84 | 1.86 |
| 213137_s_at | PTPN2 | 1087.92 | 580.44 | 1.87 |
| 213234_at | KIAA1467 | 535.86 | 1044.85 | 0.51 |
| 213302_at | PFAS | 1015.63 | 389.48 | 2.61 |
| 213315_x_at | CXorf40A | 2273.04 | 3666.36 | 0.62 |
| 213320_at | PRMT3 | 1502.28 | 831.80 | 1.81 |
| 213427_at | RPP40 | 2334.03 | 1035.60 | 2.25 |
| 213508_at | C14orf147 | 1212.48 | 2229.91 | 0.54 |
| 213546_at | DKFZP586I1420 | 667.20 | 1195.44 | 0.56 |
| 213547_at | CAND2 | 221.14 | 97.62 | 2.27 |
| 213587_s_at | ATP6V0E2 | 1949.44 | 4262.09 | 0.46 |
| 213889_at | — | 471.80 | 285.60 | 1.65 |
| 214011_s_at | NOP16 | 2933.39 | 1784.20 | 1.64 |
| 214035_x_at | LOC399491 | 2190.80 | 3757.21 | 0.58 |
| 214062_x_at | NFKBIB | 327.32 | 194.56 | 1.68 |
| 214109_at | LRBA | 1035.04 | 1831.58 | 0.57 |
| 214169_at | — | 219.65 | 112.86 | 1.95 |
| 214440_at | NAT1 | 952.57 | 3487.98 | 0.27 |
| 214443_at | PVR | 511.16 | 220.71 | 2.32 |
| 214455_at | HIST1H2BC | 249.25 | 473.03 | 0.53 |
| 214543_x_at | QKI | 856.64 | 437.31 | 1.96 |
| 214616_at | HIST1H3E | 273.98 | 388.34 | 0.71 |
| 215198_s_at | CALD1 | 168.89 | 79.08 | 2.14 |
| 215236_s_at | PICALM | 1861.94 | 1102.09 | 1.69 |
| 215285_s_at | PHTF1 | 421.97 | 199.90 | 2.11 |
| 215407_s_at | ASTN2 | 234.96 | 543.61 | 0.43 |
| 215696_s_at | SEC16A | 3066.40 | 6214.55 | 0.49 |
| 215707_s_at | PRNP | 2489.96 | 452.75 | 5.50 |
| 215728_s_at | ACOT7 | 927.19 | 622.07 | 1.49 |
| 215743_at | NMT2 | 197.44 | 77.57 | 2.55 |
| 216942_s_at | CD58 | 1645.47 | 842.90 | 1.95 |
| 217200_x_at | CYB561 | 2590.59 | 4256.08 | 0.61 |
| 217456_x_at | HLA-E | 1221.15 | 913.20 | 1.34 |
| 217677_at | PLEKHA2 | 188.70 | 100.04 | 1.89 |
| 217756_x_at | SERF2 | 9482.74 | 14659.37 | 0.65 |
| 217795_s_at | TMEM43 | 2552.99 | 1554.85 | 1.64 |
| 217940_s_at | CARKD | 2123.20 | 3235.99 | 0.66 |
| 217993_s_at | MAT2B | 4879.78 | 3104.83 | 1.57 |
| 218065_s_at | TMEM9B | 2702.93 | 3966.20 | 0.68 |
| 218096_at | AGPAT5 | 2689.68 | 1311.89 | 2.05 |
| 218156_s_at | TSR1 | 2843.66 | 1552.00 | 1.83 |
| 218164_at | SPATA20 | 1318.86 | 2336.83 | 0.56 |
| 218174_s_at | C10orf57 | 425.20 | 851.80 | 0.50 |
| 218194_at | REXO2 | 7741.59 | 4172.99 | 1.86 |
| 218195_at | C6orf211 | 3035.51 | 6148.10 | 0.49 |
| 218242_s_at | SUV420H1 | 1444.31 | 2742.91 | 0.53 |
| 218245_at | TSKU | 1169.02 | 2877.33 | 0.41 |
| 218288_s_at | CCDC90B | 2741.82 | 1591.30 | 1.72 |
| 218307_at | RSAD1 | 791.08 | 1130.25 | 0.70 |
| 218373_at | AKTIP | 1441.65 | 3889.24 | 0.37 |
| 218379_at | RBM7 | 2123.97 | 1201.65 | 1.77 |
| 218394_at | ROGDI | 848.38 | 1462.38 | 0.58 |
| 218561_s_at | LYRM4 | 2074.33 | 991.43 | 2.09 |
| 218566_s_at | CHORDC1 | 4656.24 | 2550.72 | 1.83 |
| 218597_s_at | CISD1 | 3450.72 | 1913.78 | 1.80 |
| 218611_at | IER5 | 4512.03 | 1754.63 | 2.57 |
| 218662_s_at | NCAPG | 1459.03 | 836.16 | 1.74 |
| 218663_at | NCAPG | 1565.98 | 987.91 | 1.59 |
| 218770_s_at | TMEM39B | 620.45 | 281.42 | 2.20 |
| 218776_s_at | TMEM62 | 527.70 | 1158.65 | 0.46 |
| 218778_x_at | EPS8L1 | 258.92 | 409.09 | 0.63 |
| 218818_at | FHL3 | 225.90 | 101.81 | 2.22 |
| 218834_s_at | TMEM132A | 1127.75 | 1642.48 | 0.69 |
| 218851_s_at | WDR33 | 95.31 | 183.60 | 0.52 |
| 218862_at | ASB13 | 922.18 | 1762.90 | 0.52 |
| 218886_at | PAK1IP1 | 1440.11 | 751.15 | 1.92 |
| 218890_x_at | MRPL35 | 1641.85 | 1018.02 | 1.61 |
| 218978_s_at | SLC25A37 | 153.88 | 72.45 | 2.12 |
| 219164_s_at | ATG2B | 335.57 | 527.88 | 0.64 |
| 219223_at | C9orf7 | 396.70 | 805.74 | 0.49 |
| 219234_x_at | SCRN3 | 167.99 | 282.15 | 0.60 |
| 219236_at | PAQR6 | 273.44 | 646.12 | 0.42 |
| 219366_at | AVEN | 961.87 | 584.61 | 1.65 |
| 219374_s_at | ALG9 | 882.42 | 480.59 | 1.84 |
| 219626_at | MAP7D3 | 474.98 | 261.68 | 1.82 |
| 219687_at | HHAT | 136.81 | 272.56 | 0.50 |
| 219741_x_at | ZNF552 | 547.40 | 912.14 | 0.60 |
| 219760_at | LIN7B | 200.94 | 323.19 | 0.62 |
| 219913_s_at | CRNKL1 | 1055.17 | 1764.82 | 0.60 |
| 220238_s_at | KLHL7 | 906.48 | 612.73 | 1.48 |
| 220239_at | KLHL7 | 1140.04 | 670.21 | 1.70 |
| 220295_x_at | DEPDC1 | 1588.76 | 758.82 | 2.09 |
| 220486_x_at | TMEM164 | 1306.17 | 2868.46 | 0.46 |
| 220682_s_at | — | 156.83 | 98.33 | 1.59 |
| 220936_s_at | H2AFJ | 153.79 | 395.40 | 0.39 |
| 221222_s_at | C1orf56 | 447.50 | 843.18 | 0.53 |
| 221273_s_at | RNF208 | 269.58 | 681.17 | 0.40 |
| 221379_at | — | 138.93 | 81.03 | 1.71 |
| 221449_s_at | ITFG1 | 2193.03 | 3365.69 | 0.65 |
| 221517_s_at | MED17 | 1866.16 | 1177.05 | 1.59 |
| 221519_at | FBXW4 | 811.34 | 1087.19 | 0.75 |
| 221580_s_at | TAF1D | 3556.21 | 1686.99 | 2.11 |
| 221622_s_at | TMEM126B | 4578.70 | 2973.94 | 1.54 |
| 221685_s_at | CCDC99 | 2913.75 | 1471.85 | 1.98 |
| 221756_at | PIK3IP1 | 167.86 | 406.40 | 0.41 |
| 221838_at | KLHL22 | 286.05 | 480.29 | 0.60 |
| 221869_at | ZNF512B | 531.98 | 1154.43 | 0.46 |
| 221920_s_at | SLC25A37 | 454.12 | 239.91 | 1.89 |
| 222234_s_at | DBNDD1 | 573.38 | 908.41 | 0.63 |
| 222303_at | — | 185.28 | 59.16 | 3.13 |
| 34726_at | CACNB3 | 626.40 | 1170.88 | 0.53 |
| 35147_at | MCF2L | 476.61 | 1163.32 | 0.41 |
| 37028_at | PPP1R15A | 957.54 | 495.21 | 1.93 |
| 38340_at | HIP1R /// LOC100294412 | 1616.47 | 2717.04 | 0.59 |
| 38766_at | SRCAP | 402.71 | 636.85 | 0.63 |
| 41329_at | SCYL3 | 391.17 | 987.31 | 0.40 |
| 45653_at | KCTD13 | 390.05 | 573.99 | 0.68 |
| 57516_at | ZNF764 | 284.81 | 449.40 | 0.63 |
| 61874_at | C9orf7 | 708.94 | 1393.41 | 0.51 |
| 62987_r_at | CACNG4 | 1248.36 | 2751.03 | 0.45 |
| 74694_s_at | RABEP2 | 699.94 | 1327.07 | 0.53 |

TABLE 3
FEC

| probeID | Gene.Symbol | mean_sens | mean_resis | fold.change |
|---|---|---|---|---|
| 177_at | PLD1 | 164.79 | 94.41 | 1.75 |
| 200755_s_at | CALU | 3522.35 | 1805.50 | 1.95 |
| 200757_s_at | CALU | 6100.30 | 3398.68 | 1.79 |
| 200864_s_at | RAB11A | 1950.30 | 3306.97 | 0.59 |
| 200894_s_at | FKBP4 | 2875.84 | 5062.24 | 0.57 |
| 200895_s_at | FKBP4 | 5941.20 | 10110.61 | 0.59 |
| 200904_at | HLA-E | 930.49 | 335.86 | 2.77 |
| 200905_x_at | HLA-E | 3157.77 | 2035.51 | 1.55 |
| 201003_x_at | RNPEP /// TMEM189 /// TMEM189- | 4236.90 | 5719.43 | 0.74 |
| | UBE2V1 /// UBE2V1 /// UBE2V1P2 | | | |
| 201319_at | MRCL3 | 3892.08 | 2854.18 | 1.36 |
| 201323_at | EBNA1BP2 | 3603.85 | 1414.56 | 2.55 |
| 201329_s_at | ETS2 | 683.86 | 229.83 | 2.98 |
| 201330_at | RARS | 4807.11 | 2615.76 | 1.84 |
| 201467_s_at | NQO1 | 3479.77 | 8167.38 | 0.43 |
| 201468_s_at | NQO1 | 5376.29 | 13090.14 | 0.41 |
| 201484_at | SUPT4H1 | 1134.57 | 1875.04 | 0.61 |
| 201552_at | LAMP1 | 6244.41 | 8442.89 | 0.74 |
| 201582_at | SEC23B | 781.24 | 1289.71 | 0.61 |
| 201605_x_at | CNN2 | 2129.21 | 1359.44 | 1.57 |
| 201613_s_at | AP1G2 | 898.73 | 1621.71 | 0.55 |
| 201626_at | INSIG1 | 1931.66 | 3105.24 | 0.62 |
| 201627_s_at | INSIG1 | 2034.05 | 3319.33 | 0.61 |
| 201631_s_at | IER3 | 10331.43 | 5418.61 | 1.91 |
| 201658_at | ARL1 | 1920.57 | 2577.10 | 0.75 |
| 201734_at | CLCN3 | 1809.93 | 2835.19 | 0.64 |
| 201764_at | TMEM106C | 3342.02 | 5387.71 | 0.62 |
| 201853_s_at | CDC25B | 5380.42 | 3098.56 | 1.74 |
| 201886_at | WDR23 | 1176.13 | 1696.40 | 0.69 |
| 202132_at | WWTR1 | 713.92 | 270.91 | 2.64 |
| 202133_at | WWTR1 | 2854.75 | 953.54 | 2.99 |
| 202134_s_at | WWTR1 | 962.36 | 365.19 | 2.64 |
| 202204_s_at | AMFR | 720.83 | 1263.44 | 0.57 |
| 202381_at | ADAM9 | 6281.84 | 2993.47 | 2.10 |
| 202449_s_at | RXRA | 2634.07 | 4332.61 | 0.61 |
| 202479_s_at | TRIB2 | 545.00 | 252.31 | 2.16 |
| 202558_s_at | HSPA13 | 1669.02 | 876.50 | 1.90 |
| 202590_s_at | PDK2 | 291.84 | 697.67 | 0.42 |
| 202613_at | CTPS | 3097.18 | 1619.78 | 1.91 |
| 202623_at | EAPP | 1800.65 | 2585.10 | 0.70 |
| 202636_at | RNF103 | 2254.86 | 3984.62 | 0.57 |
| 202684_s_at | RNMT | 340.09 | 170.19 | 2.00 |
| 202704_at | TOB1 | 5166.08 | 11274.26 | 0.46 |
| 202708_s_at | HIST2H2BE | 577.79 | 2312.23 | 0.25 |
| 202870_s_at | CDC20 | 5503.72 | 2957.35 | 1.86 |
| 202900_s_at | NUP88 | 2323.82 | 1374.98 | 1.69 |
| 203009_at | BCAM | 135.21 | 294.56 | 0.46 |
| 203023_at | NOP16 | 1993.86 | 1211.95 | 1.65 |
| 203045_at | NINJ1 | 1151.48 | 2113.26 | 0.54 |
| 203122_at | TTC15 | 577.55 | 373.42 | 1.55 |
| 203282_at | GBE1 | 3487.51 | 1162.12 | 3.00 |
| 203350_at | AP1G1 | 1285.74 | 2483.44 | 0.52 |
| 203411_s_at | LMNA | 8659.48 | 5477.99 | 1.58 |
| 203491_s_at | CEP57 | 792.14 | 502.84 | 1.58 |
| 203492_x_at | CEP57 | 1411.68 | 854.75 | 1.65 |
| 203712_at | KIAA0020 | 2172.01 | 1159.62 | 1.87 |
| 203754_s_at | BRF1 | 187.19 | 410.02 | 0.46 |
| 203764_at | DLGAP5 | 3132.63 | 2014.17 | 1.56 |
| 203778_at | MANBA | 539.28 | 817.94 | 0.66 |
| 203795_s_at | BCL7A | 299.71 | 615.12 | 0.49 |
| 203796_s_at | BCL7A | 166.39 | 386.80 | 0.43 |
| 203870_at | USP46 | 667.14 | 1082.93 | 0.62 |
| 203967_at | CDC6 | 3278.74 | 1383.41 | 2.37 |
| 203968_s_at | CDC6 | 3583.54 | 1413.45 | 2.54 |
| 204049_s_at | PHACTR2 | 1387.17 | 841.49 | 1.65 |
| 204067_at | SUOX | 733.33 | 996.45 | 0.74 |
| 204088_at | P2RX4 | 642.48 | 1458.64 | 0.44 |
| 204162_at | NDC80 | 2386.02 | 1131.43 | 2.11 |
| 204182_s_at | ZBTB43 | 238.59 | 465.56 | 0.51 |
| 204194_at | BACH1 | 914.46 | 456.73 | 2.00 |
| 204199_at | RALGPS1 | 158.24 | 386.26 | 0.41 |
| 204287_at | SYNGR1 | 277.78 | 524.60 | 0.53 |
| 204317_at | GTSE1 | 506.89 | 293.05 | 1.73 |
| 204365_s_at | REEP1 | 230.86 | 696.01 | 0.33 |
| 204395_s_at | GRK5 | 287.93 | 101.72 | 2.83 |
| 204485_s_at | TOM1L1 | 1507.13 | 4597.47 | 0.33 |
| 204509_at | CA12 | 97.03 | 207.39 | 0.47 |
| 204687_at | DKFZP564O0823 | 148.54 | 540.37 | 0.27 |
| 204906_at | RPS6KA2 | 559.79 | 301.62 | 1.86 |
| 204934_s_at | HPN | 182.64 | 345.00 | 0.53 |
| 204958_at | PLK3 | 220.65 | 127.91 | 1.73 |
| 204969_s_at | RDX | 566.78 | 241.38 | 2.35 |
| 204975_at | EMP2 | 2360.25 | 5575.21 | 0.42 |
| 205005_s_at | NMT2 | 720.23 | 308.98 | 2.33 |
| 205006_s_at | NMT2 | 463.23 | 176.46 | 2.63 |
| 205126_at | VRK2 | 1277.15 | 940.75 | 1.36 |
| 205173_x_at | CD58 | 2426.03 | 1181.60 | 2.05 |
| 205193_at | MAFF | 520.25 | 285.96 | 1.82 |
| 205251_at | PER2 | 782.30 | 1440.76 | 0.54 |
| 205443_at | SNAPC1 | 1564.63 | 605.50 | 2.58 |
| 205474_at | CRLF3 | 1948.63 | 1109.66 | 1.76 |
| 205536_at | VAV2 | 215.68 | 323.53 | 0.67 |
| 205594_at | ZNF652 | 1022.22 | 3140.46 | 0.33 |
| 205702_at | PHTF1 | 387.49 | 249.58 | 1.55 |
| 205743_at | STAC | 984.58 | 198.85 | 4.95 |
| 205796_at | TCP11L1 | 354.66 | 186.59 | 1.90 |
| 205961_s_at | PSIP1 | 2045.85 | 1131.92 | 1.81 |
| 205996_s_at | AK2 | 1022.46 | 569.98 | 1.79 |
| 206076_at | LRRC23 | 136.52 | 287.63 | 0.47 |
| 206194_at | HOXC4 | 441.72 | 831.76 | 0.53 |
| 206272_at | RAB4A /// SPHAR | 611.39 | 1048.88 | 0.58 |
| 206275_s_at | MICAL2 | 203.01 | 101.69 | 2.00 |
| 206299_at | FAM155B | 119.58 | 252.93 | 0.47 |
| 206412_at | FER | 313.12 | 155.57 | 2.01 |
| 206527_at | ABAT | 224.17 | 566.95 | 0.40 |
| 206653_at | POLR3G | 334.74 | 145.99 | 2.29 |
| 206752_s_at | DFFB | 247.42 | 145.43 | 1.70 |
| 207181_s_at | CASP7 | 971.17 | 1477.32 | 0.66 |
| 207196_s_at | TNIP1 | 2140.62 | 1288.85 | 1.66 |
| 207296_at | ZNF343 | 133.14 | 61.53 | 2.16 |
| 207345_at | FST | 213.81 | 71.15 | 3.01 |
| 207629_s_at | ARHGEF2 | 757.57 | 454.29 | 1.67 |
| 207809_s_at | ATP6AP1 | 7428.31 | 11728.97 | 0.63 |
| 208002_s_at | ACOT7 | 3507.03 | 2256.37 | 1.55 |
| 208033_s_at | ZFHX3 | 217.42 | 453.63 | 0.48 |
| 208270_s_at | RNPEP | 4498.19 | 6291.81 | 0.71 |
| 208309_s_at | MALT1 | 988.03 | 392.28 | 2.52 |
| 208384_s_at | MID2 | 471.42 | 751.77 | 0.63 |
| 208636_at | ACTN1 | 10084.47 | 5589.44 | 1.80 |
| 208637_x_at | ACTN1 | 5431.91 | 2442.74 | 2.22 |
| 208740_at | SAP18 | 974.43 | 1405.21 | 0.69 |
| 208741_at | SAP18 | 447.76 | 840.94 | 0.53 |
| 208817_at | COMT | 3038.56 | 5346.16 | 0.57 |
| 208818_s_at | COMT | 7634.52 | 12122.43 | 0.63 |
| 208820_at | PTK2 | 2563.63 | 4691.97 | 0.55 |
| 208912_s_at | CNP | 2424.44 | 1448.59 | 1.67 |
| 208921_s_at | SRI | 6134.02 | 2735.38 | 2.24 |
| 208927_at | SPOP | 1629.62 | 2802.83 | 0.58 |
| 208931_s_at | ILF3 | 2600.54 | 1258.95 | 2.07 |
| 208933_s_at | LGALS8 | 1273.42 | 3204.66 | 0.40 |
| 208934_s_at | LGALS8 | 1752.28 | 3847.59 | 0.46 |
| 208935_s_at | LGALS8 | 571.86 | 1365.03 | 0.42 |
| 208936_x_at | LGALS8 | 1233.50 | 3068.56 | 0.40 |
| 208999_at | 8-Sep | 1727.65 | 2885.59 | 0.60 |
| 209037_s_at | EHD1 | 1112.86 | 641.29 | 1.74 |
| 209050_s_at | RALGDS | 757.33 | 1292.51 | 0.59 |
| 209051_s_at | RALGDS | 461.39 | 715.64 | 0.64 |
| 209087_x_at | MCAM | 986.19 | 156.12 | 6.32 |
| 209112_at | CDKN1B | 2882.97 | 5756.21 | 0.50 |
| 209163_at | CYB561 | 3067.32 | 5390.64 | 0.57 |
| 209164_s_at | CYB561 | 1735.59 | 3152.70 | 0.55 |
| 209209_s_at | FERMT2 | 1809.97 | 446.03 | 4.06 |
| 209210_s_at | FERMT2 | 3732.70 | 1083.11 | 3.45 |
| 209333_at | ULK1 | 387.11 | 775.19 | 0.50 |
| 209337_at | PSIP1 | 2795.75 | 1539.95 | 1.82 |
| 209339_at | SIAH2 | 1559.23 | 4253.10 | 0.37 |
| 209431_s_at | PATZ1 | 487.61 | 1099.21 | 0.44 |
| 209435_s_at | ARHGEF2 | 2132.31 | 1338.30 | 1.59 |
| 209494_s_at | PATZ1 | 794.11 | 2193.46 | 0.36 |
| 209530_at | CACNB3 | 418.48 | 1000.54 | 0.42 |
| 209572_s_at | EED | 2609.70 | 1887.52 | 1.38 |
| 209611_s_at | SLC1A4 | 338.65 | 633.73 | 0.53 |
| 209623_at | MCCC2 | 3296.67 | 5800.79 | 0.57 |
| 209624_s_at | MCCC2 | 1293.48 | 2562.26 | 0.50 |
| 209642_at | BUB1 | 1762.24 | 1249.03 | 1.41 |
| 209645_s_at | ALDH1B1 | 439.08 | 276.05 | 1.59 |
| 209667_at | CES2 | 976.13 | 1773.59 | 0.55 |
| 209681_at | SLC19A2 | 886.71 | 1819.88 | 0.49 |
| 209693_at | ASTN2 | 187.86 | 396.34 | 0.47 |
| 209703_x_at | METTL7A | 528.32 | 1007.35 | 0.52 |
| 209818_s_at | HABP4 | 236.28 | 110.46 | 2.14 |
| 209862_s_at | CEP57 | 997.30 | 619.17 | 1.61 |
| 209883_at | GLT25D2 | 160.36 | 96.27 | 1.67 |
| 209935_at | ATP2C1 | 667.25 | 314.23 | 2.12 |
| 210005_at | GART | 747.32 | 387.54 | 1.93 |
| 210010_s_at | SLC25A1 | 3272.65 | 4683.77 | 0.70 |
| 210018_x_at | MALT1 | 908.66 | 405.71 | 2.24 |
| 210183_x_at | PNN | 9693.76 | 14305.14 | 0.68 |
| 210191_s_at | PHTF1 | 530.06 | 299.76 | 1.77 |
| 210519_s_at | NQO1 | 11618.87 | 18995.78 | 0.61 |
| 210740_s_at | ITPK1 | 1803.19 | 3501.59 | 0.51 |
| 210958_s_at | MAST4 | 173.41 | 454.64 | 0.38 |
| 211084_x_at | PRKD3 | 647.49 | 299.73 | 2.16 |
| 211113_s_at | ABCG1 | 240.56 | 579.30 | 0.42 |
| 211160_x_at | ACTN1 | 4057.05 | 1589.52 | 2.55 |
| 211391_s_at | PATZ1 | 340.61 | 731.51 | 0.47 |
| 211392_s_at | PATZ1 | 482.15 | 1196.53 | 0.40 |
| 211416_x_at | GGTLC1 | 349.79 | 617.75 | 0.57 |
| 211519_s_at | KIF2C | 1834.94 | 1061.02 | 1.73 |
| 211559_s_at | CCNG2 | 695.83 | 1481.83 | 0.47 |
| 211565_at | SH3GL3 | 89.87 | 176.33 | 0.51 |
| 211574_s_at | CD46 | 2142.35 | 3029.29 | 0.71 |
| 211686_s_at | MAK16 | 1550.19 | 899.29 | 1.72 |
| 211744_s_at | CD58 | 1432.70 | 758.74 | 1.89 |
| 211919_s_at | CXCR4 | 345.24 | 1018.10 | 0.34 |
| 211967_at | TMEM123 | 9254.49 | 5170.21 | 1.79 |
| 212046_x_at | MAPK3 | 748.55 | 2186.49 | 0.34 |
| 212110_at | SLC39A14 | 3087.38 | 1110.56 | 2.78 |
| 212114_at | ATXN7L3B | 2417.69 | 3773.11 | 0.64 |
| 212120_at | RHOQ | 2463.82 | 1377.37 | 1.79 |
| 212155_at | RNF187 | 3749.43 | 5620.81 | 0.67 |
| 212174_at | AK2 | 1533.04 | 770.78 | 1.99 |
| 212239_at | PIK3R1 | 589.09 | 1548.14 | 0.38 |
| 212246_at | MCFD2 | 1624.56 | 735.95 | 2.21 |
| 212262_at | QKI | 1291.40 | 606.04 | 2.13 |
| 212263_at | QKI | 1421.25 | 813.76 | 1.75 |
| 212332_at | RBL2 | 391.28 | 1190.63 | 0.33 |
| 212367_at | FEM1B | 637.40 | 1343.84 | 0.47 |
| 212372_at | MYH10 | 2566.04 | 1322.48 | 1.94 |
| 212398_at | RDX | 2112.62 | 1128.30 | 1.87 |
| 212400_at | FAM102A | 1256.51 | 3289.67 | 0.38 |
| 212441_at | KIAA0232 | 1213.38 | 2586.33 | 0.47 |
| 212442_s_at | LASS6 | 2288.05 | 4960.83 | 0.46 |
| 212446_s_at | LASS6 | 1427.99 | 3166.57 | 0.45 |
| 212462_at | MYST4 | 1004.86 | 1913.35 | 0.53 |
| 212506_at | PICALM | 4453.20 | 2941.14 | 1.51 |
| 212508_at | MOAP1 | 1640.43 | 3078.15 | 0.53 |
| 212569_at | SMCHD1 | 1005.52 | 561.40 | 1.79 |
| 212577_at | SMCHD1 | 1405.18 | 739.46 | 1.90 |
| 212637_s_at | WWP1 | 1252.22 | 2383.46 | 0.53 |
| 212638_s_at | WWP1 | 3753.93 | 6979.61 | 0.54 |
| 212662_at | PVR | 778.53 | 388.55 | 2.00 |
| 212668_at | SMURF1 | 156.74 | 77.88 | 2.01 |
| 212672_at | ATM | 444.48 | 267.34 | 1.66 |
| 212692_s_at | LRBA | 1122.31 | 2576.76 | 0.44 |
| 212729_at | DLG3 | 711.14 | 1219.52 | 0.58 |
| 212811_x_at | SLC1A4 | 1013.61 | 2090.76 | 0.48 |
| 212830_at | MEGF9 | 817.29 | 3059.38 | 0.27 |
| 212891_s_at | GADD45GIP1 | 1216.37 | 756.64 | 1.61 |
| 212923_s_at | C6orf145 | 2117.86 | 350.33 | 6.05 |
| 212959_s_at | GNPTAB | 1236.87 | 1738.15 | 0.71 |
| 212960_at | TBC1D9 | 313.97 | 685.74 | 0.46 |
| 213005_s_at | KANK1 | 1583.23 | 480.35 | 3.30 |
| 213035_at | ANKRD28 | 918.63 | 433.34 | 2.12 |
| 213055_at | CD47 | 223.40 | 392.92 | 0.57 |
| 213067_at | MYH10 | 320.26 | 136.20 | 2.35 |
| 213093_at | PRKCA | 1309.20 | 299.35 | 4.37 |
| 213136_at | PTPN2 | 1774.78 | 1020.35 | 1.74 |
| 213137_s_at | PTPN2 | 1024.37 | 578.31 | 1.77 |
| 213143_at | C2orf72 | 185.62 | 456.73 | 0.41 |
| 213234_at | KIAA1467 | 511.83 | 1052.93 | 0.49 |
| 213283_s_at | SALL2 | 339.21 | 881.55 | 0.38 |
| 213302_at | PFAS | 850.18 | 395.21 | 2.15 |
| 213342_at | YAP1 | 1938.35 | 1169.44 | 1.66 |
| 213349_at | TMCC1 | 562.11 | 1113.39 | 0.50 |
| 213352_at | TMCC1 | 323.64 | 662.77 | 0.49 |
| 213427_at | RPP40 | 2197.60 | 1164.43 | 1.89 |
| 213508_at | C14orf147 | 1368.20 | 2064.45 | 0.66 |
| 213573_at | — | 2354.97 | 1336.24 | 1.76 |
| 213587_s_at | ATP6V0E2 | 2154.34 | 4170.53 | 0.52 |
| 213679_at | TTC30A | 147.09 | 296.77 | 0.50 |
| 213724_s_at | PDK2 | 317.82 | 760.14 | 0.42 |
| 214011_s_at | NOP16 | 2965.06 | 1952.82 | 1.52 |
| 214035_x_at | LOC399491 | 2499.84 | 3631.35 | 0.69 |
| 214062_x_at | NFKBIB | 347.30 | 212.50 | 1.63 |
| 214109_at | LRBA | 981.18 | 1732.38 | 0.57 |
| 214169_at | — | 213.88 | 114.53 | 1.87 |
| 214212_x_at | FERMT2 | 734.29 | 262.66 | 2.80 |
| 214317_x_at | RPS9 | 14232.98 | 8081.48 | 1.76 |
| 214443_at | PVR | 562.44 | 228.88 | 2.46 |
| 214449_s_at | RHOQ | 1032.65 | 532.98 | 1.94 |
| 214543_x_at | QKI | 757.72 | 463.85 | 1.63 |
| 214616_at | HIST1H3E | 237.05 | 394.74 | 0.60 |
| 214670_at | ZKSCAN1 | 1684.70 | 2380.62 | 0.71 |
| 215236_s_at | PICALM | 1823.23 | 1122.60 | 1.62 |
| 215285_s_at | PHTF1 | 385.91 | 198.13 | 1.95 |
| 215407_s_at | ASTN2 | 209.87 | 527.76 | 0.40 |
| 215464_s_at | TAX1BP3 | 2465.80 | 1358.84 | 1.81 |
| 215696_s_at | SEC16A | 3162.37 | 5906.61 | 0.54 |
| 215707_s_at | PRNP | 2811.64 | 461.81 | 6.09 |
| 215728_s_at | ACOT7 | 899.64 | 602.46 | 1.49 |
| 215743_at | NMT2 | 203.55 | 77.42 | 2.63 |
| 216044_x_at | FAM69A | 702.04 | 344.31 | 2.04 |
| 216262_s_at | TGIF2 | 582.86 | 958.94 | 0.61 |
| 216942_s_at | CD58 | 1676.97 | 870.49 | 1.93 |
| 217200_x_at | CYB561 | 2666.32 | 4321.21 | 0.62 |
| 217456_x_at | HLA-E | 1303.25 | 955.18 | 1.36 |
| 217677_at | PLEKHA2 | 193.58 | 98.34 | 1.97 |
| 217756_x_at | SERF2 | 9805.44 | 14764.72 | 0.66 |
| 217795_s_at | TMEM43 | 2762.24 | 1552.00 | 1.78 |
| 217940_s_at | CARKD | 2190.66 | 3587.26 | 0.61 |
| 218065_s_at | TMEM9B | 2673.78 | 4015.66 | 0.67 |
| 218096_at | AGPAT5 | 2680.04 | 1400.39 | 1.91 |
| 218156_s_at | TSR1 | 2662.40 | 1607.20 | 1.66 |
| 218164_at | SPATA20 | 1245.84 | 2422.53 | 0.51 |
| 218174_s_at | C10orf57 | 395.54 | 827.43 | 0.48 |
| 218194_at | REXO2 | 8436.03 | 4204.86 | 2.01 |
| 218195_at | C6orf211 | 2473.59 | 5786.75 | 0.43 |
| 218242_s_at | SUV420H1 | 1470.04 | 2660.75 | 0.55 |
| 218245_at | TSKU | 1240.82 | 3781.04 | 0.33 |
| 218288_s_at | CCDC90B | 2424.02 | 1588.82 | 1.53 |
| 218373_at | AKTIP | 1631.30 | 3881.10 | 0.42 |
| 218379_at | RBM7 | 2282.65 | 1217.14 | 1.88 |
| 218394_at | ROGDI | 870.83 | 1504.90 | 0.58 |
| 218417_s_at | SLC48A1 | 480.28 | 1093.84 | 0.44 |
| 218561_s_at | LYRM4 | 1778.14 | 1023.52 | 1.74 |
| 218566_s_at | CHORDC1 | 4695.31 | 2558.06 | 1.84 |
| 218611_at | IER5 | 3656.40 | 1805.81 | 2.02 |
| 218640_s_at | PLEKHF2 | 1927.86 | 4487.15 | 0.43 |
| 218662_s_at | NCAPG | 1450.08 | 896.32 | 1.62 |
| 218663_at | NCAPG | 1592.94 | 1049.39 | 1.52 |
| 218689_at | FANCF | 511.68 | 927.62 | 0.55 |
| 218724_s_at | TGIF2 | 292.57 | 487.05 | 0.60 |
| 218770_s_at | TMEM39B | 637.15 | 284.17 | 2.24 |
| 218851_s_at | WDR33 | 96.99 | 190.52 | 0.51 |
| 218862_at | ASB13 | 830.59 | 1752.26 | 0.47 |
| 218886_at | PAK1IP1 | 1411.30 | 775.44 | 1.82 |
| 218890_x_at | MRPL35 | 1791.19 | 1066.38 | 1.68 |
| 218978_s_at | SLC25A37 | 190.28 | 71.41 | 2.66 |
| 219017_at | ETNK1 | 1162.51 | 1704.55 | 0.68 |
| 219051_x_at | METRN | 1505.71 | 3749.29 | 0.40 |
| 219164_s_at | ATG2B | 329.81 | 542.82 | 0.61 |
| 219165_at | PDLIM2 | 1641.85 | 364.38 | 4.51 |
| 219223_at | C9orf7 | 446.82 | 774.34 | 0.58 |
| 219234_x_at | SCRN3 | 170.17 | 276.53 | 0.62 |
| 219236_at | PAQR6 | 289.07 | 642.05 | 0.45 |
| 219311_at | CEP76 | 702.87 | 495.56 | 1.42 |
| 219366_at | AVEN | 1035.47 | 653.19 | 1.59 |
| 219374_s_at | ALG9 | 907.65 | 539.08 | 1.68 |
| 219401_at | XYLT2 | 263.07 | 440.25 | 0.60 |
| 219411_at | ELMO3 | 371.55 | 945.40 | 0.39 |
| 219439_at | C1GALT1 | 1249.22 | 643.76 | 1.94 |
| 219626_at | MAP7D3 | 535.04 | 262.11 | 2.04 |
| 219687_at | HHAT | 128.39 | 265.80 | 0.48 |
| 219692_at | KREMEN2 | 158.35 | 416.81 | 0.38 |
| 219741_x_at | ZNF552 | 546.15 | 946.25 | 0.58 |
| 219913_s_at | CRNKL1 | 1068.96 | 1676.64 | 0.64 |
| 220166_at | CNNM1 | 99.62 | 181.49 | 0.55 |
| 220238_s_at | KLHL7 | 900.02 | 563.63 | 1.60 |
| 220295_x_at | DEPDC1 | 1437.86 | 734.61 | 1.96 |
| 220319_s_at | MYLIP | 673.49 | 1591.51 | 0.42 |
| 220486_x_at | TMEM164 | 1312.49 | 2959.54 | 0.44 |
| 220936_s_at | H2AFJ | 133.40 | 374.69 | 0.36 |
| 221012_s_at | TRIM8 | 1172.07 | 2285.29 | 0.51 |
| 221222_s_at | C1orf56 | 432.67 | 834.06 | 0.52 |
| 221273_s_at | RNF208 | 234.21 | 668.80 | 0.35 |
| 221501_x_at | LOC339047 | 2264.19 | 3313.22 | 0.68 |
| 221580_s_at | TAF1D | 3569.01 | 1741.97 | 2.05 |
| 221622_s_at | TMEM126B | 4582.22 | 3067.11 | 1.49 |
| 221685_s_at | CCDC99 | 2966.17 | 1531.05 | 1.94 |
| 221869_at | ZNF512B | 471.78 | 1152.98 | 0.41 |
| 221882_s_at | TMEM8A | 1130.00 | 2175.15 | 0.52 |
| 221920_s_at | SLC25A37 | 619.74 | 242.15 | 2.56 |
| 222199_s_at | BIN3 | 651.58 | 477.48 | 1.36 |
| 222234_s_at | DBNDD1 | 376.76 | 911.95 | 0.41 |
| 222273_at | PAPOLG | 254.64 | 157.25 | 1.62 |
| 34726_at | CACNB3 | 570.77 | 1172.46 | 0.49 |
| 35147_at | MCF2L | 511.63 | 1157.56 | 0.44 |
| 37028_at | PPP1R15A | 973.18 | 493.95 | 1.97 |
| 38340_at | HIP1R /// LOC100294412 | 1533.94 | 2630.37 | 0.58 |
| 38766_at | SRCAP | 437.02 | 642.82 | 0.68 |
| 40420_at | STK10 | 724.82 | 526.97 | 1.38 |
| 41329_at | SCYL3 | 410.51 | 984.74 | 0.42 |
| 44040_at | FBXO41 | 371.71 | 607.75 | 0.61 |
| 45653_at | KCTD13 | 364.58 | 551.66 | 0.66 |
| 48106_at | SLC48A1 | 558.86 | 1283.58 | 0.44 |
| 55872_at | ZNF512B | 1623.17 | 3458.78 | 0.47 |
| 57516_at | ZNF764 | 266.65 | 447.32 | 0.60 |
| 61874_at | C9orf7 | 749.70 | 1291.55 | 0.58 |
| 62987_r_at | CACNG4 | 1227.07 | 2657.12 | 0.46 |
| 74694_s_at | RABEP2 | 737.11 | 1175.30 | 0.63 |

TABLE 4
AC

| probeID | Gene.Symbol | mean_sens | mean_resis | fold.change |
|---|---|---|---|---|
| 1552277_a_at | C9orf30 | 2116.47 | 943 | 2.24 |
| 1554026_a_at | MYO10 | 249.27 | 96.64 | 2.58 |
| 1554830_a_at | STEAP3 | 421.01 | 236.14 | 1.78 |
| 1555483_x_at | FBLIM1 | 233.32 | 81.38 | 2.87 |
| 1555841_at | C9orf30 | 1074.75 | 459.9 | 2.34 |
| 1555982_at | ZFYVE16 | 229.88 | 412.83 | 0.56 |
| 1557049_at | BTBD19 | 176.47 | 83.7 | 2.11 |
| 1559064_at | NUP153 | 304.47 | 138.55 | 2.2 |
| 1559591_s_at | CHDH | 260.97 | 497.47 | 0.52 |
| 1564907_s_at | MATR3 /// SNHG4 | 226.65 | 65.18 | 3.48 |
| 1564911_at | SNHG4 | 193.49 | 65.66 | 2.95 |
| 1568838_at | LOC100132169 | 152.52 | 507.68 | 0.3 |
| 1569024_at | FAM13A | 158.64 | 82.77 | 1.92 |
| 1569149_at | PDLIM7 | 395.93 | 208.1 | 1.9 |
| 1569150_x_at | PDLIM7 | 378.18 | 218.9 | 1.73 |
| 1569470_a_at | FRMD5 | 262.11 | 92.02 | 2.85 |
| 1569867_at | EME2 | 346.9 | 714.47 | 0.49 |
| 1569868_s_at | EME2 | 334.17 | 697.39 | 0.48 |
| 177_at | PLD1 | 178.44 | 97.16 | 1.84 |
| 200755_s_at | CALU | 3660.82 | 1690.71 | 2.17 |
| 200894_s_at | FKBP4 | 2501.31 | 5300.55 | 0.47 |
| 200895_s_at | FKBP4 | 5168.02 | 10457.44 | 0.49 |
| 200904_at | HLA-E | 1010.61 | 305.43 | 3.31 |
| 200905_x_at | HLA-E | 3204.76 | 1808.68 | 1.77 |
| 201323_at | EBNA1BP2 | 3636.04 | 1426.2 | 2.55 |
| 201329_s_at | ETS2 | 675.92 | 219.58 | 3.08 |
| 201467_s_at | NQO1 | 3266.22 | 8193.83 | 0.4 |
| 201468_s_at | NQO1 | 4997.85 | 13199.73 | 0.38 |
| 201582_at | SEC23B | 753.29 | 1251.19 | 0.6 |
| 201631_s_at | IER3 | 10700.39 | 4975 | 2.15 |
| 201764_at | TMEM106C | 3449.36 | 5490.57 | 0.63 |
| 201853_s_at | CDC25B | 5105.65 | 2998.39 | 1.7 |
| 201968_s_at | PGM1 | 4656.4 | 1826.14 | 2.55 |
| 202132_at | WWTR1 | 780.45 | 277.68 | 2.81 |
| 202134_s_at | WWTR1 | 997.5 | 374.31 | 2.66 |
| 202187_s_at | PPP2R5A | 1228.8 | 2218.88 | 0.55 |
| 202204_s_at | AMFR | 665.5 | 1226.66 | 0.54 |
| 202381_at | ADAM9 | 6638.27 | 3075.88 | 2.16 |
| 202431_s_at | MYC | 4722.4 | 2143.15 | 2.2 |
| 202558_s_at | HSPA13 | 1721.13 | 842.41 | 2.04 |
| 202613_at | CTPS | 2911.09 | 1495.58 | 1.95 |
| 202636_at | RNF103 | 1975.8 | 4197.3 | 0.47 |
| 202684_s_at | RNMT | 339.2 | 167.33 | 2.03 |
| 202704_at | TOB1 | 4807.4 | 11795.1 | 0.41 |
| 202708_s_at | HIST2H2BE | 493.25 | 2338.18 | 0.21 |
| 202870_s_at | CDC20 | 5547.15 | 2923.33 | 1.9 |
| 202900_s_at | NUP88 | 2425.31 | 1462.44 | 1.66 |
| 203009_at | BCAM | 132.22 | 324.94 | 0.41 |
| 203045_at | NINJ1 | 1060.11 | 2001.2 | 0.53 |
| 203282_at | GBE1 | 3585.7 | 1255.5 | 2.86 |
| 203350_at | AP1G1 | 1220.89 | 2523.78 | 0.48 |
| 203370_s_at | PDLIM7 | 794.47 | 352.98 | 2.25 |
| 203754_s_at | BRF1 | 168.79 | 405.56 | 0.42 |
| 203870_at | USP46 | 639.63 | 1129.62 | 0.57 |
| 203968_s_at | CDC6 | 2865.69 | 1323.26 | 2.17 |
| 204088_at | P2RX4 | 777.93 | 1506.12 | 0.52 |
| 204162_at | NDC80 | 2517.9 | 1111.87 | 2.26 |
| 204194_at | BACH1 | 935.64 | 472.85 | 1.98 |
| 204199_at | RALGPS1 | 138.12 | 385.35 | 0.36 |
| 204287_at | SYNGR1 | 269.95 | 492.41 | 0.55 |
| 204365_s_at | REEP1 | 221.05 | 815.47 | 0.27 |
| 204485_s_at | TOM1L1 | 1508.94 | 4633.31 | 0.33 |
| 204687_at | PARM1 | 163.6 | 551.92 | 0.3 |
| 204958_at | PLK3 | 231.17 | 125.94 | 1.84 |
| 204975_at | EMP2 | 2036.9 | 5613.45 | 0.36 |
| 205005_s_at | NMT2 | 816.36 | 297.29 | 2.75 |
| 205006_s_at | NMT2 | 512.11 | 164.67 | 3.11 |
| 205074_at | SLC22A5 | 899.55 | 2019.9 | 0.45 |
| 205126_at | VRK2 | 1361.19 | 922.38 | 1.48 |
| 205173_x_at | CD58 | 2568.43 | 1105.54 | 2.32 |
| 205251_at | PER2 | 766.35 | 1439.74 | 0.53 |
| 205443_at | SNAPC1 | 1580.3 | 579.01 | 2.73 |
| 205594_at | ZNF652 | 1049.39 | 3510.1 | 0.3 |
| 205796_at | TCP11L1 | 348.68 | 198.23 | 1.76 |
| 205961_s_at | PSIP1 | 1911.73 | 1000.09 | 1.91 |
| 205996_s_at | AK2 | 1031.97 | 556.46 | 1.85 |
| 206074_s_at | HMGA1 | 7795.53 | 3385.5 | 2.3 |
| 206076_at | LRRC23 | 131.31 | 293.85 | 0.45 |
| 206275_s_at | MICAL2 | 211.63 | 99.88 | 2.12 |
| 206412_at | FER | 347.24 | 159.28 | 2.18 |
| 206491_s_at | NAPA | 2280.03 | 3639.02 | 0.63 |
| 206506_s_at | SUPT3H | 333.39 | 131.69 | 2.53 |
| 206527_at | ABAT | 231.24 | 539.41 | 0.43 |
| 206653_at | POLR3G | 352.21 | 123.42 | 2.85 |
| 206752_s_at | DFFB | 245.21 | 128.95 | 1.9 |
| 207809_s_at | ATP6AP1 | 6634.46 | 12047.48 | 0.55 |
| 208002_s_at | ACOT7 | 3769.08 | 2159.89 | 1.75 |
| 208309_s_at | MALT1 | 1026 | 378.38 | 2.71 |
| 208384_s_at | MID2 | 467.87 | 760.72 | 0.62 |
| 208636_at | ACTN1 | 10030.75 | 5381.77 | 1.86 |
| 208637_x_at | ACTN1 | 5501.79 | 2374.66 | 2.32 |
| 208740_at | SAP18 | 908.99 | 1404.96 | 0.65 |
| 208741_at | SAP18 | 443 | 877.75 | 0.5 |
| 208817_at | COMT | 2892.56 | 5649.28 | 0.51 |
| 208818_s_at | COMT | 7070.09 | 12746.92 | 0.55 |
| 208886_at | H1F0 | 4134.75 | 5763.46 | 0.72 |
| 208933_s_at | LGALS8 | 1179.61 | 3364.79 | 0.35 |
| 208934_s_at | LGALS8 | 1737.37 | 3978.52 | 0.44 |
| 208935_s_at | LGALS8 | 535.36 | 1436.19 | 0.37 |
| 208936_x_at | LGALS8 | 1123.37 | 3180.76 | 0.35 |
| 209087_x_at | MCAM | 1305.5 | 147.05 | 8.88 |
| 209110_s_at | RGL2 | 2127.92 | 3392.67 | 0.63 |
| 209112_at | CDKN1B | 3033.1 | 5728.39 | 0.53 |
| 209163_at | CYB561 | 2849.81 | 5516.43 | 0.52 |
| 209164_s_at | CYB561 | 1608.93 | 3225.7 | 0.5 |
| 209222_s_at | OSBPL2 | 1242.09 | 2088.24 | 0.59 |
| 209333_at | ULK1 | 337.55 | 785.75 | 0.43 |
| 209337_at | PSIP1 | 2792.5 | 1369.14 | 2.04 |
| 209431_s_at | PATZ1 | 469 | 1036.3 | 0.45 |
| 209494_s_at | PATZ1 | 766.88 | 2118.86 | 0.36 |
| 209572_s_at | EED | 2729.49 | 1875.58 | 1.46 |
| 209611_s_at | SLC1A4 | 381.22 | 690.15 | 0.55 |
| 209624_s_at | MCCC2 | 1211.23 | 2493.14 | 0.49 |
| 209645_s_at | ALDH1B1 | 457.42 | 248.07 | 1.84 |
| 209703_x_at | METTL7A | 484.22 | 1025.2 | 0.47 |
| 209818_s_at | HABP4 | 245.01 | 113.27 | 2.16 |
| 209862_s_at | CEP57 | 1044.97 | 611.19 | 1.71 |
| 209883_at | GLT25D2 | 170.22 | 99.41 | 1.71 |
| 210005_at | GART | 755.88 | 368.61 | 2.05 |
| 210010_s_at | SLC25A1 | 3128.9 | 4741.65 | 0.66 |
| 210018_x_at | MALT1 | 937.65 | 398.1 | 2.36 |
| 210191_s_at | PHTF1 | 575.67 | 292.59 | 1.97 |
| 210651_s_at | EPHB2 | 392.05 | 178.82 | 2.19 |
| 210740_s_at | ITPK1 | 1563.03 | 3486.26 | 0.45 |
| 210958_s_at | MAST4 | 218.69 | 451.68 | 0.48 |
| 211051_s_at | EXTL3 | 275.98 | 149.16 | 1.85 |
| 211160_x_at | ACTN1 | 4738.88 | 1508.42 | 3.14 |
| 211392_s_at | PATZ1 | 483.83 | 1165.23 | 0.42 |
| 211565_at | SH3GL3 | 85.16 | 169.03 | 0.5 |
| 211686_s_at | MAK16 | 1639.65 | 904.75 | 1.81 |
| 211744_s_at | CD58 | 1483.88 | 696.77 | 2.13 |
| 211919_s_at | CXCR4 | 346.15 | 1050.29 | 0.33 |
| 212046_x_at | MAPK3 | 741.71 | 2245.28 | 0.33 |
| 212155_at | RNF187 | 3207.21 | 5752.82 | 0.56 |
| 212174_at | AK2 | 1538.85 | 750.99 | 2.05 |
| 212202_s_at | TMEM87A | 1353.25 | 2411.24 | 0.56 |
| 212239_at | PIK3R1 | 540.86 | 1543.38 | 0.35 |
| 212246_at | MCFD2 | 1733.09 | 711.99 | 2.43 |
| 212262_at | QKI | 1330.1 | 592.15 | 2.25 |
| 212263_at | QKI | 1663.49 | 802.5 | 2.07 |
| 212400_at | FAM102A | 1236.71 | 3783.69 | 0.33 |
| 212442_s_at | LASS6 | 2134.97 | 5178.6 | 0.41 |
| 212446_s_at | LASS6 | 1359.27 | 3278.4 | 0.41 |
| 212508_at | MOAP1 | 1586.28 | 3110.02 | 0.51 |
| 212569_at | SMCHD1 | 1043.39 | 555.32 | 1.88 |
| 212577_at | SMCHD1 | 1475.38 | 739.47 | 2 |
| 212637_s_at | WWP1 | 1191.08 | 3076.56 | 0.39 |
| 212638_s_at | WWP1 | 3347.56 | 8103.71 | 0.41 |
| 212668_at | SMURF1 | 150.57 | 69.68 | 2.16 |
| 212672_at | ATM | 489.52 | 266.68 | 1.84 |
| 212692_s_at | LRBA | 1120.75 | 2661.79 | 0.42 |
| 212729_at | DLG3 | 618.32 | 1228.2 | 0.5 |
| 212811_x_at | SLC1A4 | 1166.32 | 2300.78 | 0.51 |
| 212830_at | MEGF9 | 867.76 | 2988.52 | 0.29 |
| 212960_at | TBC1D9 | 283.84 | 698.2 | 0.41 |
| 213005_s_at | KANK1 | 1625.68 | 497.69 | 3.27 |
| 213035_at | ANKRD28 | 958.67 | 444.26 | 2.16 |
| 213120_at | UHRF1BP1L | 112.88 | 179.69 | 0.63 |
| 213137_s_at | PTPN2 | 1107.28 | 586.7 | 1.89 |
| 213234_at | KIAA1467 | 516.49 | 1002.29 | 0.52 |
| 213302_at | PFAS | 908.51 | 378.01 | 2.4 |
| 213315_x_at | CXorf40A | 2319.76 | 3733.84 | 0.62 |
| 213342_at | YAP1 | 1685.19 | 1151.57 | 1.46 |
| 213427_at | RPP40 | 2420.84 | 1066.82 | 2.27 |
| 213508_at | C14orf147 | 1225.12 | 2307.81 | 0.53 |
| 213587_s_at | ATP6V0E2 | 2002.78 | 4210.45 | 0.48 |
| 214109_at | LRBA | 961.49 | 1762.45 | 0.55 |
| 214169_at | — | 218.11 | 109.13 | 2 |
| 214443_at | PVR | 531.06 | 225.54 | 2.35 |
| 214543_x_at | QKI | 869.42 | 456.53 | 1.9 |
| 215198_s_at | CALD1 | 165.09 | 79.15 | 2.09 |
| 215285_s_at | PHTF1 | 411.76 | 193.48 | 2.13 |
| 215696_s_at | SEC16A | 3016.28 | 6215.42 | 0.49 |
| 215707_s_at | PRNP | 3135.75 | 473.69 | 6.62 |
| 216942_s_at | CD58 | 1718.64 | 793.85 | 2.16 |
| 217200_x_at | CYB561 | 2456.77 | 4410 | 0.56 |
| 217677_at | PLEKHA2 | 207.54 | 82.9 | 2.5 |
| 218065_s_at | TMEM9B | 2745.79 | 3992.94 | 0.69 |
| 218156_s_at | TSR1 | 2860.04 | 1539.51 | 1.86 |
| 218164_at | SPATA20 | 1162.74 | 2510.02 | 0.46 |
| 218194_at | REXO2 | 8653.3 | 4245.55 | 2.04 |
| 218195_at | C6orf211 | 2433.52 | 6048.45 | 0.4 |
| 218245_at | TSKU | 1175.89 | 3815.63 | 0.31 |
| 218288_s_at | CCDC90B | 2687.36 | 1551.63 | 1.73 |
| 218373_at | AKTIP | 1332.16 | 3835.36 | 0.35 |
| 218379_at | RBM7 | 2388.64 | 1218.42 | 1.96 |
| 218394_at | ROGDI | 812.8 | 1557.24 | 0.52 |
| 218611_at | IER5 | 3866.1 | 1722.62 | 2.24 |
| 218663_at | NCAPG | 1645.24 | 1009.1 | 1.63 |
| 218770_s_at | TMEM39B | 648.69 | 273.35 | 2.37 |
| 218818_at | FHL3 | 222.45 | 100.22 | 2.22 |
| 218886_at | PAK1IP1 | 1385.46 | 729.8 | 1.9 |
| 218890_x_at | MRPL35 | 1525.63 | 1065.82 | 1.43 |
| 218978_s_at | SLC25A37 | 193.01 | 70.5 | 2.74 |
| 219223_at | C9orf7 | 388.22 | 841.91 | 0.46 |
| 219234_x_at | SCRN3 | 170.27 | 293.76 | 0.58 |
| 219236_at | PAQR6 | 263.56 | 654.99 | 0.4 |
| 219366_at | AVEN | 1003.58 | 597.74 | 1.68 |
| 219411_at | ELMO3 | 397.41 | 926.12 | 0.43 |
| 219626_at | MAP7D3 | 570.24 | 258.94 | 2.2 |
| 219741_x_at | ZNF552 | 534.28 | 976.52 | 0.55 |
| 220295_x_at | DEPDC1 | 1611.87 | 762.31 | 2.11 |
| 220936_s_at | H2AFJ | 141.32 | 397.72 | 0.36 |
| 221222_s_at | C1orf56 | 406.68 | 802.14 | 0.51 |
| 221273_s_at | RNF208 | 251.99 | 646.44 | 0.39 |
| 221519_at | FBXW4 | 698.08 | 1092.86 | 0.64 |
| 221580_s_at | TAF1D | 3740.47 | 1687.96 | 2.22 |
| 221685_s_at | CCDC99 | 3026.63 | 1384.28 | 2.19 |
| 221869_at | ZNF512B | 459.16 | 1177.12 | 0.39 |
| 221920_s_at | SLC25A37 | 617.44 | 239.08 | 2.58 |
| 222234_s_at | DBNDD1 | 346.57 | 852.3 | 0.41 |
| 222477_s_at | TM7SF3 | 2644.29 | 4794.6 | 0.55 |
| 222566_at | SUV420H1 | 327.53 | 632.86 | 0.52 |
| 222608_s_at | ANLN | 5868.58 | 3368.31 | 1.74 |
| 222646_s_at | ERO1L | 3943.74 | 2189.45 | 1.8 |
| 222728_s_at | TAF1D | 2763.95 | 1275.24 | 2.17 |
| 222811_at | FTSJD1 | 1130.86 | 1824.69 | 0.62 |
| 222867_s_at | MED31 | 1346.75 | 736 | 1.83 |
| 223072_s_at | INO80B /// WBP1 | 889.62 | 1790.13 | 0.5 |
| 223089_at | VEZT | 434.31 | 833.84 | 0.52 |
| 223151_at | DCUN1D5 | 5399.54 | 2666.94 | 2.02 |
| 223179_at | YPEL3 | 806.55 | 1689.11 | 0.48 |
| 223199_at | MKNK2 | 1260.73 | 2373.3 | 0.53 |
| 223202_s_at | TMEM164 | 837.03 | 1849.27 | 0.45 |
| 223225_s_at | SEH1L | 1675.43 | 743.55 | 2.25 |
| 223279_s_at | UACA | 615.55 | 210.87 | 2.92 |
| 223376_s_at | BRI3 | 5303.92 | 2506.07 | 2.12 |
| 223386_at | FAM118B | 832.38 | 437.03 | 1.9 |
| 223412_at | KBTBD7 | 381.65 | 697.76 | 0.55 |
| 223413_s_at | LYAR | 1694.07 | 705.8 | 2.4 |
| 223458_at | SEZ6L2 | 242.32 | 501.54 | 0.48 |
| 223611_s_at | LNX1 | 322.36 | 848.11 | 0.38 |
| 223847_s_at | ERGIC1 | 1494.7 | 2722.86 | 0.55 |
| 223963_s_at | IGF2BP2 | 159.77 | 80.69 | 1.98 |
| 223989_s_at | REXO2 | 1121.19 | 522.07 | 2.15 |
| 224336_s_at | DUSP16 | 391.05 | 971.68 | 0.4 |
| 224657_at | ERRFI1 | 4531.8 | 1606.45 | 2.82 |
| 224734_at | HMGB1 | 1515.69 | 2610.95 | 0.58 |
| 224832_at | DUSP16 | 717.15 | 2032.97 | 0.35 |
| 224894_at | YAP1 | 4628.99 | 2403.96 | 1.93 |
| 224895_at | YAP1 | 3725.49 | 2420.68 | 1.54 |
| 224905_at | WDR26 | 1532.23 | 2640.07 | 0.58 |
| 224927_at | KIAA1949 | 2426.36 | 701.63 | 3.46 |
| 224998_at | CMTM4 | 1733.81 | 4002.65 | 0.43 |
| 225009_at | CMTM4 | 1461.53 | 3180.55 | 0.46 |
| 225025_at | IGSF8 | 579.25 | 1251.4 | 0.46 |
| 225032_at | FNDC3B | 3171.13 | 1832.52 | 1.73 |
| 225067_at | ULK3 | 544.32 | 961.52 | 0.57 |
| 225079_at | EMP2 | 1851.29 | 4879.21 | 0.38 |
| 225197_at | — | 610.66 | 1138.7 | 0.54 |
| 225203_at | PPP1R16A | 597.2 | 1476.94 | 0.4 |
| 225299_at | MYO5B | 328.47 | 735.01 | 0.45 |
| 225327_at | KIAA1370 | 893.21 | 2419.22 | 0.37 |
| 225331_at | CCDC50 | 3746.28 | 1292.07 | 2.9 |
| 225418_at | PVRL2 | 1382.08 | 2604.39 | 0.53 |
| 225520_at | MTHFD1L | 1879.68 | 751.41 | 2.5 |
| 225561_at | SELT | 772.68 | 1349.53 | 0.57 |
| 225604_s_at | GLIPR2 | 336.84 | 92.03 | 3.66 |
| 225606_at | BCL2L11 | 800.01 | 1815.01 | 0.44 |
| 225659_at | SPOPL | 562.34 | 1202.68 | 0.47 |
| 225799_at | LOC541471 /// | 5018.81 | 1963.32 | 2.56 |
| | NCRNA00152 | | | |
| 225866_at | RPF2 | 2568.25 | 1667.93 | 1.54 |
| 225914_s_at | CAB39L | 569.37 | 1014.51 | 0.56 |
| 225961_at | KLHDC5 | 387.52 | 687.75 | 0.56 |
| 225988_at | HERC4 | 2493.5 | 1169.61 | 2.13 |
| 226072_at | FUK | 485.48 | 995.15 | 0.49 |
| 226111_s_at | ZNF385A | 462.29 | 939.95 | 0.49 |
| 226403_at | TMC4 | 453.62 | 2022.07 | 0.22 |
| 226448_at | FAM89A | 401.97 | 200.45 | 2.01 |
| 226613_at | GATSL3 /// TBC1D10A | 214.49 | 455.22 | 0.47 |
| 226773_at | — | 725.23 | 1250.53 | 0.58 |
| 226791_at | KIFC2 | 774.16 | 1988.49 | 0.39 |
| 226792_s_at | KIFC2 | 444.16 | 981.38 | 0.45 |
| 226861_at | ASB8 | 849.7 | 1260.58 | 0.67 |
| 226893_at | ABL2 | 720.98 | 266.29 | 2.71 |
| 226968_at | KIF1B | 1003.32 | 498.11 | 2.01 |
| 227040_at | NHLRC3 | 362.31 | 849.16 | 0.43 |
| 227166_at | DNAJC18 | 281.69 | 106.49 | 2.65 |
| 227172_at | TMEM116 | 503.19 | 1012.45 | 0.5 |
| 227208_at | CCDC84 | 1204.57 | 508.44 | 2.37 |
| 227372_s_at | BAIAP2L1 | 2550.01 | 1572.79 | 1.62 |
| 227413_at | UBLCP1 | 1545.43 | 948.05 | 1.63 |
| 227534_at | C9orf21 | 997.52 | 455.5 | 2.19 |
| 227562_at | MAPKSP1 | 294.41 | 503.02 | 0.59 |
| 227569_at | LNX2 | 620.41 | 1215.37 | 0.51 |
| 227572_at | USP30 | 372.08 | 627.86 | 0.59 |
| 227698_s_at | RAB40C | 1085.05 | 1745.1 | 0.62 |
| 227699_at | C14orf149 | 464.77 | 243.61 | 1.91 |
| 227904_at | AZI2 | 686.03 | 350.35 | 1.96 |
| 227945_at | TBC1D1 | 272.33 | 173.13 | 1.57 |
| 228098_s_at | MYLIP | 1092.25 | 2975.25 | 0.37 |
| 228213_at | H2AFJ | 111.29 | 360.13 | 0.31 |
| 228217_s_at | PSMG4 | 2701.45 | 782.59 | 3.45 |
| 228457_at | — | 151.8 | 255.25 | 0.59 |
| 228693_at | CCDC50 | 288.17 | 122.05 | 2.36 |
| 228834_at | TOB1 | 4541.93 | 12281.3 | 0.37 |
| 228856_at | ZNF747 | 245.29 | 551.98 | 0.44 |
| 228990_at | SNHG12 | 908.27 | 555.47 | 1.64 |
| 229114_at | GAB1 | 270.69 | 464.39 | 0.58 |
| 229223_at | ESRP2 | 414.39 | 925.63 | 0.45 |
| 229310_at | KLHL29 | 518.49 | 102.84 | 5.04 |
| 229440_at | RBM47 | 166.86 | 385.51 | 0.43 |
| 230142_s_at | CIRBP | 294.21 | 520.53 | 0.57 |
| 230172_at | IFI27L1 | 770.55 | 449.93 | 1.71 |
| 230769_at | DENND2C | 205.39 | 134.91 | 1.52 |
| 230799_at | LOC100134259 | 204.42 | 134.33 | 1.52 |
| 231111_at | — | 94.38 | 231.27 | 0.41 |
| 231274_s_at | — | 859.77 | 330.51 | 2.6 |
| 231411_at | LHFP | 267.15 | 132.98 | 2.01 |
| 232035_at | HIST1H4H | 368.22 | 1212.98 | 0.3 |
| 232078_at | PVRL2 | 851.8 | 2037.19 | 0.42 |
| 232079_s_at | PVRL2 | 1024.83 | 2219.78 | 0.46 |
| 232333_at | — | 208.21 | 105.35 | 1.98 |
| 232350_x_at | GPR161 | 202.53 | 88.1 | 2.3 |
| 233528_s_at | GATSL3 /// TBC1D10A | 290.19 | 522.02 | 0.56 |
| 233571_x_at | PPDPF | 5392.92 | 10368.73 | 0.52 |
| 233803_s_at | MYBBP1A | 327.87 | 173.55 | 1.89 |
| 234975_at | GSPT1 | 577.51 | 1224.89 | 0.47 |
| 235020_at | TAF4B | 448.59 | 181.3 | 2.47 |
| 235398_at | ZNF805 | 181.01 | 322.82 | 0.56 |
| 235463_s_at | LASS6 | 719.03 | 1860.82 | 0.39 |
| 235501_at | — | 514.48 | 1145.46 | 0.45 |
| 235577_at | ZNF652 | 347.9 | 1204.47 | 0.29 |
| 235681_at | — | 204.76 | 682.83 | 0.3 |
| 236370_at | — | 224.19 | 132.89 | 1.69 |
| 236704_at | — | 168.72 | 101.33 | 1.67 |
| 237400_at | ATP5S | 278.87 | 113.23 | 2.46 |
| 238002_at | GOLIM4 | 1965.32 | 741.3 | 2.65 |
| 238628_s_at | TRAPPC2L | 123.82 | 242.19 | 0.51 |
| 238909_at | — | 364.39 | 210.81 | 1.73 |
| 239210_at | — | 105.46 | 201.72 | 0.52 |
| 239824_s_at | TMEM107 | 931.23 | 395.58 | 2.35 |
| 240261_at | TOM1L1 | 275.36 | 913.71 | 0.3 |
| 241957_x_at | LIN7B | 293.23 | 507.13 | 0.58 |
| 242019_at | LASS6 | 209.74 | 698.02 | 0.3 |
| 242053_at | — | 167.51 | 324.96 | 0.52 |
| 242260_at | MATR3 | 770.01 | 207.6 | 3.71 |
| 242389_at | — | 176.55 | 548.61 | 0.32 |
| 243931_at | — | 633.8 | 359.56 | 1.76 |
| 244647_at | — | 142.94 | 270.76 | 0.53 |
| 244765_at | — | 145.91 | 330.82 | 0.44 |
| 34726_at | CACNB3 | 564.95 | 1063.37 | 0.53 |
| 35147_at | MCF2L | 397.27 | 1184.92 | 0.34 |
| 37028_at | PPP1R15A | 1034.1 | 489.13 | 2.11 |
| 38340_at | HIP1R /// LOC100294412 | 1560.41 | 2836.99 | 0.55 |
| 41329_at | SCYL3 | 357.85 | 1005.97 | 0.36 |
| 55872_at | ZNF512B | 1605.66 | 3474.76 | 0.46 |
| 61874_at | C9orf7 | 683.37 | 1436.63 | 0.48 |
| 62987_r_at | CACNG4 | 1101.03 | 2703.96 | 0.41 |
| 74694_s_at | RABEP2 | 701.77 | 1321.97 | 0.53 |

TABLE 5
ACT

| probeID | Gene.Symbol | mean_sens | mean_resis | fold.change |
|---|---|---|---|---|
| 1552277_a_at | C9orf30 | 2018.46 | 978.75 | 2.06 |
| 1553212_at | KRT78 | 164.08 | 264.84 | 0.62 |
| 1553274_a_at | SNRNP48 | 570.74 | 336.52 | 1.70 |
| 1554026_a_at | MYO10 | 218.08 | 124.92 | 1.75 |
| 1554241_at | COCH | 3061.10 | 4272.22 | 0.72 |
| 1555841_at | C9orf30 | 1041.11 | 418.45 | 2.49 |
| 1555993_at | CACNA1D | 132.59 | 194.56 | 0.68 |
| 1557121_s_at | LOC100289294 | 203.63 | 422.82 | 0.48 |
| 1560916_a_at | DPY19L1 | 561.63 | 249.76 | 2.25 |
| 1563253_s_at | ERBB3 | 419.20 | 855.83 | 0.49 |
| 1563809_a_at | MCF2L | 92.95 | 194.81 | 0.48 |
| 1564907_s_at | MATR3 /// SNHG4 | 248.69 | 92.00 | 2.70 |
| 1564911_at | SNHG4 | 196.76 | 79.55 | 2.47 |
| 1565436_s_at | MLL | 128.92 | 75.90 | 1.70 |
| 1569149_at | PDLIM7 | 363.63 | 225.28 | 1.61 |
| 1569867_at | EME2 | 350.56 | 684.89 | 0.51 |
| 200894_s_at | FKBP4 | 2750.09 | 4910.79 | 0.56 |
| 200895_s_at | FKBP4 | 5564.88 | 9684.33 | 0.57 |
| 200904_at | HLA-E | 938.35 | 302.08 | 3.11 |
| 200905_x_at | HLA-E | 3319.96 | 1881.49 | 1.76 |
| 200961_at | SEPHS2 | 3391.93 | 5510.20 | 0.62 |
| 201323_at | EBNA1BP2 | 3622.28 | 1608.04 | 2.25 |
| 201330_at | RARS | 4616.21 | 2890.16 | 1.60 |
| 201580_s_at | TMX4 | 1104.89 | 404.90 | 2.73 |
| 201613_s_at | AP1G2 | 852.04 | 1522.14 | 0.56 |
| 201734_at | CLCN3 | 1799.33 | 2884.43 | 0.62 |
| 201764_at | TMEM106C | 3253.86 | 5020.61 | 0.65 |
| 201853_s_at | CDC25B | 5081.74 | 3219.87 | 1.58 |
| 201886_at | DCAF11 | 1147.69 | 1794.77 | 0.64 |
| 202076_at | BIRC2 | 4729.27 | 2453.80 | 1.93 |
| 202187_s_at | PPP2R5A | 1258.72 | 2098.83 | 0.60 |
| 202204_s_at | AMFR | 718.16 | 1266.06 | 0.57 |
| 202321_at | GGPS1 | 536.77 | 987.24 | 0.54 |
| 202479_s_at | TRIB2 | 543.12 | 228.54 | 2.38 |
| 202558_s_at | HSPA13 | 1737.39 | 832.92 | 2.09 |
| 202579_x_at | HMGN4 | 4508.22 | 2603.21 | 1.73 |
| 202613_at | CTPS | 2923.73 | 1496.99 | 1.95 |
| 202636_at | RNF103 | 1963.46 | 4187.56 | 0.47 |
| 202704_at | TOB1 | 4696.27 | 12358.73 | 0.38 |
| 202708_s_at | HIST2H2BE | 549.71 | 2190.17 | 0.25 |
| 202743_at | PIK3R3 | 1777.94 | 4696.15 | 0.38 |
| 202870_s_at | CDC20 | 5766.87 | 3014.96 | 1.91 |
| 202900_s_at | NUP88 | 2330.38 | 1458.86 | 1.60 |
| 203009_at | BCAM | 127.09 | 321.73 | 0.40 |
| 203045_at | NINJ1 | 1040.33 | 2069.40 | 0.50 |
| 203306_s_at | SLC35A1 | 2017.46 | 3142.05 | 0.64 |
| 203350_at | AP1G1 | 1302.88 | 2420.61 | 0.54 |
| 203370_s_at | PDLIM7 | 755.69 | 396.45 | 1.91 |
| 203491_s_at | CEP57 | 851.49 | 516.20 | 1.65 |
| 203492_x_at | CEP57 | 1481.80 | 899.74 | 1.65 |
| 203796_s_at | BCL7A | 177.92 | 359.51 | 0.49 |
| 203870_at | USP46 | 638.73 | 1106.07 | 0.58 |
| 203968_s_at | CDC6 | 3109.00 | 1525.13 | 2.04 |
| 204067_at | SUOX | 697.09 | 935.38 | 0.75 |
| 204157_s_at | SIK3 | 476.30 | 312.19 | 1.53 |
| 204194_at | BACH1 | 979.24 | 465.36 | 2.10 |
| 204287_at | SYNGR1 | 258.58 | 591.45 | 0.44 |
| 204295_at | SURF1 | 2180.76 | 3876.10 | 0.56 |
| 204365_s_at | REEP1 | 234.05 | 709.72 | 0.33 |
| 204613_at | PLCG2 | 298.90 | 172.56 | 1.73 |
| 204745_x_at | MT1G | 2368.33 | 1165.66 | 2.03 |
| 204958_at | PLK3 | 209.44 | 120.60 | 1.74 |
| 204975_at | EMP2 | 2149.63 | 5554.10 | 0.39 |
| 204977_at | DDX10 | 2091.85 | 996.42 | 2.10 |
| 205005_s_at | NMT2 | 808.11 | 282.79 | 2.86 |
| 205006_s_at | NMT2 | 507.49 | 158.21 | 3.21 |
| 205173_x_at | CD58 | 2428.92 | 1117.31 | 2.17 |
| 205260_s_at | ACYP1 | 1403.97 | 651.32 | 2.16 |
| 205574_x_at | BMP1 | 401.48 | 169.93 | 2.36 |
| 205594_at | ZNF652 | 1047.60 | 3777.81 | 0.28 |
| 205607_s_at | SCYL3 | 336.82 | 806.12 | 0.42 |
| 205961_s_at | PSIP1 | 2002.69 | 1062.55 | 1.88 |
| 205996_s_at | AK2 | 1063.74 | 585.64 | 1.82 |
| 206275_s_at | MICAL2 | 208.09 | 109.88 | 1.89 |
| 206308_at | TRDMT1 | 229.94 | 108.87 | 2.11 |
| 206412_at | FER | 349.23 | 145.27 | 2.40 |
| 206527_at | ABAT | 231.67 | 526.88 | 0.44 |
| 206653_at | POLR3G | 353.96 | 141.04 | 2.51 |
| 206745_at | HOXC11 | 547.87 | 1348.95 | 0.41 |
| 207163_s_at | AKT1 | 2275.32 | 3735.82 | 0.61 |
| 207809_s_at | ATP6AP1 | 6774.48 | 10641.43 | 0.64 |
| 207986_x_at | CYB561 | 2483.01 | 5159.32 | 0.48 |
| 208002_s_at | ACOT7 | 3602.66 | 2279.05 | 1.58 |
| 208637_x_at | ACTN1 | 5643.75 | 2343.17 | 2.41 |
| 208740_at | SAP18 | 781.64 | 1300.71 | 0.60 |
| 208741_at | SAP18 | 384.24 | 807.20 | 0.48 |
| 208817_at | COMT | 2753.37 | 5051.04 | 0.55 |
| 208818_s_at | COMT | 7000.72 | 11441.54 | 0.61 |
| 208873_s_at | REEP5 | 3144.19 | 6793.99 | 0.46 |
| 208921_s_at | SRI | 6239.69 | 2772.45 | 2.25 |
| 208927_at | SPOP | 1689.67 | 3416.55 | 0.49 |
| 208935_s_at | LGALS8 | 524.36 | 1500.17 | 0.35 |
| 209112_at | CDKN1B | 2878.08 | 5124.38 | 0.56 |
| 209164_s_at | CYB561 | 1638.42 | 3367.59 | 0.49 |
| 209195_s_at | ADCY6 | 1034.52 | 1534.16 | 0.67 |
| 209222_s_at | OSBPL2 | 1249.08 | 2051.08 | 0.61 |
| 209275_s_at | CLN3 | 1266.23 | 2694.17 | 0.47 |
| 209333_at | ULK1 | 375.23 | 736.10 | 0.51 |
| 209337_at | PSIP1 | 2792.88 | 1381.60 | 2.02 |
| 209380_s_at | ABCC5 | 1311.51 | 2284.91 | 0.57 |
| 209431_s_at | PATZ1 | 467.74 | 999.71 | 0.47 |
| 209494_s_at | PATZ1 | 760.41 | 2099.79 | 0.36 |
| 209624_s_at | MCCC2 | 1213.72 | 2574.15 | 0.47 |
| 209645_s_at | ALDH1B1 | 449.75 | 259.78 | 1.73 |
| 209650_s_at | TBC1D22A | 254.39 | 104.82 | 2.43 |
| 209786_at | HMGN4 | 4377.80 | 2582.52 | 1.70 |
| 209787_s_at | HMGN4 | 3000.41 | 1885.62 | 1.59 |
| 209818_s_at | HABP4 | 241.67 | 116.20 | 2.08 |
| 209862_s_at | CEP57 | 1054.08 | 662.18 | 1.59 |
| 210005_at | GART | 765.57 | 362.81 | 2.11 |
| 210010_s_at | SLC25A1 | 3070.64 | 4605.33 | 0.67 |
| 210191_s_at | PHTF1 | 547.59 | 291.43 | 1.88 |
| 210542_s_at | SLCO3A1 | 184.18 | 81.25 | 2.27 |
| 210719_s_at | HMG20B | 1883.65 | 2691.93 | 0.70 |
| 210740_s_at | ITPK1 | 1749.11 | 3540.50 | 0.49 |
| 210816_s_at | CYB561 | 506.73 | 1120.30 | 0.45 |
| 210859_x_at | CLN3 | 1685.88 | 3386.05 | 0.50 |
| 211160_x_at | ACTN1 | 4275.94 | 1416.24 | 3.02 |
| 211392_s_at | PATZ1 | 489.77 | 1181.82 | 0.41 |
| 211559_s_at | CCNG2 | 700.45 | 1494.29 | 0.47 |
| 211565_at | SH3GL3 | 81.30 | 167.92 | 0.48 |
| 211580_s_at | PIK3R3 | 297.19 | 766.67 | 0.39 |
| 211744_s_at | CD58 | 1430.86 | 712.16 | 2.01 |
| 212046_x_at | MAPK3 | 718.45 | 2222.38 | 0.32 |
| 212090_at | GRINA | 2641.66 | 4722.09 | 0.56 |
| 212110_at | SLC39A14 | 3056.58 | 1056.30 | 2.89 |
| 212155_at | RNF187 | 3390.37 | 5466.16 | 0.62 |
| 212174_at | AK2 | 1566.62 | 768.52 | 2.04 |
| 212246_at | MCFD2 | 1704.25 | 760.11 | 2.24 |
| 212262_at | QKI | 1325.94 | 637.43 | 2.08 |
| 212263_at | QKI | 1601.13 | 802.78 | 1.99 |
| 212372_at | MYH10 | 2907.35 | 1153.96 | 2.52 |
| 212400_at | FAM102A | 1218.60 | 3686.79 | 0.33 |
| 212441_at | KIAA0232 | 1173.45 | 2433.14 | 0.48 |
| 212442_s_at | LASS6 | 2166.36 | 5146.63 | 0.42 |
| 212446_s_at | LASS6 | 1340.01 | 3372.17 | 0.40 |
| 212473_s_at | MICAL2 | 2620.79 | 570.88 | 4.59 |
| 212508_at | MOAP1 | 1584.08 | 3091.48 | 0.51 |
| 212637_s_at | WWP1 | 1062.79 | 2975.71 | 0.36 |
| 212638_s_at | WWP1 | 3259.77 | 7922.19 | 0.41 |
| 212672_at | ATM | 487.66 | 232.23 | 2.10 |
| 212692_s_at | LRBA | 1103.75 | 2523.18 | 0.44 |
| 212728_at | DLG3 | 427.74 | 813.97 | 0.53 |
| 212729_at | DLG3 | 661.89 | 1278.86 | 0.52 |
| 212944_at | SLC5A3 | 2066.81 | 1097.14 | 1.88 |
| 213067_at | MYH10 | 368.27 | 114.87 | 3.21 |
| 213093_at | PRKCA | 1283.92 | 164.58 | 7.80 |
| 213120_at | UHRF1BP1L | 99.42 | 177.48 | 0.56 |
| 213143_at | C2orf72 | 193.34 | 542.72 | 0.36 |
| 213234_at | KIAA1467 | 496.56 | 853.98 | 0.58 |
| 213302_at | PFAS | 860.04 | 364.60 | 2.36 |
| 213342_at | YAP1 | 2029.41 | 1196.64 | 1.70 |
| 213427_at | RPP40 | 2359.95 | 1173.35 | 2.01 |
| 213508_at | C14orf147 | 1202.46 | 2213.43 | 0.54 |
| 213587_s_at | ATP6V0E2 | 1976.59 | 3868.03 | 0.51 |
| 213710_s_at | CALM1 | 605.75 | 1059.59 | 0.57 |
| 213737_x_at | LOC728498 | 581.38 | 408.64 | 1.42 |
| 214062_x_at | NFKBIB | 337.80 | 205.70 | 1.64 |
| 214109_at | LRBA | 920.59 | 1724.11 | 0.53 |
| 214543_x_at | QKI | 851.47 | 498.52 | 1.71 |
| 215285_s_at | PHTF1 | 391.70 | 204.77 | 1.91 |
| 215696_s_at | SEC16A | 2994.37 | 6198.22 | 0.48 |
| 215707_s_at | PRNP | 3051.81 | 848.25 | 3.60 |
| 215743_at | NMT2 | 215.09 | 80.56 | 2.67 |
| 216044_x_at | FAM69A | 723.11 | 309.40 | 2.34 |
| 216942_s_at | CD58 | 1653.79 | 796.63 | 2.08 |
| 217200_x_at | CYB561 | 2569.68 | 4603.85 | 0.56 |
| 217456_x_at | HLA-E | 1356.09 | 855.17 | 1.59 |
| 217595_at | GSPT1 | 247.71 | 574.71 | 0.43 |
| 217677_at | PLEKHA2 | 205.22 | 98.75 | 2.08 |
| 218032_at | SNN | 795.79 | 1412.03 | 0.56 |
| 218156_s_at | TSR1 | 2866.14 | 1664.73 | 1.72 |
| 218164_at | SPATA20 | 1221.59 | 2583.51 | 0.47 |
| 218174_s_at | C10orf57 | 374.61 | 879.38 | 0.43 |
| 218194_at | REXO2 | 8465.72 | 3836.90 | 2.21 |
| 218237_s_at | SLC38A1 | 4750.69 | 7015.64 | 0.68 |
| 218244_at | NOL8 | 1536.35 | 988.69 | 1.55 |
| 218288_s_at | CCDC90B | 2632.76 | 1649.35 | 1.60 |
| 218373_at | AKTIP | 1536.19 | 4075.84 | 0.38 |
| 218379_at | RBM7 | 2360.02 | 1143.63 | 2.06 |
| 218394_at | ROGDI | 850.99 | 1378.23 | 0.62 |
| 218561_s_at | LYRM4 | 2035.10 | 939.80 | 2.17 |
| 218566_s_at | CHORDC1 | 4920.96 | 2736.17 | 1.80 |
| 218611_at | IER5 | 3980.17 | 1761.51 | 2.26 |
| 218640_s_at | PLEKHF2 | 2110.15 | 4571.43 | 0.46 |
| 218770_s_at | TMEM39B | 635.27 | 306.11 | 2.08 |
| 218778_x_at | EPS8L1 | 243.53 | 440.40 | 0.55 |
| 218828_at | PLSCR3 | 825.22 | 437.03 | 1.89 |
| 218978_s_at | SLC25A37 | 190.98 | 79.88 | 2.39 |
| 218985_at | SLC2A8 | 299.25 | 715.66 | 0.42 |
| 219057_at | RABEP2 | 117.30 | 309.56 | 0.38 |
| 219100_at | OBFC1 | 576.37 | 1125.21 | 0.51 |
| 219223_at | C9orf7 | 417.12 | 809.65 | 0.52 |
| 219338_s_at | LRRC49 | 251.51 | 141.78 | 1.77 |
| 219342_at | CASD1 | 562.45 | 1015.30 | 0.55 |
| 219401_at | XYLT2 | 284.37 | 596.01 | 0.48 |
| 219626_at | MAP7D3 | 557.88 | 240.97 | 2.32 |
| 219741_x_at | ZNF552 | 512.19 | 977.45 | 0.52 |
| 219847_at | HDAC11 | 123.95 | 348.13 | 0.36 |
| 219913_s_at | CRNKL1 | 956.93 | 1586.84 | 0.60 |
| 219929_s_at | ZFYVE21 | 862.30 | 1425.51 | 0.60 |
| 220073_s_at | PLEKHG6 | 234.96 | 481.70 | 0.49 |
| 220239_at | KLHL7 | 1244.15 | 720.16 | 1.73 |
| 220258_s_at | WRAP53 | 514.05 | 314.35 | 1.64 |
| 221012_s_at | TRIM8 | 1234.71 | 2382.00 | 0.52 |
| 221222_s_at | C1orf56 | 379.75 | 825.53 | 0.46 |
| 221273_s_at | RNF208 | 247.04 | 742.67 | 0.33 |
| 221580_s_at | TAF1D | 3796.25 | 1673.13 | 2.27 |
| 221685_s_at | CCDC99 | 3075.82 | 1480.38 | 2.08 |
| 221869_at | ZNF512B | 443.90 | 1248.30 | 0.36 |
| 222160_at | AKAP8L | 67.63 | 131.95 | 0.51 |
| 222566_at | SUV420H1 | 316.88 | 705.65 | 0.45 |
| 222599_s_at | NAV2 | 341.23 | 176.02 | 1.94 |
| 222699_s_at | PLEKHF2 | 1958.02 | 4519.77 | 0.43 |
| 222728_s_at | TAF1D | 2717.93 | 1194.46 | 2.28 |
| 222867_s_at | MED31 | 1258.56 | 680.56 | 1.85 |
| 223179_at | YPEL3 | 800.02 | 1885.19 | 0.42 |
| 223199_at | MKNK2 | 1344.04 | 2461.96 | 0.55 |
| 223202_s_at | TMEM164 | 822.54 | 1735.11 | 0.47 |
| 223279_s_at | UACA | 581.46 | 223.18 | 2.61 |
| 223376_s_at | BRI3 | 5246.95 | 2681.86 | 1.96 |
| 223377_x_at | CISH | 708.45 | 1705.24 | 0.42 |
| 223386_at | FAM118B | 855.45 | 462.21 | 1.85 |
| 223412_at | KBTBD7 | 353.82 | 660.67 | 0.54 |
| 223413_s_at | LYAR | 1751.68 | 794.42 | 2.20 |
| 223611_s_at | LNX1 | 335.18 | 883.70 | 0.38 |
| 223847_s_at | ERGIC1 | 1583.34 | 2538.03 | 0.62 |
| 223894_s_at | AKTIP | 1280.14 | 3125.03 | 0.41 |
| 223989_s_at | REXO2 | 1085.93 | 494.07 | 2.20 |
| 224002_s_at | FKBP7 | 339.57 | 144.82 | 2.34 |
| 224445_s_at | ZFYVE21 | 2433.25 | 4001.02 | 0.61 |
| 224450_s_at | RIOK1 | 1431.54 | 814.75 | 1.76 |
| 224574_at | C17orf49 | 1126.00 | 590.87 | 1.91 |
| 224576_at | ERGIC1 | 4388.66 | 7514.28 | 0.58 |
| 224577_at | ERGIC1 | 1576.17 | 2703.06 | 0.58 |
| 224657_at | ERRFI1 | 5112.96 | 1661.92 | 3.08 |
| 224690_at | C20orf108 | 3979.80 | 6005.43 | 0.66 |
| 224734_at | HMGB1 | 1367.63 | 2273.09 | 0.60 |
| 224832_at | DUSP16 | 624.04 | 1892.33 | 0.33 |
| 224894_at | YAP1 | 4846.80 | 2510.56 | 1.93 |
| 224897_at | WDR26 | 1491.36 | 2665.01 | 0.56 |
| 224927_at | KIAA1949 | 2349.12 | 797.23 | 2.95 |
| 224998_at | CMTM4 | 1668.00 | 3832.55 | 0.44 |
| 225009_at | CMTM4 | 1450.80 | 3135.91 | 0.46 |
| 225197_at | — | 606.82 | 1111.11 | 0.55 |
| 225203_at | PPP1R16A | 620.92 | 1560.99 | 0.40 |
| 225266_at | ZNF652 | 788.00 | 2683.56 | 0.29 |
| 225299_at | MYO5B | 282.73 | 751.19 | 0.38 |
| 225561_at | SELT | 638.15 | 1372.74 | 0.46 |
| 225606_at | BCL2L11 | 809.74 | 1760.66 | 0.46 |
| 225659_at | SPOPL | 537.67 | 1191.68 | 0.45 |
| 225866_at | RPF2 | 2684.93 | 1572.68 | 1.71 |
| 225891_at | TPRN | 513.45 | 1029.26 | 0.50 |
| 225912_at | TP53INP1 | 870.60 | 3599.78 | 0.24 |
| 225981_at | C17orf28 | 573.38 | 1619.87 | 0.35 |
| 225988_at | HERC4 | 2427.07 | 1188.24 | 2.04 |
| 226072_at | FUK | 485.92 | 827.40 | 0.59 |
| 226111_s_at | ZNF385A | 481.00 | 934.24 | 0.51 |
| 226363_at | ABCC5 | 370.45 | 623.70 | 0.59 |
| 226403_at | TMC4 | 456.05 | 1670.76 | 0.27 |
| 226613_at | GATSL3 /// TBC1D10A | 222.93 | 468.28 | 0.48 |
| 226765_at | SPTBN1 | 215.71 | 109.58 | 1.97 |
| 226791_at | KIFC2 | 786.46 | 2187.62 | 0.36 |
| 226792_s_at | KIFC2 | 397.28 | 1129.75 | 0.35 |
| 226861_at | ASB8 | 839.18 | 1243.92 | 0.67 |
| 227029_at | FAM177A1 | 1208.93 | 2292.38 | 0.53 |
| 227172_at | TMEM116 | 510.95 | 1042.66 | 0.49 |
| 227208_at | CCDC84 | 1198.86 | 501.15 | 2.39 |
| 227293_at | — | 210.45 | 371.63 | 0.57 |
| 227352_at | C19orf39 | 335.29 | 556.65 | 0.60 |
| 227407_at | TAPT1 | 1025.59 | 1685.18 | 0.61 |
| 227413_at | UBLCP1 | 1574.43 | 1055.14 | 1.49 |
| 227446_s_at | C14orf167 | 628.62 | 1237.27 | 0.51 |
| 227562_at | MAPKSP1 | 261.10 | 513.96 | 0.51 |
| 227569_at | LNX2 | 631.74 | 1154.83 | 0.55 |
| 227667_at | CUEDC1 | 656.44 | 1260.12 | 0.52 |
| 227699_at | C14orf149 | 439.43 | 200.40 | 2.19 |
| 227904_at | AZI2 | 650.53 | 390.96 | 1.66 |
| 227959_at | — | 472.76 | 868.41 | 0.54 |
| 228098_s_at | MYLIP | 1136.76 | 2857.80 | 0.40 |
| 228217_s_at | PSMG4 | 2657.49 | 921.13 | 2.89 |
| 228457_at | — | 145.04 | 270.14 | 0.54 |
| 228702_at | FLJ43663 | 316.50 | 173.88 | 1.82 |
| 229114_at | GAB1 | 250.62 | 491.43 | 0.51 |
| 229223_at | ESRP2 | 394.58 | 849.66 | 0.46 |
| 229310_at | KLHL29 | 542.38 | 105.57 | 5.14 |
| 229408_at | HDAC5 | 140.95 | 76.51 | 1.84 |
| 229440_at | RBM47 | 213.94 | 402.15 | 0.53 |
| 230142_s_at | CIRBP | 309.02 | 509.34 | 0.61 |
| 230172_at | IFI27L1 | 818.04 | 469.82 | 1.74 |
| 230769_at | DENND2C | 203.79 | 126.69 | 1.61 |
| 230799_at | LOC100134259 | 213.35 | 142.69 | 1.50 |
| 231111_at | — | 97.78 | 239.67 | 0.41 |
| 231403_at | TRIO | 188.17 | 105.18 | 1.79 |
| 231411_at | LHFP | 259.94 | 131.31 | 198 |
| 231828_at | LOC253039 | 622.33 | 1120.34 | 0.56 |
| 231872_at | LRRCC1 | 284.24 | 659.78 | 0.43 |
| 232035_at | HIST1H4H | 322.37 | 1428.62 | 0.23 |
| 232064_at | — | 192.90 | 92.84 | 2.08 |
| 232078_at | PVRL2 | 847.30 | 1879.85 | 0.45 |
| 232079_s_at | PVRL2 | 956.73 | 2093.71 | 0.46 |
| 232103_at | BPNT1 | 829.84 | 1558.88 | 0.53 |
| 232140_at | — | 256.82 | 165.22 | 1.55 |
| 232322_x_at | STARD10 | 2089.24 | 8068.69 | 0.26 |
| 232350_x_at | GPR161 | 201.78 | 95.57 | 2.11 |
| 233252_s_at | STRBP | 1118.24 | 1930.52 | 0.58 |
| 233528_s_at | GATSL3 /// TBC1D10A | 295.70 | 560.16 | 0.53 |
| 233571_x_at | PPDPF | 5482.87 | 9819.89 | 0.56 |
| 233803_s_at | MYBBP1A | 329.54 | 190.87 | 1.73 |
| 234107_s_at | DTD1 | 3258.11 | 1624.56 | 2.01 |
| 234975_at | GSPT1 | 516.87 | 1201.57 | 0.43 |
| 235463_s_at | LASS6 | 778.66 | 1937.10 | 0.40 |
| 235501_at | — | 483.76 | 1093.11 | 0.44 |
| 235577_at | ZNF652 | 342.40 | 1262.91 | 0.27 |
| 235681_at | — | 205.61 | 1011.26 | 0.20 |
| 235955_at | MARVELD2 | 156.90 | 361.41 | 0.43 |
| 236125_at | — | 196.81 | 435.39 | 0.45 |
| 236370_at | — | 221.63 | 125.20 | 1.77 |
| 238058_at | LOC150381 | 1906.03 | 981.39 | 1.94 |
| 238191_at | — | 322.31 | 601.44 | 0.54 |
| 238467_at | — | 360.49 | 891.62 | 0.40 |
| 238500_at | EMP2 | 186.85 | 326.41 | 0.57 |
| 238818_at | KIAA1429 | 162.20 | 273.58 | 0.59 |
| 238909_at | — | 372.11 | 176.54 | 2.11 |
| 239047_at | FAM122C | 191.92 | 108.84 | 1.76 |
| 239210_at | — | 108.05 | 205.45 | 0.53 |
| 239307_at | MYH11 | 82.47 | 206.38 | 0.40 |
| 239598_s_at | LPCAT2 | 464.17 | 268.86 | 1.73 |
| 239824_s_at | TMEM107 | 891.15 | 443.68 | 2.01 |
| 240261_at | TOM1L1 | 280.07 | 874.19 | 0.32 |
| 242019_at | LASS6 | 222.66 | 712.35 | 0.31 |
| 242052_at | — | 208.86 | 87.96 | 2.37 |
| 242053_at | — | 168.57 | 310.83 | 0.54 |
| 242260_at | MATR3 | 773.54 | 245.21 | 3.15 |
| 242723_at | — | 186.81 | 128.20 | 1.46 |
| 242749_at | — | 126.01 | 84.69 | 1.49 |
| 243495_s_at | — | 808.07 | 3082.60 | 0.26 |
| 243552_at | MBTD1 | 191.19 | 546.57 | 0.35 |
| 243634_at | — | 240.55 | 823.40 | 0.29 |
| 243862_at | — | 99.17 | 221.74 | 0.45 |
| 244765_at | — | 145.70 | 332.04 | 0.44 |
| 35147_at | MCF2L | 470.59 | 1133.56 | 0.42 |
| 37028_at | PPP1R15A | 1030.42 | 516.75 | 1.99 |
| 38340_at | HIP1R /// LOC100294412 | 1531.40 | 2572.59 | 0.60 |
| 40093_at | BCAM | 457.48 | 1153.91 | 0.40 |
| 40420_at | STK10 | 726.81 | 529.61 | 1.37 |
| 41329_at | SCYL3 | 355.36 | 1014.44 | 0.35 |
| 55872_at | ZNF512B | 1568.93 | 3333.81 | 0.47 |
| 57516_at | ZNF764 | 254.73 | 461.64 | 0.55 |
| 61874_at | C9orf7 | 695.66 | 1373.65 | 0.51 |

TABLE 6
TFEC

| probeID | Gene.Symbol | mean_sens | mean_resis | fold.change |
|---|---|---|---|---|
| 177_at | PLD1 | 167.10 | 118.42 | 1.41 |
| 200076_s_at | C19orf50 | 2543.67 | 1355.76 | 1.88 |
| 200709_at | FKBP1A | 9650.88 | 5929.42 | 1.63 |
| 200790_at | ODC1 | 6645.80 | 2767.67 | 2.40 |
| 200864_s_at | RAB11A | 1988.29 | 3166.88 | 0.63 |
| 200875_s_at | NOP56 | 5243.86 | 3540.99 | 1.48 |
| 200895_s_at | FKBP4 | 5886.85 | 9922.75 | 0.59 |
| 200905_x_at | HLA-E | 3030.21 | 1646.01 | 1.84 |
| 200916_at | TAGLN2 | 9822.30 | 7161.49 | 1.37 |
| 201266_at | TXNRD1 | 7848.05 | 4738.82 | 1.66 |
| 201323_at | EBNA1BP2 | 3478.49 | 1710.40 | 2.03 |
| 201329_s_at | ETS2 | 689.43 | 256.33 | 2.69 |
| 201330_at | RARS | 4881.39 | 2079.97 | 2.35 |
| 201337_s_at | VAMP3 | 2813.59 | 1792.36 | 1.57 |
| 201439_at | GBF1 | 733.62 | 1022.44 | 0.72 |
| 201468_s_at | NQO1 | 4700.09 | 9916.66 | 0.47 |
| 201484_at | SUPT4H1 | 1103.85 | 2009.17 | 0.55 |
| 201582_at | SEC23B | 749.26 | 1285.33 | 0.58 |
| 201626_at | INSIG1 | 1684.52 | 3030.99 | 0.56 |
| 201627_s_at | INSIG1 | 1741.57 | 2970.79 | 0.59 |
| 201660_at | ACSL3 | 1920.01 | 3286.63 | 0.58 |
| 201661_s_at | ACSL3 | 1753.94 | 2884.83 | 0.61 |
| 201734_at | CLCN3 | 1670.85 | 2852.02 | 0.59 |
| 201853_s_at | CDC25B | 4847.03 | 3093.41 | 1.57 |
| 201886_at | DCAF11 | 1250.19 | 1700.21 | 0.74 |
| 202061_s_at | SEL1L | 1839.84 | 2821.48 | 0.65 |
| 202076_at | BIRC2 | 4009.15 | 2397.69 | 1.67 |
| 202132_at | WWTR1 | 458.16 | 323.66 | 1.42 |
| 202133_at | WWTR1 | 1728.46 | 1069.00 | 1.62 |
| 202134_s_at | WWTR1 | 687.23 | 443.43 | 1.55 |
| 202172_at | VEZF1 | 1531.01 | 2847.70 | 0.54 |
| 202173_s_at | VEZF1 | 1953.83 | 3980.69 | 0.49 |
| 202204_s_at | AMFR | 655.87 | 1060.92 | 0.62 |
| 202321_at | GGPS1 | 480.93 | 1159.10 | 0.41 |
| 202431_s_at | MYC | 5854.60 | 2337.07 | 2.51 |
| 202558_s_at | HSPA13 | 1434.74 | 1085.27 | 1.32 |
| 202579_x_at | HMGN4 | 3660.82 | 2156.73 | 1.70 |
| 202590_s_at | PDK2 | 237.24 | 1004.28 | 0.24 |
| 202613_at | CTPS | 2847.20 | 1465.19 | 1.94 |
| 202636_at | RNF103 | 2450.38 | 4728.45 | 0.52 |
| 202704_at | TOB1 | 5037.05 | 11689.76 | 0.43 |
| 202708_s_at | HIST2H2BE | 648.03 | 2058.01 | 0.31 |
| 202769_at | CCNG2 | 1507.54 | 3897.54 | 0.39 |
| 202770_s_at | CCNG2 | 1162.16 | 2813.18 | 0.41 |
| 202854_at | HPRT1 | 6330.95 | 4342.03 | 1.46 |
| 202870_s_at | CDC20 | 5047.28 | 2987.14 | 1.69 |
| 202900_s_at | NUP88 | 2433.21 | 1419.77 | 1.71 |
| 202955_s_at | ARFGEF1 | 845.25 | 1599.41 | 0.53 |
| 202982_s_at | ACOT1 /// ACOT2 | 1015.07 | 2181.12 | 0.47 |
| 203009_at | BCAM | 143.38 | 369.02 | 0.39 |
| 203023_at | NOP16 | 2193.80 | 1056.64 | 2.08 |
| 203040_s_at | HMBS | 2292.06 | 1083.93 | 2.11 |
| 203212_s_at | MTMR2 | 512.69 | 307.53 | 1.67 |
| 203247_s_at | ZNF24 | 1115.09 | 2191.91 | 0.51 |
| 203350_at | AP1G1 | 1493.09 | 2090.54 | 0.71 |
| 203370_s_at | PDLIM7 | 583.92 | 386.71 | 1.51 |
| 203388_at | ARRB2 | 765.19 | 485.47 | 1.58 |
| 203411_s_at | LMNA | 8270.66 | 5357.72 | 1.54 |
| 203491_s_at | CEP57 | 780.84 | 470.23 | 1.66 |
| 203492_x_at | CEP57 | 1363.96 | 780.33 | 1.75 |
| 203494_s_at | CEP57 | 1299.83 | 820.84 | 1.58 |
| 203554_x_at | PTTG1 | 8523.19 | 5795.13 | 1.47 |
| 203594_at | RTCD1 | 3269.44 | 2194.74 | 1.49 |
| 203712_at | KIAA0020 | 2210.86 | 993.14 | 2.23 |
| 203758_at | CTSO | 311.13 | 733.64 | 0.42 |
| 203764_at | DLGAP5 | 3042.52 | 1832.74 | 1.66 |
| 203795_s_at | BCL7A | 324.77 | 739.55 | 0.44 |
| 203796_s_at | BCL7A | 187.52 | 393.57 | 0.48 |
| 203856_at | VRK1 | 2086.79 | 1244.17 | 1.68 |
| 203867_s_at | NLE1 | 924.70 | 619.65 | 1.49 |
| 203870_at | USP46 | 713.61 | 1108.82 | 0.64 |
| 203926_x_at | ATP5D | 1196.92 | 614.09 | 1.95 |
| 203967_at | CDC6 | 3342.45 | 1110.90 | 3.01 |
| 203968_s_at | CDC6 | 3713.62 | 1191.39 | 3.12 |
| 204033_at | TRIP13 | 6104.25 | 2436.01 | 2.51 |
| 204048_s_at | PHACTR2 | 1263.73 | 715.83 | 1.77 |
| 204088_at | P2RX4 | 543.12 | 1253.77 | 0.43 |
| 204157_s_at | SIK3 | 449.53 | 286.84 | 1.57 |
| 204182_s_at | ZBTB43 | 242.65 | 481.86 | 0.50 |
| 204194_at | BACH1 | 883.78 | 447.60 | 1.97 |
| 204208_at | RNGTT | 768.66 | 550.24 | 1.40 |
| 204287_at | SYNGR1 | 272.87 | 623.52 | 0.44 |
| 204365_s_at | REEP1 | 229.35 | 719.92 | 0.32 |
| 204485_s_at | TOM1L1 | 1665.01 | 4172.88 | 0.40 |
| 204571_x_at | PIN4 | 2999.33 | 1941.87 | 1.54 |
| 204589_at | NUAK1 | 1056.67 | 251.25 | 4.21 |
| 204613_at | PLCG2 | 275.80 | 181.59 | 1.52 |
| 204766_s_at | NUDT1 | 775.05 | 551.87 | 1.40 |
| 204805_s_at | H1FX | 3282.72 | 5227.02 | 0.63 |
| 204833_at | ATG12 | 666.62 | 360.67 | 1.85 |
| 204958_at | PLK3 | 227.21 | 125.44 | 1.81 |
| 204969_s_at | RDX | 539.95 | 199.94 | 2.70 |
| 204977_at | DDX10 | 1932.03 | 886.83 | 2.18 |
| 205005_s_at | NMT2 | 611.58 | 316.19 | 1.93 |
| 205006_s_at | NMT2 | 376.26 | 180.85 | 2.08 |
| 205023_at | RAD51 | 135.27 | 91.29 | 1.48 |
| 205071_x_at | XRCC4 | 393.89 | 248.85 | 1.58 |
| 205126_at | VRK2 | 1407.28 | 1046.77 | 1.34 |
| 205167_s_at | CDC25C | 657.24 | 466.92 | 1.41 |
| 205173_x_at | CD58 | 2197.05 | 986.66 | 2.23 |
| 205260_s_at | ACYP1 | 1221.17 | 688.01 | 1.77 |
| 205412_at | ACAT1 | 6089.59 | 2917.26 | 2.09 |
| 205443_at | SNAPC1 | 1419.06 | 562.48 | 2.52 |
| 205527_s_at | GEMIN4 | 790.06 | 408.99 | 1.93 |
| 205594_at | ZNF652 | 1127.75 | 4126.59 | 0.27 |
| 205607_s_at | SCYL3 | 423.43 | 824.36 | 0.51 |
| 205732_s_at | NCOA2 | 218.15 | 460.09 | 0.47 |
| 205796_at | TCP11L1 | 325.57 | 241.14 | 1.35 |
| 205961_s_at | PSIP1 | 1765.19 | 944.02 | 1.87 |
| 205996_s_at | AK2 | 1059.95 | 583.94 | 1.82 |
| 206005_s_at | KIAA1009 | 139.06 | 77.74 | 1.79 |
| 206074_s_at | HMGA1 | 7573.47 | 4034.30 | 1.88 |
| 206076_at | LRRC23 | 150.44 | 312.21 | 0.48 |
| 206085_s_at | CTH | 457.53 | 111.09 | 4.12 |
| 206194_at | HOXC4 | 348.29 | 772.32 | 0.45 |
| 206245_s_at | IVNS1ABP | 4282.89 | 2858.16 | 1.50 |
| 206297_at | CTRC | 100.09 | 154.27 | 0.65 |
| 206412_at | FER | 291.20 | 145.05 | 2.01 |
| 206491_s_at | NAPA | 1961.14 | 3398.15 | 0.58 |
| 206527_at | ABAT | 254.31 | 510.92 | 0.50 |
| 206653_at | POLR3G | 362.42 | 165.82 | 2.19 |
| 206745_at | HOXC11 | 583.83 | 1223.08 | 0.48 |
| 206752_s_at | DFFB | 283.11 | 138.27 | 2.05 |
| 207163_s_at | AKT1 | 2429.14 | 3908.26 | 0.62 |
| 207196_s_at | TNIP1 | 2031.55 | 1399.31 | 1.45 |
| 207392_x_at | UGT2B15 | 108.53 | 932.37 | 0.12 |
| 207809_s_at | ATP6AP1 | 6850.38 | 10418.63 | 0.66 |
| 207821_s_at | PTK2 | 1780.21 | 3518.58 | 0.51 |
| 208002_s_at | ACOT7 | 4050.31 | 2262.24 | 1.79 |
| 208033_s_at | ZFHX3 | 251.62 | 377.33 | 0.67 |
| 208072_s_at | DGKD | 643.24 | 1083.09 | 0.59 |
| 208636_at | ACTN1 | 8901.27 | 5517.49 | 1.61 |
| 208637_x_at | ACTN1 | 4560.21 | 2674.93 | 1.70 |
| 208741_at | SAP18 | 417.47 | 785.90 | 0.53 |
| 208817_at | COMT | 2977.90 | 5221.73 | 0.57 |
| 208818_s_at | COMT | 7785.54 | 11616.39 | 0.67 |
| 208820_at | PTK2 | 2672.63 | 5661.17 | 0.47 |
| 208886_at | H1F0 | 3602.42 | 5458.05 | 0.66 |
| 208927_at | SPOP | 1446.19 | 3506.29 | 0.41 |
| 208930_s_at | ILF3 | 1526.32 | 851.91 | 1.79 |
| 208931_s_at | ILF3 | 2889.19 | 1487.14 | 1.94 |
| 208935_s_at | LGALS8 | 629.40 | 1661.51 | 0.38 |
| 209112_at | CDKN1B | 3402.13 | 5608.75 | 0.61 |
| 209163_at | CYB561 | 3181.87 | 5686.05 | 0.56 |
| 209164_s_at | CYB561 | 1932.32 | 3314.54 | 0.58 |
| 209222_s_at | OSBPL2 | 1325.26 | 2032.46 | 0.65 |
| 209333_at | ULK1 | 391.45 | 852.33 | 0.46 |
| 209337_at | PSIP1 | 2353.57 | 1209.61 | 1.95 |
| 209339_at | SIAH2 | 1356.54 | 3941.23 | 0.34 |
| 209426_s_at | AMACR /// C1QTNF3 | 403.70 | 672.33 | 0.60 |
| 209431_s_at | PATZ1 | 552.22 | 1022.50 | 0.54 |
| 209464_at | AURKB | 2121.60 | 975.80 | 2.17 |
| 209494_s_at | PATZ1 | 834.03 | 2230.87 | 0.37 |
| 209509_s_at | DPAGT1 | 2491.64 | 1441.86 | 1.73 |
| 209572_s_at | EED | 2640.30 | 1551.74 | 1.70 |
| 209610_s_at | SLC1A4 | 901.71 | 3145.77 | 0.29 |
| 209611_s_at | SLC1A4 | 287.68 | 700.86 | 0.41 |
| 209645_s_at | ALDH1B1 | 412.03 | 235.42 | 1.75 |
| 209786_at | HMGN4 | 3494.59 | 2077.74 | 1.68 |
| 209787_s_at | HMGN4 | 2391.91 | 1580.65 | 1.51 |
| 209818_s_at | HABP4 | 210.80 | 109.02 | 1.93 |
| 209862_s_at | CEP57 | 989.03 | 596.78 | 1.66 |
| 209891_at | SPC25 | 1442.94 | 1046.41 | 1.38 |
| 210005_at | GART | 746.97 | 403.59 | 1.85 |
| 210008_s_at | MRPS12 | 468.06 | 252.32 | 1.86 |
| 210010_s_at | SLC25A1 | 3115.13 | 4350.92 | 0.72 |
| 210075_at | 2-Mar | 393.67 | 701.61 | 0.56 |
| 210175_at | C2orf3 | 836.39 | 420.94 | 1.99 |
| 210191_s_at | PHTF1 | 505.44 | 285.39 | 1.77 |
| 210463_x_at | TRMT1 | 915.27 | 435.18 | 2.10 |
| 210519_s_at | NQO1 | 10927.71 | 15482.26 | 0.71 |
| 210534_s_at | B9D1 | 1143.21 | 404.63 | 2.83 |
| 210567_s_at | SKP2 | 1235.98 | 536.92 | 2.30 |
| 210582_s_at | LIMK2 | 923.13 | 1661.12 | 0.56 |
| 210731_s_at | LGALS8 | 226.38 | 433.93 | 0.52 |
| 210740_s_at | ITPK1 | 2043.70 | 3414.83 | 0.60 |
| 210778_s_at | MXD4 | 186.34 | 385.34 | 0.48 |
| 210816_s_at | CYB561 | 600.12 | 1074.99 | 0.56 |
| 210817_s_at | CALCOCO2 | 2254.85 | 5331.42 | 0.42 |
| 211042_x_at | MCAM | 2247.23 | 1296.46 | 1.73 |
| 211084_x_at | PRKD3 | 634.76 | 300.95 | 2.11 |
| 211097_s_at | PBX2 | 459.03 | 351.83 | 1.30 |
| 211160_x_at | ACTN1 | 3073.28 | 1627.73 | 1.89 |
| 211391_s_at | PATZ1 | 393.23 | 724.62 | 0.54 |
| 211392_s_at | PATZ1 | 509.53 | 1231.63 | 0.41 |
| 211416_x_at | GGTLC1 | 342.04 | 727.93 | 0.47 |
| 211417_x_at | GGT1 | 609.24 | 1584.92 | 0.38 |
| 211559_s_at | CCNG2 | 676.39 | 1708.16 | 0.40 |
| 211600_at | PTPRO | 9107.62 | 13876.03 | 0.66 |
| 211686_s_at | MAK16 | 1412.78 | 942.52 | 1.50 |
| 211919_s_at | CXCR4 | 420.32 | 1098.55 | 0.38 |
| 212046_x_at | MAPK3 | 980.54 | 2045.21 | 0.48 |
| 212090_at | GRINA | 2320.23 | 4832.64 | 0.48 |
| 212164_at | TMEM183A | 578.66 | 856.72 | 0.68 |
| 212174_at | AK2 | 1632.72 | 791.12 | 2.06 |
| 212246_at | MCFD2 | 1617.13 | 704.00 | 2.30 |
| 212262_at | QKI | 1144.55 | 663.94 | 1.72 |
| 212263_at | QKI | 1473.39 | 821.65 | 1.79 |
| 212334_at | GNS | 2748.41 | 3752.17 | 0.73 |
| 212335_at | GNS | 2530.10 | 3651.61 | 0.69 |
| 212350_at | TBC1D1 | 1090.85 | 502.72 | 2.17 |
| 212372_at | MYH10 | 3342.76 | 999.46 | 3.34 |
| 212379_at | GART | 2117.50 | 1474.67 | 1.44 |
| 212398_at | RDX | 1962.39 | 969.95 | 2.02 |
| 212400_at | FAM102A | 1323.12 | 3644.52 | 0.36 |
| 212441_at | KIAA0232 | 1252.44 | 2524.46 | 0.50 |
| 212442_s_at | LASS6 | 2516.28 | 5274.60 | 0.48 |
| 212446_s_at | LASS6 | 1540.01 | 3439.47 | 0.45 |
| 212534_at | ZNF24 | 1277.27 | 2026.99 | 0.63 |
| 212630_at | EXOC3 | 1308.74 | 647.57 | 2.02 |
| 212637_s_at | WWP1 | 1230.53 | 3012.33 | 0.41 |
| 212638_s_at | WWP1 | 3675.08 | 8071.28 | 0.46 |
| 212662_at | PVR | 683.24 | 359.58 | 1.90 |
| 212672_at | ATM | 437.75 | 263.13 | 1.66 |
| 212692_s_at | LRBA | 1177.87 | 2511.54 | 0.47 |
| 212729_at | DLG3 | 785.76 | 1268.09 | 0.62 |
| 212811_x_at | SLC1A4 | 844.45 | 2511.53 | 0.34 |
| 212830_at | MEGF9 | 934.77 | 2958.10 | 0.32 |
| 212831_at | MEGF9 | 155.45 | 541.08 | 0.29 |
| 212867_at | — | 1136.19 | 2227.11 | 0.51 |
| 212870_at | SOS2 | 1229.65 | 1672.46 | 0.74 |
| 212944_at | SLC5A3 | 1830.04 | 978.80 | 1.87 |
| 212960_at | TBC1D9 | 373.87 | 570.56 | 0.66 |
| 212961_x_at | CXorf40B | 2197.98 | 4065.27 | 0.54 |
| 213061_s_at | NTAN1 | 1281.49 | 1909.39 | 0.67 |
| 213062_at | NTAN1 | 892.30 | 1293.23 | 0.69 |
| 213067_at | MYH10 | 458.55 | 111.95 | 4.10 |
| 213120_at | UHRF1BP1L | 104.93 | 172.87 | 0.61 |
| 213143_at | C2orf72 | 185.69 | 612.60 | 0.30 |
| 213234_at | KIAA1467 | 534.72 | 925.40 | 0.58 |
| 213302_at | PFAS | 1017.30 | 371.15 | 2.74 |
| 213315_x_at | CXorf40A | 2363.89 | 4412.25 | 0.54 |
| 213320_at | PRMT3 | 1547.85 | 939.68 | 1.65 |
| 213342_at | YAP1 | 1816.38 | 1086.94 | 1.67 |
| 213427_at | RPP40 | 2211.57 | 1092.74 | 2.02 |
| 213508_at | C14orf147 | 1353.68 | 2182.28 | 0.62 |
| 213587_s_at | ATP6V0E2 | 2309.61 | 4200.65 | 0.55 |
| 213710_s_at | CALM1 | 580.31 | 1082.24 | 0.54 |
| 213724_s_at | PDK2 | 241.25 | 1032.78 | 0.23 |
| 214011_s_at | NOP16 | 3261.83 | 1641.71 | 1.99 |
| 214062_x_at | NFKBIB | 374.27 | 216.01 | 1.73 |
| 214112_s_at | CXorf40A /// CXorf40B | 1712.93 | 3494.77 | 0.49 |
| 214119_s_at | FKBP1A | 6122.28 | 3537.99 | 1.73 |
| 214121_x_at | PDLIM7 | 346.14 | 160.97 | 2.15 |
| 214169_at | — | 229.37 | 136.31 | 1.68 |
| 214266_s_at | PDLIM7 | 295.78 | 170.44 | 1.74 |
| 214357_at | C1orf105 | 112.20 | 176.57 | 0.64 |
| 214444_s_at | PVR | 420.28 | 250.00 | 1.68 |
| 214543_x_at | QKI | 833.97 | 514.00 | 1.62 |
| 214616_at | HIST1H3E | 231.38 | 368.92 | 0.63 |
| 214771_x_at | MPRIP | 4481.82 | 2830.97 | 1.58 |
| 214785_at | VPS13A | 586.05 | 431.55 | 1.36 |
| 215136_s_at | EXOSC8 | 2618.06 | 1460.25 | 1.79 |
| 215236_s_at | PICALM | 1673.85 | 1071.61 | 1.56 |
| 215285_s_at | PHTF1 | 402.97 | 205.70 | 1.96 |
| 215696_s_at | SEC16A | 3292.51 | 6301.74 | 0.52 |
| 215707_s_at | PRNP | 2225.55 | 622.59 | 3.57 |
| 215728_s_at | ACOT7 | 1022.54 | 609.21 | 1.68 |
| 215747_s_at | RCC1 /// SNHG3-RCC1 | 1077.79 | 612.67 | 1.76 |
| 215921_at | NPIPL3 | 292.18 | 560.15 | 0.52 |
| 215990_s_at | BCL6 | 221.60 | 391.03 | 0.57 |
| 216044_x_at | FAM69A | 634.57 | 316.99 | 2.00 |
| 216247_at | — | 149.98 | 358.90 | 0.42 |
| 216266_s_at | ARFGEF1 | 1402.63 | 2645.82 | 0.53 |
| 216942_s_at | CD58 | 1532.52 | 700.53 | 2.19 |
| 217200_x_at | CYB561 | 2836.40 | 4573.96 | 0.62 |
| 217456_x_at | HLA-E | 1191.55 | 775.60 | 1.54 |
| 217595_at | GSPT1 | 296.34 | 568.98 | 0.52 |
| 217750_s_at | UBE2Z | 2784.82 | 5640.81 | 0.49 |
| 218065_s_at | TMEM9B | 2833.39 | 4064.17 | 0.70 |
| 218081_at | C20orf27 | 783.35 | 489.78 | 1.60 |
| 218096_at | AGPAT5 | 2359.93 | 1359.25 | 1.74 |
| 218105_s_at | MRPL4 | 2819.61 | 1413.50 | 1.99 |
| 218156_s_at | TSR1 | 3211.84 | 1473.71 | 2.18 |
| 218164_at | SPATA20 | 1166.64 | 2456.68 | 0.47 |
| 218194_at | REXO2 | 6691.08 | 3649.67 | 1.83 |
| 218237_s_at | SLC38A1 | 4928.07 | 6764.66 | 0.73 |
| 218244_at | NOL8 | 1644.40 | 904.42 | 1.82 |
| 218245_at | TSKU | 1332.04 | 3417.92 | 0.39 |
| 218288_s_at | CCDC90B | 2357.90 | 1564.05 | 1.51 |
| 218307_at | RSAD1 | 704.21 | 1321.22 | 0.53 |
| 218379_at | RBM7 | 1980.06 | 1008.29 | 1.96 |
| 218394_at | ROGDI | 805.28 | 1524.93 | 0.53 |
| 218397_at | FANCL | 1669.84 | 1222.88 | 1.37 |
| 218471_s_at | BBS1 | 699.44 | 1012.90 | 0.69 |
| 218561_s_at | LYRM4 | 1859.34 | 920.09 | 2.02 |
| 218566_s_at | CHORDC1 | 4746.99 | 2591.08 | 1.83 |
| 218597_s_at | CISD1 | 3530.54 | 2047.88 | 1.72 |
| 218611_at | IER5 | 4816.79 | 1779.73 | 2.71 |
| 218662_s_at | NCAPG | 1373.80 | 812.77 | 1.69 |
| 218663_at | NCAPG | 1475.88 | 919.52 | 1.61 |
| 218684_at | LRRC8D | 2709.07 | 1700.79 | 1.59 |
| 218715_at | UTP6 | 1445.13 | 946.97 | 1.53 |
| 218741_at | CENPM | 796.92 | 636.42 | 1.25 |
| 218770_s_at | TMEM39B | 542.47 | 333.04 | 1.63 |
| 218826_at | SLC35F2 | 1826.06 | 706.87 | 2.58 |
| 218828_at | PLSCR3 | 781.55 | 369.16 | 2.12 |
| 218886_at | PAK1IP1 | 1524.31 | 729.13 | 2.09 |
| 218890_x_at | MRPL35 | 1836.86 | 1138.57 | 1.61 |
| 218978_s_at | SLC25A37 | 155.08 | 71.70 | 2.16 |
| 218984_at | PUS7 | 2760.81 | 1583.40 | 1.74 |
| 218997_at | POLR1E | 979.57 | 479.70 | 2.04 |
| 219100_at | OBFC1 | 691.87 | 1143.89 | 0.60 |
| 219164_s_at | ATG2B | 334.82 | 577.67 | 0.58 |
| 219189_at | FBXL6 | 590.52 | 1069.56 | 0.55 |
| 219223_at | C9orf7 | 468.14 | 837.76 | 0.56 |
| 219234_x_at | SCRN3 | 165.74 | 273.30 | 0.61 |
| 219306_at | KIF15 | 830.44 | 638.08 | 1.30 |
| 219338_s_at | LRRC49 | 253.82 | 195.34 | 1.30 |
| 219342_at | CASD1 | 648.38 | 1089.73 | 0.59 |
| 219347_at | NUDT15 | 2246.67 | 1346.99 | 1.67 |
| 219374_s_at | ALG9 | 929.89 | 460.41 | 2.02 |
| 219401_at | XYLT2 | 266.60 | 584.56 | 0.46 |
| 219626_at | MAP7D3 | 432.27 | 268.30 | 1.61 |
| 219646_at | DEF8 | 990.73 | 470.12 | 2.11 |
| 219687_at | HHAT | 127.81 | 259.94 | 0.49 |
| 219741_x_at | ZNF552 | 499.26 | 957.32 | 0.52 |
| 219760_at | LIN7B | 177.83 | 284.37 | 0.63 |
| 219793_at | SNX16 | 275.90 | 1166.67 | 0.24 |
| 219913_s_at | CRNKL1 | 950.01 | 1848.59 | 0.51 |
| 219929_s_at | ZFYVE21 | 940.02 | 1480.35 | 0.63 |
| 220155_s_at | BRD9 | 2699.27 | 986.68 | 2.74 |
| 220239_at | KLHL7 | 1107.25 | 598.45 | 1.85 |
| 220258_s_at | WRAP53 | 531.41 | 287.23 | 1.85 |
| 220576_at | PGAP1 | 139.50 | 77.11 | 1.81 |
| 220669_at | OTUD4 | 142.46 | 80.53 | 1.77 |
| 220936_s_at | H2AFJ | 129.55 | 334.45 | 0.39 |
| 221012_s_at | TRIM8 | 1136.79 | 2387.23 | 0.48 |
| 221249_s_at | FAM117A | 518.79 | 1338.09 | 0.39 |
| 221273_s_at | RNF208 | 244.62 | 709.43 | 0.34 |
| 221517_s_at | MED17 | 1833.03 | 1109.77 | 1.65 |
| 221519_at | FBXW4 | 794.68 | 1153.05 | 0.69 |
| 221580_s_at | TAF1D | 3585.82 | 1659.41 | 2.16 |
| 221649_s_at | PPAN | 1166.92 | 470.09 | 2.48 |
| 221656_s_at | ARHGEF10L | 312.12 | 494.15 | 0.63 |
| 221685_s_at | CCDC99 | 2319.60 | 1659.60 | 1.40 |
| 221750_at | HMGCS1 | 1350.72 | 1870.51 | 0.72 |
| 221756_at | PIK3IP1 | 179.60 | 390.95 | 0.46 |
| 221869_at | ZNF512B | 576.52 | 1074.18 | 0.54 |
| 221882_s_at | TMEM8A | 1294.04 | 2348.54 | 0.55 |
| 222160_at | AKAP8L | 70.00 | 157.18 | 0.45 |
| 222273_at | PAPOLG | 267.18 | 170.37 | 1.57 |
| 222303_at | — | 266.14 | 73.26 | 3.63 |
| 38340_at | HIP1R /// LOC100294412 | 1651.09 | 2702.89 | 0.61 |
| 41329_at | SCYL3 | 434.73 | 1064.19 | 0.41 |
| 45653_at | KCTD13 | 418.91 | 617.45 | 0.68 |
| 50314_i_at | C20orf27 | 1730.34 | 1068.42 | 1.62 |
| 61874_at | C9orf7 | 814.47 | 1454.33 | 0.56 |
| 62987_r_at | CACNG4 | 1081.92 | 2884.69 | 0.38 |
| 74694_s_at | RABEP2 | 753.65 | 1437.01 | 0.52 |

TABLE 7
DX

| probeID | Gene.Symbol | mean_sens | mean_resis | fold.change |
|---|---|---|---|---|
| 200658_s_at | PHB | 4771.63 | 6938.55 | 0.69 |
| 200659_s_at | PHB | 1163.81 | 2229.07 | 0.52 |
| 200664_s_at | DNAJB1 | 4050.77 | 3080.96 | 1.31 |
| 200671_s_at | SPTBN1 | 572.08 | 267.47 | 2.14 |
| 200709_at | FKBP1A | 10371.15 | 6242.07 | 1.66 |
| 200755_s_at | CALU | 4187.67 | 1811.87 | 2.31 |
| 200756_x_at | CALU | 3107.31 | 1202.26 | 2.58 |
| 200757_s_at | CALU | 6990.06 | 3425.65 | 2.04 |
| 200810_s_at | CIRBP | 2751.00 | 4450.16 | 0.62 |
| 200864_s_at | RAB11A | 2000.85 | 2801.71 | 0.71 |
| 200890_s_at | SSR1 | 2752.35 | 1894.95 | 1.45 |
| 200895_s_at | FKBP4 | 5086.86 | 8438.69 | 0.60 |
| 200935_at | CALR | 1293.36 | 874.49 | 1.48 |
| 201041_s_at | DUSP1 | 2700.88 | 1232.74 | 2.19 |
| 201237_at | CAPZA2 | 3601.08 | 2035.51 | 1.77 |
| 201329_s_at | ETS2 | 706.14 | 249.58 | 2.83 |
| 201464_x_at | JUN | 3456.26 | 1669.92 | 2.07 |
| 201482_at | QSOX1 | 1896.29 | 705.64 | 2.69 |
| 201559_s_at | CLIC4 | 2621.71 | 1176.73 | 2.23 |
| 201631_s_at | IER3 | 12245.47 | 6774.56 | 1.81 |
| 201658_at | ARL1 | 1264.33 | 2072.43 | 0.61 |
| 201886_at | DCAF11 | 1103.86 | 1494.71 | 0.74 |
| 201900_s_at | AKR1A1 | 2976.98 | 3869.20 | 0.77 |
| 201945_at | FURIN | 618.42 | 308.32 | 2.01 |
| 201954_at | ARPC1B | 7961.89 | 3244.41 | 2.45 |
| 201976_s_at | MYO10 | 2953.70 | 1129.83 | 2.61 |
| 202087_s_at | CTSL1 | 2609.35 | 1141.56 | 2.29 |
| 202129_s_at | RIOK3 | 1623.61 | 966.25 | 1.68 |
| 202185_at | PLOD3 | 4569.92 | 2376.31 | 1.92 |
| 202187_s_at | PPP2R5A | 1493.55 | 2048.84 | 0.73 |
| 202290_at | PDAP1 | 5359.02 | 3043.86 | 1.76 |
| 202321_at | GGPS1 | 498.70 | 1040.54 | 0.48 |
| 202431_s_at | MYC | 4907.91 | 2554.67 | 1.92 |
| 202558_s_at | HSPA13 | 1719.29 | 1184.86 | 1.45 |
| 202590_s_at | PDK2 | 300.09 | 754.78 | 0.40 |
| 202623_at | EAPP | 1832.81 | 2350.24 | 0.78 |
| 202636_at | RNF103 | 2519.83 | 3991.30 | 0.63 |
| 202665_s_at | WIPF1 | 396.54 | 123.03 | 3.22 |
| 202696_at | OXSR1 | 2664.83 | 1417.73 | 1.88 |
| 202708_s_at | HIST2H2BE | 760.32 | 1879.94 | 0.40 |
| 202727_s_at | IFNGR1 | 3352.54 | 1782.29 | 1.88 |
| 202762_at | ROCK2 | 1356.32 | 884.60 | 1.53 |
| 202862_at | FAH | 950.68 | 1633.14 | 0.58 |
| 202900_s_at | NUP88 | 2358.21 | 1712.91 | 1.38 |
| 202942_at | ETFB | 1754.73 | 3138.64 | 0.56 |
| 202964_s_at | RFX5 | 947.94 | 1286.82 | 0.74 |
| 202982_s_at | ACOT1 /// ACOT2 | 1074.32 | 2042.57 | 0.53 |
| 203023_at | NOP16 | 2039.92 | 1424.71 | 1.43 |
| 203072_at | MYO1E | 515.37 | 292.30 | 1.76 |
| 203179_at | GALT | 507.34 | 629.94 | 0.81 |
| 203188_at | B3GNT1 | 867.59 | 1383.67 | 0.63 |
| 203245_s_at | NCRNA00094 | 559.29 | 833.77 | 0.67 |
| 203313_s_at | TGIF1 | 2598.74 | 1837.02 | 1.41 |
| 203513_at | SPG11 | 1670.78 | 2439.85 | 0.68 |
| 203754_s_at | BRF1 | 169.61 | 344.35 | 0.49 |
| 203758_at | CTSO | 289.42 | 549.54 | 0.53 |
| 203793_x_at | PCGF2 | 396.07 | 870.80 | 0.45 |
| 203826_s_at | PITPNM1 | 483.73 | 401.28 | 1.21 |
| 203929_s_at | MAPT | 123.84 | 479.34 | 0.26 |
| 203968_s_at | CDC6 | 3638.19 | 1743.33 | 2.09 |
| 203991_s_at | KDM6A | 260.81 | 342.87 | 0.76 |
| 204008_at | DNAL4 | 334.88 | 514.19 | 0.65 |
| 204048_s_at | PHACTR2 | 1292.30 | 696.58 | 1.86 |
| 204049_s_at | PHACTR2 | 1382.58 | 867.26 | 1.59 |
| 204280_at | RGS14 | 142.73 | 215.41 | 0.66 |
| 204294_at | AMT | 215.06 | 369.88 | 0.58 |
| 204357_s_at | LIMK1 | 245.64 | 115.15 | 2.13 |
| 204365_s_at | REEP1 | 242.08 | 545.39 | 0.44 |
| 204382_at | NAT9 | 637.78 | 926.90 | 0.69 |
| 204395_s_at | GRK5 | 245.09 | 122.60 | 2.00 |
| 204453_at | ZNF84 | 515.17 | 798.82 | 0.64 |
| 204509_at | CA12 | 100.73 | 210.96 | 0.48 |
| 204510_at | CDC7 | 887.28 | 1309.94 | 0.68 |
| 204538_x_at | NPIP | 1910.29 | 2522.06 | 0.76 |
| 204541_at | SEC14L2 | 188.43 | 341.35 | 0.55 |
| 204562_at | IRF4 | 106.16 | 148.57 | 0.71 |
| 204693_at | CDC42EP1 | 2222.66 | 769.41 | 2.89 |
| 204859_s_at | APAF1 | 316.48 | 550.54 | 0.57 |
| 204906_at | RPS6KA2 | 566.43 | 302.52 | 1.87 |
| 204958_at | PLK3 | 272.34 | 123.40 | 2.21 |
| 204966_at | BAI2 | 259.69 | 485.29 | 0.54 |
| 204969_s_at | RDX | 642.55 | 314.05 | 2.05 |
| 205017_s_at | MBNL2 | 564.86 | 261.44 | 2.16 |
| 205018_s_at | MBNL2 | 1368.43 | 650.45 | 2.10 |
| 205034_at | CCNE2 | 1645.87 | 2608.95 | 0.63 |
| 205059_s_at | IDUA | 241.03 | 491.60 | 0.49 |
| 205193_at | MAFF | 535.19 | 322.33 | 1.66 |
| 205354_at | GAMT | 272.47 | 600.60 | 0.45 |
| 205500_at | C5 | 93.33 | 192.44 | 0.48 |
| 205594_at | ZNF652 | 1039.22 | 3137.33 | 0.33 |
| 205607_s_at | SCYL3 | 400.25 | 657.70 | 0.61 |
| 205617_at | PRRG2 | 309.13 | 480.61 | 0.64 |
| 205756_s_at | F8 | 313.14 | 442.98 | 0.71 |
| 205791_x_at | ZNF230 | 126.42 | 192.19 | 0.66 |
| 205796_at | TCP11L1 | 423.42 | 196.20 | 2.16 |
| 206048_at | OVOL2 | 120.61 | 175.66 | 0.69 |
| 206170_at | ADRB2 | 333.19 | 163.00 | 2.04 |
| 206175_x_at | ZNF222 | 105.11 | 188.00 | 0.56 |
| 206274_s_at | CROCC | 89.68 | 154.64 | 0.58 |
| 206412_at | FER | 317.99 | 194.19 | 1.64 |
| 206417_at | CNGA1 | 97.52 | 244.71 | 0.40 |
| 206491_s_at | NAPA | 1936.06 | 2855.97 | 0.68 |
| 206523_at | CYTH3 | 253.47 | 125.13 | 2.03 |
| 206527_at | ABAT | 247.05 | 435.41 | 0.57 |
| 206533_at | CHRNA5 | 571.47 | 392.38 | 1.46 |
| 206648_at | ZNF571 | 139.45 | 260.68 | 0.53 |
| 207133_x_at | ALPK1 | 74.39 | 145.89 | 0.51 |
| 207143_at | CDK6 | 242.35 | 77.17 | 3.14 |
| 207300_s_at | F7 | 113.20 | 328.34 | 0.34 |
| 207467_x_at | CAST | 5767.82 | 3246.00 | 1.78 |
| 207711_at | C20orf117 | 232.50 | 384.14 | 0.61 |
| 208078_s_at | SIK1 | 1530.80 | 734.28 | 2.08 |
| 208158_s_at | OSBPL1A | 1642.75 | 705.78 | 2.33 |
| 208296_x_at | TNFAIP8 | 1552.29 | 494.87 | 3.14 |
| 208372_s_at | LIMK1 | 262.71 | 151.76 | 1.73 |
| 208527_x_at | HIST1H2BE | 1183.68 | 1921.27 | 0.62 |
| 208637_x_at | ACTN1 | 5874.82 | 2910.83 | 2.02 |
| 208741_at | SAP18 | 385.82 | 618.72 | 0.62 |
| 208744_x_at | HSPH1 | 3646.24 | 2928.94 | 1.24 |
| 208751_at | NAPA | 986.57 | 1563.58 | 0.63 |
| 208783_s_at | CD46 | 5447.93 | 7754.41 | 0.70 |
| 208820_at | PTK2 | 2597.45 | 5226.91 | 0.50 |
| 208853_s_at | CANX | 6626.47 | 4775.53 | 1.39 |
| 208878_s_at | PAK2 | 1594.24 | 2181.61 | 0.73 |
| 208908_s_at | CAST | 3708.48 | 1820.17 | 2.04 |
| 208920_at | SRI | 769.28 | 334.90 | 2.30 |
| 208930_s_at | ILF3 | 1409.35 | 900.18 | 1.57 |
| 208931_s_at | ILF3 | 2680.79 | 1698.80 | 1.58 |
| 208933_s_at | LGALS8 | 1167.02 | 2833.04 | 0.41 |
| 208934_s_at | LGALS8 | 1902.05 | 3717.48 | 0.51 |
| 208935_s_at | LGALS8 | 517.45 | 1532.87 | 0.34 |
| 208936_x_at | LGALS8 | 1280.18 | 2734.67 | 0.47 |
| 208938_at | PRCC | 1695.20 | 2156.32 | 0.79 |
| 208955_at | DUT | 1085.92 | 1465.19 | 0.74 |
| 209065_at | UQCRB | 712.86 | 1084.72 | 0.66 |
| 209194_at | CETN2 | 2717.09 | 3446.97 | 0.79 |
| 209195_s_at | ADCY6 | 1167.99 | 1719.66 | 0.68 |
| 209203_s_at | BICD2 | 560.17 | 382.29 | 1.47 |
| 209213_at | CBR1 | 1682.29 | 504.69 | 3.33 |
| 209250_at | DEGS1 | 2326.01 | 4256.58 | 0.55 |
| 209333_at | ULK1 | 361.99 | 634.35 | 0.57 |
| 209373_at | MALL | 2897.12 | 600.79 | 4.82 |
| 209380_s_at | ABCC5 | 1684.66 | 2240.32 | 0.75 |
| 209431_s_at | PATZ1 | 538.41 | 905.34 | 0.59 |
| 209485_s_at | OSBPL1A | 1487.24 | 456.59 | 3.26 |
| 209494_s_at | PATZ1 | 848.32 | 1717.42 | 0.49 |
| 209575_at | IL10RB | 1153.30 | 688.40 | 1.68 |
| 209654_at | KIAA0947 | 1916.59 | 1282.17 | 1.49 |
| 209799_at | PRKAA1 | 983.23 | 555.65 | 1.77 |
| 209947_at | UBAP2L | 639.83 | 1120.12 | 0.57 |
| 210026_s_at | CARD10 | 992.42 | 535.51 | 1.85 |
| 210186_s_at | FKBP1A | 3280.01 | 1814.66 | 1.81 |
| 210191_s_at | PHTF1 | 483.44 | 388.40 | 1.24 |
| 210260_s_at | TNFAIP8 | 1324.02 | 450.51 | 2.94 |
| 210278_s_at | AP4S1 | 245.10 | 357.17 | 0.69 |
| 210457_x_at | HMGA1 | 732.79 | 237.93 | 3.08 |
| 210580_x_at | SULT1A3 /// SULT1A4 | 1663.52 | 2308.19 | 0.72 |
| 210719_s_at | HMG20B | 1999.27 | 2446.02 | 0.82 |
| 210720_s_at | NECAB3 | 710.85 | 1073.29 | 0.66 |
| 210740_s_at | ITPK1 | 1735.22 | 2850.02 | 0.61 |
| 210778_s_at | MXD4 | 214.21 | 360.81 | 0.59 |
| 210935_s_at | WDR1 | 2993.19 | 1884.29 | 1.59 |
| 211012_s_at | GOLGA6L4 /// PML | 315.39 | 114.57 | 2.75 |
| 211051_s_at | EXTL3 | 290.91 | 171.11 | 1.70 |
| 211084_x_at | PRKD3 | 733.36 | 339.26 | 2.16 |
| 211160_x_at | ACTN1 | 4874.18 | 1842.39 | 2.65 |
| 211332_x_at | HFE | 264.41 | 412.33 | 0.64 |
| 211574_s_at | CD46 | 1945.69 | 2499.36 | 0.78 |
| 211599_x_at | MET | 2026.86 | 631.67 | 3.21 |
| 211600_at | PTPRO | 9594.04 | 12471.45 | 0.77 |
| 211672_s_at | ARPC4 | 2335.77 | 1516.74 | 1.54 |
| 211676_s_at | IFNGR1 | 1950.54 | 989.72 | 1.97 |
| 211681_s_at | PDLIM5 | 1185.68 | 698.51 | 1.70 |
| 211686_s_at | MAK16 | 1664.55 | 903.57 | 1.84 |
| 211691_x_at | — | 73.33 | 158.13 | 0.46 |
| 211954_s_at | IPO5 | 4278.91 | 2756.91 | 1.55 |
| 211955_at | IPO5 | 3093.72 | 2012.86 | 1.54 |
| 212046_x_at | MAPK3 | 964.02 | 1656.42 | 0.58 |
| 212053_at | PDXDC1 | 2926.14 | 3665.62 | 0.80 |
| 212071_s_at | SPTBN1 | 7527.92 | 4234.92 | 1.78 |
| 212150_at | EFR3A | 1836.92 | 2542.76 | 0.72 |
| 212239_at | PIK3R1 | 510.54 | 931.80 | 0.55 |
| 212240_s_at | PIK3R1 | 574.86 | 1371.15 | 0.42 |
| 212246_at | MCFD2 | 1648.66 | 877.06 | 1.88 |
| 212262_at | QKI | 1285.99 | 770.59 | 1.67 |
| 212263_at | QKI | 1469.15 | 954.88 | 1.54 |
| 212350_at | TBC1D1 | 1330.50 | 845.52 | 1.57 |
| 212367_at | FEM1B | 825.92 | 1181.21 | 0.70 |
| 212398_at | RDX | 2229.42 | 1403.96 | 1.59 |
| 212400_at | FAM102A | 1305.19 | 2493.25 | 0.52 |
| 212446_s_at | LASS6 | 1375.16 | 2593.38 | 0.53 |
| 212458_at | SPRED2 | 1346.07 | 2177.91 | 0.62 |
| 212492_s_at | KDM4B | 985.65 | 2385.63 | 0.41 |
| 212495_at | KDM4B | 469.80 | 1127.68 | 0.42 |
| 212496_s_at | KDM4B | 1073.17 | 2478.23 | 0.43 |
| 212508_at | MOAP1 | 1524.55 | 3036.38 | 0.50 |
| 212522_at | PDE8A | 2451.66 | 1287.46 | 1.90 |
| 212586_at | CAST | 5149.85 | 2062.46 | 2.50 |
| 212593_s_at | PDCD4 | 1816.48 | 6878.14 | 0.26 |
| 212596_s_at | HMGXB4 | 1143.74 | 1660.45 | 0.69 |
| 212616_at | CHD9 | 1131.23 | 3064.62 | 0.37 |
| 212668_at | SMURF1 | 187.57 | 84.78 | 2.21 |
| 212692_s_at | LRBA | 1162.25 | 2269.30 | 0.51 |
| 212772_s_at | ABCA2 | 494.57 | 750.27 | 0.66 |
| 212779_at | KIAA1109 | 666.22 | 981.42 | 0.68 |
| 212810_s_at | SLC1A4 | 424.68 | 716.67 | 0.59 |
| 212811_x_at | SLC1A4 | 1057.17 | 1593.17 | 0.66 |
| 212830_at | MEGF9 | 770.96 | 1720.69 | 0.45 |
| 212856_at | GRAMD4 | 682.10 | 1167.59 | 0.58 |
| 212870_at | SOS2 | 1148.16 | 1383.22 | 0.83 |
| 213049_at | RALGAPA1 | 1022.76 | 1469.67 | 0.70 |
| 213093_at | PRKCA | 814.10 | 391.60 | 2.08 |
| 213137_s_at | PTPN2 | 1195.30 | 702.91 | 1.70 |
| 213198_at | ACVR1B | 961.89 | 1342.00 | 0.72 |
| 213224_s_at | NCRNA00081 | 391.03 | 1004.39 | 0.39 |
| 213246_at | C14orf109 | 2166.73 | 3164.12 | 0.68 |
| 213305_s_at | PPP2R5C | 1632.48 | 2112.07 | 0.77 |
| 213315_x_at | CXorf40A | 2280.04 | 3671.71 | 0.62 |
| 213446_s_at | IQGAP1 | 1560.08 | 929.17 | 1.68 |
| 213459_at | RPL37A | 346.68 | 495.17 | 0.70 |
| 213464_at | LOC100291393 /// SHC2 | 57.72 | 126.41 | 0.46 |
| 213508_at | C14orf147 | 1162.88 | 1793.19 | 0.65 |
| 213546_at | DKFZP58611420 | 586.97 | 1280.62 | 0.46 |
| 213763_at | HIPK2 | 322.29 | 532.80 | 0.60 |
| 213784_at | IFT27 | 202.27 | 342.40 | 0.59 |
| 213807_x_at | MET | 1785.51 | 517.92 | 3.45 |
| 213820_s_at | STARD5 | 161.91 | 361.45 | 0.45 |
| 214011_s_at | NOP16 | 3049.02 | 2099.91 | 1.45 |
| 214033_at | ABCC6 | 341.59 | 673.54 | 0.51 |
| 214035_x_at | LOC399491 | 2252.95 | 3250.72 | 0.69 |
| 214048_at | MBD4 | 252.32 | 403.66 | 0.63 |
| 214083_at | PPP2R5C | 215.35 | 296.66 | 0.73 |
| 214109_at | LRBA | 909.30 | 1816.34 | 0.50 |
| 214119_s_at | FKBP1A | 6610.07 | 3575.29 | 1.85 |
| 214455_at | HIST1H2BC | 272.04 | 688.00 | 0.40 |
| 214542_x_at | HISTH2AI | 248.31 | 378.48 | 0.66 |
| 214543_x_at | QKI | 815.14 | 511.51 | 1.59 |
| 214616_at | HIST1H3E | 257.02 | 347.49 | 0.74 |
| 214802_at | EXOC7 | 150.87 | 235.85 | 0.64 |
| 214845_s_at | CALU | 3788.43 | 1458.08 | 2.60 |
| 214855_s_at | RALGAPA1 | 778.83 | 1042.32 | 0.75 |
| 214870_x_at | LOC100288442 /// | 2367.03 | 3268.70 | 0.72 |
| | LOC339047 /// NPIP | | | |
| 215236_s_at | PICALM | 1866.03 | 1212.38 | 1.54 |
| 215281_x_at | POGZ | 177.90 | 215.90 | 0.82 |
| 215696_s_at | SEC16A | 3250.97 | 5475.34 | 0.59 |
| 215706_x_at | ZYX | 2973.13 | 1432.91 | 2.07 |
| 215921_at | NPIPL3 | 222.61 | 427.00 | 0.52 |
| 216092_s_at | SLC7A8 | 403.29 | 2165.04 | 0.19 |
| 216242_x_at | POLR2J2 | 1942.61 | 1126.67 | 1.72 |
| 216247_at | — | 152.02 | 302.21 | 0.50 |
| 216604_s_at | SLC7A8 | 149.59 | 1301.65 | 0.11 |
| 217363_x_at | — | 191.41 | 381.10 | 0.50 |
| 217677_at | PLEKHA2 | 249.15 | 169.09 | 1.47 |
| 217744_s_at | PERP | 8421.03 | 3869.52 | 2.18 |
| 217756_x_at | SERF2 | 10307.73 | 11728.03 | 0.88 |
| 217824_at | UBE2J1 | 735.70 | 334.83 | 2.20 |
| 218065_s_at | TMEM9B | 2749.33 | 3305.73 | 0.83 |
| 218081_at | C20orf27 | 827.70 | 561.02 | 1.48 |
| 218096_at | AGPAT5 | 2634.35 | 1442.14 | 1.83 |
| 218105_s_at | MRPL4 | 2806.69 | 1542.51 | 1.82 |
| 218156_s_at | TSR1 | 2980.30 | 1867.75 | 1.60 |
| 218164_at | SPATA20 | 1057.32 | 1998.23 | 0.53 |
| 218178_s_at | CHMP1B | 3283.19 | 1806.35 | 1.82 |
| 218204_s_at | FYCO1 | 562.39 | 811.18 | 0.69 |
| 218254_s_at | SAR1B | 2878.01 | 4125.54 | 0.70 |
| 218280_x_at | HIST2H2AA3 /// | 2121.24 | 4286.85 | 0.49 |
| | HIST2H2AA4 | | | |
| 218285_s_at | BDH2 | 699.28 | 1219.58 | 0.57 |
| 218291_at | ROBLD3 | 1733.49 | 2258.64 | 0.77 |
| 218306_s_at | HERC1 | 844.45 | 1151.31 | 0.73 |
| 218307_at | RSAD1 | 696.46 | 1202.32 | 0.58 |
| 218323_at | RHOT1 | 1595.14 | 2391.07 | 0.67 |
| 218344_s_at | RCOR3 | 472.75 | 757.75 | 0.62 |
| 218352_at | RCBTB1 | 592.58 | 1011.39 | 0.59 |
| 218417_s_at | SLC48A1 | 533.22 | 1205.71 | 0.44 |
| 218487_at | ALAD | 516.31 | 911.70 | 0.57 |
| 218489_s_at | ALAD | 353.41 | 565.18 | 0.63 |
| 218530_at | FHOD1 | 840.00 | 1486.27 | 0.57 |
| 218561_s_at | LYRM4 | 1731.52 | 1243.01 | 1.39 |
| 218611_at | IER5 | 4404.75 | 2125.30 | 2.07 |
| 218788_s_at | SMYD3 | 835.77 | 1484.33 | 0.56 |
| 218815_s_at | TMEM51 | 437.55 | 272.83 | 1.60 |
| 218841_at | ASB8 | 303.14 | 446.12 | 0.68 |
| 218916_at | ZNF768 | 559.21 | 779.31 | 0.72 |
| 219019_at | LRDD | 294.72 | 501.84 | 0.59 |
| 219028_at | HIPK2 | 190.23 | 438.55 | 0.43 |
| 219044_at | THNSL2 | 229.60 | 385.40 | 0.60 |
| 219061_s_at | LAGE3 | 2572.26 | 3466.64 | 0.74 |
| 219145_at | LPHN1 | 579.09 | 913.15 | 0.63 |
| 219155_at | PITPNC1 | 503.69 | 862.60 | 0.58 |
| 219164_s_at | ATG2B | 313.01 | 552.41 | 0.57 |
| 219165_at | PDLIM2 | 1940.99 | 461.91 | 4.20 |
| 219223_at | C9orf7 | 484.45 | 682.15 | 0.71 |
| 219234_x_at | SCRN3 | 156.89 | 223.01 | 0.70 |
| 219236_at | PAQR6 | 270.74 | 756.98 | 0.36 |
| 219255_x_at | IL17RB | 425.34 | 766.26 | 0.56 |
| 219266_at | ZNF350 | 327.45 | 690.96 | 0.47 |
| 219268_at | ETNK2 | 342.16 | 1302.29 | 0.26 |
| 219396_s_at | NEIL1 | 113.33 | 221.66 | 0.51 |
| 219401_at | XYLT2 | 278.58 | 451.99 | 0.62 |
| 219428_s_at | PXMP4 | 1800.16 | 2390.21 | 0.75 |
| 219475_at | OSGIN1 | 90.92 | 321.14 | 0.28 |
| 219500_at | CLCF1 | 461.52 | 289.55 | 1.59 |
| 219520_s_at | WWC3 | 918.15 | 1913.60 | 0.48 |
| 219741_x_at | ZNF552 | 455.97 | 935.60 | 0.49 |
| 219749_at | SH2D4A | 875.88 | 324.35 | 2.70 |
| 219760_at | LIN7B | 158.55 | 263.24 | 0.60 |
| 220992_s_at | C1orf25 | 408.96 | 502.87 | 0.81 |
| 221012_s_at | TRIM8 | 1041.60 | 2487.02 | 0.42 |
| 221019_s_at | COLEC12 | 108.93 | 507.01 | 0.21 |
| 221196_x_at | BRCC3 | 1879.02 | 2495.02 | 0.75 |
| 221213_s_at | ZNF280D | 112.66 | 207.80 | 0.54 |
| 221215_s_at | RIPK4 | 1965.00 | 839.80 | 2.34 |
| 221222_s_at | C1orf56 | 451.06 | 708.44 | 0.64 |
| 221249_s_at | FAM117A | 581.55 | 1124.71 | 0.52 |
| 221273_s_at | RNF208 | 234.17 | 626.68 | 0.37 |
| 221379_at | — | 140.42 | 77.68 | 1.81 |
| 221473_x_at | SERINC3 | 4103.34 | 2423.31 | 1.69 |
| 221501_x_at | LOC339047 | 1957.40 | 2934.88 | 0.67 |
| 221519_at | FBXW4 | 655.48 | 1095.67 | 0.60 |
| 221718_s_at | AKAP13 | 616.96 | 384.73 | 1.60 |
| 221820_s_at | MYST1 | 944.14 | 1539.14 | 0.61 |
| 221864_at | ORAI3 | 400.25 | 955.20 | 0.42 |
| 221869_at | ZNF512B | 569.38 | 1067.11 | 0.53 |
| 221881_s_at | CLIC4 | 1434.81 | 655.78 | 2.19 |
| 221904_at | FAM131A | 569.93 | 850.01 | 0.67 |
| 221920_s_at | SLC25A37 | 618.04 | 256.93 | 2.41 |
| 221992_at | NPIPL2 | 301.90 | 592.50 | 0.51 |
| 222018_at | NACA | 320.88 | 521.90 | 0.61 |
| 222024_s_at | AKAP13 | 396.81 | 296.15 | 1.34 |
| 222075_s_at | OAZ3 | 242.56 | 595.76 | 0.41 |
| 222199_s_at | BIN3 | 658.47 | 456.99 | 1.44 |
| 222209_s_at | TMEM135 | 1264.21 | 1850.68 | 0.68 |
| 222303_at | — | 267.58 | 90.91 | 2.94 |
| 222362_at | AGFG2 | 155.50 | 220.04 | 0.71 |
| 222380_s_at | PDCD6 | 461.07 | 843.54 | 0.55 |
| 32837_at | AGPAT2 | 1251.19 | 1455.68 | 0.86 |
| 35160_at | LDB1 | 360.90 | 790.69 | 0.46 |
| 36711_at | MAFF | 1444.18 | 648.71 | 2.23 |
| 41329_at | SCYL3 | 466.02 | 831.99 | 0.56 |
| 41858_at | PGAP2 | 850.88 | 1345.58 | 0.63 |
| 45653_at | KCTD13 | 365.19 | 569.56 | 0.64 |
| 48106_at | SLC48A1 | 602.63 | 1475.79 | 0.41 |
| 50314_i_at | C20or127 | 1711.06 | 1306.31 | 1.31 |
| 52940_at | LOC100294402 /// SIGIRR | 970.78 | 1460.21 | 0.66 |
| 57516_at | ZNF764 | 242.95 | 443.29 | 0.55 |
| 59437_at | C9orf116 | 269.74 | 466.95 | 0.58 |
| 61874_at | C9orf7 | 752.82 | 1102.65 | 0.68 |
| 62987_r_at | CACNG4 | 1110.21 | 2340.08 | 0.47 |
| 64371_at | SFRS14 | 279.11 | 398.71 | 0.70 |
| 74694_s_at | RABEP2 | 769.56 | 1107.10 | 0.70 |

### Example 2

### Identification and Validation of TFEC MultiGene Predictor (MGP)

42 breast cancer cell lines were tested for their responses to the combination of docetaxel (T), fluorouracil (F), epirubicin (E) and cyclophosphamide (C) in vitro, and their gene expression profiles were used to derive a predictor for sensitivity to TFEC. This MGP was applied to predict the patient chemotherapy responses in US Oncology Study 02-103 clinical trial. The prediction procedure was performed blindly without knowledge of patient clinical outcomes and the prediction results were evaluated independently.

### Methods

### Patients and Samples

US Oncology 02-103 was a phase II clinical trial on women with stage II/III breast cancer. A majority of patients whose tumors were HER2-negative received 4 cycles of FEC followed by 4 cycles of TX, whereas most patients whose tumors were HER2-positive received trastuzumab (H) in addition to FEC/TX. HER2 status was assessed by IHC or FISH. IHC ≧3+ was considered positive and IHC 1+ or 2+ was confirmed by FISH. To conduct the present study, Institutional review board approval was obtained from US Oncology Research, MD Anderson Cancer Center and Precision Therapeutics and all patients signed informed consent for genomic analysis of their specimens. Pretreatment FNA specimens were obtained and immediately placed in RNAIater (Ambion, Austin, Tex.), and the FNA specimens were used for RNA extraction and purification. Gene expression profiling was performed using the Affymetrix HG-U133A microarray platform (Affymetrix, Santa Clara, Calif.).

### In Vitro Chemosensitivity Testing of Breast Cancer Cell Lines

Forty two breast cancer cell lines were obtained from either ATCC (Manassas, Va.) or DSMZ (Braunschweig, Germany). All cell lines were maintained in RPMI 1640 (Mediatech, Herndon, Va.) containing 10% FBS (HyClone, Logan, Utah) at 37° C. in 5% CO₂. Upon reaching approximately 80% confluence, each cell line was trypsinized and seeded into 384-well microtiter plates (Corning, Lowell, Mass.) at 8000 cells/mL and used immediately for in vitro chemoresponse testing.

The cell lines were treated with the combination of T, F, E and C to simulate the US oncology 02-103 treatment protocol of FEC followed by TX since X is an oral prodrug converted to F in vivo. Ten serial dilutions for TFEC, along with control well without drug exposure were prepared in 10% RPMI 1640 and added in triplicate to each cell line. Each cell line was incubated with the various concentrations of TFEC for 72 h at 37° C. in 5% CO₂. Non-adherent cells and the medium were then removed from each well and the remaining adherent cells were fixed in 95% ethanol and stained with DAPI (Molecular Probes, Eugene, Oreg.). An automated microscope was used to count the number of stained cells remaining after drug treatment. A survival fraction (SF) representing the ratio of cells that survived the drug treatment was calculated using the formula: SF=Mean_{drug}/Mean_{control}, where Mean_{drug} is the average of the number of surviving cells in the three replicates, and Mean_{control} is the average number of living cells in the control wells. The SF was calculated for treatment with TFEC at each of the 10 doses. The area under the dose-response curve (AUC), which is the summation of SF values over the 10 doses, was used for quantifying TFEC sensitivity of the tumor cells. A lower AUC score indicated greater sensitivity to the test drug.

### Development of the TFEC Multi-Gene Predictor

Genome-wide gene expression profiles for the 42 breast cancer cell lines were measured using Affymetrix HG-U133 Plus 2.0 array, and the microarray data were downloaded from the Gene Expression Omnibus database (Accession number GSE12777). Background adjustments and quantitative normalization were performed by the software package RMA, and then the data were log 2-transformed. Non-specific gene filtering was applied to filter out probes which have small variation or low expression values across all cell lines. The gene expression values of each cell line were normalized to mean zero and standard deviation one.

The TFEC MGP was developed using a supervised principal components regression [Bair et al., Prediction by Supervised Principal Components Journal of the American Statistical Association 2006, 101(473):119-137; Bair and Tibshirani, Semi-Supervised Methods to Predict Patient Survival from Gene Expression Data PLoS Biol 2004, 2(4):e108]. The process had four steps:

(1) Compute the univariate linear regression coefficient for each gene where the response variable was the cell line's AUC scores to TFEC and the predictor variable was the expression values of each gene.

(2) Select genes whose absolute regression coefficient is larger than a threshold estimated by the cross-validation.

(3) Compute the first principal component of the expression value matrix of selected genes.

(4) Use the first principal component in a linear regression model to predict the patient's chemotherapy responses. A lower prediction score corresponded to a greater sensitivity to chemotherapy, and therefore greater likelihood of achieving pCR.

### TFEC MGP Validation

The receiver operating characteristics (ROC) curve analysis was employed and the area under the curve (AU-ROC) was used to evaluate the performance of prediction. The logistic regression analysis was applied to determine the independent function of the TFEC MGP adjusted for age, tumor size, node involvement as well as estrogen receptor status (ER) and progesterone receptor (PR) status. To control the confounding effect of H, analyses were done separately for patients who were treated with FEC/TX and those who were treated with FEC/TX plus H.

### Results

Derivation of the MGP from Breast Cell Lines

In vitro chemosensitivities to TFEC for 42 breast cancer cell lines are listed below:

| Cell line | AUC |
|---|---|
| AU565 | 3.627349 |
| BT20 | 4.79883 |
| BT474 | 6.730071 |
| BT483 | 6.285304 |
| BT549 | 4.153593 |
| CAL120 | 3.656632 |
| CAL51 | 2.796302 |
| CAL851 | 4.281127 |
| CAMA1 | 4.656248 |
| EFM19 | 6.991756 |
| EFM192A | 4.848844 |
| EVSAT | 3.411344 |
| HCC1143 | 5.067855 |
| HCC1395 | 3.853306 |
| HCC1419 | 6.826185 |
| HCC1428 | 6.707 |
| HCC1500 | 7.265938 |
| HCC1569 | 5.014099 |
| HCC1806 | 2.725509 |
| HCC1937 | 4.490156 |
| HCC1954 | 3.516476 |
| HCC202 | 6.812468 |
| HCC38 | 3.821732 |
| HDQP1 | 4.106369 |
| JIMT1 | 4.113162 |
| KPL1 | 2.830166 |
| MCF7 | 4.761028 |
| MDAMB134VI | 5.056164 |
| MDAMB175VII | 7.941894 |
| MDAMB231 | 3.635202 |
| MDAMB361 | 7.734985 |
| MDAMB415 | 4.447872 |
| MDAMB436 | 4.678117 |
| MDAMB453 | 6.268773 |
| MDAMB468 | 3.178351 |
| MFM223 | 3.107546 |
| SKBR3 | 2.431297 |
| SW527 | 3.012309 |
| T47D | 3.791712 |
| UACC812 | 2.710829 |
| ZR751 | 6.974679 |
| ZR7530 | 6.429155 |

Two hundred ninety-one genes (listed in Table 8) that were highly associated with in vitro drug responses were selected to develop the MGP. To understand the function of these 291 genes, we computed the overlap between these genes and the c2 collection (curated gene sets) of molecular signatures database v3.0 provided by broad institute. The p-values of each curated gene sets were calculated by Fisher's exact test. Of 291 genes used in the TFEC MGP, 68 genes were found to be related to BRCA network, and 38 genes related to CHECH2 network, and 40 genes related to Myc oncogenic transcription factor.

### Clinical Validation of TFEC MGP

A total of 192 pretreatment FNA specimens were obtained from US Oncology Research (Houston, Tex.). More than 1 μg of RNA, which was defined as the minimum requirement for total RNA for gene expression profiling, was isolated from each of 145 specimens. Of these, 95 unique specimens from 95 patients were included in the final analysis. Reasons for exclusion included low-quality RNA (n=26), failure for cRNA generation (n=12), failure to meet quality control standards for array analysis (n=8), and violation of chemotherapy treatment protocol (n=4). Of the 95 patients eligible for the study, 66 received treatment with FEC/TX and 29 received treatment with FEC/TX with H after the FNA specimens were obtained and processed for gene expression profiling.

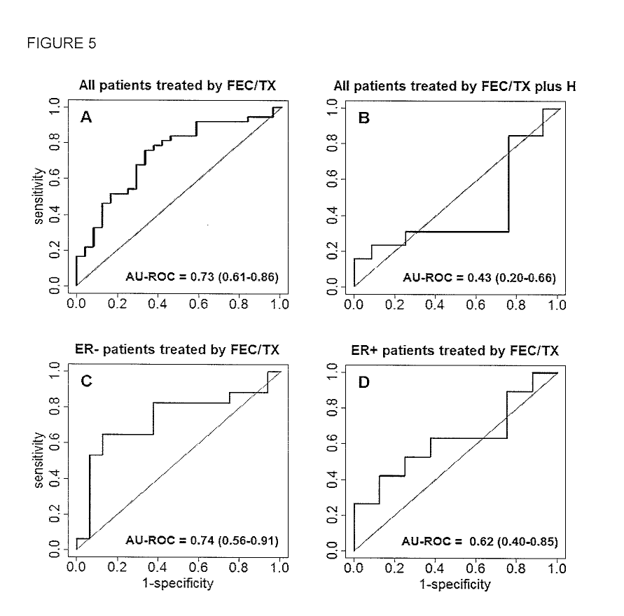

The performance of the TFEC MGP stratified by H treatment status was evaluated for predicting pCR using ROC curves (FIG. 5). The AU-ROC was 0.73 (95% CI: 0.61-0.86) for patients treated with FEC/TX and the MGP score was significantly different between pCR and RD (FIG. 5A, Wilcoxon test p<0.01). In contrast, for the FEC/TX with H group, the AU-ROC was 0.43 (95% CI: 0.20-0.66) and no difference was detected in the MGP scores between the two groups (FIG. 5B, Wilcoxon test p=0.57). We further stratified the data from the FEC/TX group based on ER status and ROC analysis resulted in AU-ROC of 0.62 (95% CI: 0.40-0.85) for the ER-positive subgroup, and 0.74 (95% CI: 0.56-0.91) for the ER-negative subgroup (FIGS. 5C and 5D), suggesting that MGP might have better performance for ER-negative tumors compared to ER-positive tumors, although this difference was not statistically significant.

Logistic regression models were also used to further assess the correlation of the TFEC MGP and pCR. Univariate analysis revealed that the MGP prediction score for the FEC/TX group was significantly associated with pCR. Multivariate analysis adjusted for the clinical covariates stage, tumor size, lymph node status, tumor grade, ER status, PR status and HER2 status indicated that MGP prediction score was more associated with pCR than other clinical covariates. However, regression analysis for the FEC/TX with H group revealed no significant association between the TFEC MGP and pCR.

### Discussion

We developed a TFEC MGP from breast cancer cell lines by incorporating cell line responses to drug treatment and their respective gene expression profiling data. Validation of this MGP using clinical data from patients enrolled in US Oncology 02-103 indicated that this cell line-based MGP was able to differentiate between patients who would experience pCR and those who would have RD as a result of neoadjuvant treatment with FEC followed by TX. This result demonstrates the feasibility of using chemoresponse data and gene expression profiling from breast cancer cell lines to predict clinical responses of patients to a specific chemotherapy treatment.

These results differ from other previous studies that developed MGPs from NCI-60 cancer cell lines [Potti A, et al. Genomic signatures to guide the use of chemotherapeutics Nat Med 2006, 12(11):1294-1300]. Our success may be attributed to the use of breast cancer cell lines rather than NCI-60 cell lines for training the data. NCI-60 cell lines include cells from different histological origins. Based on the concept that drug resistance mechanisms could be consistent across different histological origins, NCI-60 cell lines have been widely used for studying drug responses and developing drug-specific phamacogenomic predictors. However this concept may not be entirely true and it is not clear to what extent the various histological origins may confound the discovery of MGP.

It is well known that chemotherapy response in breast cancer is affected by clinical/biologic variables such as ER, PR, HER2 and tumor grade. Most of MGPs currently available tend to capture similar information as those clinical/biologic phenotypes and some of them were also able to provide additional predictive value. In particularly, it is more difficult to develop MGP in ER-negative patients. Of note, the subset analysis stratified by ER status revealed that our MGP may encode information independent of ER status.

It is notable that the MGP developed for the FEC/TX treatment arm could not predict the pCR for patients in the FEC/TX plus H treatment arm. The AU-ROC of the MGP for FEC/TX plus H arm was no better than random guess. This is a reasonable result because trastuzumab can improve the chemotherapy response for both HER2+ and HER2− patients, and our MGP did not consider the effect of trastuzumab. This result indicates that the MGP may have the potential to be regimen-specific.

The size of training data also plays a crucial role in determining the power of MGP in prediction. Liedtke et al. developed an MGP from 19 breast cancer cell lines that had an AU-ROC of approximately 0.5 [Liedtke et al., Response to neoadjuvant therapy and long-term survival in patients with triple-negative breast cancer J. Clin. Oncol. 2008, 26(8):1275-1281]. The present study involved 39 breast cancer cell lines and achieved an AU-ROC of approximately 0.7.

In summary, we used chemosensitivity and gene expression profiling data from breast cancer cell lines to generate an MGP to TFEC treatment. This MGP was validated to be predictive of clinical response in patients treated sequentially with FEC followed by TX, and particularly in tumors that are ER-negative, which typically are more biologically homogeneous and difficult to derive pharmacogenetic predictors.

TABLE 8
TFEC gene expression signature

| | | Mean | Mean | |
|---|---|---|---|---|
| | | expression | expression | Fold change |
| | | score for | score for | from |
| | Gene | sensitive | resistant | sensitive |
| Probe IDs | Symbol | samples | samples | to resistant |
| 117_at | HSPA6 | 115.7435 | 160.8848 | 0.719418 |
| 200044_at | SFRS9 | 9162.164 | 11122.64 | 0.82374 |
| 200049_at | MYST2 | 1146.791 | 2946.447 | 0.389211 |
| 200054_at | ZNF259 | 1223.51 | 690.9934 | 1.770654 |
| 200074_s_at | RPL14 | 13941.79 | 10599.6 | 1.315313 |
| 200087_s_at | TMED2 | 13327.92 | 15816.98 | 0.842634 |
| 200614_at | CLTC | 13393.41 | 18846.84 | 0.710645 |
| 200617_at | MLEC | 3070.657 | 4407.449 | 0.696697 |
| 200803_s_at | TMBIM6 | 10993.56 | 13947.74 | 0.788196 |
| 200804_at | TMBIM6 | 9514.076 | 12895.86 | 0.737762 |
| 200806_s_at | HSPD1 | 16956.88 | 12267.84 | 1.382222 |
| 200864_s_at | RAB11A | 2133.104 | 3166.506 | 0.673646 |
| 200869_at | NA | 27442.45 | 19289.36 | 1.422673 |
| 200925_at | COX6A1 | 16314.83 | 20032.21 | 0.81443 |
| 200927_s_at | RAB14 | 2708.873 | 3549.842 | 0.763097 |
| 200934_at | DEK | 13171.53 | 8930.135 | 1.474953 |
| 200956_s_at | SSRP1 | 3471.897 | 2380.275 | 1.458612 |
| 200987_x_at | PSME3 | 2777.846 | 1871.324 | 1.484428 |
| 201068_s_at | PSMC2 | 9457.255 | 7166.115 | 1.319719 |
| 201138_s_at | SSB | 3351.38 | 2467.13 | 1.358413 |
| 201144_s_at | EIF2S1 | 7515.915 | 5764.926 | 1.303731 |
| 201176_s_at | ARCN1 | 5622.616 | 3603.339 | 1.560391 |
| 201231_s_at | ENO1 | 20203.12 | 11949.24 | 1.690746 |
| 201276_at | RAB5B | 1377.776 | 1962.704 | 0.701978 |
| 201291_s_at | TOP2A | 6940.859 | 4028.309 | 1.72302 |
| 201323_at | EBNA1BP2 | 3330.056 | 1682.364 | 1.97939 |
| 201336_at | VAMP3 | 4618.832 | 3109.314 | 1.485483 |
| 201339_s_at | SCP2 | 4521.832 | 5970.388 | 0.757377 |
| 201370_s_at | CUL3 | 533.4329 | 820.3061 | 0.650285 |
| 201371_s_at | CUL3 | 5022.654 | 6067.351 | 0.827817 |
| 201443_s_at | ATP6AP2 | 8944.633 | 11079.03 | 0.807348 |
| 201503_at | G3BP1 | 6333.045 | 4541.926 | 1.394352 |
| 201646_at | SCARB2 | 1828.498 | 3594.388 | 0.508709 |
| 201647_s_at | SCARB2 | 914.4681 | 1716.978 | 0.532603 |
| 201662_s_at | ACSL3 | 3737.222 | 6139.461 | 0.608722 |
| 201698_s_at | SFRS9 | 7805.406 | 9498.678 | 0.821736 |
| 201706_s_at | PEX19 | 1379.305 | 2008.117 | 0.686865 |
| 201797_s_at | VARS | 2010.536 | 1346.282 | 1.493399 |
| 201838_s_at | SUPT7L | 181.1054 | 270.9998 | 0.668286 |
| 202026_at | SDHD | 5771.024 | 3583.361 | 1.610506 |
| 202038_at | UBE4A | 4813.61 | 3026.576 | 1.590448 |
| 202042_at | HARS | 3354.21 | 2035.718 | 1.647679 |
| 202106_at | GOLGA3 | 669.6143 | 1180.409 | 0.567273 |
| 202136_at | ZMYND11 | 4359.457 | 6660.611 | 0.654513 |
| 202137_s_at | ZMYND11 | 910.8246 | 1357.066 | 0.671172 |
| 202170_s_at | AASDHPPT | 2185.886 | 1157.782 | 1.887995 |
| 202197_at | MTMR3 | 740.5151 | 1026.37 | 0.721489 |
| 202200_s_at | SRPK1 | 4641.763 | 3000.278 | 1.547111 |
| 202249_s_at | DCAF8 | 471.6991 | 704.0207 | 0.670007 |
| 202309_at | MTHFD1 | 7517.459 | 5566.847 | 1.350398 |
| 202346_at | UBE2K | 2140.403 | 3138.997 | 0.681875 |
| 202384_s_at | TCOF1 | 660.1933 | 368.3113 | 1.792487 |
| 202385_s_at | TCOF1 | 991.3093 | 657.7641 | 1.507089 |
| 202433_at | SLC35B1 | 2917.685 | 5279.648 | 0.552629 |
| 202448_s_at | ZER1 | 251.0933 | 333.6784 | 0.752501 |
| 202521_at | CTCF | 2060.861 | 2603.676 | 0.79152 |
| 202690_s_at | SNRPD1 | 7533.303 | 4685.021 | 1.607955 |
| 202696_at | OXSR1 | 2154.489 | 1142.571 | 1.885651 |
| 202715_at | CAD | 1833.069 | 1153.737 | 1.58881 |
| 202882_x_at | NOL7 | 7024.216 | 4577.358 | 1.534557 |
| 202900_s_at | NUP88 | 2384.831 | 1400.243 | 1.703155 |
| 202955_s_at | ARFGEF1 | 934.7113 | 1619.288 | 0.577236 |
| 203023_at | NOP16 | 2093.772 | 1061.562 | 1.972351 |
| 203040_s_at | HMBS | 2347.845 | 1087.828 | 2.158287 |
| 203095_at | MTIF2 | 2614.534 | 1768.639 | 1.478275 |
| 203341_at | CEBPZ | 2462.922 | 1581.759 | 1.557077 |
| 203383_s_at | GOLGA1 | 677.7924 | 971.864 | 0.697415 |
| 203384_s_at | GOLGA1 | 380.014 | 549.7136 | 0.691294 |
| 203388_at | ARRB2 | 742.2734 | 466.2584 | 1.591979 |
| 203405_at | PSMG1 | 5107.024 | 2713.197 | 1.88229 |
| 203462_x_at | EIF3B | 8467.719 | 5831.918 | 1.451961 |
| 203492_x_at | CEP57 | 1396.224 | 771.9291 | 1.808747 |
| 203529_at | PPP6C | 3781.572 | 4742.893 | 0.797313 |
| 203622_s_at | PNO1 | 3315.894 | 2288.912 | 1.448677 |
| 203694_s_at | DHX16 | 1881.213 | 1540.109 | 1.221481 |
| 203707_at | ZNF263 | 817.4016 | 1066.827 | 0.766199 |
| 203764_at | DLGAP5 | 3164.142 | 1878.095 | 1.684761 |
| 203825_at | BRD3 | 2354.793 | 4040.837 | 0.582749 |
| 203856_at | VRK1 | 2097.84 | 1316.247 | 1.593804 |
| 203870_at | USP46 | 707.8694 | 1127.675 | 0.627724 |
| 203901_at | TAB1 | 286.1758 | 431.9597 | 0.662506 |
| 203944_x_at | BTN2A1 | 755.3709 | 529.7962 | 1.425776 |
| 204028_s_at | RABGAP1 | 1661.511 | 2483.629 | 0.668985 |
| 204175_at | ZNF593 | 1746.664 | 1235.139 | 1.414144 |
| 204228_at | PPIH | 2047.483 | 1471.701 | 1.391236 |
| 204251_s_at | CEP164 | 514.4119 | 356.7329 | 1.442008 |
| 204327_s_at | ZNF202 | 556.5402 | 371.5959 | 1.497703 |
| 204384_at | GOLGA2 | 525.491 | 782.0147 | 0.671971 |
| 204405_x_at | DIMT1L | 3052.986 | 1875.434 | 1.627882 |
| 204458_at | PLA2G15 | 409.4907 | 647.8378 | 0.632088 |
| 204640_s_at | SPOP | 1607.667 | 3295.747 | 0.4878 |
| 204690_at | STX8 | 1273.143 | 840.8007 | 1.514203 |
| 204905_s_at | EEF1E1 | 4644.546 | 2304.47 | 2.015451 |
| 204977_at | DDX10 | 1949.104 | 913.9113 | 2.132706 |
| 205176_s_at | ITGB3BP | 2101.838 | 1428.947 | 1.4709 |
| 205252_at | ZNF174 | 336.3944 | 437.0478 | 0.769697 |
| 205324_s_at | FTSJ1 | 4202.552 | 2431.21 | 1.728584 |
| 205395_s_at | MRE11A | 1410.135 | 668.0657 | 2.110773 |
| 205423_at | AP1B1 | 1122.914 | 1694.807 | 0.662562 |
| 205545_x_at | DNAJC8 | 1879.129 | 1285.085 | 1.46226 |
| 205677_s_at | DLEU1 | 1255.681 | 927.597 | 1.353693 |
| 205996_s_at | AK2 | 1018.938 | 572.9381 | 1.778443 |
| 206098_at | ZBTB6 | 326.5067 | 626.5577 | 0.521112 |
| 206174_s_at | PPP6C | 2590.332 | 3279.083 | 0.789956 |
| 206499_s_at | NA | 3202.248 | 1995.17 | 1.605 |
| 206653_at | POLR3G | 349.0509 | 163.0942 | 2.14018 |
| 206752_s_at | DFFB | 267.3757 | 136.5099 | 1.958654 |
| 206968_s_at | NFRKB | 834.1006 | 548.7964 | 1.519873 |
| 207127_s_at | HNRNPH3 | 2536.712 | 1784.935 | 1.421179 |
| 207458_at | C8orf51 | 252.6023 | 390.1452 | 0.647457 |
| 207573_x_at | ATP5L | 12868.94 | 7157.65 | 1.797928 |
| 207668_x_at | PDIA6 | 11425.04 | 8538.803 | 1.338014 |
| 208002_s_at | ACOT7 | 3896.674 | 2218.566 | 1.756393 |
| 208152_s_at | DDX21 | 6159.006 | 4031.128 | 1.527862 |
| 208398_s_at | TBPL1 | 1455.744 | 904.8625 | 1.608802 |
| 208627_s_at | YBX1 | 16334.62 | 11386.92 | 1.434507 |
| 208688_x_at | EIF3B | 9248.889 | 6289.878 | 1.47044 |
| 208696_at | CCT5 | 12958.07 | 8806.64 | 1.471398 |
| 208736_at | ARPC3 | 7943.565 | 9914.436 | 0.801212 |
| 208737_at | ATP6V1G1 | 8214.979 | 11207.68 | 0.732977 |
| 208746_x_at | ATP5L | 15091.22 | 8805.705 | 1.7138 |
| 208756_at | EIF3I | 7693.947 | 5770.094 | 1.333418 |
| 208841_s_at | G3BP2 | 4066.553 | 5554.157 | 0.732164 |
| 208897_s_at | DDX18 | 3157.994 | 2131.123 | 1.481845 |
| 208910_s_at | C1QBP | 10486.57 | 6176.669 | 1.697771 |
| 208927_at | SPOP | 1515.317 | 3400.63 | 0.445599 |
| 208959_s_at | ERP44 | 3174.715 | 2133.049 | 1.488346 |
| 209104_s_at | NHP2 | 11207.61 | 7400.507 | 1.514438 |
| 209196_at | WDR46 | 773.0434 | 478.9066 | 1.614184 |
| 209221_s_at | OSBPL2 | 503.6307 | 752.0827 | 0.669648 |
| 209333_at | ULK1 | 405.6357 | 836.6194 | 0.484851 |
| 209390_at | TSC1 | 658.0203 | 873.068 | 0.753687 |
| 209421_at | MSH2 | 2316.457 | 1678.295 | 1.380244 |
| 209630_s_at | FBXW2 | 1856.153 | 3194.777 | 0.580996 |
| 209654_at | KIAA0947 | 1764.443 | 1071.689 | 1.646414 |
| 209669_s_at | SERBP1 | 7387.272 | 4924.087 | 1.500232 |
| 209798_at | NPAT | 697.1785 | 453.1317 | 1.538578 |
| 209820_s_at | TBL3 | 927.8397 | 639.1812 | 1.451607 |
| 209862_s_at | CEP57 | 1005.628 | 581.3507 | 1.729812 |
| 210005_at | GART | 734.2607 | 402.8177 | 1.822811 |
| 210075_at | 2-Mar | 382.1707 | 693.7915 | 0.550844 |
| 210097_s_at | NOL7 | 6978.315 | 4489.217 | 1.554461 |
| 210098_s_at | NA | 241.9521 | 170.344 | 1.420374 |
| 210110_x_at | HNRNPH3 | 2127.35 | 1237.802 | 1.718651 |
| 210175_at | C2orf3 | 819.9656 | 415.0427 | 1.975617 |
| 210453_x_at | ATP5L | 14692.8 | 8695.455 | 1.68971 |
| 210466_s_at | SERBP1 | 13817.55 | 8495.895 | 1.626379 |
| 210581_x_at | PATZ1 | 274.963 | 508.161 | 0.541094 |
| 210633_x_at | KRT10 | 8886.917 | 5288.54 | 1.68041 |
| 211150_s_at | DLAT | 2600.216 | 1127.826 | 2.30551 |
| 211392_s_at | PATZ1 | 505.1098 | 1200.361 | 0.420798 |
| 211493_x_at | DTNA | 156.6095 | 261.3332 | 0.599271 |
| 211503_s_at | RAB14 | 3249.621 | 4205.631 | 0.772683 |
| 211623_s_at | FBL | 11260.83 | 7071.324 | 1.592464 |
| 211787_s_at | EIF4A1 | 19951.47 | 14284.43 | 1.396728 |
| 211979_at | GPR107 | 719.4302 | 1091.796 | 0.658942 |
| 212053_at | PDXDC1 | 2972.44 | 4712.484 | 0.630759 |
| 212068_s_at | BAT2L1 | 1369.342 | 2031.806 | 0.673953 |
| 212295_s_at | SLC7A1 | 4132.039 | 2720.654 | 1.518767 |
| 212319_at | SGSM2 | 337.5604 | 524.2509 | 0.643891 |
| 212348_s_at | KDM1A | 2220.508 | 1563.413 | 1.420296 |
| 212367_at | FEM1B | 801.3594 | 1387.24 | 0.577664 |
| 212378_at | GART | 2636.639 | 1853.351 | 1.422633 |
| 212400_at | FAM102A | 1463.942 | 3599.978 | 0.406653 |
| 212403_at | UBE3B | 720.6819 | 1096.403 | 0.657315 |
| 212404_s_at | UBE3B | 330.821 | 422.2035 | 0.783558 |
| 212518_at | PIP5K1C | 686.5707 | 983.59 | 0.698025 |
| 212547_at | BRD3 | 1443.112 | 2151.673 | 0.670693 |
| 212568_s_at | DLAT | 3384.49 | 1734.521 | 1.951253 |
| 212603_at | MRPS31 | 1170.868 | 888.1795 | 1.318279 |
| 212604_at | MRPS31 | 1649.495 | 1072.273 | 1.538317 |
| 212653_s_at | EHBP1 | 1801.29 | 1125.869 | 1.599911 |
| 212725_s_at | TUG1 | 4212.491 | 5793.129 | 0.727153 |
| 212846_at | RRP1B | 4570.108 | 2888.289 | 1.582289 |
| 212858_at | PAQR4 | 890.3623 | 1249.141 | 0.712779 |
| 212920_at | NA | 1159.801 | 1583.023 | 0.73265 |
| 213028_at | NFRKB | 856.9258 | 468.9625 | 1.82728 |
| 213097_s_at | DNAJC2 | 3147.828 | 1942.552 | 1.62046 |
| 213141_at | PSKH1 | 320.3534 | 490.7227 | 0.65282 |
| 213149_at | DLAT | 2033.226 | 987.3523 | 2.059271 |
| 213185_at | KIAA0556 | 717.9326 | 1020.674 | 0.70339 |
| 213196_at | ZNF629 | 790.2709 | 1314.819 | 0.601049 |
| 213302_at | PFAS | 985.6257 | 371.1814 | 2.655375 |
| 213473_at | BRAP | 383.3691 | 545.4516 | 0.702847 |
| 213588_x_at | RPL14 | 12521.06 | 10267.72 | 1.219458 |
| 213743_at | CCNT2 | 446.6372 | 656.4078 | 0.680426 |
| 213864_s_at | NAP1L1 | 13753.63 | 9480.823 | 1.450679 |
| 214011_s_at | NOP16 | 3143.842 | 1679.824 | 1.871531 |
| 214070_s_at | ATP10B | 201.2146 | 286.7921 | 0.701604 |
| 214138_at | ZNF79 | 122.1608 | 181.1471 | 0.674373 |
| 214209_s_at | ABCB9 | 227.6885 | 408.6881 | 0.55712 |
| 214317_x_at | RPS9 | 14390.26 | 8016.467 | 1.795088 |
| 214448_x_at | NFKBIB | 452.5948 | 322.1789 | 1.404793 |
| 215113_s_at | SENP3 | 1172.252 | 723.4552 | 1.620352 |
| 215136_s_at | EXOSC8 | 2583.367 | 1460.727 | 1.768548 |
| 215207_x_at | NA | 953.1323 | 632.3857 | 1.507201 |
| 215696_s_at | SEC16A | 3337.169 | 6268.931 | 0.532335 |
| 215728_s_at | ACOT7 | 989.4201 | 591.0173 | 1.674097 |
| 215766_at | GSTA1 | 232.347 | 315.6997 | 0.735975 |
| 215982_s_at | DOM3Z | 796.3964 | 525.539 | 1.51539 |
| 216226_at | TAF4B | 231.9066 | 160.8661 | 1.441612 |
| 216294_s_at | KIAA1109 | 247.9177 | 319.8404 | 0.77513 |
| 216326_s_at | HDAC3 | 1784.063 | 1286.286 | 1.386988 |
| 216389_s_at | DCAF11 | 767.9973 | 1069.883 | 0.717833 |
| 216961_s_at | RPAIN | 129.1827 | 76.92163 | 1.679406 |
| 217106_x_at | DIMT1L | 2869.628 | 1874.642 | 1.53076 |
| 217294_s_at | ENO1 | 17742.55 | 9893.597 | 1.793337 |
| 217445_s_at | GART | 889.0726 | 589.2969 | 1.508701 |
| 217747_s_at | RPS9 | 17269.64 | 13264.43 | 1.301952 |
| 217777_s_at | PTPLAD1 | 2463.443 | 4044.677 | 0.609058 |
| 217939_s_at | AFTPH | 1794.925 | 2376.986 | 0.755126 |
| 217994_x_at | CPSF3L | 1618.11 | 1056.148 | 1.532086 |
| 218104_at | TEX10 | 1390.295 | 932.7098 | 1.490598 |
| 218107_at | WDR26 | 4774.3 | 7057.717 | 0.676465 |
| 218155_x_at | TSR1 | 540.7369 | 391.5009 | 1.381189 |
| 218156_s_at | TSR1 | 3052.831 | 1441.476 | 2.117851 |
| 218190_s_at | UQCR10 | 13114.27 | 16200.97 | 0.809474 |
| 218244_at | NOL8 | 1563.344 | 919.849 | 1.699566 |
| 218278_at | WDR74 | 827.359 | 564.8019 | 1.464866 |
| 218333_at | DERL2 | 2137.201 | 1261.894 | 1.693645 |
| 218350_s_at | GMNN | 5065.954 | 3153.542 | 1.606433 |
| 218512_at | WDR12 | 2981.38 | 2197.331 | 1.356818 |
| 218525_s_at | HIF1AN | 470.2369 | 599.2914 | 0.784655 |
| 218527_at | APTX | 1124.797 | 1496.674 | 0.751531 |
| 218566_s_at | CHORDC1 | 4839.274 | 2626.314 | 1.842611 |
| 218580_x_at | AURKAIP1 | 6051.183 | 4431.204 | 1.365584 |
| 218597_s_at | CISD1 | 3600.918 | 2070.359 | 1.739272 |
| 218626_at | EIF4ENIF1 | 914.2403 | 1297.272 | 0.70474 |
| 218710_at | TTC27 | 1062.235 | 768.9373 | 1.381432 |
| 218754_at | NOL9 | 1502.367 | 1019.784 | 1.473221 |
| 218774_at | DCPS | 1193.406 | 660.9693 | 1.805539 |
| 218830_at | RPL26L1 | 4485.148 | 3394.633 | 1.321247 |
| 218877_s_at | TRMT11 | 1534.32 | 802.5965 | 1.911696 |
| 218886_at | PAK1IP1 | 1481.188 | 729.511 | 2.030385 |
| 218982_s_at | NA | 4813.206 | 2783.311 | 1.72931 |
| 219081_at | ANKHD1 | 1041.326 | 630.9951 | 1.650292 |
| 219086_at | ZNF839 | 315.2181 | 419.6135 | 0.75121 |
| 219098_at | MYBBP1A | 1034.593 | 701.145 | 1.475577 |
| 219122_s_at | THG1L | 503.4555 | 293.5091 | 1.715298 |
| 219220_x_at | MRPS22 | 3919.705 | 2773.158 | 1.413444 |
| 219293_s_at | OLA1 | 9726.41 | 7589.345 | 1.281588 |
| 219336_s_at | ASCC1 | 881.3802 | 611.7619 | 1.440724 |
| 219374_s_at | ALG9 | 924.3227 | 473.5073 | 1.952077 |
| 219679_s_at | WAC | 1460.09 | 2137.224 | 0.683171 |
| 219784_at | FBXO31 | 291.4867 | 165.2849 | 1.763541 |
| 220223_at | ATAD5 | 331.1321 | 231.426 | 1.430834 |
| 220255_at | FANCE | 528.5699 | 358.6645 | 1.473717 |
| 220419_s_at | USP25 | 1330.991 | 892.0542 | 1.492052 |
| 220606_s_at | C17orf48 | 369.1168 | 215.157 | 1.71557 |
| 220943_s_at | C2orf56 | 315.9343 | 172.7772 | 1.828565 |
| 220964_s_at | RAB1B | 3117.226 | 4754.226 | 0.655675 |
| 221096_s_at | TMCO6 | 684.2554 | 400.0512 | 1.710419 |
| 221158_at | C21orf66 | 756.7798 | 572.7715 | 1.32126 |
| 221230_s_at | ARID4B | 1872.991 | 2971.586 | 0.6303 |
| 221255_s_at | TMEM93 | 3588.787 | 2388.781 | 1.502351 |
| 221263_s_at | SF3B5 | 6480.339 | 4181.837 | 1.549639 |
| 221434_s_at | C14orf156 | 12412.39 | 7539.846 | 1.646239 |
| 221488_s_at | CUTA | 8889.569 | 6035.513 | 1.472877 |
| 221504_s_at | ATP6V1H | 1985.846 | 3122.422 | 0.635995 |
| 221517_s_at | MED17 | 1833.489 | 1141.791 | 1.605802 |
| 221580_s_at | TAF1D | 3586.833 | 1619.988 | 2.214111 |
| 221691_x_at | NPM1 | 18249.33 | 12330.1 | 1.480063 |
| 221699_s_at | DDX50 | 3134.898 | 2233 | 1.403895 |
| 221700_s_at | UBA52 | 18018.97 | 13894.85 | 1.29681 |
| 221712_s_at | WDR74 | 2012.179 | 1331.996 | 1.51065 |
| 221836_s_at | TRAPPC9 | 366.2582 | 610.1727 | 0.600253 |
| 221923_s_at | NPM1 | 11950.14 | 6882.591 | 1.736285 |
| 221987_s_at | TSR1 | 1058.162 | 615.5203 | 1.719134 |
| 222000_at | C1orf174 | 1776.278 | 1132.765 | 1.568091 |
| 222029_x_at | PFDN6 | 1649.205 | 961.1623 | 1.715844 |
| 222163_s_at | SPATA5L1 | 1539.103 | 1073.811 | 1.433308 |
| 222200_s_at | BSDC1 | 667.2134 | 995.3221 | 0.670349 |
| 222229_x_at | RPL26 | 10986.62 | 7642.051 | 1.437653 |
| 222244_s_at | TUG1 | 5336.587 | 7204.677 | 0.740712 |
| 33760_at | PEX14 | 956.6173 | 760.0027 | 1.258703 |
| 35436_at | GOLGA2 | 1497.479 | 2331.246 | 0.642351 |
| 37079_at | YDD19 | 467.9044 | 304.3738 | 1.537269 |
| 37831_at | SIPA1L3 | 723.9675 | 1091.681 | 0.663168 |
| 38157_at | DOM3Z | 760.3216 | 573.1502 | 1.326566 |
| 40829_at | WDTC1 | 870.4659 | 1187.746 | 0.732872 |
| 41512_at | BRAP | 227.9488 | 334.9325 | 0.680581 |
| 43977_at | TMEM161A | 1993.581 | 1429.159 | 1.394933 |
| 44563_at | WRAP53 | 1548.051 | 894.9573 | 1.729749 |
| 45526_g_at | NAT15 | 2463.246 | 3165.33 | 0.778196 |
| 46256_at | SPSB3 | 1633.875 | 2435.708 | 0.670801 |
| 46270_at | UBAP1 | 819.4812 | 1164.926 | 0.703462 |
| 50376_at | ZNF444 | 995.8318 | 1393.046 | 0.714859 |
| 56829_at | TRAPPC9 | 942.1797 | 1794.472 | 0.525046 |
| 61874_at | C9orf7 | 825.8467 | 1464.858 | 0.563773 |
| 64440_at | IL17RC | 904.1722 | 1410.434 | 0.641059 |
| 77508_r_at | RABEP2 | 495.5632 | 765.0419 | 0.64776 |

### Example 3

### Identification and Validation of AC and ACT MultiGene Predictor (MGP)

### Methods

### Development of the Genomic Predictors

Forty-two breast cancer cell lines were treated with the combination of doxorubicin (A) and an active metabolite of cyclophosphamide (C) or the combination of A, C, and docetaxel (T) as already described. In vitro chemoresponse was measured as described herein. Briefly, cell growth inhibition was evaluated at 10 concentrations of combination AC or ACT and a dose-response curve was established. The area under the curve (AUC) was calculated to quantify the sensitivity of each cell line to the treatment; a lower AUC score indicates greater sensitivity. Gene expression profile data for these 42 cell lines were downloaded from the Gene Expression Omnibus database (GSE12777). The MGP for AC (MGP-AC) and the MGP for ACT (MGP-ACT) were separately developed using supervised principal components regressions. By this method, a lower MGP score corresponds to a greater sensitivity to chemotherapy, and therefore a higher likelihood of achieving treatment response.

### Clinical Validation of the MGPs

The MGP-AC and MGP-ACT were evaluated using the patients enrolled in the NSABP B-27 protocol. B-27 was a phase III trial to determine the effect of adding docetaxel (T) to preoperative doxorubicin and cyclophosphamide (AC) on clinical outcomes of women with operable primary breast cancer. Patients were allocated to receive either four cycles of AC followed surgery (group I: AC), or four cycles of AC followed by four cycles of docetaxel, and then surgery (group II: AC+T), or four cycles of AC followed by surgery and then four cycles of postoperative T (group III: AC→T). The endpoints included pathologic complete response (pCR), disease-free survival (DFS), and overall survival (OS). pCR was defined as no invasive cancer in the breast at surgery by the end of preoperative chemotherapy; DFS was calculated from the time of randomization until disease progression (any local, regional or distant recurrence, any clinically inoperable and residual disease at surgery, or any contralateral breast cancer, second cancer, or death); and OS was calculated from the time of randomization until death from any cause. The addition of preoperative T after preoperative AC significantly increased pCR (26% vs. 14%) and slightly improved DFS, but did not affect OS. The women enrolled in the B-27 study gave written consent for translational research, and gene expression profiles from formalin-fixed, paraffin-embedded (FFPE) tissues were obtained using the Affymetrix HG-U133A microarray platform (Affymetrix, Santa Clara, Calif.) for a subset of patients. The two genomic predictors were developed by Precision Therapeutics, Inc., and the clinical validation was independently conducted by NSABP.

To determine the ability to predict pCR, MGP-AC was evaluated in group I and III patients, and MGP-ACT in group II patients. To determine the ability to predict DFS and OS, MGP-AC was evaluated in group I patients, and MGP-ACT in group II and III patients. A logistic regression model was employed to assess the associations of the MGPs with pCR adjusted for age, tumor size (>4.0 cm vs. ≦4.0 cm), clinical node (positive vs. negative), and estrogen receptor status (ER+ vs. ER−). Receiver operator characteristics (ROC) curves were also plotted to evaluate prediction performance. The area under the ROC curve (AU-ROC) was calculated from the c-statistic to represent the predictive accuracy. An optimal classification of MGP-score for prediction was also explored based on the maximum of the sum of sensitivity and specificity. The pCR rate for patients classified as high-response was compared with the rate for those classified as low-response using Chi-square test. The associations of MGPs with DFS and OS were assessed using a Cox proportional hazards model by controlling for age, tumor size, clinical node, and ER status.

### Results

A total of 322 patients with available microarray data (103 treated by AC, 102 by AC+T and 117 by AC→T) were included in this analysis. The patient characteristics of this study population were similar to those reported in the parent NSABP B-27 protocol.

Patient Clinical Characteristics and Outcomes

| | Group I | Group II | Group III |
|---|---|---|---|
| | Pre-OpAC | Pre-OpAC + T | Pre-OpAC + Post-Op T |
| | (AC) | (AC + T) | (AC→T) |
| | (n = 103) | (n = 102) | (n = 117) |
| Age (years) | | | |
| <50 | 59 (57.3) | 57 (55.9) | 63 (53.9) |
| ≧50 | 44 (42.7) | 45 (44.1) | 54 (46.1) |
| Median (range) | 48.0 | 48.5 | 48.0 |
| | (21.0-79.0) | (30.0-74.0) | (23.0-70.0) |
| Clinical | | | |
| tumor size | | | |
| ≦4.0 | 65 (63.1) | 60 (58.8) | 80 (68.4) |
| >4.0 | 38 (36.9) | 42 (41.2) | 37 (31.6) |
| Clinical node | | | |
| Negative | 76 (73.8) | 68 (66.7) | 90 (76.9) |
| Positive | 27 (26.2) | 34 (33.3) | 27 (23.1) |
| ER | | | |
| Negative | 31 (30.1) | 31 (30.4) | 35 (29.9) |
| Positive | 65 (63.1) | 67 (65.7) | 80 (68.4) |
| Unknown | 7 (6.8) | 4 (3.9) | 2 (1.7) |
| pCR | | | |
| No | 90 (87.4) | 77 (75.5) | 105 (89.7) |
| Yes | 13 (12.6) | 25 (24.5) | 12 (10.3) |

Neither MGP-AC nor MGP-ACT was associated with patient age, clinical tumor size, or lymph node status. However, both MGPs were associated with ER status; ER− patients showed significantly lower scores than ER+ patients (p<0.0001).

MGP Scores by Patient Characteristics

| | MGP-AC | | MGP-ACT | |
|---|---|---|---|---|
| | Mean (SD) | P | Mean (SD) | P |
| Age | | 0.160 | | 0.213 |
| (years) | | | | |
| <50 | 0.05999 (0.04420) | | 0.05293 (0.04290) | |
| ≧50 | 0.06694 (0.04377) | | 0.05887 (0.04176) | |
| Tumor | | 0.363 | | 0.534 |
| size | | | | |
| ≦4.0 | 0.06477 (0.04300) | | 0.05668 (0.04176) | |
| >4.0 | 0.06011 (0.04594) | | 0.05362 (0.04370) | |
| Clinical | | 0.804 | | 0.734 |
| node | | | | |
| Negative | 0.06270 (0.04511) | | 0.05508 (0.04282) | |
| Positive | 0.06407 (0.04142) | | 0.05688 (0.04162) | |
| ER | | <0.0001 | | <0.0001 |
| Negative | 0.02189 (0.04339) | | 0.01641 (0.04118) | |
| Positive | 0.08244 (0.02988) | | 0.07426 (0.02922) | |
| All | 0.06308 (0.04408) | | 0.05557 (0.04244) | |
| patients | | | | |

### MGP for AC

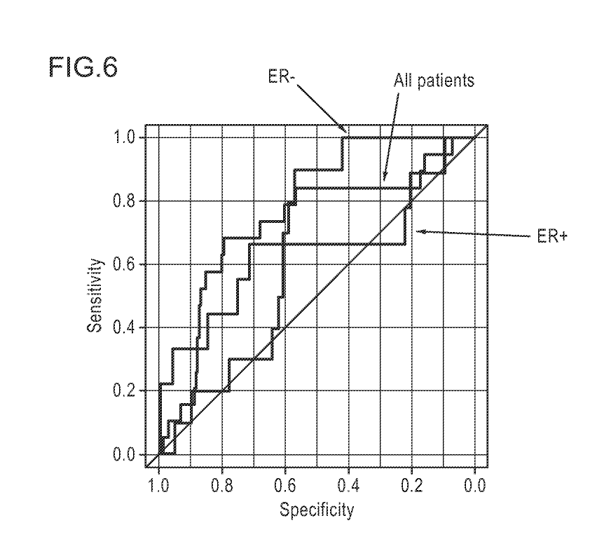

MGP-AC was generated based on 417 probe sets (Table 9). The ability of MGP-AC to predict pCR was validated using data from the 220 women who received pre-operative AC (group I and II). In this group of patients, 25 (11.4%) achieved pCR. By univariate analysis, ER status and MGP-AC were the two factors significantly associated with the response. Specifically, patients with ER+tumors (OR=0.33, 95% CI=0.14-0.82, p=0.016) or high MGP-AC score (OR=0.45, 95% CI=0.30-0.68, p=0.0002) were less likely to achieve pCR. In multivariate analysis, MGP-AC remained the only independent predictor of pCR independent of ER status, tumor size, lymph node status, and age (OR=0.49, 95% CI=0.27-0.88, p=0.017). The accuracy of the prediction was also illustrated using the ROC analysis, with an AU-ROC of 0.75 (95% CI=0.64-0.86) (FIG. 6). There is an indication that the prediction could be more accurate in ER negative compared to ER positive patients (AU-ROC: 0.71 vs. 0.63) (FIG. 6). An optimal classification resulted in a sensitivity of 0.72 and a specificity of 0.80, and the pCR rate was 31% in patients predicted by the MGP-AC as high-response compared with 4% in those predicted as low-response

MGP-AC in prediction of pCR based on optimal cutoff

| | pCR | | |
|---|---|---|---|
| MGP Prediction | Yes | No | |
| Response | 18 | 40 | PPV = 0.31 |
| Non-response | 7 | 155 | NPV = 0.96 |
| | Sensitivity = 0.72 | Specificity = 0.80 | |

The ability of MGP-AC to predict disease free survival (DFS) or overall survival (OS) was assessed on 103 patients treated with AC (group I). There was no relationship identified from univariate analysis. However, after adjusting for clinical covariates (ER status, clinical tumor size, lymph node status, and age), a higher MGP-AC score was significantly associated with an increased risk for disease progression (HR=1.48, 95% confidence interval [CI]=1.02-2.15, p=0.040) or death (HR=1.66, 95% CI=1.06-2.62, p=0.028). By adding MGP-AC to the clinical model, the accuracy for predicting 5-year DFS was improved from 63% to 72%. The DFS and OS based on the cut-off obtained above were also evaluated, and there were no differences in survival functions for high- vs. low-response group.

Association of MGP-AC with pCR, DFS and OS

| | pCR | | DFS | | OS | |
|---|---|---|---|---|---|---|
| | (Group I and Group III) | | (Group II) | | (Group II) | |
| MGP-AC | Univariate | Multivariate | Univariate | Multivariate | Univariate | Multivariate |
| Age (years) | 0.81 | 0.98 | 1.59 | 1.73 | 1.68 | 1.95 |
| (≧50 vs <50 yrs) | (0.35-1.89) | (0.38-2.53) | (0.81-3.12) | (0.81-3.70) | (0.75-3.76) | (0.77-4.98) |
| Tumor Size | 1.10 | 0.86 | 1.56 | 1.44 | 2.18 | 2.18 |
| (>4 vs ≦4 cm) | (0.46-2.62) | (0.33-2.29) | (0.79-3.06) | (0.69-3.02) | (0.97-4.86) | (0.89-5.32) |
| Node | 0.75 | 0.68 | 1.74 | 2.01 | 1.93 | 2.28 |
| (Pos vs Neg) | (0.27-2.09) | (0.20-2.24) | (0.86-3.52) | (0.92-4.36) | (0.84-4.41) | (0.89-5.83) |
| ER | 0.33 | 0.84 | 0.69 | 0.41 | 0.64 | 0.39 |
| (Pos vs Neg) | (0.14-0.82) | (0.23-2.99) | (0.34-1.41) | (0.17-0.98) | (0.27-1.49) | (0.15-1.06) |
| MGP (inc 1 | 0.45 | 0.49 | 1.24 | 1.48 | 1.34 | 1.66 |
| std) | (0.30-0.68) | (0.27-0.88) | (0.88-1.74) | (1.02-2.15) | (0.88-2.05) | (1.06-2.62) |

### MGP for ACT

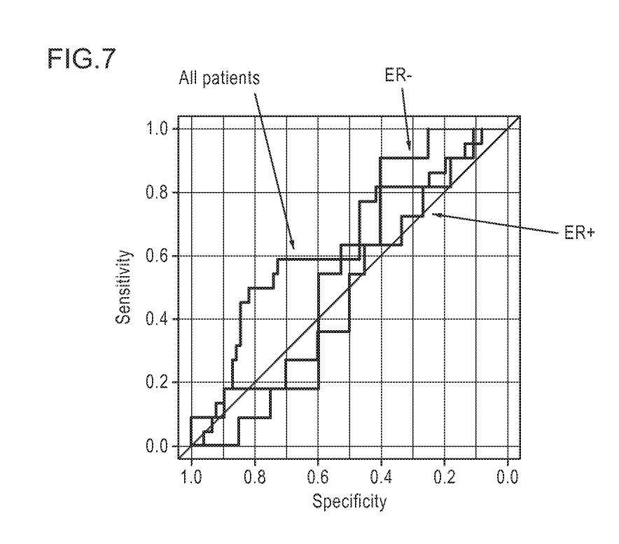

MGP for ACT was generated based on 438 probe sets (Table 10). The ability of MGP-ACT to predict chemotherapy response was evaluated using data from 102 women who received pre-operative AC+T (group II). In this group of patients, 25 (24.5%) achieved pCR. By univariate analysis, patients with higher MGP-ACT scores (OR=0.62. 95% CI=0.39-0.99, p=0.044) were less likely to achieve pCR; however, the association was no longer significant after adjusting for ER status and other clinical factors (OR=0.79, 95% CI=0.38-1.64, p=0.528). These results were also supported by the ROC analysis (FIG. 7). Similarly, there was no evidence that MGP-ACT predicted either DFS(HR=1.03, 95% CI=0.78-1.37, p=0.817) or OS(HR=1.05, 95% CI=0.73-1.51, p=0.799) among patients treated with AC+T (group I) or ACàT (group III).

Association of MGP-ACT with pCR, DFS and OS

| | pCR | | DFS | | OS | |
|---|---|---|---|---|---|---|
| | (Group I and Group III) | | (Group II) | | (Group II) | |
| MGP-ACT | Univariate | Multivariate | Univariate | Multivariate | Univariate | Multivariate |
| Age (years) | 0.80 | 0.64 | 1.22 | 1.26 | 1.07 | 1.16 |
| (≧50 vs <50 yrs) | (0.32-2.00) | (0.23-1.78) | (0.80-1.85) | (0.83-1.93) | (0.61-1.88) | (0.65-2.06) |
| Tumor Size | 0.47 | 0.50 | 2.07 | 2.00 | 2.07 | 2.01 |
| (>4 vs ≦4 cm) | (0.18-1.25) | (0.18-1.45) | (1.36-3.16) | (1.31-3.06) | (1.18-3.63) | (1.13-3.57) |
| Node | 1.47 | 1.63 | 1.32 | 1.22 | 1.53 | 1.33 |
| (Pos vs Neg) | (0.58-3.75) | (0.58-4.59) | (0.84-2.08) | (0.77-1.93) | (0.85-2.75) | (0.73-2.42) |
| ER | 0.36 | 0.48 | 0.63 | 0.64 | 0.37 | 0.36 |
| (Pos vs Neg) | (0.13-0.95) | (0.11-2.15) | (0.41-0.98) | (0.36-1.14) | (0.21-0.64) | (0.17-0.76) |
| MGP (inc 1 | 0.62 | 0.79 | 0.92 | 1.03 | 0.78 | 1.05 |
| std) | (0.39-0.99) | (0.38-1.64) | (0.74-1.14) | (0.78-1.37) | (0.58-1.03) | (0.73-1.51) |

### Discussion

Using 42 breast cancer cell lines, their publicly available gene expression profile data, and an in vitro chemoresponse assay, we derived MGPs for AC and ACT. Blinded evaluation of these MGPs with clinical response data from 322 patients participating in the NSABP B-27 phase III clinical trial indicated that breast cancer cell line-derived MGPs have the ability to predict both short and long term clinical outcomes. Specifically, the MGP for AC predicted pCR with an accuracy or 75%. MGP for ACT might also be able to predict pCR or survival.

We have taken advantage of the increasing availability of breast cancer specific cell lines. In the current study, MGPs were developed from 42 breast cancer cell lines. Our results show that MGP-AC was predictive of pCR based on both univariate and multivariate analysis, and was predictive of DFS and OS in multivariate analysis. Although patients who achieve pCR by the end of neoadjuvant chemotherapy are more likely to have a longer DFS or OS, it is frequently observed that a gene signature positively associated with pCR may not correlate with, or even negatively correlate with, survival. This phenomenon is usually caused by the confounding effects of various biologic or clinical factors. For example, tumors with ER-negative status, poor differentiation, or high proliferation are more sensitive to chemotherapy, but all of these features are also unfavorable prognostic factors associated with poor survival. Therefore, the true function of a pharmacogenomic predictor of DFS or OS can only be illustrated with a large sample size after controlling for these confounders.

An important concern of cell line-derived predictors is whether they have similar performance as tumor-derived MGPs. Conceptually, tumor-derived MGPs might be more accurate than cell line-derived predictors. However, the accuracy of tumor derived MGPs is significantly reduced by unreliable assessment of clinical outcomes and the disparity between protocols used for training and validation cohorts. In contrast, as in the current study, cell lines were grown under identical conditions, and assays were performed in a well-controlled system. Considering the advantages and disadvantages of the two approaches, we suggest that cell line-derived MGPs may perform as well as tumor-derived MGPs.

Various histologic and pathologic factors, including ER, PR, HR, and grade are known to be significantly related to drug response. Although our MGP-AC was significantly associated with ER status, it predicted pCR in both ER− and ER+ patients, indicating that it contains more predictive information than ER status regarding chemosensitivity. Bioinformatic functional analysis indicates that genes in MGP-AC are involved in a large number of functions, including cell cycle, cell death, cellular growth and proliferation, cell signaling, drug metabolism, and lipid metabolism.

Canonical pathways identified by IPA associated with MGP-AC

| Ingenuity Canonical | −log | | |
|---|---|---|---|
| Pathways | (p-value) | Ratio | Molecules |
| Protein | 3.710 | 5.11E−02 | USP21, ANAPC2, USP28, |
| Ubiquitination | | | USP38, UBE3B, HSPA5, |
| Pathway | | | DNAJB14, DNAJC11, |
| | | | DNAJC5, CBL, DNAJC8, |
| | | | USP46, PSMC2, USP25 |
| Fcγ | 1.600 | 4.90E−02 | ACTR3, CBL, VAMP3, |
| Receptor-mediated | | | RAB11A, ARPC3 |
| Phagocytosis in | | | |
| Macrophages and | | | |
| Monocytes | | | |
| Aminoacyl-tRNA | 1.600 | 3.85E−02 | EARS2, DARS, HARS |
| Biosynthesis | | | |
| Alanine and | 1.530 | 3.66E−02 | ADSL, DLAT, DARS |
| Aspartate | | | |
| Metabolism | | | |
| RAN Signaling | 1.480 | 8.70E−02 | KPNB1, RANBP2 |
| Endoplasmic | 1.380 | 1.11E−01 | HSPA5, EIF2AK3 |
| Reticulum | | | |
| Stress Pathway | | | |
| NRF2-mediated | 1.380 | 3.63E−02 | CUL3, DNAJC5, DNAJC8, |
| Oxidative | | | DNAJB14, EIF2AK3, |
| Stress Response | | | PTPLAD1, DNAJC11 |
| Purine Metabolism | 1.370 | 2.30E−02 | ADSL, KIF1B, ATP5L, |
| | | | ATP6V1G1, PSMC2, AK2, |
| | | | HSPA5, GART, PDE6D |

Further support of the utility of cell line-derived MGPs is evidenced in the ability of the currently described MGP-AC to predict clinical outcome in ER− patients, an historically difficult task because of the more molecularly homogeneous ER− tumors. An additional advantage to the current approach is the use of FFPE tumor samples. Since FFPE tissue is easily obtained and has been the standard for tumor archiving, the genomic predictors based on this platform will be more clinically useful.

The lower predictive ability of MGP-ACT for clinical outcomes may in part be the result of the disparity between how it was developed and how the patients were treated. MGP-ACT was developed by testing the combination of three drugs (A, C, T) concurrently in vitro, whereas the patients were treated sequentially with 4 cycles of AC followed by 4 cycles of T. Although our exploratory approach of mathematically generating an MGP for AC+T yielded a slightly improved predictive ability, the far more complex mechanisms of drug synergy in vivo than in vitro remain a challenge in developing MGPs for sequential chemotherapy treatments.

In summary, by taking advantage of the increasing number of breast cancer-specific cell lines, the large number of breast cancer patients participating in a phase III clinical trial in which long term outcomes were recorded and tumor samples were available for uniform genetic profiling, and a validated in vitro chemoresponse assay, we were able to demonstrate that breast cancer cell line-derived MGPs can predict short and long term patient outcomes.

TABLE 9
Gene signature for sensitivity to AC

| Probe ID | Gene Symbol | Entrez Gene Name | Location | Type(s) |
|---|---|---|---|---|
| 1553690_at | SGOL1 | shugoshin-like 1 (S. pombe) | Nucleus | other |
| 1553990_at | C16orf79 | chromosome 16 open | unknown | enzyme |
| | | reading frame 79 | | |
| 1554082_a_at | NOL9 | nucleolar protein 9 | Nucleus | other |
| 1554213_at | ARHGEF10 | Rho guanine nucleotide | Cytoplasm | peptidase |
| | | exchange factor (GEF) | | |
| | | 10 | | |
| 1554600_s_at | LMNA | lamin A/C | Nucleus | other |
| 1554677_s_at | CMTM4 | CKLF-like MARVEL | Extracellular | cytokine |
| | | transmembrane domain | Space | |
| | | containing 4 | | |
| 1555015_a_at | ZNF398 | zinc finger protein 398 | Nucleus | transcription |
| | | | | regulator |
| 1555399_a_at | DUSP16 | dual specificity | Nucleus | phosphatase |
| | | phosphatase 16 | | |
| 1555500_s_at | SLC2A4RG | SLC2A4 regulator | Cytoplasm | transcription |
| | | | | regulator |
| 1555803_a_at | C11orf57 | chromosome 11 open | unknown | other |
| | | reading frame 57 | | |
| 1555897_at | KDM1A | lysine (K)-specific | Nucleus | enzyme |
| | | demethylase 1A | | |
| 1555982_at | ZFYVE16 | zinc finger, FYVE | Nucleus | transporter |
| | | domain containing 16 | | |
| 1558044_s_at | EXOSC6 | exosome component 6 | Nucleus | other |
| 1558953_s_at | CEP164 | centrosomal protein | Cytoplasm | other |
| | | 164 kDa | | |
| 1559893_at | CCDC75 | coiled-coil domain | unknown | other |
| | | containing 75 | | |
| 1564911_at | SNHG4 | small nucleolar RNA | unknown | other |
| | | host gene 4 (non-protein | | |
| | | coding) | | |
| 1568877_a_at | ACBD5 | acyl-CoA binding | unknown | other |
| | | domain containing 5 | | |
| 1569867_at | EME2 | essential meiotic | unknown | other |
| | | endonuclease 1 homolog | | |
| | | 2 (S. pombe) | | |
| 200035_at | CTDNEP1 | CTD nuclear envelope | Extracellular | phosphatase |
| | | phosphatase 1 | Space | |
| 200044_at | SRSF9 | serine/arginine-rich | Nucleus | enzyme |
| | | splicing factor 9 | | |
| 200054_at | ZNF259 | zinc finger protein 259 | Nucleus | other |
| 200074_s_at | RPL14 | ribosomal protein L14 | Cytoplasm | other |
| 200617_at | MLEC | malectin | Plasma | other |
| | | | Membrane | |
| 200794_x_at | DAZAP2 | DAZ associated protein 2 | Nucleus | other |
| 200803_s_at | TMBIM6 | transmembrane BAX | Nucleus | other |
| | | inhibitor motif | | |
| | | containing 6 | | |
| 200804_at | TMBIM6 | transmembrane BAX | Nucleus | other |
| | | inhibitor motif | | |
| | | containing 6 | | |
| 200836_s_at | MAP4 | microtubule-associated | Cytoplasm | other |
| | | protein 4 | | |
| 200858_s_at | RPS8 | ribosomal protein S8 | Cytoplasm | other |
| 200861_at | CNOT1 | CCR4-NOT | Cytoplasm | other |
| | | transcription complex, | | |
| | | subunit 1 | | |
| 200864_s_at | RAB11A | RAB11A, member RAS | Cytoplasm | enzyme |
| | | oncogene family | | |
| 200925_at | COX6A1 | cytochrome c oxidase | Cytoplasm | enzyme |
| | | subunit VIa polypeptide 1 | | |
| 200934_at | DEK | DEK oncogene | Nucleus | transcription |
| | | | | regulator |
| 200941_at | HSBP1 | heat shock factor | Nucleus | transcription |
| | | binding protein 1 | | regulator |
| 200969_at | SERP1 | stress-associated | Cytoplasm | other |
| | | endoplasmic reticulum | | |
| | | protein 1 | | |
| 201064_s_at | PABPC4 | poly(A) binding protein, | Cytoplasm | other |
| | | cytoplasmic 4 (inducible | | |
| | | form) | | |
| 201174_s_at | TERF2IP | telomeric repeat binding | Nucleus | other |
| | | factor 2, interacting | | |
| | | protein | | |
| 201176_s_at | ARCN1 | archain 1 | Cytoplasm | other |
| 201231_s_at | ENO1 | enolase 1, (alpha) | Cytoplasm | transcription |
| | | | | regulator |
| 201276_at | RAB5B | RAB5B, member RAS | Cytoplasm | enzyme |
| | | oncogene family | | |
| 201285_at | MKRN1 | makorin ring finger | unknown | other |
| | | protein 1 | | |
| 201323_at | EBNA1BP2 | EBNA1 binding protein 2 | Nucleus | other |
| 201336_at | VAMP3 | vesicle-associated | Plasma | other |
| | | membrane protein 3 | Membrane | |
| | | (cellubrevin) | | |
| 201370_s_at | CUL3 | cullin 3 | Nucleus | enzyme |
| 201371_s_at | CUL3 | cullin 3 | Nucleus | enzyme |
| 201443_s_at | ATP6AP2 | ATPase, H+ | Cytoplasm | transporter |
| | | transporting, lysosomal | | |
| | | accessory protein 2 | | |
| 201499_s_at | USP7 | ubiquitin specific | Nucleus | peptidase |
| | | peptidase 7 (herpes | | |
| | | virus-associated) | | |
| 201503_at | G3BP1 | GTPase activating | Nucleus | enzyme |
| | | protein (SH3 domain) | | |
| | | binding protein 1 | | |
| 201623_s_at | DARS | aspartyl-tRNA | Cytoplasm | enzyme |
| | | synthetase | | |
| 201646_at | SCARB2 | scavenger receptor class | Plasma | other |
| | | B, member 2 | Membrane | |
| 201698_s_at | SRSF9 | serine/arginine-rich | Nucleus | enzyme |
| | | splicing factor 9 | | |
| 201712_s_at | RANBP2 | RAN binding protein 2 | Nucleus | enzyme |
| 201716_at | SNX1 | sorting nexin 1 | Cytoplasm | transporter |
| 201776_s_at | KIAA0494 | KIAA0494 | unknown | other |
| 201886_at | DCAF11 | DDB1 and CUL4 | unknown | other |
| | | associated factor 11 | | |
| 201892_s_at | IMPDH2 | IMP (inosine 5′- | Cytoplasm | enzyme |
| | | monophosphate) | | |
| | | dehydrogenase 2 | | |
| 201972_at | ATP6V1A | ATPase, H+ | Cytoplasm | transporter |
| | | transporting, lysosomal | | |
| | | 70 kDa, V1 subunit A | | |
| 201990_s_at | CREBL2 | cAMP responsive | Nucleus | transcription |
| | | element binding protein- | | regulator |
| | | like 2 | | |
| 201993_x_at | HNRPDL | heterogeneous nuclear | Nucleus | other |
| | | ribonucleoprotein D-like | | |
| 202026_at | SDHD | succinate | Cytoplasm | enzyme |
| | | dehydrogenase complex, | | |
| | | subunit D, integral | | |
| | | membrane protein | | |
| 202042_at | HARS | histidyl-tRNA | Cytoplasm | enzyme |
| | | synthetase | | |
| 202076_at | BIRC2 | baculoviral IAP repeat | Cytoplasm | other |
| | | containing 2 | | |
| 202106_at | GOLGA3 | golgin A3 | Cytoplasm | transporter |
| 202136_at | ZMYND11 | zinc finger, MYND-type | Nucleus | other |
| | | containing 11 | | |
| 202137_s_at | ZMYND11 | zinc finger, MYND-type | Nucleus | other |
| | | containing 11 | | |
| 202144_s_at | ADSL | adenylosuccinate lyase | Cytoplasm | enzyme |
| 202170_s_at | AASDHPPT | aminoadipate- | Cytoplasm | enzyme |
| | | semialdehyde | | |
| | | dehydrogenase- | | |
| | | phosphopantetheinyl | | |
| | | transferase | | |
| 202204_s_at | AMFR | autocrine motility factor | Plasma | transmembrane |
| | | receptor | Membrane | receptor |
| 202302_s_at | RSRC2 | arginine/serine-rich | unknown | other |
| | | coiled-coil 2 | | |
| 202384_s_at | TCOF1 | Treacher Collins- | Nucleus | transporter |
| | | Franceschetti syndrome 1 | | |
| 202385_s_at | TCOF1 | Treacher Collins- | Nucleus | transporter |
| | | Franceschetti syndrome 1 | | |
| 202428_x_at | DBI | diazepam binding | Cytoplasm | other |
| | | inhibitor (GABA | | |
| | | receptor modulator, acyl- | | |
| | | CoA binding protein) | | |
| 202433_at | SLC35B1 | solute carrier family 35, | Cytoplasm | transporter |
| | | member B1 | | |
| 202452_at | ZER1 | zer-1 homolog (C. elegans) | unknown | enzyme |
| 202521_at | CTCF | CCCTC-binding factor | Nucleus | transcription |
| | | (zinc finger protein) | | regulator |
| 202636_at | RNF103 | ring finger protein 103 | Cytoplasm | enzyme |
| 202690_s_at | SNRPD1 | small nuclear | Nucleus | other |
| | | ribonucleoprotein D1 | | |
| | | polypeptide 16 kDa | | |
| 202696_at | OXSR1 | oxidative-stress | Nucleus | kinase |
| | | responsive 1 | | |
| 202713_s_at | KIAA0391 | KIAA0391 | unknown | other |
| 202715_at | CAD | carbamoyl-phosphate | Cytoplasm | enzyme |
| | | synthetase 2, aspartate | | |
| | | transcarbamylase, and | | |
| | | dihydroorotase | | |
| 202852_s_at | AAGAB | alpha- and gamma- | Cytoplasm | other |
| | | adaptin binding protein | | |
| 202882_x_at | NOL7 | nucleolar protein 7, | Nucleus | other |
| | | 27 kDa | | |
| 202884_s_at | PPP2R1B | protein phosphatase 2, | unknown | phosphatase |
| | | regulatory subunit A, | | |
| | | beta | | |
| 203040_s_at | HMBS | hydroxymethylbilane | Cytoplasm | enzyme |
| | | synthase | | |
| 203051_at | BAHD1 | bromo adjacent | Nucleus | other |
| | | homology domain | | |
| | | containing 1 | | |
| 203089_s_at | HTRA2 | HtrA serine peptidase 2 | Cytoplasm | peptidase |
| 203119_at | CCDC86 | coiled-coil domain | Nucleus | other |
| | | containing 86 | | |
| 203160_s_at | RNF8 | ring finger protein 8 | Nucleus | enzyme |
| 203230_at | DVL1 | dishevelled, dsh | Cytoplasm | other |
| | | homolog 1 (Drosophila) | | |
| 203341_at | CEBPZ | CCAAT/enhancer | Nucleus | other |
| | | binding protein (C/EBP), | | |
| | | zeta | | |
| 203383_s_at | GOLGA1 | golgin A1 | Cytoplasm | other |
| 203384_s_at | GOLGA1 | golgin A1 | Cytoplasm | other |
| 203405_at | PSMG1 | proteasome (prosome, | Plasma | other |
| | | macropain) assembly | Membrane | |
| | | chaperone 1 | | |
| 203492_x_at | CEP57 | centrosomal protein | Cytoplasm | other |
| | | 57 kDa | | |
| 203614_at | UTP14C | UTP14, U3 small | Nucleus | other |
| | | nucleolar | | |
| | | ribonucleoprotein, | | |
| | | homolog C (yeast) | | |
| 203622_s_at | PNO1 | partner of NOB1 | Nucleus | other |
| | | homolog (S. cerevisiae) | | |
| 203693_s_at | E2F3 | E2F transcription factor 3 | Nucleus | transcription |
| | | | | regulator |
| 203764_at | DLGAP5 | discs, large (Drosophila) | Nucleus | phosphatase |
| | | homolog-associated | | |
| | | protein 5 | | |
| 203825_at | BRD3 | bromodomain | Nucleus | kinase |
| | | containing 3 | | |
| 203831_at | R3HDM2 | R3H domain containing 2 | Nucleus | other |
| 203870_at | USP46 | ubiquitin specific | unknown | peptidase |
| | | peptidase 46 | | |
| 203944_x_at | BTN2A1 | butyrophilin, subfamily | Plasma | other |
| | | 2, member A1 | Membrane | |
| 204067_at | SUOX | sulfite oxidase | Cytoplasm | enzyme |
| 204144_s_at | PIGQ | phosphatidylinositol | Cytoplasm | enzyme |
| | | glycan anchor | | |
| | | biosynthesis, class Q | | |
| 204194_at | BACH1 | BTB and CNC | Nucleus | transcription |
| | | homology 1, basic | | regulator |
| | | leucine zipper | | |
| | | transcription factor 1 | | |
| 204251_s_at | CEP164 | centrosomal protein | Cytoplasm | other |
| | | 164 kDa | | |
| 204315_s_at | GTSE1 | G-2 and S-phase | Cytoplasm | other |
| | | expressed 1 | | |
| 204327_s_at | ZNF202 | zinc finger protein 202 | Nucleus | transcription |
| | | | | regulator |
| 204405_x_at | DIMT1L | DIM1 | Cytoplasm | enzyme |
| | | dimethyladenosine | | |
| | | transferase 1-like (S. cerevisiae) | | |
| 204690_at | STX8 | syntaxin 8 | Plasma | other |
| | | | Membrane | |
| 204791_at | NR2C1 | nuclear receptor | Nucleus | transcription |
| | | subfamily 2, group C, | | regulator |
| | | member 1 | | |
| 204905_s_at | EEF1E1 | eukaryotic translation | Cytoplasm | translation |
| | | elongation factor 1 | | regulator |
| | | epsilon 1 | | |
| 204977_at | DDX10 | DEAD (Asp-Glu-Ala- | Nucleus | enzyme |
| | | Asp) box polypeptide 10 | | |
| 205176_s_at | ITGB3BP | integrin beta 3 binding | Nucleus | other |
| | | protein (beta3- | | |
| | | endonexin) | | |
| 205202_at | PCMT1 | protein-L-isoaspartate | Cytoplasm | enzyme |
| | | (D-aspartate) O- | | |
| | | methyltransferase | | |
| 205203_at | PLD1 | phospholipase D1, | Cytoplasm | enzyme |
| | | phosphatidylcholine- | | |
| | | specific | | |
| 205252_at | ZNF174 | zinc finger protein 174 | Nucleus | transcription |
| | | | | regulator |
| 205996_s_at | AK2 | adenylate kinase 2 | Cytoplasm | kinase |
| 206098_at | ZBTB6 | zinc finger and BTB | Nucleus | other |
| | | domain containing 6 | | |
| 206452_x_at | PPP2R4 | protein phosphatase 2A | Cytoplasm | phosphatase |
| | | activator, regulatory | | |
| | | subunit 4 | | |
| 206636_at | RASA2 | RAS p21 protein | Cytoplasm | other |
| | | activator 2 | | |
| 206653_at | POLR3G | polymerase (RNA) III | Nucleus | enzyme |
| | | (DNA directed) | | |
| | | polypeptide G (32 kD) | | |
| 207112_s_at | GAB1 | GRB2-associated | Cytoplasm | other |
| | | binding protein 1 | | |
| 207127_s_at | HNRNPH3 | heterogeneous nuclear | Nucleus | other |
| | | ribonucleoprotein H3 | | |
| | | (2H9) | | |
| 207270_x_at | CD300C | CD300c molecule | Plasma | transmembrane |
| | | | Membrane | receptor |
| 207458_at | C8orf51 | chromosome 8 open | unknown | other |
| | | reading frame 51 | | |
| 207573_x_at | ATP5L | ATP synthase, H+ | Cytoplasm | transporter |
| | | transporting, | | |
| | | mitochondrial Fo | | |
| | | complex, subunit G | | |
| 207801_s_at | RNF10 | ring finger protein 10 | Cytoplasm | other |
| 207809_s_at | ATP6AP1 | ATPase, H+ | Cytoplasm | transporter |
| | | transporting, lysosomal | | |
| | | accessory protein 1 | | |
| 207941_s_at | RBM39 | RNA binding motif | Nucleus | transcription |
| | | protein 39 | | regulator |
| 208033_s_at | ZFHX3 | zinc finger homeobox 3 | Nucleus | transcription |
| | | | | regulator |
| 208405_s_at | CD164 | CD164 molecule, | Plasma | other |
| | | sialomucin | Membrane | |
| 208463_at | GABRA4 | gamma-aminobutyric | Plasma | ion channel |
| | | acid (GABA) A receptor, | Membrane | |
| | | alpha 4 | | |
| 208627_s_at | YBX1 | Y box binding protein 1 | Nucleus | transcription |
| | | | | regulator |
| 208653_s_at | CD164 | CD164 molecule, | Plasma | other |
| | | sialomucin | Membrane | |
| 208654_s_at | CD164 | CD164 molecule, | Plasma | other |
| | | sialomucin | Membrane | |
| 208688_x_at | EIF3B | eukaryotic translation | Cytoplasm | translation |
| | | initiation factor 3, | | regulator |
| | | subunit B | | |
| 208736_at | ARPC3 | actin related protein ⅔ | Cytoplasm | other |
| | | complex, subunit 3, | | |
| | | 21 kDa | | |
| 208737_at | ATP6V1G1 | ATPase, H+ | Cytoplasm | transporter |
| | | transporting, lysosomal | | |
| | | 13 kDa, V1 subunit G1 | | |
| 208746_x_at | ATP5L | ATP synthase, H+ | Cytoplasm | transporter |
| | | transporting, | | |
| | | mitochondrial Fo | | |
| | | complex, subunit G | | |
| 208752_x_at | NAP1L1 | nucleosome assembly | Nucleus | other |
| | | protein 1-like 1 | | |
| 208756_at | EIF3I | eukaryotic translation | Cytoplasm | translation |
| | | initiation factor 3, | | regulator |
| | | subunit I | | |
| 208874_x_at | PPP2R4 | protein phosphatase 2A | Cytoplasm | phosphatase |
| | | activator, regulatory | | |
| | | subunit 4 | | |
| 208921_s_at | SRI | sorcin | Cytoplasm | transporter |
| 209112_at | CDKN1B | cyclin-dependent kinase | Nucleus | other |
| | | inhibitor 1B (p27, Kip1) | | |
| 209221_s_at | OSBPL2 | oxysterol binding | Cytoplasm | other |
| | | protein-like 2 | | |
| 209232_s_at | DCTN5 | dynactin 5 (p25) | unknown | other |
| 209390_at | TSC1 | tuberous sclerosis 1 | Cytoplasm | other |
| 209431_s_at | PATZ1 | POZ (BTB) and AT | Nucleus | transcription |
| | | hook containing zinc | | regulator |
| | | finger 1 | | |
| 209494_s_at | PATZ1 | POZ (BTB) and AT | Nucleus | transcription |
| | | hook containing zinc | | regulator |
| | | finger 1 | | |
| 209623_at | MCCC2 | methylcrotonoyl-CoA | Cytoplasm | enzyme |
| | | carboxylase 2 (beta) | | |
| 209624_s_at | MCCC2 | methylcrotonoyl-CoA | Cytoplasm | enzyme |
| | | carboxylase 2 (beta) | | |
| 209630_s_at | FBXW2 | F-box and WD repeat | Cytoplasm | enzyme |
| | | domain containing 2 | | |
| 209669_s_at | SERBP1 | SERPINE1 mRNA | Nucleus | other |
| | | binding protein 1 | | |
| 209798_at | NPAT | nuclear protein, ataxia- | Nucleus | transcription |
| | | telangiectasia locus | | regulator |
| 209862_s_at | CEP57 | centrosomal protein | Cytoplasm | other |
| | | 57 kDa | | |
| 209934_s_at | ATP2C1 | ATPase, Ca++ | Cytoplasm | transporter |
| | | transporting, type 2C, | | |
| | | member 1 | | |
| 210005_at | GART | phosphoribosylglycinamide | Cytoplasm | enzyme |
| | | formyltransferase, | | |
| | | phosphoribosylglycinamide | | |
| | | synthetase, | | |
| | | phosphoribosylaminoimidazole | | |
| | | synthetase | | |
| 210097_s_at | NOL7 | nucleolar protein 7, | Nucleus | other |
| | | 27 kDa | | |
| 210160_at | PAFAH1B2 | platelet-activating factor | Cytoplasm | enzyme |
| | | acetylhydrolase 1b, | | |
| | | catalytic subunit 2 | | |
| | | (30 kDa) | | |
| 210183_x_at | PNN | pinin, desmosome | Plasma | other |
| | | associated protein | Membrane | |
| 210453_x_at | ATP5L | ATP synthase, H+ | Cytoplasm | transporter |
| | | transporting, | | |
| | | mitochondrial Fo | | |
| | | complex, subunit G | | |
| 210466_s_at | SERBP1 | SERPINE1 mRNA | Nucleus | other |
| | | binding protein 1 | | |
| 210581_x_at | PATZ1 | POZ (BTB) and AT | Nucleus | transcription |
| | | hook containing zinc | | regulator |
| | | finger 1 | | |
| 211034_s_at | C12orf51 | chromosome 12 open | unknown | other |
| | | reading frame 51 | | |
| 211150_s_at | DLAT | dihydrolipoamide S- | Cytoplasm | enzyme |
| | | acetyltransferase | | |
| 211391_s_at | PATZ1 | POZ (BTB) and AT | Nucleus | transcription |
| | | hook containing zinc | | regulator |
| | | finger 1 | | |
| 211392_s_at | PATZ1 | POZ (BTB) and AT | Nucleus | transcription |
| | | hook containing zinc | | regulator |
| | | finger 1 | | |
| 211584_s_at | NPAT | nuclear protein, ataxia- | Nucleus | transcription |
| | | telangiectasia locus | | regulator |
| 211623_s_at | FBL | fibrillarin | Nucleus | other |
| 211749_s_at | VAMP3 | vesicle-associated | Plasma | other |
| | | membrane protein 3 | Membrane | |
| | | (cellubrevin) | | |
| 211787_s_at | EIF4A1 | eukaryotic translation | Cytoplasm | translation |
| | | initiation factor 4A1 | | regulator |
| 212046_x_at | MAPK3 | mitogen-activated | Cytoplasm | kinase |
| | | protein kinase 3 | | |
| 212053_at | PDXDC1 | pyridoxal-dependent | unknown | other |
| | | decarboxylase domain | | |
| | | containing 1 | | |
| 212064_x_at | MAZ | MYC-associated zinc | Nucleus | transcription |
| | | finger protein (purine- | | regulator |
| | | binding transcription | | |
| | | factor) | | |
| 212114_at | ATXN7L3B | ataxin 7-like 3B | unknown | other |
| 212320_at | TUBB | tubulin, beta | Cytoplasm | other |
| 212367_at | FEM1B | fem-1 homolog b (C. elegans) | Nucleus | transcription |
| | | | | regulator |
| 212373_at | FEM1B | fem-1 homolog b (C. elegans) | Nucleus | transcription |
| | | | | regulator |
| 212400_at | FAM102A | family with sequence | unknown | other |
| | | similarity 102, member A | | |
| 212403_at | UBE3B | ubiquitin protein ligase | unknown | enzyme |
| | | E3B | | |
| 212506_at | PICALM | phosphatidylinositol | Cytoplasm | other |
| | | binding clathrin | | |
| | | assembly protein | | |
| 212518_at | PIP5K1C | phosphatidylinositol-4- | Plasma | kinase |
| | | phosphate 5-kinase, type | Membrane | |
| | | I, gamma | | |
| 212547_at | BRD3 | bromodomain | Nucleus | kinase |
| | | containing 3 | | |
| 212617_at | ZNF609 | zinc finger protein 609 | unknown | other |
| 212652_s_at | SNX4 | sorting nexin 4 | Cytoplasm | transporter |
| 212653_s_at | EHBP1 | EH domain binding | unknown | other |
| | | protein 1 | | |
| 212846_at | RRP1B | ribosomal RNA | Nucleus | other |
| | | processing 1 homolog B | | |
| | | (S. cerevisiae) | | |
| 212871_at | MAPKAPK5 | mitogen-activated | Cytoplasm | kinase |
| | | protein kinase-activated | | |
| | | protein kinase 5 | | |
| 212920_at | REST | RE1-silencing | Nucleus | transcription |
| | | transcription factor | | regulator |
| 212995_x_at | MZT2B | mitotic spindle | Cytoplasm | other |
| | | organizing protein 2B | | |
| 213025_at | THUMPD1 | THUMP domain | unknown | other |
| | | containing 1 | | |
| 213141_at | PSKH1 | protein serine kinase H1 | Nucleus | kinase |
| 213153_at | SETD1B | SET domain containing | Nucleus | other |
| | | 1B | | |
| 213185_at | KIAA0556 | KIAA0556 | Extracellular | other |
| | | | Space | |
| 213196_at | ZNF629 | zinc finger protein 629 | Nucleus | other |
| 213234_at | KIAA1467 | KIAA1467 | unknown | other |
| 213473_at | BRAP | BRCA1 associated | Cytoplasm | enzyme |
| | | protein | | |
| 213508_at | C14orf147 | chromosome 14 open | Cytoplasm | other |
| | | reading frame 147 | | |
| 213509_x_at | CES2 | carboxylesterase 2 | Cytoplasm | enzyme |
| 213588_x_at | RPL14 | ribosomal protein L14 | Cytoplasm | other |
| 213615_at | LPCAT3 | lysophosphatidylcholine | Plasma | other |
| | | acyltransferase 3 | Membrane | |
| 213743_at | CCNT2 | cyclin T2 | Nucleus | transcription |
| | | | | regulator |
| 213798_s_at | CAP1 | CAP, adenylate cyclase- | Plasma | other |
| | | associated protein 1 | Membrane | |
| | | (yeast) | | |
| 213864_s_at | NAP1L1 | nucleosome assembly | Nucleus | other |
| | | protein 1-like 1 | | |
| 213907_at | EEF1E1 | eukaryotic translation | Cytoplasm | translation |
| | | elongation factor 1 | | regulator |
| | | epsilon 1 | | |
| 214011_s_at | NOP16 | NOP16 nucleolar | Nucleus | other |
| | | protein homolog (yeast) | | |
| 214138_at | ZNF79 | zinc finger protein 79 | Nucleus | other |
| 214317_x_at | RPS9 | ribosomal protein S9 | Cytoplasm | translation |
| | | | | regulator |
| 214483_s_at | ARFIP1 | ADP-ribosylation factor | Cytoplasm | other |
| | | interacting protein 1 | | |
| 214635_at | CLDN9 | claudin 9 | Plasma | other |
| | | | Membrane | |
| 215458_s_at | SMURF1 | SMAD specific E3 | Cytoplasm | enzyme |
| | | ubiquitin protein ligase 1 | | |
| 215493_x_at | BTN2A1 | butyrophilin, subfamily | Plasma | other |
| | | 2, member A1 | Membrane | |
| 215696_s_at | SEC16A | SEC16 homolog A (S. cerevisiae) | Cytoplasm | phosphatase |
| 216105_x_at | PPP2R4 | protein phosphatase 2A | Cytoplasm | phosphatase |
| | | activator, regulatory | | |
| | | subunit 4 | | |
| 216226_at | TAF4B | TAF4b RNA | Nucleus | transcription |
| | | polymerase II, TATA | | regulator |
| | | box binding protein | | |
| | | (TBP)-associated factor, | | |
| | | 105 kDa | | |
| 216326_s_at | HDAC3 | histone deacetylase 3 | Nucleus | transcription |
| | | | | regulator |
| 216389_s_at | DCAF11 | DDB1 and CUL4 | unknown | other |
| | | associated factor 11 | | |
| 216624_s_at | MLL | myeloid/lymphoid or | Nucleus | transcription |
| | | mixed-lineage leukemia | | regulator |
| | | (trithorax homolog, | | |
| | | Drosophila) | | |
| 217142_at | | | | |
| 217156_at | | | | |
| 217185_s_at | ZNF259 | zinc finger protein 259 | Nucleus | other |
| 217294_s_at | ENO1 | enolase 1, (alpha) | Cytoplasm | transcription |
| | | | | regulator |
| 217445_s_at | GART | phosphoribosylglycinamide | Cytoplasm | enzyme |
| | | formyltransferase, | | |
| | | phosphoribosylglycinamide | | |
| | | synthetase, | | |
| | | phosphoribosylaminoimidazole | | |
| | | synthetase | | |
| 217747_s_at | RPS9 | ribosomal protein S9 | Cytoplasm | translation |
| | | | | regulator |
| 217756_x_at | SERF2 | small EDRK-rich factor 2 | unknown | other |
| 217777_s_at | PTPLAD1 | protein tyrosine | Cytoplasm | other |
| | | phosphatase-like A | | |
| | | domain containing 1 | | |
| 217795_s_at | TMEM43 | transmembrane protein | Nucleus | other |
| | | 43 | | |
| 217844_at | CTDSP1 | CTD (carboxy-terminal | Nucleus | phosphatase |
| | | domain, RNA | | |
| | | polymerase II, | | |
| | | polypeptide A) small | | |
| | | phosphatase 1 | | |
| 217939_s_at | AFTPH | aftiphilin | Cytoplasm | other |
| 217994_x_at | CPSF3L | cleavage and | Nucleus | other |
| | | polyadenylation specific | | |
| | | factor 3-like | | |
| 218194_at | REXO2 | REX2, RNA | Cytoplasm | enzyme |
| | | exonuclease 2 homolog | | |
| | | (S. cerevisiae) | | |
| 218230_at | ARFIP1 | ADP-ribosylation factor | Cytoplasm | other |
| | | interacting protein 1 | | |
| 218259_at | MKL2 | MKL/myocardin-like 2 | Nucleus | transcription |
| | | | | regulator |
| 218301_at | RNPEPL1 | arginyl aminopeptidase | unknown | peptidase |
| | | (aminopeptidase B)-like 1 | | |
| 218314_s_at | C11orf57 | chromosome 11 open | unknown | other |
| | | reading frame 57 | | |
| 218333_at | DERL2 | Der1-like domain | Cytoplasm | other |
| | | family, member 2 | | |
| 218350_s_at | GMNN | geminin, DNA | Nucleus | transcription |
| | | replication inhibitor | | regulator |
| 218488_at | EIF2B3 | eukaryotic translation | Cytoplasm | translation |
| | | initiation factor 2B, | | regulator |
| | | subunit 3 gamma, 58 kDa | | |
| 218494_s_at | SLC2A4RG | SLC2A4 regulator | Cytoplasm | transcription |
| | | | | regulator |
| 218527_at | APTX | aprataxin | Nucleus | phosphatase |
| 218533_s_at | UCKL1 | uridine-cytidine kinase | Cytoplasm | kinase |
| | | 1-like 1 | | |
| 218561_s_at | LYRM4 | LYR motif containing 4 | Cytoplasm | other |
| 218566_s_at | CHORDC1 | cysteine and histidine- | unknown | other |
| | | rich domain (CHORD) | | |
| | | containing 1 | | |
| 218597_s_at | CISD1 | CDGSH iron sulfur | Cytoplasm | other |
| | | domain 1 | | |
| 218626_at | EIF4ENIF1 | eukaryotic translation | Cytoplasm | translation |
| | | initiation factor 4E | | regulator |
| | | nuclear import factor 1 | | |
| 218661_at | NAT15 | N-acetyltransferase 15 | unknown | enzyme |
| | | (GCN5-related, putative) | | |
| 218696_at | EIF2AK3 | eukaryotic translation | Cytoplasm | kinase |
| | | initiation factor 2-alpha | | |
| | | kinase 3 | | |
| 218710_at | TTC27 | tetratricopeptide repeat | unknown | other |
| | | domain 27 | | |
| 218754_at | NOL9 | nucleolar protein 9 | Nucleus | other |
| 218886_at | PAK1IP1 | PAK1 interacting | Nucleus | other |
| | | protein 1 | | |
| 218889_at | NOC3L | nucleolar complex | Nucleus | other |
| | | associated 3 homolog (S. cerevisiae) | | |
| 219081_at | ANKHD1 | ankyrin repeat and KH | Nucleus | transcription |
| | | domain containing 1 | | regulator |
| 219098_at | MYBBP1A | MYB binding protein | Nucleus | transcription |
| | | (P160) 1a | | regulator |
| 219120_at | C2orf44 | chromosome 2 open | unknown | other |
| | | reading frame 44 | | |
| 219122_s_at | THG1L | tRNA-histidine | Cytoplasm | enzyme |
| | | guanylyltransferase 1- | | |
| | | like (S. cerevisiae) | | |
| 219220_x_at | MRPS22 | mitochondrial ribosomal | Cytoplasm | other |
| | | protein S22 | | |
| 219223_at | C9orf7 | chromosome 9 open | unknown | other |
| | | reading frame 7 | | |
| 219339_s_at | EHMT1 | euchromatic histone- | Nucleus | transcription |
| | | lysine N- | | regulator |
| | | methyltransferase 1 | | |
| 219374_s_at | ALG9 | asparagine-linked | Cytoplasm | enzyme |
| | | glycosylation 9, alpha- | | |
| | | 1,2-mannosyltransferase | | |
| | | homolog (S. cerevisiae) | | |
| 219382_at | SERTAD3 | SERTA domain | Nucleus | transcription |
| | | containing 3 | | regulator |
| 219679_s_at | WAC | WW domain containing | Nucleus | other |
| | | adaptor with coiled-coil | | |
| 220223_at | ATAD5 | ATPase family, AAA | unknown | other |
| | | domain containing 5 | | |
| 220606_s_at | C17orf48 | chromosome 17 open | unknown | other |
| | | reading frame 48 | | |
| 220943_s_at | C2orf56 | chromosome 2 open | Cytoplasm | other |
| | | reading frame 56 | | |
| 220947_s_at | TBC1D10B | TBC1 domain family, | unknown | enzyme |
| | | member 10B | | |
| 221230_s_at | ARID4B | AT rich interactive | Nucleus | other |
| | | domain 4B (RBP1-like) | | |
| 221253_s_at | TXNDC5 | thioredoxin domain | Cytoplasm | enzyme |
| | | containing 5 | | |
| | | (endoplasmic reticulum) | | |
| 221434_s_at | C14orf156 | chromosome 14 open | Cytoplasm | other |
| | | reading frame 156 | | |
| 221452_s_at | TMEM14B | transmembrane protein | unknown | other |
| | | 14B | | |
| 221488_s_at | CUTA | cutA divalent cation | unknown | other |
| | | tolerance homolog (E. coli) | | |
| 221517_s_at | MED17 | mediator complex | Nucleus | transcription |
| | | subunit 17 | | regulator |
| 221580_s_at | TAF1D | TATA box binding | Nucleus | other |
| | | protein (TBP)-associated | | |
| | | factor, RNA polymerase | | |
| | | I, D, 41 kDa | | |
| 221597_s_at | TMEM208 | transmembrane protein | unknown | other |
| | | 208 | | |
| 221769_at | SPSB3 | splA/ryanodine receptor | unknown | other |
| | | domain and SOCS box | | |
| | | containing 3 | | |
| 221832_s_at | LUZP1 | leucine zipper protein 1 | Nucleus | other |
| 221869_at | ZNF512B | zinc finger protein 512B | Nucleus | other |
| 221923_s_at | NPM1 | nucleophosmin | Nucleus | transcription |
| | | (nucleolar | | regulator |
| | | phosphoprotein B23, | | |
| | | numatrin) | | |
| 221987_s_at | TSR1 | TSR1, 20S rRNA | Nucleus | other |
| | | accumulation, homolog | | |
| | | (S. cerevisiae) | | |
| 222000_at | C1orf174 | chromosome 1 open | unknown | other |
| | | reading frame 174 | | |
| 222029_x_at | PFDN6 | prefoldin subunit 6 | Cytoplasm | other |
| 222229_x_at | RPL26 | ribosomal protein L26 | Cytoplasm | other |
| 222404_x_at | PTPLAD1 | protein tyrosine | Cytoplasm | other |
| | | phosphatase-like A | | |
| | | domain containing 1 | | |
| 222405_at | PTPLAD1 | protein tyrosine | Cytoplasm | other |
| | | phosphatase-like A | | |
| | | domain containing 1 | | |
| 222418_s_at | TMEM43 | transmembrane protein | Nucleus | other |
| | | 43 | | |
| 222427_s_at | LARS | leucyl-tRNA synthetase | Cytoplasm | enzyme |
| 222428_s_at | LARS | leucyl-tRNA synthetase | Cytoplasm | enzyme |
| 222703_s_at | YRDC | yrdC domain containing | unknown | other |
| | | (E. coli) | | |
| 222728_s_at | TAF1D | TATA box binding | Nucleus | other |
| | | protein (TBP)-associated | | |
| | | factor, RNA polymerase | | |
| | | I, D, 41 kDa | | |
| 222873_s_at | EHMT1 | euchromatic histone- | Nucleus | transcription |
| | | lysine N- | | regulator |
| | | methyltransferase 1 | | |
| 222875_at | DHX33 | DEAH (Asp-Glu-Ala- | Nucleus | enzyme |
| | | His) box polypeptide 33 | | |
| 223010_s_at | OCIAD1 | OCIA domain | Cytoplasm | other |
| | | containing 1 | | |
| 223017_at | TXNDC12 | thioredoxin domain | Cytoplasm | enzyme |
| | | containing 12 | | |
| | | (endoplasmic reticulum) | | |
| 223089_at | VEZT | vezatin, adherens | Plasma | other |
| | | junctions transmembrane | Membrane | |
| | | protein | | |
| 223106_at | TMEM14C | transmembrane protein | Plasma | other |
| | | 14C | Membrane | |
| 223133_at | TMEM14B | transmembrane protein | unknown | other |
| | | 14B | | |
| 223151_at | DCUN1D5 | DCN1, defective in | unknown | other |
| | | cullin neddylation 1, | | |
| | | domain containing 5 (S. cerevisiae) | | |
| 223245_at | STRBP | spermatid perinuclear | Cytoplasm | other |
| | | RNA binding protein | | |
| 223334_at | TMEM126A | transmembrane protein | Cytoplasm | other |
| | | 126A | | |
| 223336_s_at | RAB18 | RAB18, member RAS | Cytoplasm | enzyme |
| | | oncogene family | | |
| 223401_at | C17orf48 | chromosome 17 open | unknown | other |
| | | reading frame 48 | | |
| 223414_s_at | LYAR | Ly1 antibody reactive | Plasma | other |
| | | homolog (mouse) | Membrane | |
| 223440_at | C16orf70 | chromosome 16 open | Cytoplasm | other |
| | | reading frame 70 | | |
| 223448_x_at | MRPS22 | mitochondrial ribosomal | Cytoplasm | other |
| | | protein S22 | | |
| 223560_s_at | C2orf56 | chromosome 2 open | Cytoplasm | other |
| | | reading frame 56 | | |
| 223773_s_at | SNHG12 | small nucleolar RNA | unknown | other |
| | | host gene 12 (non- | | |
| | | protein coding) | | |
| 223907_s_at | PINX1 | PIN2/TERF1 | Nucleus | other |
| | | interacting, telomerase | | |
| | | inhibitor 1 | | |
| 223954_x_at | NECAB3 | N-terminal EF-hand | Cytoplasm | other |
| | | calcium binding protein 3 | | |
| 224312_x_at | CPSF3L | cleavage and | Nucleus | other |
| | | polyadenylation specific | | |
| | | factor 3-like | | |
| 224450_s_at | RIOK1 | RIO kinase 1 (yeast) | unknown | kinase |
| 224504_s_at | BUD13 | BUD13 homolog (S. cerevisiae) | Nucleus | other |
| 224511_s_at | TXNDC17 | thioredoxin domain | Cytoplasm | enzyme |
| | | containing 17 | | |
| 224523_s_at | C3orf26 | chromosome 3 open | unknown | other |
| | | reading frame 26 | | |
| 224610_at | SNHG1 | small nucleolar RNA | unknown | other |
| | | host gene 1 (non-protein | | |
| | | coding) | | |
| 224614_at | DYNC1LI2 | dynein, cytoplasmic 1, | Cytoplasm | other |
| | | light intermediate chain 2 | | |
| 224625_x_at | SERF2 | small EDRK-rich factor 2 | unknown | other |
| 224654_at | DDX21 | DEAD (Asp-Glu-Ala- | Nucleus | enzyme |
| | | Asp) box polypeptide 21 | | |
| 224777_s_at | PAFAH1B2 | platelet-activating factor | Cytoplasm | enzyme |
| | | acetylhydrolase 1b, | | |
| | | catalytic subunit 2 | | |
| | | (30 kDa) | | |
| 224789_at | DCAF12 | DDB1 and CUL4 | Cytoplasm | other |
| | | associated factor 12 | | |
| 224809_x_at | TINF2 | TERF1 (TRF1)- | Nucleus | other |
| | | interacting nuclear factor 2 | | |
| 224886_at | JMJD8 | jumonji domain | unknown | other |
| | | containing 8 | | |
| 224894_at | YAP1 | Yes-associated protein 1 | Nucleus | transcription |
| | | | | regulator |
| 224907_s_at | SH3GLB2 | SH3-domain GRB2-like | Cytoplasm | other |
| | | endophilin B2 | | |
| 224983_at | SCARB2 | scavenger receptor class | Plasma | other |
| | | B, member 2 | Membrane | |
| 224986_s_at | PDPK1 | 3-phosphoinositide | Cytoplasm | kinase |
| | | dependent protein | | |
| | | kinase-1 | | |
| 224998_at | CMTM4 | CKLF-like MARVEL | Extracellular | cytokine |
| | | transmembrane domain | Space | |
| | | containing 4 | | |
| 225009_at | CMTM4 | CKLF-like MARVEL | Extracellular | cytokine |
| | | transmembrane domain | Space | |
| | | containing 4 | | |
| 225172_at | CRAMP1L | Crm, cramped-like | unknown | other |
| | | (Drosophila) | | |
| 225231_at | CBL | Cas-Br-M (murine) | Nucleus | transcription |
| | | ecotropic retroviral | | regulator |
| | | transforming sequence | | |
| 225236_at | RBM18 | RNA binding motif | unknown | other |
| | | protein 18 | | |
| 225276_at | GSPT1 | G1 to S phase transition 1 | Cytoplasm | translation |
| | | | | regulator |
| 225409_at | C2orf64 | chromosome 2 open | Cytoplasm | other |
| | | reading frame 64 | | |
| 225417_at | EPC1 | enhancer of polycomb | Nucleus | transcription |
| | | homolog 1 (Drosophila) | | regulator |
| 225429_at | PPP6C | protein phosphatase 6, | Nucleus | phosphatase |
| | | catalytic subunit | | |
| 225461_at | EHMT1 | euchromatic histone- | Nucleus | transcription |
| | | lysine N- | | regulator |
| | | methyltransferase 1 | | |
| 225658_at | SPOPL | speckle-type POZ | unknown | other |
| | | protein-like | | |
| 225659_at | SPOPL | speckle-type POZ | unknown | other |
| | | protein-like | | |
| 225663_at | ACBD5 | acyl-CoA binding | unknown | other |
| | | domain containing 5 | | |
| 225672_at | GOLGA2 | golgin A2 | Cytoplasm | other |
| 225712_at | GEMIN5 | gem (nuclear organelle) | Nucleus | other |
| | | associated protein 5 | | |
| 225771_at | AP1G1 | adaptor-related protein | Cytoplasm | transporter |
| | | complex 1, gamma 1 | | |
| | | subunit | | |
| 225831_at | LUZP1 | leucine zipper protein 1 | Nucleus | other |
| 225878_at | KIF1B | kinesin family member | Cytoplasm | transporter |
| | | 1B | | |
| 225993_at | EARS2 | glutamyl-tRNA | Cytoplasm | enzyme |
| | | synthetase 2, | | |
| | | mitochondrial (putative) | | |
| 226072_at | FUK | fucokinase | unknown | kinase |
| 226076_s_at | MBD6 | methyl-CpG binding | unknown | other |
| | | domain protein 6 | | |
| 226095_s_at | ATXN1L | ataxin 1-like | unknown | other |
| 226262_at | DHX33 | DEAH (Asp-Glu-Ala- | Nucleus | enzyme |
| | | His) box polypeptide 33 | | |
| 226298_at | RUNDC1 | RUN domain containing 1 | unknown | other |
| 226329_s_at | MITD1 | MIT, microtubule | unknown | other |
| | | interacting and transport, | | |
| | | domain containing 1 | | |
| 226386_at | C7orf30 | chromosome 7 open | Extracellular | other |
| | | reading frame 30 | Space | |
| 226392_at | | | | |
| 226493_at | KCTD18 | potassium channel | unknown | other |
| | | tetramerisation domain | | |
| | | containing 18 | | |
| 226619_at | SENP1 | SUMO1/sentrin specific | Nucleus | peptidase |
| | | peptidase 1 | | |
| 226679_at | SLC26A11 | solute carrier family 26, | Cytoplasm | transporter |
| | | member 11 | | |
| 226692_at | SERF2 | small EDRK-rich factor 2 | unknown | other |
| 226784_at | TWISTNB | TWIST neighbor | Nucleus | other |
| 226849_at | DENND1A | DENN/MADD domain | Plasma | other |
| | | containing 1A | Membrane | |
| 226968_at | KIF1B | kinesin family member | Cytoplasm | transporter |
| | | 1B | | |
| 226981_at | MLL | myeloid/lymphoid or | Nucleus | transcription |
| | | mixed-lineage leukemia | | regulator |
| | | (trithorax homolog, | | |
| | | Drosophila) | | |
| 227018_at | DPP8 | dipeptidyl-peptidase 8 | Cytoplasm | peptidase |
| 227029_at | FAM177A1 | family with sequence | unknown | other |
| | | similarity 177, member | | |
| | | A1 | | |
| 227149_at | TNRC6C | trinucleotide repeat | unknown | other |
| | | containing 6C | | |
| 227207_x_at | ZNF213 | zinc finger protein 213 | Nucleus | transcription |
| | | | | regulator |
| 227208_at | CCDC84 | coiled-coil domain | unknown | other |
| | | containing 84 | | |
| 227412_at | PPP1R3E | protein phosphatase 1, | unknown | other |
| | | regulatory (inhibitor) | | |
| | | subunit 3E | | |
| 227700_x_at | ATAD3A/ATAD3B | ATPase family, AAA | Nucleus | other |
| | | domain containing 3A | | |
| 227833_s_at | MBD6 | methyl-CpG binding | unknown | other |
| | | domain protein 6 | | |
| 227876_at | ARHGAP39 | Rho GTPase activating | Nucleus | other |
| | | protein 39 | | |
| 227904_at | AZI2 | 5-azacytidine induced 2 | Cytoplasm | other |
| 227905_s_at | AZI2 | 5-azacytidine induced 2 | Cytoplasm | other |
| 227951_s_at | FAM98C | family with sequence | unknown | other |
| | | similarity 98, member C | | |
| 228200_at | ZNF252 | zinc finger protein 252 | unknown | other |
| 228216_at | | | | |
| 228217_s_at | PSMG4 | proteasome (prosome, | unknown | transcription |
| | | macropain) assembly | | regulator |
| | | chaperone 4 | | |
| 228283_at | CMC1 | COX assembly | Cytoplasm | other |
| | | mitochondrial protein | | |
| | | homolog (S. cerevisiae) | | |
| 228355_s_at | NDUFAF2 | NADH dehydrogenase | Cytoplasm | other |
| | | (ubiquinone) 1 alpha | | |
| | | subcomplex, assembly | | |
| | | factor 2 | | |
| 228774_at | CEP78 | centrosomal protein | Cytoplasm | other |
| | | 78 kDa | | |
| 229262_at | LRRC68 | leucine rich repeat | unknown | other |
| | | containing 68 | | |
| 229582_at | INO80C | INO80 complex subunit C | Nucleus | other |
| 229798_s_at | BRI3 | brain protein I3 | unknown | other |
| 229884_s_at | MRPL2 | mitochondrial ribosomal | Extracellular | other |
| | | protein L2 | Space | |
| 230106_at | ZXDC | ZXD family zinc finger C | unknown | transcription |
| | | | | regulator |
| 230165_at | SGOL2 | shugoshin-like 2 (S. pombe) | Nucleus | other |
| 230379_x_at | C2orf56 | chromosome 2 open | Cytoplasm | other |
| | | reading frame 56 | | |
| 231065_at | PDE6D | phosphodiesterase 6D, | Cytoplasm | enzyme |
| | | cGMP-specific, rod, | | |
| | | delta | | |
| 231643_s_at | CMIP | c-Maf-inducing protein | Cytoplasm | other |
| 231756_at | ZP4 | zona pellucida | Extracellular | other |
| | | glycoprotein 4 | Space | |
| 232157_at | SPRY3 | sprouty homolog 3 | Plasma | other |
| | | (Drosophila) | Membrane | |
| 232219_x_at | USP21 | ubiquitin specific | Cytoplasm | peptidase |
| | | peptidase 21 | | |
| 232350_x_at | GPR161 | G protein-coupled | Plasma | G-protein |
| | | receptor 161 | Membrane | coupled |
| | | | | receptor |
| 233451_at | C20orf54 | chromosome 20 open | Plasma | other |
| | | reading frame 54 | Membrane | |
| 233588_x_at | PFDN6 | prefoldin subunit 6 | Cytoplasm | other |
| 233655_s_at | HAUS6 | HAUS augmin-like | Cytoplasm | other |
| | | complex, subunit 6 | | |
| 233732_at | LOC401320 | hypothetical | unknown | other |
| | | LOC401320 | | |
| 234000_s_at | PTPLAD1 | protein tyrosine | Cytoplasm | other |
| | | phosphatase-like A | | |
| | | domain containing 1 | | |
| 234107_s_at | DTD1 | D-tyrosyl-tRNA | Cytoplasm | enzyme |
| | | deacylase 1 homolog (S. cerevisiae) | | |
| 234735_s_at | USP21 | ubiquitin specific | Cytoplasm | peptidase |
| | | peptidase 21 | | |
| 234983_at | | | | |
| 234998_at | | | | |
| 235040_at | RUNDC1 | RUN domain containing 1 | unknown | other |
| 235459_at | | | | |
| 235677_at | SRR | serine racemase | Cytoplasm | enzyme |
| 235756_at | | | | |
| 236165_at | MSL3 | male-specific lethal 3 | Nucleus | transcription |
| | | homolog (Drosophila) | | regulator |
| 237045_at | FAM91A1 | family with sequence | unknown | other |
| | | similarity 91, member | | |
| | | A1 | | |
| 237167_at | KIAA1217 | KIAA1217 | Cytoplasm | other |
| 237875_at | | | | |
| 238153_at | PDE6B | phosphodiesterase 6B, | Cytoplasm | enzyme |
| | | cGMP-specific, rod, beta | | |
| 238652_at | | | | |
| 238765_at | ATP6V1G1 | ATPase, H+ | Cytoplasm | transporter |
| | | transporting, lysosomal | | |
| | | 13 kDa, V1 subunit G1 | | |
| 239042_at | TSR1 | TSR1, 20S rRNA | Nucleus | other |
| | | accumulation, homolog | | |
| | | (S. cerevisiae) | | |
| 239316_at | METTL12 | methyltransferase like | unknown | other |
| | | 12 | | |
| 239616_at | REXO2 | REX2, RNA | Cytoplasm | enzyme |
| | | exonuclease 2 homolog | | |
| | | (S. cerevisiae) | | |
| 240499_at | | | | |
| 240698_s_at | | | | |
| 241627_x_at | ARHGEF40 | Rho guanine nucleotide | unknown | other |
| | | exchange factor (GEF) | | |
| | | 40 | | |
| 242145_at | | | | |
| 242335_at | SLC25A37 | solute carrier family 25, | Cytoplasm | transporter |
| | | member 37 | | |
| 242684_at | ZNF425 | zinc finger protein 425 | unknown | other |
| 242787_at | | | | |
| 242923_at | ZNF678 | zinc finger protein 678 | Nucleus | other |
| 243055_at | | | | |
| 244377_at | SLC1A4 | solute carrier family 1 | Plasma | transporter |
| | | (glutamate/neutral amino | Membrane | |
| | | acid transporter), | | |
| | | member 4 | | |
| 244647_at | | | | |
| 244765_at | | | | |
| 32029_at | PDPK1 | 3-phosphoinositide | Cytoplasm | kinase |
| | | dependent protein | | |
| | | kinase-1 | | |
| 35436_at | GOLGA2 | golgin A2 | Cytoplasm | other |
| 40465_at | DDX23 | DEAD (Asp-Glu-Ala- | Nucleus | enzyme |
| | | Asp) box polypeptide 23 | | |
| 41512_at | BRAP | BRCA1 associated | Cytoplasm | enzyme |
| | | protein | | |
| 45526_g_at | NAT15 | N-acetyltransferase 15 | unknown | enzyme |
| | | (GCN5-related, putative) | | |
| 45687_at | PRR14 | proline rich 14 | unknown | other |
| 46256_at | SPSB3 | splA/ryanodine receptor | unknown | other |
| | | domain and SOCS box | | |
| | | containing 3 | | |
| 46270_at | UBAP1 | ubiquitin associated | Cytoplasm | other |
| | | protein 1 | | |
| 50376_at | ZNF444 | zinc finger protein 444 | Nucleus | transcription |
| | | | | regulator |
| 53987_at | RANBP10 | RAN binding protein 10 | Cytoplasm | other |
| 56829_at | TRAPPC9 | trafficking protein | Plasma | other |
| | | particle complex 9 | Membrane | |
| 61874_at | C9orf7 | chromosome 9 open | unknown | other |
| | | reading frame 7 | | |
| 77508_r_at | RABEP2 | rabaptin, RAB GTPase | Extracellular | growth factor |
| | | binding effector protein 2 | Space | |

TABLE 10
Gene Signature for sensitivity to ACT

| Probe ID | Gene Symbol | Entrez Gene Name | Location | Type(s) |
|---|---|---|---|---|
| 1553103_at | NFX1 | nuclear transcription | Nucleus | transcription |
| | | factor, X-box binding 1 | | regulator |
| 1554082_a_at | NOL9 | nucleolar protein 9 | Nucleus | other |
| 1554213_at | ARHGEF10 | Rho guanine nucleotide | Cytoplasm | peptidase |
| | | exchange factor (GEF) | | |
| | | 10 | | |
| 1554537_at | TMEM126B | transmembrane protein | unknown | other |
| | | 126B | | |
| 1554677_s_at | CMTM4 | CKLF-like MARVEL | Extracellular | cytokine |
| | | transmembrane domain | Space | |
| | | containing 4 | | |
| 1555015_a_at | ZNF398 | zinc finger protein 398 | Nucleus | transcription |
| | | | | regulator |
| 1555399_a_at | DUSP16 | dual specificity | Nucleus | phosphatase |
| | | phosphatase 16 | | |
| 1555500_s_at | SLC2A4RG | SLC2A4 regulator | Cytoplasm | transcription |
| | | | | regulator |
| 1555897_at | KDM1A | lysine (K)-specific | Nucleus | enzyme |
| | | demethylase 1A | | |
| 1556442_x_at | | | | |
| 1558953_s_at | CEP164 | centrosomal protein | Cytoplasm | other |
| | | 164 kDa | | |
| 1568877_a_at | ACBD5 | acyl-CoA binding | unknown | other |
| | | domain containing 5 | | |
| 200049_at | MYST2 | MYST histone | Nucleus | enzyme |
| | | acetyltransferase 2 | | |
| 200054_at | ZNF259 | zinc finger protein 259 | Nucleus | other |
| 200074_s_at | RPL14 | ribosomal protein L14 | Cytoplasm | other |
| 200803_s_at | TMBIM6 | transmembrane BAX | Nucleus | other |
| | | inhibitor motif | | |
| | | containing 6 | | |
| 200804_at | TMBIM6 | transmembrane BAX | Nucleus | other |
| | | inhibitor motif | | |
| | | containing 6 | | |
| 200864_s_at | RAB11A | RAB11A, member RAS | Cytoplasm | enzyme |
| | | oncogene family | | |
| 200889_s_at | SSR1 | signal sequence | Cytoplasm | other |
| | | receptor, alpha | | |
| 200925_at | COX6A1 | cytochrome c oxidase | Cytoplasm | enzyme |
| | | subunit VIa polypeptide 1 | | |
| 200927_s_at | RAB14 | RAB14, member RAS | Cytoplasm | enzyme |
| | | oncogene family | | |
| 200969_at | SERP1 | stress-associated | Cytoplasm | other |
| | | endoplasmic reticulum | | |
| | | protein 1 | | |
| 200987_x_at | PSME3 | proteasome (prosome, | Cytoplasm | peptidase |
| | | macropain) activator | | |
| | | subunit 3 (PA28 gamma; | | |
| | | Ki) | | |
| 201068_s_at | PSMC2 | proteasome (prosome, | Nucleus | peptidase |
| | | macropain) 26S subunit, | | |
| | | ATPase, 2 | | |
| 201138_s_at | SSB | Sjogren syndrome | Nucleus | enzyme |
| | | antigen B (autoantigen | | |
| | | La) | | |
| 201157_s_at | NMT1 | N-myristoyltransferase 1 | Cytoplasm | enzyme |
| 201176_s_at | ARCN1 | archain 1 | Cytoplasm | other |
| 201231_s_at | ENO1 | enolase 1, (alpha) | Cytoplasm | transcription |
| | | | | regulator |
| 201276_at | RAB5B | RAB5B, member RAS | Cytoplasm | enzyme |
| | | oncogene family | | |
| 201285_at | MKRN1 | makorin ring finger | unknown | other |
| | | protein 1 | | |
| 201306_s_at | ANP32B | acidic (leucine-rich) | Nucleus | other |
| | | nuclear phosphoprotein | | |
| | | 32 family, member B | | |
| 201336_at | VAMP3 | vesicle-associated | Plasma | other |
| | | membrane protein 3 | Membrane | |
| | | (cellubrevin) | | |
| 201370_s_at | CUL3 | cullin 3 | Nucleus | enzyme |
| 201503_at | G3BP1 | GTPase activating | Nucleus | enzyme |
| | | protein (SH3 domain) | | |
| | | binding protein 1 | | |
| 201582_at | SEC23B | Sec23 homolog B (S. cerevisiae) | Cytoplasm | transporter |
| 201623_s_at | DARS | aspartyl-tRNA | Cytoplasm | enzyme |
| | | synthetase | | |
| 201698_s_at | SRSF9 | serine/arginine-rich | Nucleus | enzyme |
| | | splicing factor 9 | | |
| 201712_s_at | RANBP2 | RAN binding protein 2 | Nucleus | enzyme |
| 201776_s_at | KIAA0494 | KIAA0494 | unknown | other |
| 201838_s_at | SUPT7L | suppressor of Ty 7 (S. cerevisiae)- | Nucleus | transcription |
| | | like | | regulator |
| 201948_at | GNL2 | guanine nucleotide | Nucleus | enzyme |
| | | binding protein-like 2 | | |
| | | (nucleolar) | | |
| 201993_x_at | HNRPDL | heterogeneous nuclear | Nucleus | other |
| | | ribonucleoprotein D-like | | |
| 202042_at | HARS | histidyl-tRNA | Cytoplasm | enzyme |
| | | synthetase | | |
| 202106_at | GOLGA3 | golgin A3 | Cytoplasm | transporter |
| 202136_at | ZMYND11 | zinc finger, MYND-type | Nucleus | other |
| | | containing 11 | | |
| 202137_s_at | ZMYND11 | zinc finger, MYND-type | Nucleus | other |
| | | containing 11 | | |
| 202144_s_at | ADSL | adenylosuccinate lyase | Cytoplasm | enzyme |
| 202170_s_at | AASDHPPT | aminoadipate- | Cytoplasm | enzyme |
| | | semialdehyde | | |
| | | dehydrogenase- | | |
| | | phosphopantetheinyl | | |
| | | transferase | | |
| 202181_at | KIAA0247 | KIAA0247 | unknown | other |
| 202249_s_at | DCAF8 | DDB1 and CUL4 | unknown | other |
| | | associated factor 8 | | |
| 202428_x_at | DBI | diazepam binding | Cytoplasm | other |
| | | inhibitor (GABA | | |
| | | receptor modulator, acyl- | | |
| | | CoA binding protein) | | |
| 202433_at | SLC35B1 | solute carrier family 35, | Cytoplasm | transporter |
| | | member B1 | | |
| 202448_s_at | ZER1 | zer-1 homolog (C. elegans) | unknown | enzyme |
| 202521_at | CTCF | CCCTC-binding factor | Nucleus | transcription |
| | | (zinc finger protein) | | regulator |
| 202636_at | RNF103 | ring finger protein 103 | Cytoplasm | enzyme |
| 202690_s_at | SNRPD1 | small nuclear | Nucleus | other |
| | | ribonucleoprotein D1 | | |
| | | polypeptide 16 kDa | | |
| 202704_at | TOB1 | transducer of ERBB2, 1 | Nucleus | transcription |
| | | | | regulator |
| 202713_s_at | KIAA0391 | KIAA0391 | unknown | other |
| 202882_x_at | NOL7 | nucleolar protein 7, | Nucleus | other |
| | | 27 kDa | | |
| 202919_at | MOBKL3 | MOB1, Mps One | Cytoplasm | other |
| | | Binder kinase activator- | | |
| | | like 3 (yeast) | | |
| 203009_at | BCAM | basal cell adhesion | Plasma | transmembrane |
| | | molecule (Lutheran | Membrane | receptor |
| | | blood group) | | |
| 203383_s_at | GOLGA1 | golgin A1 | Cytoplasm | other |
| 203384_s_at | GOLGA1 | golgin A1 | Cytoplasm | other |
| 203405_at | PSMG1 | proteasome (prosome, | Plasma | other |
| | | macropain) assembly | Membrane | |
| | | chaperone 1 | | |
| 203436_at | RPP30 | ribonuclease P/MRP | Nucleus | enzyme |
| | | 30 kDa subunit | | |
| 203492_x_at | CEP57 | centrosomal protein | Cytoplasm | other |
| | | 57 kDa | | |
| 203529_at | PPP6C | protein phosphatase 6, | Nucleus | phosphatase |
| | | catalytic subunit | | |
| 203622_s_at | PNO1 | partner of NOBI | Nucleus | other |
| | | homolog (S. cerevisiae) | | |
| 203693_s_at | E2F3 | E2F transcription factor 3 | Nucleus | transcription |
| | | | | regulator |
| 203694_s_at | DHX16 | DEAH (Asp-Glu-Ala- | Nucleus | enzyme |
| | | His) box polypeptide 16 | | |
| 203707_at | ZNF263 | zinc finger protein 263 | Nucleus | transcription |
| | | | | regulator |
| 203764_at | DLGAP5 | discs, large (Drosophila) | Nucleus | phosphatase |
| | | homolog-associated | | |
| | | protein 5 | | |
| 203825_at | BRD3 | bromodomain | Nucleus | kinase |
| | | containing 3 | | |
| 203870_at | USP46 | ubiquitin specific | unknown | peptidase |
| | | peptidase 46 | | |
| 203901_at | TAB1 | TGF-beta activated | Cytoplasm | enzyme |
| | | kinase 1/MAP3K7 | | |
| | | binding protein 1 | | |
| 203944_x_at | BTN2A1 | butyrophilin, subfamily | Plasma | other |
| | | 2, member A1 | Membrane | |
| 204028_s_at | RABGAP1 | RAB GTPase activating | Cytoplasm | other |
| | | protein 1 | | |
| 204251_s_at | CEP164 | centrosomal protein | Cytoplasm | other |
| | | 164 kDa | | |
| 204295_at | SURF1 | surfeit 1 | Cytoplasm | enzyme |
| 204315_s_at | GTSE1 | G-2 and S-phase | Cytoplasm | other |
| | | expressed 1 | | |
| 204327_s_at | ZNF202 | zinc finger protein 202 | Nucleus | transcription |
| | | | | regulator |
| 204371_s_at | KHSRP | KH-type splicing | Nucleus | enzyme |
| | | regulatory protein | | |
| 204905_s_at | EEF1E1 | eukaryotic translation | Cytoplasm | translation |
| | | elongation factor 1 | | regulator |
| | | epsilon 1 | | |
| 204977_at | DDX10 | DEAD (Asp-Glu-Ala- | Nucleus | enzyme |
| | | Asp) box polypeptide 10 | | |
| 204986_s_at | TAOK2 | TAO kinase 2 | Cytoplasm | kinase |
| 205006_s_at | NMT2 | N-myristoyltransferase 2 | Cytoplasm | enzyme |
| 205176_s_at | ITGB3BP | integrin beta 3 binding | Nucleus | other |
| | | protein (beta3- | | |
| | | endonexin) | | |
| 205252_at | ZNF174 | zinc finger protein 174 | Nucleus | transcription |
| | | | | regulator |
| 205298_s_at | BTN2A2 | butyrophilin, subfamily | unknown | other |
| | | 2, member A2 | | |
| 205423_at | AP1B1 | adaptor-related protein | Cytoplasm | transporter |
| | | complex 1, beta 1 | | |
| | | subunit | | |
| 205545_x_at | DNAJC8 | DnaJ (Hsp40) homolog, | Nucleus | other |
| | | subfamily C, member 8 | | |
| 205594_at | ZNF652 | zinc finger protein 652 | unknown | other |
| 205812_s_at | TMED9 | transmembrane emp24 | Cytoplasm | transporter |
| | | protein transport domain | | |
| | | containing 9 | | |
| 205996_s_at | AK2 | adenylate kinase 2 | Cytoplasm | kinase |
| 206098_at | ZBTB6 | zinc finger and BTB | Nucleus | other |
| | | domain containing 6 | | |
| 206174_s_at | PPP6C | protein phosphatase 6, | Nucleus | phosphatase |
| | | catalytic subunit | | |
| 206452_x_at | PPP2R4 | protein phosphatase 2A | Cytoplasm | phosphatase |
| | | activator, regulatory | | |
| | | subunit 4 | | |
| 207112_s_at | GAB1 | GRB2-associated | Cytoplasm | other |
| | | binding protein 1 | | |
| 207458_at | C8orf51 | chromosome 8 open | unknown | other |
| | | reading frame 51 | | |
| 207573_x_at | ATP5L | ATP synthase, H+ | Cytoplasm | transporter |
| | | transporting, | | |
| | | mitochondrial Fo | | |
| | | complex, subunit G | | |
| 208002_s_at | ACOT7 | acyl-CoA thioesterase 7 | Cytoplasm | enzyme |
| 208398_s_at | TBPL1 | TBP-like 1 | Nucleus | transcription |
| | | | | regulator |
| 208405_s_at | CD164 | CD164 molecule, | Plasma | other |
| | | sialomucin | Membrane | |
| 208627_s_at | YBX1 | Y box binding protein 1 | Nucleus | transcription |
| | | | | regulator |
| 208636_at | ACTN1 | actinin, alpha 1 | Cytoplasm | other |
| 208637_x_at | ACTN1 | actinin, alpha 1 | Cytoplasm | other |
| 208659_at | CLIC1 | chloride intracellular | Nucleus | ion channel |
| | | channel 1 | | |
| 208736_at | ARPC3 | actin related protein 2/3 | Cytoplasm | other |
| | | complex, subunit 3, | | |
| | | 21 kDa | | |
| 208737_at | ATP6V1G1 | ATPase, H+ | Cytoplasm | transporter |
| | | transporting, lysosomal | | |
| | | 13 kDa, V1 subunit G1 | | |
| 208746_x_at | ATP5L | ATP synthase, H+ | Cytoplasm | transporter |
| | | transporting, | | |
| | | mitochondrial Fo | | |
| | | complex, subunit G | | |
| 208756_at | EIF3I | eukaryotic translation | Cytoplasm | translation |
| | | initiation factor 3, | | regulator |
| | | subunit I | | |
| 208839_s_at | CAND1 | cullin-associated and | Cytoplasm | transcription |
| | | neddylation-dissociated 1 | | regulator |
| 208841_s_at | G3BP2 | GTPase activating | Nucleus | enzyme |
| | | protein (SH3 domain) | | |
| | | binding protein 2 | | |
| 208874_x_at | PPP2R4 | protein phosphatase 2A | Cytoplasm | phosphatase |
| | | activator, regulatory | | |
| | | subunit 4 | | |
| 208974_x_at | KPNB1 | karyopherin (importin) | Nucleus | transporter |
| | | beta 1 | | |
| 208975_s_at | KPNB1 | karyopherin (importin) | Nucleus | transporter |
| | | beta 1 | | |
| 209232_s_at | DCTN5 | dynactin 5 (p25) | unknown | other |
| 209390_at | TSC1 | tuberous sclerosis 1 | Cytoplasm | other |
| 209391_at | DPM2 | dolichyl-phosphate | Cytoplasm | enzyme |
| | | mannosyltransferase | | |
| | | polypeptide 2, regulatory | | |
| | | subunit | | |
| 209537_at | EXTL2 | exostoses (multiple)-like 2 | Cytoplasm | enzyme |
| 209623_at | MCCC2 | methylcrotonoyl-CoA | Cytoplasm | enzyme |
| | | carboxylase 2 (beta) | | |
| 209624_s_at | MCCC2 | methylcrotonoyl-CoA | Cytoplasm | enzyme |
| | | carboxylase 2 (beta) | | |
| 209630_s_at | FBXW2 | F-box and WD repeat | Cytoplasm | enzyme |
| | | domain containing 2 | | |
| 209642_at | BUB1 | budding uninhibited by | Nucleus | kinase |
| | | benzimidazoles 1 | | |
| | | homolog (yeast) | | |
| 209654_at | KIAA0947 | KIAA0947 | unknown | other |
| 209694_at | PTS | 6- | Cytoplasm | enzyme |
| | | pyruvoyltetrahydropterin | | |
| | | synthase | | |
| 209798_at | NPAT | nuclear protein, ataxia- | Nucleus | transcription |
| | | telangiectasia locus | | regulator |
| 209820_s_at | TBL3 | transducin (beta)-like 3 | Cytoplasm | peptidase |
| 210005_at | GART | phosphoribosylglycinamide | Cytoplasm | enzyme |
| | | formyltransferase, | | |
| | | phosphoribosylglycinamide | | |
| | | synthetase, | | |
| | | phosphoribosylaminoimidazole | | |
| | | synthetase | | |
| 210097_s_at | NOL7 | nucleolar protein 7, | Nucleus | other |
| | | 27 kDa | | |
| 210158_at | ERCC4 | excision repair cross- | Nucleus | enzyme |
| | | complementing rodent | | |
| | | repair deficiency, | | |
| | | complementation group 4 | | |
| 210453_x_at | ATP5L | ATP synthase, H+ | Cytoplasm | transporter |
| | | transporting, | | |
| | | mitochondrial Fo | | |
| | | complex, subunit G | | |
| 210466_s_at | SERBP1 | SERPINE1 mRNA | Nucleus | other |
| | | binding protein 1 | | |
| 210581_x_at | PATZ1 | POZ (BTB) and AT | Nucleus | transcription |
| | | hook containing zinc | | regulator |
| | | finger 1 | | |
| 210740_s_at | ITPK1 | inositol 1,3,4- | Cytoplasm | kinase |
| | | triphosphate 5/6 kinase | | |
| 211150_s_at | DLAT | dihydrolipoamide S- | Cytoplasm | enzyme |
| | | acetyltransferase | | |
| 211392_s_at | PATZ1 | POZ (BTB) and AT | Nucleus | transcription |
| | | hook containing zinc | | regulator |
| | | finger 1 | | |
| 211503_s_at | RAB14 | RAB14, member RAS | Cytoplasm | enzyme |
| | | oncogene family | | |
| 211584_s_at | NPAT | nuclear protein, ataxia- | Nucleus | transcription |
| | | telangiectasia locus | | regulator |
| 211749_s_at | VAMP3 | vesicle-associated | Plasma | other |
| | | membrane protein 3 | Membrane | |
| | | (cellubrevin) | | |
| 211787_s_at | EIF4A1 | eukaryotic translation | Cytoplasm | translation |
| | | initiation factor 4A1 | | regulator |
| 211936_at | HSPA5 | heat shock 70 kDa | Cytoplasm | other |
| | | protein 5 (glucose- | | |
| | | regulated protein, | | |
| | | 78 kDa) | | |
| 211979_at | GPR107 | G protein-coupled | Plasma | G-protein |
| | | receptor 107 | Membrane | coupled receptor |
| 211985_s_at | CALM1 | calmodulin 1 | unknown | other |
| | (includes others) | (phosphorylase kinase, | | |
| | | delta) | | |
| 212032_s_at | PTOV1 | prostate tumor | Nucleus | other |
| | | overexpressed 1 | | |
| 212053_at | PDXDC1 | pyridoxal-dependent | unknown | other |
| | | decarboxylase domain | | |
| | | containing 1 | | |
| 212064_x_at | MAZ | MYC-associated zinc | Nucleus | transcription |
| | | finger protein (purine- | | regulator |
| | | binding transcription | | |
| | | factor) | | |
| 212164_at | TMEM183A | transmembrane protein | unknown | other |
| | | 183A | | |
| 212246_at | MCFD2 | multiple coagulation | Cytoplasm | other |
| | | factor deficiency 2 | | |
| 212320_at | TUBB | tubulin, beta | Cytoplasm | other |
| 212367_at | FEM1B | fem-1 homolog b (C. elegans) | Nucleus | transcription |
| | | | | regulator |
| 212400_at | FAM102A | family with sequence | unknown | other |
| | | similarity 102, member A | | |
| 212403_at | UBE3B | ubiquitin protein ligase | unknown | enzyme |
| | | E3B | | |
| 212404_s_at | UBE3B | ubiquitin protein ligase | unknown | enzyme |
| | | E3B | | |
| 212485_at | GPATCH8 | G patch domain | unknown | other |
| | | containing 8 | | |
| 212487_at | GPATCH8 | G patch domain | unknown | other |
| | | containing 8 | | |
| 212506_at | PICALM | phosphatidylinositol | Cytoplasm | other |
| | | binding clathrin | | |
| | | assembly protein | | |
| 212547_at | BRD3 | bromodomain | Nucleus | kinase |
| | | containing 3 | | |
| 212568_s_at | DLAT | dihydrolipoamide S- | Cytoplasm | enzyme |
| | | acetyltransferase | | |
| 212571_at | CHD8 | chromodomain helicase | Nucleus | enzyme |
| | | DNA binding protein 8 | | |
| 212637_s_at | WWP1 | WW domain containing | Cytoplasm | enzyme |
| | | E3 ubiquitin protein | | |
| | | ligase 1 | | |
| 212638_s_at | WWP1 | WW domain containing | Cytoplasm | enzyme |
| | | E3 ubiquitin protein | | |
| | | ligase 1 | | |
| 212652_s_at | SNX4 | sorting nexin 4 | Cytoplasm | transporter |
| 212653_s_at | EHBP1 | EH domain binding | unknown | other |
| | | protein 1 | | |
| 212729_at | DLG3 | discs, large homolog 3 | Plasma | kinase |
| | | (Drosophila) | Membrane | |
| 212858_at | PAQR4 | progestin and adipoQ | unknown | other |
| | | receptor family member | | |
| | | IV | | |
| 212871_at | MAPKAPK5 | mitogen-activated | Cytoplasm | kinase |
| | | protein kinase-activated | | |
| | | protein kinase 5 | | |
| 212920_at | REST | RE1-silencing | Nucleus | transcription |
| | | transcription factor | | regulator |
| 213025_at | THUMPD1 | THUMP domain | unknown | other |
| | | containing 1 | | |
| 213102_at | ACTR3 | ARP3 actin-related | Plasma | other |
| | | protein 3 homolog | Membrane | |
| | | (yeast) | | |
| 213120_at | UHRF1BP1L | UHRF1 binding protein | unknown | other |
| | | 1-like | | |
| 213141_at | PSKH1 | protein serine kinase H1 | Nucleus | kinase |
| 213145_at | FBXL14 | F-box and leucine-rich | unknown | other |
| | | repeat protein 14 | | |
| 213185_at | KIAA0556 | KIAA0556 | Extracellular | other |
| | | | Space | |
| 213196_at | ZNF629 | zinc finger protein 629 | Nucleus | other |
| 213237_at | C16orf88 | chromosome 16 open | unknown | other |
| | | reading frame 88 | | |
| 213313_at | RABGAP1 | RAB GTPase activating | Cytoplasm | other |
| | | protein 1 | | |
| 213398_s_at | SDR39U1 | short chain | unknown | other |
| | | dehydrogenase/reductase | | |
| | | family 39U, member 1 | | |
| 213473_at | BRAP | BRCA1 associated | Cytoplasm | enzyme |
| | | protein | | |
| 213615_at | LPCAT3 | lysophosphatidylcholine | Plasma | other |
| | | acyltransferase 3 | Membrane | |
| 213681_at | CYHR1 | cysteine/histidine-rich 1 | unknown | other |
| 213688_at | CALM1 | calmodulin 1 | unknown | other |
| | (includes others) | (phosphorylase kinase, | | |
| | | delta) | | |
| 213743_at | CCNT2 | cyclin T2 | Nucleus | transcription |
| | | | | regulator |
| 213798_s_at | CAP1 | CAP, adenylate cyclase- | Plasma | other |
| | | associated protein 1 | Membrane | |
| | | (yeast) | | |
| 213803_at | KPNB1 | karyopherin (importin) | Nucleus | transporter |
| | | beta 1 | | |
| 213864_s_at | NAP1L1 | nucleosome assembly | Nucleus | other |
| | | protein 1-like 1 | | |
| 214011_s_at | NOP16 | NOP16 nucleolar | Nucleus | other |
| | | protein homolog (yeast) | | |
| 214070_s_at | ATP10B | ATPase, class V, type | Plasma | transporter |
| | | 10B | Membrane | |
| 214138_at | ZNF79 | zinc finger protein 79 | Nucleus | other |
| 214635_at | CLDN9 | claudin 9 | Plasma | other |
| | | | Membrane | |
| 215088_s_at | SDHC | succinate | Cytoplasm | enzyme |
| | | dehydrogenase complex, | | |
| | | subunit C, integral | | |
| | | membrane protein, | | |
| | | 15 kDa | | |
| 215207_x_at | NUS1 | nuclear undecaprenyl | unknown | other |
| | | pyrophosphate synthase | | |
| | | 1 homolog (S. cerevisiae) | | |
| 215493_x_at | BTN2A1 | butyrophilin, subfamily | Plasma | other |
| | | 2, member A1 | Membrane | |
| 215696_s_at | SEC16A | SEC16 homolog A (S. cerevisiae) | Cytoplasm | phosphatase |
| 215792_s_at | DNAJC11 | DnaJ (Hsp40) homolog, | Cytoplasm | other |
| | | subfamily C, member 11 | | |
| 216105_x_at | PPP2R4 | protein phosphatase 2A | Cytoplasm | phosphatase |
| | | activator, regulatory | | |
| | | subunit 4 | | |
| 216326_s_at | HDAC3 | histone deacetylase 3 | Nucleus | transcription |
| | | | | regulator |
| 216389_s_at | DCAF11 | DDB1 and CUL4 | unknown | other |
| | | associated factor 11 | | |
| 216591_s_at | SDHC | succinate | Cytoplasm | enzyme |
| | | dehydrogenase complex, | | |
| | | subunit C, integral | | |
| | | membrane protein, | | |
| | | 15 kDa | | |
| 217294_s_at | ENO1 | enolase 1, (alpha) | Cytoplasm | transcription |
| | | | | regulator |
| 217747_s_at | RPS9 | ribosomal protein S9 | Cytoplasm | translation |
| | | | | regulator |
| 217777_s_at | PTPLAD1 | protein tyrosine | Cytoplasm | other |
| | | phosphatase-like A | | |
| | | domain containing 1 | | |
| 217971_at | LAMTOR3 | late | Cytoplasm | other |
| | | endosomal/lysosomal | | |
| | | adaptor, MAPK and | | |
| | | MTOR activator 3 | | |
| 217994_x_at | CPSF3L | cleavage and | Nucleus | other |
| | | polyadenylation specific | | |
| | | factor 3-like | | |
| 218107_at | WDR26 | WD repeat domain 26 | Cytoplasm | other |
| 218333_at | DERL2 | Der1-like domain | Cytoplasm | other |
| | | family, member 2 | | |
| 218367_x_at | USP21 | ubiquitin specific | Cytoplasm | peptidase |
| | | peptidase 21 | | |
| 218494_s_at | SLC2A4RG | SLC2A4 regulator | Cytoplasm | transcription |
| | | | | regulator |
| 218512_at | WDR12 | WD repeat domain 12 | Cytoplasm | other |
| 218527_at | APTX | aprataxin | Nucleus | phosphatase |
| 218555_at | ANAPC2 | anaphase promoting | Nucleus | enzyme |
| | | complex subunit 2 | | |
| 218558_s_at | MRPL39 | mitochondrial ribosomal | Cytoplasm | other |
| | | protein L39 | | |
| 218561_s_at | LYRM4 | LYR motif containing 4 | Cytoplasm | other |
| 218566_s_at | CHORDC1 | cysteine and histidine- | unknown | other |
| | | rich domain (CHORD) | | |
| | | containing 1 | | |
| 218577_at | LRRC40 | leucine rich repeat | Nucleus | other |
| | | containing 40 | | |
| 218626_at | EIF4ENIF1 | eukaryotic translation | Cytoplasm | translation |
| | | initiation factor 4E | | regulator |
| | | nuclear import factor 1 | | |
| 218646_at | C4orf27 | chromosome 4 open | Nucleus | other |
| | | reading frame 27 | | |
| 218661_at | NAT15 | N-acetyltransferase 15 | unknown | enzyme |
| | | (GCN5-related, putative) | | |
| 218696_at | EIF2AK3 | eukaryotic translation | Cytoplasm | kinase |
| | | initiation factor 2-alpha | | |
| | | kinase 3 | | |
| 218715_at | UTP6 | UTP6, small subunit | Nucleus | other |
| | | (SSU) processome | | |
| | | component, homolog | | |
| | | (yeast) | | |
| 218754_at | NOL9 | nucleolar protein 9 | Nucleus | other |
| 218886_at | PAK1IP1 | PAK1 interacting | Nucleus | other |
| | | Protein 1 | | |
| 218982_s_at | MRPS17 | mitochondrial ribosomal | Cytoplasm | other |
| | | protein S17 | | |
| 219023_at | AP1AR | adaptor-related protein | Cytoplasm | other |
| | | complex 1 associated | | |
| | | regulatory protein | | |
| 219081_at | ANKHD1 | ankyrin repeat and KH | Nucleus | transcription |
| | | domain containing 1 | | regulator |
| 219086_at | ZNF839 | zinc finger protein 839 | unknown | other |
| 219098_at | MYBBP1A | MYB binding protein | Nucleus | transcription |
| | | (P160) 1a | | regulator |
| 219122_s_at | THG1L | tRNA-histidine | Cytoplasm | enzyme |
| | | guanylyltransferase 1- | | |
| | | like (S. cerevisiae) | | |
| 219223_at | C9orf7 | chromosome 9 open | unknown | other |
| | | reading frame 7 | | |
| 219237_s_at | DNAJB14 | DnaJ (Hsp40) homolog, | unknown | enzyme |
| | | subfamily B, member 14 | | |
| 219339_s_at | EHMT1 | euchromatic histone- | Nucleus | transcription |
| | | lysine N- | | regulator |
| | | methyltransferase 1 | | |
| 219374_s_at | ALG9 | asparagine-linked | Cytoplasm | enzyme |
| | | glycosylation 9, alpha- | | |
| | | 1,2-mannosyltransferase | | |
| | | homolog (S. cerevisiae) | | |
| 219679_s_at | WAC | WW domain containing | Nucleus | other |
| | | adaptor with coiled-coil | | |
| 219767_s_at | CRYZL1 | crystallin, zeta (quinone | Cytoplasm | enzyme |
| | | reductase)-like 1 | | |
| 219929_s_at | ZFYVE21 | zinc finger, FYVE | unknown | other |
| | | domain containing 21 | | |
| 220052_s_at | TINF2 | TERF1 (TRF1)- | Nucleus | other |
| | | interacting nuclear factor 2 | | |
| 220419_s_at | USP25 | ubiquitin specific | unknown | peptidase |
| | | peptidase 25 | | |
| 220606_s_at | C17orf48 | chromosome 17 open | unknown | other |
| | | reading frame 48 | | |
| 220947_s_at | TBC1D10B | TBC1 domain family, | unknown | enzyme |
| | | member 10B | | |
| 220964_s_at | RAB1B | RAB1B, member RAS | Cytoplasm | enzyme |
| | | oncogene family | | |
| 221096_s_at | TMCO6 | transmembrane and | unknown | other |
| | | coiled-coil domains 6 | | |
| 221230_s_at | ARID4B | AT rich interactive | Nucleus | other |
| | | domain 4B (RBP1-like) | | |
| 221253_s_at | TXNDC5 | thioredoxin domain | Cytoplasm | enzyme |
| | | containing 5 | | |
| | | (endoplasmic reticulum) | | |
| 221263_s_at | SF3B5 | splicing factor 3b, | Nucleus | other |
| | | subunit 5, 10 kDa | | |
| 221488_s_at | CUTA | cutA divalent cation | unknown | other |
| | | tolerance homolog (E. coli) | | |
| 221517_s_at | MED17 | mediator complex | Nucleus | transcription |
| | | subunit 17 | | regulator |
| 221685_s_at | CCDC99 | coiled-coil domain | Nucleus | other |
| | | containing 99 | | |
| 221691_x_at | NPM1 | nucleophosmin | Nucleus | transcription |
| | | (nucleolar | | regulator |
| | | phosphoprotein B23, | | |
| | | numatrin) | | |
| 221769_at | SPSB3 | splA/ryanodine receptor | unknown | other |
| | | domain and SOCS box | | |
| | | containing 3 | | |
| 221836_s_at | TRAPPC9 | trafficking protein | Plasma | other |
| | | particle complex 9 | Membrane | |
| 221869_at | ZNF512B | zinc finger protein 512B | Nucleus | other |
| 221923_s_at | NPM1 | nucleophosmin | Nucleus | transcription |
| | | (nucleolar | | regulator |
| | | phosphoprotein B23, | | |
| | | numatrin) | | |
| 221934_s_at | DALRD3 | DALR anticodon | unknown | other |
| | | binding domain | | |
| | | containing 3 | | |
| 222000_at | C1orf174 | chromosome 1 open | unknown | other |
| | | reading frame 174 | | |
| 222039_at | KIF18B | kinesin family member | unknown | other |
| | | 18B | | |
| 222229_x_at | RPL26 | ribosomal protein L26 | Cytoplasm | other |
| 222283_at | ZNF480 | zinc finger protein 480 | Nucleus | other |
| 222405_at | PTPLAD1 | protein tyrosine | Cytoplasm | other |
| | | phosphatase-like A | | |
| | | domain containing 1 | | |
| 222518_at | ARFGEF2 | ADP-ribosylation factor | Cytoplasm | other |
| | | guanine nucleotide- | | |
| | | exchange factor 2 | | |
| | | (brefeldin A-inhibited) | | |
| 222646_s_at | ERO1L | ERO1-like (S. cerevisiae) | Cytoplasm | enzyme |
| 222720_x_at | C1orf27 | chromosome 1 open | unknown | other |
| | | reading frame 27 | | |
| 222850_s_at | DNAJB14 | DnaJ (Hsp40) homolog, | unknown | enzyme |
| | | subfamily B, member 14 | | |
| 222873_s_at | EHMT1 | euchromatic histone- | Nucleus | transcription |
| | | lysine N- | | regulator |
| | | methyltransferase 1 | | |
| 222875_at | DHX33 | DEAH (Asp-Glu-Ala- | Nucleus | enzyme |
| | | His) box polypeptide 33 | | |
| 222887_s_at | TMEM127 | transmembrane protein | unknown | other |
| | | 127 | | |
| 223010_s_at | OCIAD1 | OCIA domain | Cytoplasm | other |
| | | containing 1 | | |
| 223016_x_at | ZRANB2 | zinc finger, RAN- | Nucleus | transcription |
| | | binding domain | | regulator |
| | | containing 2 | | |
| 223067_at | CWC15 | CWC15 spliceosome- | Nucleus | other |
| | | associated protein | | |
| | | homolog (S. cerevisiae) | | |
| 223105_s_at | TMEM14C | transmembrane protein | Plasma | other |
| | | 14C | Membrane | |
| 223151_at | DCUN1D5 | DCN1, defective in | unknown | other |
| | | cullin neddylation 1, | | |
| | | domain containing 5 (S. cerevisiae) | | |
| 223288_at | USP38 | ubiquitin specific | unknown | peptidase |
| | | peptidase 38 | | |
| 223289_s_at | USP38 | ubiquitin specific | unknown | peptidase |
| | | peptidase 38 | | |
| 223334_at | TMEM126A | transmembrane protein | Cytoplasm | other |
| | | 126A | | |
| 223336_s_at | RAB18 | RAB18, member RAS | Cytoplasm | enzyme |
| | | oncogene family | | |
| 223401_at | C17orf48 | chromosome 17 open | unknown | other |
| | | reading frame 48 | | |
| 223440_at | C16orf70 | chromosome 16 open | Cytoplasm | other |
| | | reading frame 70 | | |
| 223716_s_at | ZRANB2 | zinc finger, RAN- | Nucleus | transcription |
| | | binding domain | | regulator |
| | | containing 2 | | |
| 223776_x_at | TINF2 | TERF1 (TRF1)- | Nucleus | other |
| | | interacting nuclear factor 2 | | |
| 223907_s_at | PINX1 | PIN2/TERF1 | Nucleus | other |
| | | interacting, telomerase | | |
| | | inhibitor 1 | | |
| 223954_x_at | NECAB3 | N-terminal EF-hand | Cytoplasm | other |
| | | calcium binding protein 3 | | |
| 224312_x_at | CPSF3L | cleavage and | Nucleus | other |
| | | polyadenylation specific | | |
| | | factor 3-like | | |
| 224445_s_at | ZFYVE21 | zinc finger, FYVE | unknown | other |
| | | domain containing 21 | | |
| 224450_s_at | RIOK1 | RIO kinase 1 (yeast) | unknown | kinase |
| 224504_s_at | BUD13 | BUD13 homolog (S. cerevisiae) | Nucleus | other |
| 224523_s_at | C3orf26 | chromosome 3 open | unknown | other |
| | | reading frame 26 | | |
| 224610_at | SNHG1 | small nucleolar RNA | unknown | other |
| | | host gene 1 (non-protein | | |
| | | coding) | | |
| 224612_s_at | DNAJC5 | DnaJ (Hsp40) homolog, | Plasma | other |
| | | subfamily C, member 5 | Membrane | |
| 224613_s_at | DNAJC5 | DnaJ (Hsp40) homolog, | Plasma | other |
| | | subfamily C, member 5 | Membrane | |
| 224654_at | DDX21 | DEAD (Asp-Glu-Ala- | Nucleus | enzyme |
| | | Asp) box polypeptide 21 | | |
| 224777_s_at | PAFAH1B2 | platelet-activating factor | Cytoplasm | enzyme |
| | | acetylhydrolase 1b, | | |
| | | catalytic subunit 2 | | |
| | | (30 kDa) | | |
| 224789_at | DCAF12 | DDB1 and CUL4 | Cytoplasm | other |
| | | associated factor 12 | | |
| 224809_x_at | TINF2 | TERF1 (TRF1)- | Nucleus | other |
| | | interacting nuclear factor 2 | | |
| 224986_s_at | PDPK1 | 3-phosphoinositide | Cytoplasm | kinase |
| | | dependent protein | | |
| | | kinase-1 | | |
| 224998_at | CMTM4 | CKLF-like MARVEL | Extracellular | cytokine |
| | | transmembrane domain | Space | |
| | | containing 4 | | |
| 225023_at | GOPC | golgi-associated PDZ | Cytoplasm | transporter |
| | | and coiled-coil motif | | |
| | | containing | | |
| 225052_at | TMEM203 | transmembrane protein | unknown | other |
| | | 203 | | |
| 225172_at | CRAMP1L | Crm, cramped-like | unknown | other |
| | | (Drosophila) | | |
| 225194_at | PLRG1 | pleiotropic regulator 1 | Nucleus | transcription |
| | | (PRL1 homolog, | | regulator |
| | | Arabidopsis) | | |
| 225231_at | CBL | Cas-Br-M (murine) | Nucleus | transcription |
| | | ecotropic retroviral | | regulator |
| | | transforming sequence | | |
| 225276_at | GSPT1 | G1 to S phase transition 1 | Cytoplasm | translation |
| | | | | regulator |
| 225426_at | PPP6C | protein phosphatase 6, | Nucleus | phosphatase |
| | | catalytic subunit | | |
| 225429_at | PPP6C | protein phosphatase 6, | Nucleus | phosphatase |
| | | catalytic subunit | | |
| 225461_at | EHMT1 | euchromatic histone- | Nucleus | transcription |
| | | lysine N- | | regulator |
| | | methyltransferase 1 | | |
| 225545_at | EEF2K | eukaryotic elongation | Cytoplasm | kinase |
| | | factor-2 kinase | | |
| 225659_at | SPOPL | speckle-type POZ | unknown | other |
| | | protein-like | | |
| 225663_at | ACBD5 | acyl-CoA binding | unknown | other |
| | | domain containing 5 | | |
| 225672_at | GOLGA2 | golgin A2 | Cytoplasm | other |
| 225719_s_at | MRPL55 | mitochondrial ribosomal | Cytoplasm | other |
| | | protein L55 | | |
| 225771_at | AP1G1 | adaptor-related protein | Cytoplasm | transporter |
| | | complex 1, gamma 1 | | |
| | | subunit | | |
| 225779_at | SLC27A4 | solute carrier family 27 | Plasma | transporter |
| | | (fatty acid transporter), | Membrane | |
| | | member 4 | | |
| 225831_at | LUZP1 | leucine zipper protein 1 | Nucleus | other |
| 225866_at | RPF2 | ribosome production | Nucleus | other |
| | | factor 2 homolog (S. cerevisiae) | | |
| 225878_at | KIF1B | kinesin family member | Cytoplasm | transporter |
| | | 1B | | |
| 225993_at | EARS2 | glutamyl-tRNA | Cytoplasm | enzyme |
| | | synthetase 2, | | |
| | | mitochondrial (putative) | | |
| 225998_at | GAB1 | GRB2-associated | Cytoplasm | other |
| | | binding protein 1 | | |
| 226115_at | AHCTF1 | AT hook containing | Nucleus | transcription |
| | | transcription factor 1 | | regulator |
| 226151_x_at | CRYZL1 | crystallin, zeta (quinone | Cytoplasm | enzyme |
| | | reductase)-like 1 | | |
| 226262_at | DHX33 | DEAH (Asp-Glu-Ala- | Nucleus | enzyme |
| | | His) box polypeptide 33 | | |
| 226268_at | RAB21 | RAB21, member RAS | Cytoplasm | enzyme |
| | | oncogene family | | |
| 226298_at | RUNDC1 | RUN domain containing 1 | unknown | other |
| 226329_s_at | MITD1 | MIT, microtubule | unknown | other |
| | | interacting and transport, | | |
| | | domain containing 1 | | |
| 226399_at | | | | |
| 226493_at | KCTD18 | potassium channel | unknown | other |
| | | tetramerisation domain | | |
| | | containing 18 | | |
| 226531_at | ORAI1 | ORAI calcium release- | Plasma | ion channel |
| | | activated calcium | Membrane | |
| | | modulator 1 | | |
| 226566_at | TRIM11 | tripartite motif | Cytoplasm | other |
| | | containing 11 | | |
| 226679_at | SLC26A11 | solute carrier family 26, | Cytoplasm | transporter |
| | | member 11 | | |
| 226692_at | SERF2 | small EDRK-rich factor 2 | unknown | other |
| 226784_at | TWISTNB | TWIST neighbor | Nucleus | other |
| 226849_at | DENND1A | DENN/MADD domain | Plasma | other |
| | | containing 1A | Membrane | |
| 226874_at | KLHL8 | kelch-like 8 | unknown | other |
| | | (Drosophila) | | |
| 226936_at | CENPW | centromere protein W | unknown | other |
| 226967_at | FIZ1 | FLT3-interacting zinc | Nucleus | other |
| | | finger 1 | | |
| 226968_at | KIF1B | kinesin family member | Cytoplasm | transporter |
| | | 1B | | |
| 226981_at | MLL | myeloid/lymphoid or | Nucleus | transcription |
| | | mixed-lineage leukemia | | regulator |
| | | (trithorax homolog, | | |
| | | Drosophila) | | |
| 227029_at | FAM177A1 | family with sequence | unknown | other |
| | | similarity 177, member | | |
| | | A1 | | |
| 227207_x_at | ZNF213 | zinc finger protein 213 | Nucleus | transcription |
| | | | | regulator |
| 227208_at | CCDC84 | coiled-coil domain | unknown | other |
| | | containing 84 | | |
| 227412_at | PPP1R3E | protein phosphatase 1, | unknown | other |
| | | regulatory (inhibitor) | | |
| | | subunit 3E | | |
| 227541_at | WDR20 | WD repeat domain 20 | unknown | other |
| 227562_at | LAMTOR3 | late | Cytoplasm | other |
| | | endosomal/lysosomal | | |
| | | adaptor, MAPK and | | |
| | | MTOR activator 3 | | |
| 227739_at | NDOR1 | NADPH dependent | Cytoplasm | enzyme |
| | | diflavin oxidoreductase 1 | | |
| 227813_at | THAP6 | THAP domain | unknown | other |
| | | containing 6 | | |
| 227876_at | ARHGAP39 | Rho GTPase activating | Nucleus | other |
| | | protein 39 | | |
| 227908_at | TBC1D24 | TBC1 domain family, | Cytoplasm | other |
| | | member 24 | | |
| 228200_at | ZNF252 | zinc finger protein 252 | unknown | other |
| 228216_at | | | | |
| 228217_s_at | PSMG4 | proteasome (prosome, | unknown | transcription |
| | | macropain) assembly | | regulator |
| | | chaperone 4 | | |
| 228355_s_at | NDUFAF2 | NADH dehydrogenase | Cytoplasm | other |
| | | (ubiquinone) 1 alpha | | |
| | | subcomplex, assembly | | |
| | | factor 2 | | |
| 228437_at | CNIH4 | cornichon homolog 4 | Plasma | other |
| | | (Drosophila) | Membrane | |
| 228457_at | | | | |
| 228566_at | RPRD1A | regulation of nuclear | unknown | other |
| | | pre-mRNA domain | | |
| | | containing 1A | | |
| 228612_at | LOC100506233 | hypothetical | unknown | other |
| | | LOC100506233 | | |
| 228710_at | | | | |
| 228774_at | CEP78 | centrosomal protein | Cytoplasm | other |
| | | 78 kDa | | |
| 229375_at | PPIE | peptidylprolyl isomerase | Nucleus | enzyme |
| | | E (cyclophilin E) | | |
| 229466_at | TRIM66 | tripartite motif | Nucleus | transcription |
| | | containing 66 | | regulator |
| 229582_at | INO80C | INO80 complex subunit C | Nucleus | other |
| 229867_at | BTBD9 | BTB (POZ) domain | unknown | other |
| | | containing 9 | | |
| 230106_at | ZXDC | ZXD family zinc finger C | unknown | transcription |
| | | | | regulator |
| 230165_at | SGOL2 | shugoshin-like 2 (S. pombe) | Nucleus | other |
| 230241_at | TOR1AIP2 | torsin A interacting | Cytoplasm | other |
| | | protein 2 | | |
| 230379_x_at | C2orf56 | chromosome 2 open | Cytoplasm | other |
| | | reading frame 56 | | |
| 230623_x_at | USP28 | ubiquitin specific | Nucleus | peptidase |
| | | peptidase 28 | | |
| 231065_at | PDE6D | phosphodiesterase 6D, | Cytoplasm | enzyme |
| | | cGMP-specific, rod, | | |
| | | delta | | |
| 231111_at | | | | |
| 231437_at | SLC35D2 | solute carrier family 35, | Cytoplasm | transporter |
| | | member D2 | | |
| 232219_x_at | USP21 | ubiquitin specific | Cytoplasm | peptidase |
| | | peptidase 21 | | |
| 232860_x_at | RBM41 | RNA binding motif | unknown | other |
| | | protein 41 | | |
| 233625_x_at | CPSF3L | cleavage and | Nucleus | other |
| | | polyadenylation specific | | |
| | | factor 3-like | | |
| 233732_at | LOC401320 | hypothetical | unknown | other |
| | | LOC401320 | | |
| 234735_s_at | USP21 | ubiquitin specific | Cytoplasm | peptidase |
| | | peptidase 21 | | |
| 234998_at | | | | |
| 235040_at | RUNDC1 | RUN domain containing 1 | unknown | other |
| 235577_at | ZNF652 | zinc finger protein 652 | unknown | other |
| 235610_at | ALKBH8 | alkB, alkylation repair | Cytoplasm | enzyme |
| | | homolog 8 (E. coli) | | |
| 235677_at | SRR | serine racemase | Cytoplasm | enzyme |
| 235971_at | | | | |
| 236160_at | TRIP11 | thyroid hormone | Cytoplasm | transcription |
| | | receptor interactor 11 | | regulator |
| 236165_at | MSL3 | male-specific lethal 3 | Nucleus | transcription |
| | | homolog (Drosophila) | | regulator |
| 238538_at | ANKRD11 | ankyrin repeat domain | Nucleus | other |
| | | 11 | | |
| 238660_at | WDFY3 | WD repeat and FYVE | Cytoplasm | enzyme |
| | | domain containing 3 | | |
| 238765_at | ATP6V1G1 | ATPase, H+ | Cytoplasm | transporter |
| | | transporting, lysosomal | | |
| | | 13 kDa, V1 subunit G1 | | |
| 238797_at | TRIM11 | tripartite motif | Cytoplasm | other |
| | | containing 11 | | |
| 239053_at | CIAO1 | cytosolic iron-sulfur | Nucleus | transcription |
| | | protein assembly 1 | | regulator |
| 239081_at | | | | |
| 239324_at | | | | |
| 239329_at | | | | |
| 239616_at | REXO2 | REX2, RNA | Cytoplasm | enzyme |
| | | exonuclease 2 homolog | | |
| | | (S. cerevisiae) | | |
| 239794_at | | | | |
| 240499_at | | | | |
| 240538_at | | | | |
| 241627_x_at | ARHGEF40 | Rho guanine nucleotide | unknown | other |
| | | exchange factor (GEF) | | |
| | | 40 | | |
| 241721_at | | | | |
| 242019_at | LASS6 | LAG1 homolog, | Nucleus | transcription |
| | | ceramide synthase 6 | | regulator |
| 242145_at | | | | |
| 242389_at | | | | |
| 242684_at | ZNF425 | zinc finger protein 425 | unknown | other |
| 242923_at | ZNF678 | zinc finger protein 678 | Nucleus | other |
| 243055_at | | | | |
| 243690_at | TRIOBP | TRIO and F-actin | Nucleus | other |
| | | binding protein | | |
| 244022_at | | | | |
| 244765_at | | | | |
| 32029_at | PDPK1 | 3-phosphoinositide | Cytoplasm | kinase |
| | | dependent protein | | |
| | | kinase-1 | | |
| 35436_at | GOLGA2 | golgin A2 | Cytoplasm | other |
| 37831_at | SIPA1L3 | signal-induced | unknown | other |
| | | proliferation-associated | | |
| | | 1 like 3 | | |
| 40465_at | DDX23 | DEAD (Asp-Glu-Ala- | Nucleus | enzyme |
| | | Asp) box polypeptide 23 | | |
| 41512_at | BRAP | BRCA1 associated | Cytoplasm | enzyme |
| | | protein | | |
| 44563_at | WRAP53 | WD repeat containing, | Nucleus | other |
| | | antisense to TP53 | | |
| 45526_g_at | NAT15 | N-acetyltransferase 15 | unknown | enzyme |
| | | (GCN5-related, putative) | | |
| 46256_at | SPSB3 | splA/ryanodine receptor | unknown | other |
| | | domain and SOCS box | | |
| | | containing 3 | | |
| 50376_at | ZNF444 | zinc finger protein 444 | Nucleus | transcription |
| | | | | regulator |
| 56829_at | TRAPPC9 | trafficking protein | Plasma | other |
| | | particle complex 9 | Membrane | |
| 61874_at | C9orf7 | chromosome 9 open | unknown | other |
| | | reading frame 7 | | |
| 64440_at | IL17RC | interleukin 17 receptor C | Plasma | other |
| | | | Membrane | |
| 64883_at | MOSPD2 | motile sperm domain | unknown | other |
| | | containing 2 | | |
| 74694_s_at | RABEP2 | rabaptin, RAB GTPase | Extracellular | growth factor |
| | | binding effector protein 2 | Space | |
| 77508_r_at | RABEP2 | rabaptin, RAB GTPase | Extracellular | growth factor |
| | | binding effector protein 2 | Space | |

Without further description, it is believed that one of ordinary skill in the art can, using the preceding description and illustrative examples, practice the invention including as claimed below.

All references cited herein are hereby incorporated by reference in their entireties and for all purposes.

1. A method for preparing a gene expression profile indicative of drug-sensitivity or drug-resistance, comprising:
extracting RNA from a patient tumor specimen or cells cultured therefrom, and
determining the level of expression for at least 10 genes listed in one of Tables 1-10, thereby preparing the gene expression profile.

2. The method of claim 1, wherein the tumor is derived from a tissue selected from breast, ovaries, lung, colon, skin, prostate, kidney, endometrium, nasopharynx, pancreas, head and neck, kidney, and brain.

3. (canceled)

4. (canceled)

5. The method of claim 1, wherein the tumor specimen is a breast tumor specimen, and the breast tumor specimen is optionally determined to be ER+ or ER−.

6. The method of claim 1, wherein the patient has primary cancer.

7. The method of claim 1, wherein the patient has recurrent cancer.

8. The method of claim 1, wherein the patient is a candidate for treatment with a combination selected from: cyclophosphamide, doxorubicin, fluorouracil, and paclitaxel (TFAC); cyclophosphamide and epirubicin (EC); fluorouracil, cyclophosphamide and doxrubicin (FAC); cyclophosphamide and doxorubicin (AC); cyclophosphamide, docetaxel, and doxorubicin (ACT), cyclophosphamide, docetaxel, epirubicin, and fluorouracil, (TFEC), docetaxel and fluorouracil (DX).

9. The method of claim 1, wherein the RNA is extracted from a tumor specimen.

10. The method of claim 9, wherein the tumor specimen is formalin-fixed and paraffin-embedded.

11. The method of claim 1, wherein the RNA is extracted from cultured cells derived from the tumor specimen.

12. (canceled)

13. (canceled)

14. The method of claim 1, wherein the levels of expression are determined by hybridizing nucleic acids to oligonucleotide probes, by RT-PCR, or by direct mRNA capture.

15. (canceled)

16. (canceled)

17. (canceled)

18. (canceled)

19. The method of claim 1, wherein the gene expression profile comprises the level of expression for at least about 100 genes listed in one of Tables 1-10.

20. The method of claim 1, wherein the gene expression profile comprises the level of expression for at least about 200 genes listed in one of Tables 1-10.

21-28. (canceled)

29. A method for evaluating the sensitivity of a tumor to one or a combination of chemotherapeutic agents, comprising:
preparing a gene expression profile for a tumor specimen according to claim 1; and
determining the presence of at least one gene expression signature indicative of drug-sensitivity or drug-resistance, thereby classifying the profile as a drug-sensitive or drug-resistant profile, wherein the gene signature is based on in vitro chemosensitivity of cell lines.

30. (canceled)

31. (canceled)

32. The method of claim 29, wherein the gene expression signature is predictive of efficacy for one or more of treatment with TFAC, EC, FEC, AC, ACT, TFEC, or DX.

33. The method of claim 29, wherein the gene expression profile is classified by using one or more of Principal Components Analysis, Naïve Bayes, Support Vector Machines, Nearest Neighbors, Decision Trees, Logistic, Artificial Neural Networks, and Rule-based schemes.

34. The method of claim 29, wherein the gene expression signature is predictive of survival, pathological complete response (pCR), reduction in tumor size, or duration of progression free interval upon treatment with a chemotherapeutic agent or combination.

35. (canceled)

36. A computer system for performing the method of claim 1.

37. A probe array or probe set for performing the method of claim 1.
